(19) United States
(12) Patent Application Publication
(10) Pub. No.: US 2005/0182025 A1
(43) Pub. Date: Aug. 18, 2005

(54) Amidinylphenyl compounds and their use as fungicides

(76) Inventor: Chi-Ping Tseng, Wilmington, DE (US)

Correspondence Address: E I du Pont de Nemours and Company, Legal - Patents, 4417 Lancaster Pike, Wilmington, DE, 19898, US

(21) Appl. No.: 10/510,083

(22) PCT Filed: Apr. 30, 2003
(86) PCT No.: PCT/US03/13371

Related U.S. Application Data
(60) Provisional application No. 60/380,095, filed on May 3, 2002.

(51) Int. Cl. A01N 55/00; A01N 43/40; A01N 33/02

(52) U.S. Cl. 514/63; 514/523; 514/553; 514/631; 514/357; 514/408; 514/565; 548/561; 546/330; 546/332; 556/410

(57) ABSTRACT

Compounds of the formula (R⁵)ₘ-(R⁶A)-2-(R⁴)-1-[N═C(R¹)N(R²)(R³)]benzene and their agriculturally suitable salts, are disclosed which are useful as fungicides, wherein R¹ is H, OH, SH, SO₃H, CN, —OR⁷ or —SR⁷; C₁-C₁₀ alkyl, C₂-C₁₀ alkenyl, C₂-C₅ alkoxycarbonyl, C₂-C₁₀ alkynyl, a C₃-C₆ carbocycle or a 3-, 4-, 5- or 6-membered heterocycle, each optionally substituted; provided that when R [symbol] 1? is a heterocycle containing nitrogen as a ring member, it is not attached to the remainder of Formula I through said nitrogen ring member; R⁶ is C₅-C₂₁ alkyl, C₅-C₂₁ alkenyl, C₅-C₂₁ alkynyl, C₄-C₉alkoxycarbonyl, C₄-C₆ alkylaminocarbonyl, C₃-C₁₀ dialkylaminocarbonyl or C₃-C₁₂ trialkylsilyl, each optionally substituted; or R⁶ is C₁-C₄ alkyl or C₂-C₉ alkylcarbonyl, each substituted with one or more R¹²; A is a direct bond, O, S(O)ₙ, or NR¹⁰; n is 0, 1 or 2; m is 0, 1, 2 or 3; and R², R³, R⁴, R⁵, R⁷, R¹⁰ and R¹² are as defined in the disclosure. Also disclosed are compositions containing the compounds of the formula (R⁵)ₘ-(R⁶A)-2-(R⁴)-1-[N═C(R¹)N(R²)(R³)]benzene and a method for controlling plant diseases caused by fungal plant pathogens which involves applying an effective amount of a compound of the formula (R⁵)ₘ-(R⁶A)-2-(R⁴)-1-[N═C(R¹)N(R²)(R³)]benzene.

### FIELD OF THE INVENTION

This invention relates to certain amidines, their agriculturally suitable salts and compositions, and methods of their use as fungicides.

### BACKGROUND OF THE INVENTION

The control of plant diseases caused by fungal plant pathogens is extremely important in achieving high crop efficiency. Plant disease damage to ornamental, vegetable, field, cereal, and fruit crops can cause significant reduction in productivity and thereby result in increased costs to the consumer. Many products are commercially available for these purposes. The need continues for new compounds which are more effective, less costly, less toxic, environmentally safer and/or have different modes of action.

WO 00/46184 discloses certain phenylamidines of formula i as fungicides 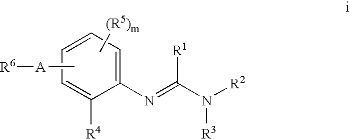
wherein,
A and R¹ through R⁵ are as defined therein; and
R⁶ is optionally substituted carbocyclyl or heterocyclyl.

Various amidinylphenyl compounds are also disclosed in U.S. Pat. No. 3,284,289, U.S. Pat. No. 3,993,469, U.S. Pat. No. 4,018,814, U.S. Pat. No. 4,154,755, U.S. Pat. No. 4,208,411, U.S. Pat. No. 4,209,319 and U.S. Pat. No. 5,219,868.

### SUMMARY OF THE INVENTION

This invention is directed to compounds of Formula I (including all geometric, tautomeric and stereoisomers) and agriculturally suitable salts thereof, agricultural compositions containing them and their use as fungicides: 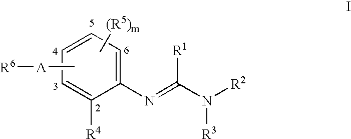
wherein
R¹ is H, OH, SH, SO₃H, CN, —OR⁷ or —SR⁷; C₁-C₁₀ alkyl, C₂-C₁₀ alkenyl, C₂-C₅ alkoxycarbonyl, C₂-C₁₀ alkynyl, a C₃-C₆ carbocycle or a 3-, 4-, 5- or 6-membered heterocycle, each optionally substituted; provided that when R¹ is a heterocycle containing nitrogen as a ring member, it is not attached to the remainder of Formula I through said nitrogen ring member,
R² is H, CN, —OR⁷, or —SR⁷; C₁-C₁₀ alkyl, C₂-C₁₀ alkenyl, C₂-C₁₀ alkynyl, C₃-C₆ carbocycle, a 3-, 4-, 5- or 6-membered heterocycle or C₂-C₁₀ alkylcarbonyl, each optionally substituted;
R³ is H; C₁-C₁₀ alkyl, C₂-C₁₀ alkenyl, C₂-C₁₀ alkynyl, a C₃-C₆ carbocycle, a 3-, 4-, 5- or 6-membered heterocycle or C₂-C₁₀ alkylcarbonyl, each optionally substituted; or
R² and R³ are taken together with their interconnecting nitrogen to form a heterocyclic ring containing 3 to 7 atoms, said ring consisting of said interconnecting nitrogen atom, carbon and optionally one or two additional atoms selected from the group consisting of nitrogen, sulfur and oxygen, and said ring being optionally substituted with one or more R⁹;
R⁴ and each R⁵ are each independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CHO, CO₂H, CONH₂, SF₅, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl;
R⁶ is C₅-C₂₁ alkyl, C₅-C₂₁ alkenyl, C₅-C₂₁ alkynyl, C₄-C₉ alkoxycarbonyl, C₄-C₆ alkylaminocarbonyl, C₃-C₁₀ dialkylaminocarbonyl or C₃-C₁₂ trialkylsilyl, each optionally substituted; or R⁶ is C₁-C₄ alkyl or C₂-C₉ alkylcarbonyl, each substituted with one or more R¹²;
A is a direct bond, O, S(O)ₙ or NR¹⁰;
each R⁷ is independently C₁-C₆ alkyl, C₂-C₆ alkenyl, C₂-C₆ alkynyl, a C₃-C₆ carbocycle or a 3-, 4-, 5- or 6-membered heterocycle, each optionally substituted;
each R⁹ is independently halogen, CN, NO₂, C₁-C₄ alkoxy, C₁-C₄ alkyl, C₁-C₄ haloalkoxy or C₁-C₄ alkylthio;
R¹⁰ is H, C₁-C₆ alkyl, C₂-C₆ alkenyl, C₂-C₆ alkynyl, C₁-C₄ alkylsulfonyl, C₁-C₄ haloalkylsulfonyl, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl;
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₃-C₁₀ alkylaminoalkylcarbonyl, C₃-C₈ dialkylaminocarbonyl, C₄-C₈ dialkylaminoalkylcarbonyl, C₃-C₉ alkylthioalkylcarbonyl, C₃-C₉ trialkylsilyl, C₃-C₉ halotrialkylsilyl, C₄-C₉ alkoxytrialkylsilyl or C₃-C₉ trialkylsilyloxy;
n is 0, 1 or 2; and
m is 0, 1, 2 or 3.

### DETAILS OF THE INVENTION

The compounds of Formula I as illustrated above can also be described as compounds of the formula (R⁵)ₘ(R⁶A)-2-(R⁴)-1-[(R¹)N(R²)(R³)]benzene, wherein R¹, R², R³, R⁴, R⁵, R⁶, A, m are as defined above.

In the above recitations, the term “alkyl”, used either alone or in compound words such as “alkylthio” or “haloalkyl” includes straight-chain or branched alkyl, such as, methyl, ethyl, n-propyl, i-propyl, or the different butyl, pentyl or hexyl isomers. “Alkenyl” includes straight-chain or branched alkenes such as ethenyl, 1-propenyl, 2-propenyl, and the different butenyl, pentenyl and hexenyl isomers. “Alkenyl” also includes polyenes such as 1,2-propadienyl and 2,4-hexadienyl. “Alkynyl” includes straight-chain or branched alkynes such as ethynyl, 1-propynyl, 2-propynyl and the different butynyl, pentynyl and hexynyl isomers. “Alkynyl” can also include moieties comprised of multiple triple bonds such as 2,5-hexadiynyl. “Alkoxy” includes, for example, methoxy, ethoxy, n-propyloxy, isopropyloxy and the different butoxy, pentoxy and hexyloxy isomers. “Alkoxyalkyl” denotes alkoxy substitution on alkyl. Examples of “alkoxyalkyl” include CH₃OCH₂, CH₃OCH₂CH₂, CH₃CH₂OCH₂, CH₃CH₂CH₂CH₂OCH₂ and CH₃CH₂OCH₂CH₂. “Alkoxyalkoxy” denotes alkoxy substitution on alkoxy. “Alkylthio” includes branched or straight-chain alkylthio moieties such as methylthio, ethylthio, and the different propylthio, butylthio, pentylthio and hexylthio isomers. “Alkylthioalkyl” denotes alkylthio substitution on alkyl. Examples of “alkylthioalkyl” include CH₃SCH₂, CH₃SCH₂CH₂, CH₃CH₂SCH₂, CH₃CH₂CH₂CH₂SCH₂ and CH₃CH₂SCH₂CH₂. “Alkylthioalkoxy” denotes alkylthio substitution on alkoxy. “Alkylsulfinyl” includes both enantiomers of an alkylsulfinyl group. Examples of “alkylsulfinyl” include CH₃S(O), CH₃CH₂S(O), CH₃CH₂CH₂S(O), (CH₃)₂CHS(O) and the different butylsulfinyl, pentylsulfinyl and hexylsulfinyl isomers. Examples of “alkylsulfonyl” include CH₃S(O)₂, CH₃CH₂S(O)₂, CH₃CH₂CH₂S(O)₂, (CH₃)₂CHS(O)₂ and the different butylsulfonyl, pentylsulfonyl and hexylsulfonyl isomers. “Alkylamino”, “dialkylamino”, and the like, are defined analogously to the above examples.

The term “carbocycle” includes “aromatic carbocyclic ring system”, which denotes fully aromatic carbocycles and carbocycles in which at least one ring of a polycyclic ring system is aromatic (where aromatic indicates that the Hückel rule is satisfied), and “nonaromatic carbocyclic ring system”, which denotes fully saturated carbocycles as well as partially or fully unsaturated carbocycles where the Hückel rule is not satisfied by any of the rings in the ring system. “Cycloalkyl” includes, for example, cyclopropyl, cyclobutyl, cyclopentyl, and cyclohexyl.

The term “hetero” in connection with rings refers to a ring in which at least one ring atom is not carbon and which can contain 1 to 4 heteroatoms independently selected from the group consisting of nitrogen, oxygen and sulfur, provided that each ring contains no more than 4 nitrogens, no more than 2 oxygens and no more than 2 sulfurs. “Heterocycle” includes “aromatic heterocyclic ring system”, which denotes fully aromatic heterocycles and heterocycles in which at least one ring of a polycyclic ring system is aromatic (where aromatic indicates that the Hückel rule is satisfied), and “nonaromatic heterocyclic ring system”, which denotes fully saturated heterocycles as well as partially or fully unsaturated heterocycles where the Hückel rule is not satisfied by any of the rings in the ring system. The heterocyclic ring systems can be attached through any available carbon or nitrogen by replacement of a hydrogen on said carbon or nitrogen.

The term “halogen”, either alone or in compound words such as “haloalkyl”, includes fluorine, chlorine, bromine or iodine. Further, when used in compound words such as “haloalkyl”, said alkyl may be partially or fully substituted with halogen atoms which may be the same or different. Examples of “haloalkyl” include F₃C, ClCH₂, CF₃CH₂ and CF₃CCl₂. The terms “haloalkenyl”, “haloalkynyl”, “haloalkoxy”, “haloalkylthio”, and the like, are defined analogously to the term “haloalkyl”. Examples of “haloalkenyl” include (Cl)₂C═CHCH₂ and CF₃CH₂CH═CHCH₂. Examples of “haloalkynyl” include HC≡CCHCl, CF₃C≡C, CCl₃C≡C and FCH₂C≡CCH₂. Examples of “haloalkoxy” include CF₃O, CCl₃CH₂O, HCF₂CH₂CH₂O and CF₃CH₂O. Examples of “haloalkylthio” include CCl₃S, CF₃S, CCl₃CH₂S and ClCH₂CH₂CH₂S. Examples of “haloalkylsulfinyl” include CF₃S(O), CCl₃S(O), CF₃CH₂S(O) and CF₃CF₂S(O). Examples of “haloalkylsulfonyl” include CF₃S(O)₂, CCl₃S(O)₂, CF₃CH₂S(O)₂ and CF₃CF₂S(O)₂.

“Trialkylsilyl” includes 3 branched and/or straight-chain alkyl radicals attached to and linked through a silicon atom such as trimethylsilyl, triethylsilyl and t-butyl-dimethylsilyl. “Halotrialkylsilyl” denotes at least one of the three alkyl radicals is partially or fully substituted with halogen atoms which may be the same or different “Alkoxytrialkylsilyl” denotes at least one of the three alkyl radicals is substituted with one or more alkoxy radicals which may be the same or different. “Trialkylsilyloxy” denotes a trialkylsilyl moiety attached through oxygen.

Examples of “alkylcarbonyl” include C(O)CH₃, C(O)CH₂CH₂CH₃ and C(O)CH(CH₃)₂. Examples of “alkoxycarbonyl” include CH₃C(═O), CH₃CH₂C(═O), CH₃CH₂CH₂C(═O), (CH₃)₂CHOC(═O) and the different butoxy- or pentoxycarbonyl isomers. Examples of “alkylaminocarbonyl” include CH₃NHC(═O), CH₃CH₂NHC(═O), CH₃CH₂CH₂NHC(═O), (CH₃)₂CHNHC(═O) and the different butylamino- or pentylaminocarbonyl isomers. Examples of “dialkylaminocarbonyl” include (CH₃)₂NC(═O), (CH₃CH₂)₂NC(═O), CH₃CH₂(CH₃)NC(═O), CH₃CH₂CH₂(CH₃)NC(═O) and (CH₃)₂CHN(CH3)C(═O). Examples of “alkoxyalkylcarbonyl” include CH₃OCH₂C(═O), CH₃OCH₂CH₂C(═O), CH₃CH₂OCH₂C(═O), CH₃CH₂CH₂CH₂OCH₂C(═O) and CH₃CH₂OCH₂CH₂C(═O). Examples of “alkylthioalkylcarbonyl” include CH₃SCH₂C(═O), CH₃SCH₂CH₂C(═O), CH₃CH₂SCH₂C(═O), CH₃CH₂CH₂CH₂SCH₂C(═O) and CH₃CH₂SCH₂CH₂C(═O). Examples of “alkylaminoalkylcarbonyl” include CH₃NHCH₂C(═O), CH₃NHCH₂CH₂C(═O), CH₃CH₂NHCH₂C(═O), CH₃CH₂CH₂CH₂NHCH₂C(═O) and CH₃CH₂NHCH₂CH₂C(═O).

The total number of carbon atoms in a substituent group is indicated by the “Cᵢ-Cⱼ” prefix where i and j are numbers from 1 to 21. For example, C₁-C₃ alkylsulfonyl designates methylsulfonyl through propylsulfonyl; C₂ alkoxyalkyl designates CH₃OCH₂; C₃ alkoxyalkyl designates, for example, CH₃CH(OCH₃), CH₃OCH₂CH₂ or CH₃CH₂OCH₂; and C₄ alkoxyalkyl designates the various isomers of an alkyl group substituted with an alkoxy group containing a total of four carbon atoms, examples including CH₃CH₂CH₂OCH₂ and CH₃CH₂OCH₂CH₂. In the above recitations, when a compound of Formula I is comprised of one or more heterocyclic rings, all substituents are attached to these rings through any available carbon or nitrogen by replacement of a hydrogen on said carbon or nitrogen.

When a compound is substituted with a substituent bearing a subscript that indicates the number of said substituents can exceed 1, said substituents (when they exceed 1) are independently selected from the group of defined substituents. Further, when the subscript indicates a range, e.g. (R)ᵢ₋ⱼ, then the number of substituents may be selected from the integers between i and j inclusive.

When a group contains a substituent which can be hydrogen, for example R¹ or R², then, when this substituent is taken as hydrogen, it is recognized that this is equivalent to said group being unsubstituted.

Compounds of this invention can exist as one or more stereoisomers. The various stereoisomers include enantiomers, diastereomers, atropisomers and geometric isomers. One skilled in the art will appreciate that one stereoisomer may be more active and/or may exhibit beneficial effects when enriched relative to the other stereoisomer(s) or when separated from the other stereoisomer(s). Additionally, the skilled artisan knows how to separate, enrich, and/or to selectively prepare said stereoisomers. Accordingly, the present invention comprises compounds selected from Formula I, N-oxides and agriculturally suitable salts thereof. The compounds of the invention may be present as a mixture of stereoisomers, individual stereoisomers, or as an optically active form.

One skilled in the art will appreciate that not all nitrogen-containing heterocycles can form N-oxides since the nitrogen requires an available lone pair for oxidation to the oxide; one skilled in the art will recognize those nitrogen-containing heterocycles which can form N-oxides. One skilled in the art will also recognize that tertiary amines can form N-oxides. Synthetic methods for the preparation of N-oxides of heterocycles and tertiary amines are very well known by one skilled in the art including the oxidation of heterocycles and tertiary amines with peroxy acids such as peracetic and m-chloroperbenzoic acid (MCPBA), hydrogen peroxide, alkyl hydroperoxides such as t-butyl hydroperoxide, sodium perborate, and dioxiranes such as dimethydioxirane. These methods for the preparation of N-oxides have been extensively described and reviewed in the literature, see for example: T. L. Gilchrist in Comprehensive Organic Synthesis, vol. 7, pp 748-750, S. V. Ley, Ed., Pergamon Press; M. Tisler and B. Stanovnik in Comprehensive Heterocyclic Chemistry, vol. 3, pp 18-20, A. J. Boulton and A. McKillop, Eds., Pergamon Press; M. R. Grimmett and B. R. T. Keene in Advances in Heterocyclic Chemistry, vol. 43, pp 149-161, A. R. Katritzky, Ed., Academic Press; M. Tisler and B. Stanovnik in Advances in Heterocyclic Chemistry, vol. 9, pp 285-291, A. R. Katritzky and A. J. Boulton, Eds., Academic Press; and G. W. H. Cheeseman and E. S. G. Werstiuk in Advances in Heterocyclic Chemistry, vol. 22, pp 390-392, A. R. Katritzky and A. J. Boulton, Eds., Academic Press.

The salts of the compounds of the invention include acid-addition salts with inorganic or organic acids such as hydrobromic, hydrochloric, nitric, phosphoric, sulfuric, acetic, butyric, fumaric, lactic, maleic, malonic, oxalic, propionic, salicylic, tartaric, 4-toluenesulfonic or valeric acids. The salts of the compounds of the invention also include those formed with organic bases (e.g., pyridine, ammonia, or triethylamine) or inorganic bases (e.g., hydrides, hydroxides, or carbonates of sodium, potassium, lithium, calcium, magnesium or barium) when the compound contains an acidic group such as a carboxylic acid or phenol.

Of note are compounds of Formula I wherein
R¹ is H, OH, SH, SO₃H, CN, —OR⁷ or —SR⁷; C₁-C₁₀ alkyl, C₂-C₁₀ alkenyl, C₂-C₁₀ alkynyl, a C₃-C₆ carbocycle or a 3-, 4-, 5- or 6-membered heterocycle, each optionally substituted; provided that when R¹ is a heterocycle containing nitrogen as a ring member, it is not attached to the remainder of Formula I through said nitrogen ring member;
R⁴ and each R⁵ are each independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CO₂H, CONH₂, SF₅, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl; and
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₃-C₈ dialkylaminoalkylcarbonyl, C₃-C₉ alkylthioalkylcarbonyl, C₃-C₉ trialkylsilyl or C₃-C₉ trialkylsilyloxy.

Preferred compounds for reasons of cost, ease of synthesis and/or biological efficacy are:

Preferred 1. Compounds of Formula I above, and agriculturally suitable salts thereof, wherein
R¹ is H, SH, SO₃H, CN, —OR⁷ or —SR⁷; C₁-C₁₀ alkyl, C₂-C₁₀ alkenyl or C₂-C₁₀ alkynyl, each optionally substituted with one or more R⁸; or a C₃-C₆ carbocycle or a 3-, 4-, 5- or 6-membered heterocycle, each optionally substituted with one or more R⁹;
R² is H, CN, —OR⁷ or —SR⁷; C₁-C₁₀ alkyl, C₂-C₁₀ alkenyl, C₂-C₁₀ alkynyl or C₂-C₁₀ alkylcarbonyl, each optionally substituted with one or more R⁸; or a C₃-C₆ carbocycle or a 3-, 4-, 5- or 6-membered heterocycle, each optionally substituted with one or more R⁹;
R³ is H; C₁-C₁₀ alkyl, C₂-C₁₀ alkenyl, C₂-C₁₀ alkynyl or C₂-C₁₀ alkylcarbonyl, each optionally substituted with one or more R⁸; or a C₃-C₆ carbocycle or a 3-, 4-, 5- or 6-membered heterocycle, each optionally substituted with one or more R⁹; or
R² and R³ are taken together with their interconnecting nitrogen to form a heterocyclic ring containing 3 to 6 atoms, said ring consisting of said interconnecting nitrogen atom, carbon and optionally one or two additional atoms selected from the group consisting of nitrogen, sulfur and oxygen, and said ring being optionally substituted with one or more R⁹;
R⁶ is C₅-C₂₁ alkyl, C₅-C₂₁ alkenyl, C₅-C₂₁ alkynyl, C₄-C₉ alkoxycarbonyl, C₄-C₆ alkylaminocarbonyl, C₃-C₁₀ dialkylaminocarbonyl or C₃-C₁₂ trialkylsilyl, each optionally substituted with one or more R¹¹; or R⁶ is C₁-C₄ alkyl or C₂-C₉ alkylcarbonyl, each substituted with one or more R¹²;
each R⁷ is independently C₁-C₆ alkyl, C₂-C₆ alkenyl, C₂-C₆ alkynyl, each optionally substituted with one or more R⁸; or a C₃-C₆ carbocycle or a 3-, 4-, 5- or 6-membered heterocycle, each optionally substituted with one or more R⁹;
each R⁸ is independently halogen, CN, NO₂, C₁-C₄ alkoxy, C₁-C₄ haloalkoxy or C₁-C₄ alkylthio; and
each R¹¹ is independently halogen, CO₂H, CONH₂, NO₂, hydroxy, C₁-C₆ alkoxy, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₄-C₈ dialkylaminoalkylcarbonyl, C₃-C₉ alkylthioalkylcarbonyl, C₂-C₈ dialkylphosphoryl, C₂-C₈ dialkylphosphinyl, C₃-C₉ trialkylsilyl or C₃-C₉ trialkylsilyloxy.

Of note are compounds of Preferred I wherein
R² is H, CN, —OR⁷ or —SR⁷; C₁-C₁₀ alkyl, C₂-C₁₀ alkenyl, C₂-C₁₀ alkynyl or C₂-C₁₀ alkylcarbonyl, each optionally substituted with one or more R⁸; or a C₃-C₆ carbocycle or a 3-, 4-, 5- or 6-membered heterocycle, each optionally substituted with one or more R⁹;
R³ is H; C₁-C₁₀ alkyl, C₂-C₁₀ alkenyl, C₂-C₁₀ alkynyl or C₂-C₁₀ alkylcarbonyl, each optionally substituted with one or more R⁸; or a C₃-C₆ carbocycle or a 3-, 4-, 5- or 6-membered heterocycle, each optionally substituted with one or more R⁹;
R⁴ and each R⁵ are each independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CO₂H, CONH₂, SF₅, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl; and
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₃-C₈ dialkylaminoalkylcarbonyl, C₃-C₉ alkylthioalkylcarbonyl, C₃-C₉ trialkylsilyl or C₃-C₉ trialkylsilyloxy.

Preferred 2. Compounds of Preferred 1 wherein
R² is H, CN, —OR⁷ or —SR⁷; C₁-C₁₀ alkyl, C₂-C₁₀ alkenyl, C₂-C₁₀ alkynyl, each optionally substituted with one or more R⁸; or phenyl optionally substituted with 1 to 3 R⁹;
R³ is H; C₁-C₁₀ alkyl, C₂-C₁₀ alkenyl or C₂-C₁₀ alkynyl, each optionally substituted with one or more R⁸; or phenyl optionally substituted with 1 to 3 R⁹; or
R² and R³ are taken together with their interconnecting nitrogen to form a heterocyclic ring containing 3 to 6 atoms, said ring consisting of said interconnecting nitrogen atom, carbon and optionally one additional atom selected from the group consisting of nitrogen, sulfur and oxygen, and said ring being optionally substituted with one or more R⁹;
R⁴ and R⁵ are each independently C₁-C₆ alkyl, C₂-C₆ alkenyl, C₂-C₆ alkynyl, C₁-C₆ haloalkyl, halogen, CO₂H, CONH₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₆ alkylcarbonyl, C₂-C₆ alkoxycarbonyl, C₂-C₆ alkylaminocarbonyl CN, CHO or C₃-C₈ dialkylaminocarbonyl;
R⁶ is C₅-C₁₅ alkyl, C₅-C₁₅ alkenyl or C₅-C₁₅ alkynyl, each optionally substituted with one or more R¹¹; or R⁶ is C₁-C₄ alkyl substituted with one or more R¹²;
each R⁷ is independently C₁-C₆ alkyl, optionally substituted with one or more R⁸;
A is a direct bond, O or S(O)ₙ; and
m is 0, 1 or 2.

Preferred 2a. Compound of Preferred 2 wherein R¹ is H, SH or C₁-C₁₀ alkyl.

Of note are compounds of Preferred 2 wherein
R¹ and R² are each independently H, CN, —OR⁷ or —SR⁷; C₁-C₁₀ alkyl, C₂-C₁₀ alkenyl, C₂-C₁ alkynyl, each optionally substituted with one or more R⁸; or phenyl optionally substituted with 1 to 3 R⁹;
R³ is H; C₁-C₁₀ alkyl, C₂-C₁₀ alkenyl or C₂-C₁₀ alkynyl, each optionally substituted with one or more R⁸; or phenyl optionally substituted with 1 to 3 R⁹;
R⁴ and R⁵ are each independently C₁-C₆ alkyl, C—C₆ alkenyl, C₂-C₆ alkynyl, C₁-C₆ haloalkyl, halogen, CO₂H, CONH₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₆ alkylcarbonyl, C₁-C₆ alkoxycarbonyl, C₁-C₆ alkylaminocarbonyl or C₂-C₈ dialkylaminocarbonyl; and
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₃-C₈ dialkylaminoalkylcarbonyl, C₃-C₉ alkylthioalkylcarbonyl, C₃-C₉ trialkylsilyl or C₃-C₉ trialkylsilyloxy.

Preferred 3. Compounds of Preferred 2 wherein
A is attached to the remainder of Formula I at the 4 position of the benzene ring.

Preferred 3a. Compounds of Preferred 3 wherein R¹ is H, SH or C₁-C₁₀ alkyl.

Of note are compounds of Preferred 3 wherein
R¹ and R² are each independently H, CN, —OR⁷ or —SR⁷; C₁-C₁₀ alkyl, C₂-C₁₀ alkenyl, C₂-C₁₀ alkynyl, each optionally substituted with one or more R⁸; or phenyl optionally substituted with 1 to 3 R⁹;
R³ is H; C₁-C₁₀ alkyl, C₂-C₁₀ alkenyl or C₂-C₁₀ alkynyl, each optionally substituted with one or more R⁸; or phenyl optionally substituted with 1 to 3 R⁹;
R⁴ and R⁵ are each independently C₁-C₆ alkyl, C₂-C₆ alkenyl, C₂-C₆ alkynyl, C₁-C₆ haloalkyl, halogen, CO₂H, CONH₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₆ alkylcarbonyl, C₁-C₆ alkoxycarbonyl, C₁-C₆ alkylaminocarbonyl or C₂-C₈ dialkylaminocarbonyl; and
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₃-C₈ dialkylaminoalkylcarbonyl, C₃-C₉ alkylthioalkylcarbonyl, C₃-C₉ trialkylsilyl or C₃-C₉ trialkylsilyloxy.

Preferred 4. Compounds of Preferred 3 wherein
R¹ is H, SH or C₁-C₁₀ alkyl;
R² and R³ are each independently H or C₁-C₁₀ alkyl; or
R² and R³ are taken together with their interconnecting nitrogen to form a heterocyclic ring containing 3 to 6 atoms, said ring consisting of said interconnecting nitrogen atom, carbon and optionally one additional atom selected from the group consisting of nitrogen, sulfur and oxygen, and said ring being optionally substituted with one or more R⁹;
R⁴ and R⁵ are each independently halogen, CN, CHO, C₁-C₆ alkyl, C₁-C₄ alkoxy, C₁-C₄ haloalkoxy, C₁-C₄ alkylthio, C₁-C₄ alkylsulfinyl, C₁-C₄ haloalkylthio, C₁-C₄ haloalkylsulfinyl or C₁-C₆ haloalkyl;
One R⁵ is attached to the remainder of Formula I at the 5 position of the benzene ring and an optional second R⁵ is attached at the 6 position of the benzene ring; and
m is 1 or 2.

Preferred 4a Compounds of Preferred 4 wherein
R¹, R² and R³ are each independently H or C₁-C₁₀ alkyl;
R⁴ and R⁵ are each independently, halogen, C₁-C₆ alkyl or C₁-C₆ haloalkyl;
R⁵ is attached to the remainder of Formula I at the 5 position of the benzene ring;
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₃-C₈ dialkylaminoalkylcarbonyl, C₃-C₉ alkylthioalkylcarbonyl, C₃-C₉ trialkylsilyl or C₃-C₉ trialkylsilyloxy; and
m is 1.

Of note are compounds of Formula I (including but not limited to compounds of Preferred 1, Preferred 2, Preferred 2a, Preferred 3, Preferred 3a, Preferred 4 and Preferred 4a) wherein R⁶ is alkyl, optionally substituted with halogen or C₁-C₆ alkoxy. Also of note are compounds of Formula I (including but not limited to compounds of Preferred 1, Preferred 2, Preferred 2a, Preferred 3, Preferred 3a, Preferred 4 and Preferred 4a) wherein R⁶ is alkenyl, optionally substituted with halogen. Examples include compounds wherein R⁶ is selected from the group consisting of (a) the branched alkyl moieties CH(CH₃)(CH₂)₃CH₃, CH(CH₃)(CH₂)₄CH₃, CH(CH₃)(CH₂)₅CH₃, CH(CH₃)(CH₂)₆CH₃, CH(CH₃)(CH₂)₇CH₃, CH(CH₃)(CH₂)₈CH₃, CH(C₂H₅)(CH₂)₃CH₃, CH(C₂H₅)(CH₂)₄CH₃, CH₂CH(CH₃)(CH₂)₂CH₃, CH₂CH(CH₃)(CH₂)₄CH₃, CH₂CH(C₂H₅)CH₂CH₂CH₂CH₃, (CH₂)₂CH(CH₃)(CH₂)₃CH(CH₃)₂, (CH₂)₂CH(CH₃)CH₂C(CH₃)₃, (CH₂)₂CH(CH₃)(CH₂)₃C(CH₃)₃, (CH₂)₂C(CH₃)₃, (CH₂)₃C(CH₃)₃, (CH₂)₃C(C₂H₅)₃, (CH₂)₃CH(C₂H₅)₃, (CH₂)₃CH(CH₃)₂, (CH₂)₄CH(CH₃)₂, (CH₂)₅CH(CH₃)₂, CH(CH₂CH₂CH₂CH₃)₂, CH(CH₂CH₂CH₃)(CH₂)₃CH₃, CH(CH₂CH₂CH₂CH₂CH₃)₂, CH(C₂H₅)CH₂CH₂CH(CH₃)₂, CH(CH₃)CH₂CH₂CH(CH₃)₂, CH(CH₃)CH₂CH₂C(CH₃)₃, CH(CH₂CH₂CH₃)CH₂CH₂CH(CH₃)₂, CH(CH₂CH₂CH(CH₃)₂)₂, CH(CH₂CH₂CH₃)₂ and CH(CH₂CH₂CH₂CH₃)(CH₂)₅CH₃, (b) the linear alkyl moieties (CH₂)₄CH₃, (CH₂)₅CH₃, (CH₂)₆CH₃, (CH₂)₇CH₃, (CH₂)₈CH₃, (CH₂)₉CH₃, (CH₂)₁₀CH₃, (c) the branched alkenyl moieties (CH₂)₂CH═C(CH₃)₂, (CH₂)₅C(CH₃)═CH₂, (CH₂)₆C(CH₃)═CH₂, (CH₂)₇C(CH₃)═CH₂, CH₂CH═C(CH₃)₂, CH₂CH═C(CH₃)(CH₂)₂CH═C(CH₃)₂, CH₂(CH═C(CH₃)(CH₂)₂)₂CH═C(CH₃)₂, (CH₂)₃C(═CH₂)CH(CH₃)₂, CH₂CH═CHCH(CH₃)₂, CH₂CH═CHCH₂CH(CH₃)₂, CH₂CH═CHC(CH₃)₃ and CH₂CH═CHCH₂C(CH₃)₃ and (d) the linear alkenyl moieties (CH₂)₃CH═CH₂, (CH₂)₄CH═CH₂, (CH₂)₅CH═CH₂, (CH₂)₆CH═CH₂, (CH₂)₇CH═CH₂, (CH₂)₈CH═CH₂ and (CH₂)₉CH═CH₂. Examples further include such compounds wherein R⁶ is selected from said alkyl and alkenyl moieties (a), (b), (c) and (d) wherein at least one hydrogen has been replaced by halogen (e.g., compounds wherein R⁶ is selected from said alkyl moieties wherein a CH₃ group has been replaced by a CF₃ group; and compounds wherein R⁶ is selected from said alkenyl moieties wherein a=CH₂ group has been replaced by a=CF₂ group). Examples also include such compounds wherein R⁶ is selected from said alkyl moieties (a) and (b) wherein at least one hydrogen has been replaced by OCH₃, OC₂H₅, OCH(CH₃)₂ or OC(CH₃)₃.

Of particular note are compounds of Formula I (including but not limited to compounds of Preferred 1, Preferred 2, Preferred 2a, Preferred 3, Preferred 3a, Preferred 4 and Preferred 4a) wherein R⁶ is selected from the group consisting of (CH₂)₃C(CH₃)₂OCH₃, (CH₂)₃C(CH₃)₂OC₂H₅, (CH₂)₃C(CH₃)₂OCH(CH₃)₂, (CH₂)₃C(CH₃)₂OC(CH₃)₃, (CH₂)₃C(CH₃)₂F, (CH₂)₃C(CH₃)₂Cl and (CH₂)₃C(CH₃)₂Br.

Preferred 5. Compounds of Preferred 4 wherein
R¹ is H; and
R⁶ is C₆-C₁₅ alkyl wherein at least one of the fourth and fifth carbon from A has one or no hydrogen attached or C₅-C₁₅ 2-alkenyl wherein the fourth or fifth carbon from A has one or no hydrogen attached (In other words, R⁶ is branched at the fourth and/or fifth carbon).

Preferred 5a. Compounds of Preferred 5 wherein R², R³, R⁴ and R⁵ are each methyl and m is 1.

Preferred 5b. Compounds of Preferred 5 wherein R² and R³ are each independently methyl or ethyl.

Of note are compounds of Formula I (including but not limited to compounds of Preferred 1, Preferred 2, Preferred 2a, Preferred 3, Preferred 3a, Preferred 4, Preferred 4a, Preferred 5, Preferred 5a and Preferred 5b) wherein R⁶ is selected from the group consisting of (a) the alkyl moieties (CH₂)₂CH(CH₃)CH₂C(CH₃)₃, (CH₂)₃CH(CH₃)₂, CH(C₂H₅)CH₂CH₂CH(CH₃)₂, CH(CH₃)CH₂CH₂CH(CH₃)₂, CH(CH₂CH₂CH₃)CH₂CH₂CH(CH₃)₂ and CH(CH₂CH₂CH(CH₃)₂)₂ and (b) the alkenyl moieties CH₂CH═CHCH(CH₃)₂, CH₂CH═CHCH₂CH(CH₃)₂, CH₂CH═CHC(CH₃)₃ and CH₂CH═CHCH₂C(CH₃)₃. Also of note are compounds of Formula I (including but not limited to compounds of Preferred 1, Preferred 2, Preferred 2a, Preferred 3, Preferred 3a, Preferred 4, Preferred 4a, Preferred 5, Preferred 5a and Preferred 5b) wherein R⁶ is (CH₂)₃C(CH₃)₃ or CH(CH₃)CH₂CH₂C(CH₃)₃,

Preferred 6. Compounds of Preferred 4 wherein
R¹ is H; and
R⁶ is C₁-C₄ alkyl substituted with one or more substituents selected from the group consisting of C₂-C₆ alkylthio, C₁-C₆ alkylsulfinyl, C₂-C₆ alkoxycarbonyl, C₂-C₈ dialkylamino, C₂-C₆ alkylcarbonyl, C₃-C₉ alkoxyalkylcarbonyl, C₂-C₆ alkylaminocarbonyl, C₃-C₈ dialkylaminocarbonyl, C₃-C₉ trialkylsilyl, C₃-C₉ halotrialkylsilyl, C₄-C₉ alkoxytrialkylsilyl or C₃-C₉ trialkylsilyloxy.

Preferred 6a. Compounds of Preferred 6 wherein
R², R³, R⁴ and R⁵ are each methyl; and
R⁶ is C₁-C₄ alkyl substituted with one or more substituents selected from the group consisting of C₂-C₆ alkylthio, C₁-C₆ alkylsulfinyl, C₂-C₆ alkoxycarbonyl, C₂-C₈ dialkylamino, C₂-C₆ alkylcarbonyl, C₃-C₉ alkoxyalkylcarbonyl, C₂-C₆ alkylaminocarbonyl, C₃-C₈ dialkylaminocarbonyl, C₃-C₉ trialkylsilyl or C₃-C₉ trialkylsilyloxy.

Preferred 6b. Compounds of Preferred 6 wherein R² and R³ are each methyl or ethyl.

Of note are compounds of Formula I (including but not limited to compounds of Preferred 1, Preferred 2, Preferred 2a, Preferred 3, Preferred 3a, Preferred 4, Preferred 4a, Preferred 5, Preferred 5a, Preferred 5b, Preferred 6, Preferred 6a and Preferred 6b) wherein R⁶ is alkyltrialkylsilyl. Also of note are compounds of Formula I (including but not limited to compounds of Preferred 1, Preferred 2, Preferred 2a, Preferred 3, Preferred 3a, Preferred 4, Preferred 4a, Preferred 5, Preferred 5a, Preferred 5b, Preferred 6, Preferred 6a and Preferred 6b) wherein R⁶ is alkyltrialkylsilyloxy. Examples include compounds wherein R⁶ is selected from the group consisting of (e) the alkyltrialkylsilyl moieties CH₂Si(CH₃)₃, CH₂CH₂Si(CH₃)₃, CH₂CH₂CH₂Si(CH₃)₃, CH₂CH₂CH₂CH₂Si(CH₃)₃, CH₂Si(C₂H₅)₃, CH₂CH₂Si(C₂H₅)₃, CH₂CH₂CH₂Si(CH₃)₂(C₂H₅), CH₂CH₂CH₂Si(C₂H₅)₃, CH₂CH₂CH₂CH₂Si(C₂H₅)₃, CH₂Si(CH(CH₃)₂)₃, CH₂CH₂Si(CH(CH₃)₂)₃, CH₂CH₂CH₂Si(CH(CH₃)₂)₃, CH₂CH₂CH₂CH₂Si(CH(CH₃)₂)₃, CH₂Si(CH₃)₂C(CH₃)₃, CH₂CH₂Si(CH₃)₂C(CH₃)₃, CH₂CH₂CH₂Si(CH₃)₂C(CH₃)₃ and CH₂CH₂CH₂CH₂Si(CH₃)₂C(CH₃)₃ and (f) the alkyltrialkylsilyloxy moieties CH₂OSi(CH₃)₃, CH₂CH₂OSi(CH₃)₃, CH₂CH₂CH₂OSi(CH₃)₃, CH₂CH₂CH₂CH₂OSi(CH₃)₃, CH₂OSi(CH₂H₅)₃, CH₂CH₂OSi(C₂H₅)₃, CH₂CH₂CH₂OSi(C₂H₅)₃, CH₂CH₂CH₂CH₂OSi(C₂H₅)₃, CH₂OSi(CH(CH₃)₂)₃, CH₂CH₂OSi(CH(CH₃)₂)₃, CH₂CH₂CH₂OSi(CH(CH₃)₂)₃, CH₂CH₂CH₂CH₂OSi(CH(CH₃)₂)₃, CH₂OSi(CH₃)₂C(CH₃)₃, CH₂CH₂OSi(CH₃)₂C(CH₃)₃, CH₂CH₂CH₂OSi(CH₃)₂C(CH₃)₃ and CH₂CH₂CH₂CH₂OSi(CH₃)₂C(CH₃)₃.

This invention also relates to fungicidal compositions comprising fungicidally effective amounts of the compounds of the invention and at least one additional component selected from the group consisting surfactants, solid diluents and liquid diluents. The preferred compositions of the present invention are those which comprise the above preferred compounds.

This invention also relates to a method for controlling plant diseases caused by fungal plant pathogens comprising applying to the plant or portion thereof, or to the plant seed or seedling, a fungicidally effective amount of the compounds of the invention (e.g., as a composition described herein). The preferred methods of use are those involving the above preferred compounds.

The compounds of Formula I can be prepared by one or more of the following methods and variations as described in Schemes 1-9. The definitions of R¹ to R¹², A, m and n in the compounds of Formulae 1-13 below are as defined above in the Summary of the Invention and Details of the Invention unless otherwise stated. Compounds of Formulae Ia-Ig are various subsets of the compounds of Formula I, and all substituents for Formulae Ia-Ig are as defined above for Formula I unless otherwise stated.

As illustrated in Scheme 1, compounds of Formula Ia can be prepared from anilines of Formula 1. There are a variety of methods for this transformation. The following four methods are especially useful. 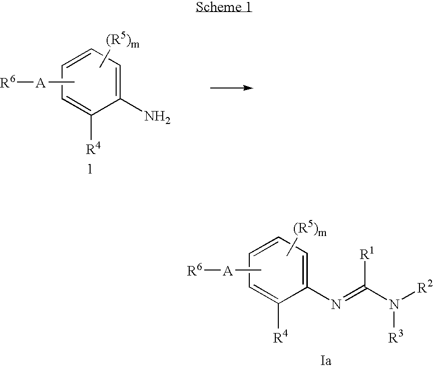
wherein R¹ is H; C₁-C₁₀ alkyl, C₂-C₁₀ alkenyl, C₂-C₁₀ alkynyl, C₂-C₅ alkoxycarbonyl, a C₃-C₆ carbocycle or C₃-C₆ heterocycle.

Method 1: Treatment of an aniline of Formula 1 with an acetal of formula R²R³NC(R¹)(OR¹³)₂, wherein R¹³ is an alkyl. For a leading reference to this method see, Toste et al, Synth. Commun. 1994, 24(11), 1617-1624.

Method 2: Treatment of an aniline of Formula 1 with an amide of formula R¹C(═O)NR²R³ in the presence of a halogenating reagent such as, but not limited to, POCl₃ or SOCl₂. For a leading reference to this method see, Bergman et al, Tetrahedron, 1990, 46(17), 6058-6112.

Method 3: Treatment of an aniline of Formula 1 with an orthoester of formula R¹C(OR¹³)₃, wherein R¹³ is alkyl, to form a corresponding iminoether followed by heating the iminoether with an amine of formula HNR²R³. For a leading reference to this method see, Pissiotas et al, U.S. Pat. No. 4,209,319.

Method 4: Treatment of an aniline of Formula 1 with phosgene to form an isocyanate followed by reaction of the isocyanate with an amide of formula R¹C(═O)NR²R³. For a leading reference to this method see, Charles et al, WO 00/46184.

Method 5: Treatment of an aniline of Formula 1 with C₂H₅OCH═NCN to form an N-cyanoamidine followed by reaction of the N-cyanoamidine with an amine of formula HNR²R³. For a leading reference to this method see, Charles et al, WO 00/46184.

Compounds of Formula Ib, can be prepared by the method outlined in Scheme 2. Treatment of a compound of Formula I with 4,5-dichloro-1,2,3-dithiazolium chloride (Formula 2) affords the corresponding 4-chloro-5-(phenylimino)-5H-1,2,3-dithiazole (Formula 3). Reaction of the said dithiazole with an amine of Formula 4 in a suitable organic solvent such as, but not limited to, dichloromethane at room temperature provides the compound of Formula Ib. For a leading reference to this method see, Lee et al, J. Org. Chem., 1993, 58(25), 7001-7008.

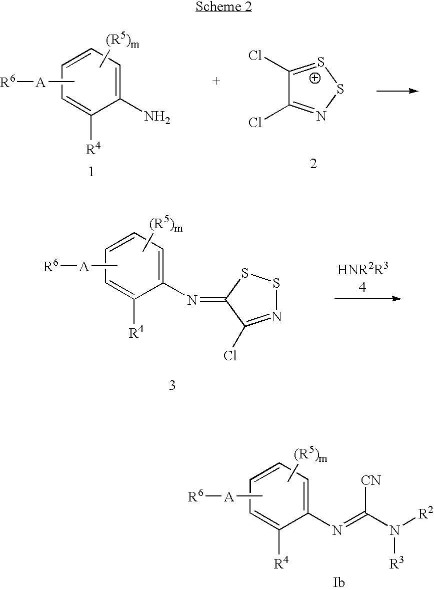

Compounds of Formula Ic, can be prepared by the method outlined in Scheme 3. Reaction of an aniline of Formula 1 with a carbamoyl chloride of Formula 5 provides the urea of Formula Ig. The urea of Formula Ig is then O-alkylated to form the compound of Formula Ic by contact with an alkylating agent of Formula 7 (R⁷X) in the presence of a base. In the alkylating agent of Formula 7, X is a nucleophilic reaction leaving group such as halogen (e.g., Br, 1), OS(O)₂CH₃ (methanesulfonate), OS(O)₂CF₃, OS(O)₂Ph-p-CH₃ (p-toluenesulfonate), and the like. The suitable bases can be, for example but not limited to, potassium carbonate (K₂CO₃) or silver oxide (Ag₂O). For a leading reference to this method see, Curtis et al, Aust. J. Chem., 1988, 41(4), 585-595. 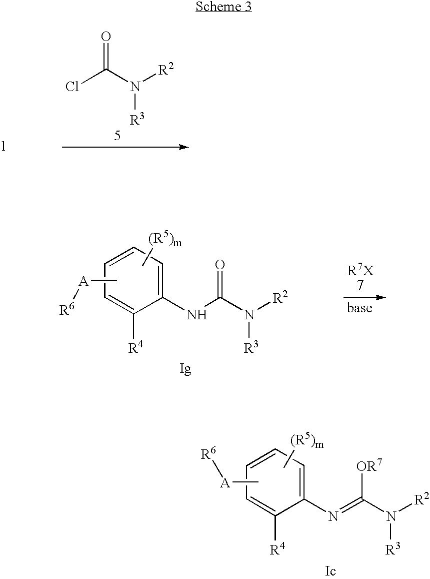
wherein X is a leaving group.

Compounds of Formula Id, can be prepared by the method outlined in Scheme 4. Treatment of an aniline of Formula 1 with thiophosgene (or its equivalent) provides the corresponding isothiocyanate. The isothiocyanate is then reacted with an amine of Formula 4 to afford the thiourea of Formula Ih. The thiourea of Formula Ih is then alkylated to give the compound of Formula Id by contact with an alkylating agent of Formula 7 (R⁷X). The suitable bases can be, for example but not limited to, potassium hydroxide. For a leading reference to this method see, Filop et al, Tetrahedron, 1985, 41(24), 5981-5988. 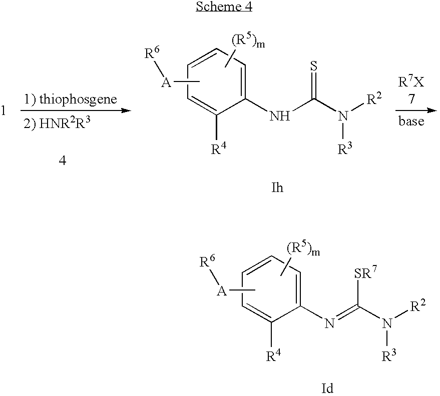
wherein X is a leaving group.

Of note is that R² and R³ groups in compounds of Formula I can be converted to other R² and R³ groups as defined above, by treatment with an appropriate amine or by acylation or alkylation when R² or R³ is hydrogen.

As illustrated in Scheme 5, a compound of Formula I can also be prepared by alkylation of a compound of Formula 8 with an alkylating agent of Formula 9 in the presence of a base. Compounds of Formula 8 are known compounds or can be prepared by literature procedures (J. Med. Chem., 1984, 27(12), 1705-10; EP 94052 and WO 00/46184). In the alkylating agent of Formula 9, X is a nucleophilic reaction leaving group as defined above for Formula 7. The reaction is conducted in the presence of at least one equivalent of a base, preferably from 1 to 2 equivalents. Suitable bases include inorganic bases, such as alkali metal (such as lithium, sodium or potassium) hydrides, carbonates and hydroxides, and organic bases, such as triethylamine, diisopropylethylamine and 1,8-diazabicyclo-[5.4.0]undec-7-ene. The reaction is generally conducted in a solvent, which can comprise aromatic solvents such as benzene and toluene, ethers such as tetrahydrofuran and diethyl ether, and polar aprotic solvents such as acetonitrile, N,N-dimethylformamide, and the like. The reaction is generally conducted between about −20 and 150° C., and preferably between 20 and 140° C. The reaction time can range from 1 hour to 7 days. The compound of Formula I can be isolated by conventional techniques such as extraction. Further experimental details for the method of Scheme 5 are illustrated in Example 1. 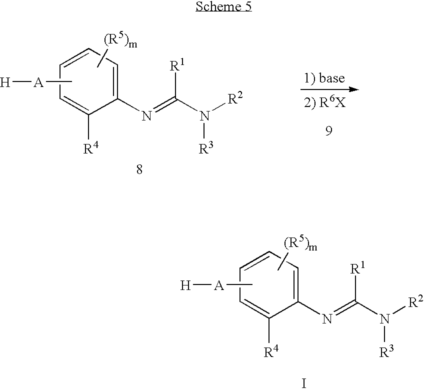
wherein A is O, S or NR¹⁰; and X is a nucleophilic reaction leaving group.

In addition, reductive amination of a compound of Formula 8, wherein A is NH, in the presence of an aldehyde or a ketone can also provide the compound of Formula I, wherein R⁶ is an optionally substituted alkyl group. Reaction conditions for the reductive amination are taught in J. Med. Chem., 1984, 17(12), 1705-1710, and references cited within.

As an alternative to the method illustrated in Scheme 3, compounds of Formula Ic can also be prepared by the method outlined in Scheme 6. Heating a phenyl isocyanide dichloride of Formula 10 with an amine of Formula 4 provides the corresponding imidoyl intermediate. Treatment of the imidoyl intermediate with an alcohol of Formula 11 in the presence of an inert base such as, but not limited to, triethylamine, gives the compound of Formula Ic. For references to this method see, Filop et al, Izv. Akad. Nauk SSSR, Ser. Khim., 1989, (11), 2596-2601, and references cited within. The phenyl isocyanide dichloride of Formula 10 can be prepared by literature procedures (J. Chem. Soc., Perkin Trans. 1, 1987, (5), 1069-1076; Tetrahedron Leu., 1982, 23(35), 3539-3542; Chem. Ber., 1987, 120(3), 421-424).

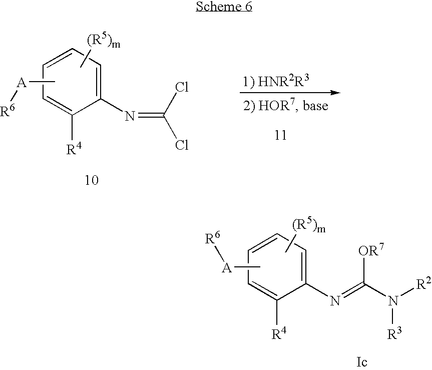

Compounds of Formula If can be prepared by oxidation of compounds of Formula Ie as illustrated in Scheme 7. The oxidizing agent can be peracetic acid, hydrogen peroxide, potassium permanganate, sodium periodate or 3-chloroperoxybenzoic acid. The solvent can be, for example but not limited to, dichloromethane, acetic acid or water. Detailed conditions for this method can be found in J. Med. Chem., 1996, 39(26), 5072-5082, J. Med. Chem., 1983, 26(1), 107-110, and references cited within. 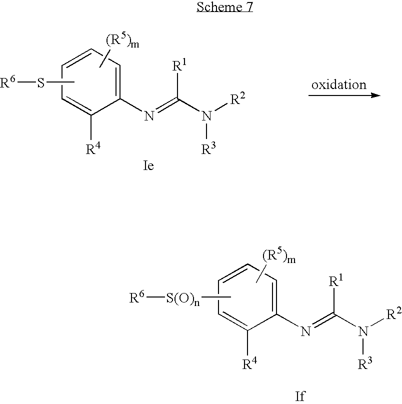
wherein n is 1 or 2.

Compounds of Formula 1 can be prepared by reduction of the nitro group in compounds of Formula 12. There are many methods for this reduction reaction. Preferred methods include stannous chloride reduction in concentrated hydrochloric acid (J. Med. Chem., 1984, 24(12), 1705-1710) and iron powder reduction in a solution of acetic acid and water (J. Org. Chem., 2001, 66(13), 4563-4575).

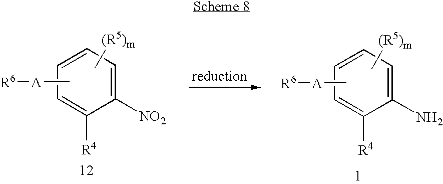

As illustrated in Scheme 9, compounds of Formula 12 can be prepared by alkylation of compounds of Formula 13 with an alkylating agent of Formula 9 in the presence of a base. The reaction conditions for this alkylation are already described for the conversion of the compounds of Formula 8 to the compounds of Formula I in Scheme 5. Compounds of Formula 13 are known compounds or can be prepared by literature procedures (Can. J. Chem., 1984, 62(8), 1446-51; Aust. J. Chem., 1991, 44(1), 151-6). 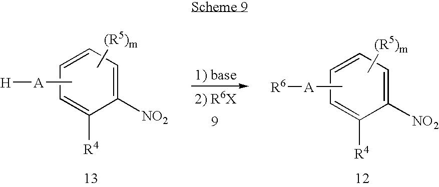
wherein A is O, S or NR¹⁰; and X is a nucleophilic reaction leaving group.

Alternatively, compounds of Formula 12, wherein A is O, S or NR¹⁰ and R⁶ is an optionally substituted alkyl group, can also be prepared from compounds of Formula 13 through a Mitsunobu reaction, which involves reaction of a compound of Formula 13 with the appropriate alcohol R⁶OH. The general reaction conditions of Mitsunobu Reaction is well documented in the chemical literature. For a review of the Mitsunobu Reaction see Hughes, Org. React., 1992, 42, 335-656 and references cited within.

Compounds of Formula 12, wherein A is a direct bond, are available by a variety of known methods. One skilled in art can prepare the compounds of Formula 12 by methods extensively described in the literature; see for example: Synth. Commun., 2001, 31(14), 2113-2117; Synth. Commun., 1999, 29(12), 2169-2174; J. Chem. Res., Synop., 1998, (8), 410, 1701-1714; J. Chem. Soc., Perkin Trans. 1, 1998, (12), 1903-1912; Synthesis, 1982 (10), 836-9; J. Org. Chem., 1977, 42(24), 3907-9.

It is recognized that some reagents and reaction conditions described above for preparing compounds of Formula I may not be compatible with certain functionalities present in the intermediates. In these instances, the incorporation of protection/deprotection sequences or functional group interconversions into the synthesis will aid in obtaining the desired products. The use and choice of the protecting groups will be apparent to one skilled in chemical synthesis (see, for example, Greene, T. W.; Wuts, P. G. M. Protective Groups in Organic Synthesis, 2nd ed.; Wiley: New York, 1991). One skilled in the art will recognize that, in some cases, after the introduction of a given reagent as it is depicted in any individual scheme, it may be necessary to perform additional routine synthetic steps not described in detail to complete the synthesis of compounds of Formula I. One skilled in the art will also recognize that it may be necessary to perform a combination of the steps illustrated in the above schemes in an order other than that implied by the particular sequence presented to prepare the compounds of Formula I.

One skilled in the art will also recognize that compounds of Formula I and the intermediates described herein can be subjected to various electrophilic, nucleophilic, radical, organometallic, oxidation, and reduction reactions to add substituents or modify existing substituents.

Without further elaboration, it is believed that one skilled in the art using the preceding description can utilize the present invention to its fullest extent. The following Examples are, therefore, to be construed as merely illustrative, and not limiting of the disclosure in any way whatsoever. Percentages are by weight except for chromatographic solvent mixtures or where otherwise indicated. Parts and percentages for chromatographic solvent mixtures are by volume unless otherwise indicated. ¹H NMR spectra are reported in ppm downfield from tetramethylsilane; s=singlet, d=doublet, t=triplet, q=quartet, m=multiplet, dd=doublet of doublets, dt=doublet of triplets, br s=broad singlet.

### EXAMPLE 1

### Preparation of N′-[2,5-Dimethyl-4-[(3-methyl-2-butenyl)-oxy]phenyl]-N,N-dimethylmethanimidamide

The title compound was prepared from N′-(4-hydroxy-2,5-dimethylphenyl)-N,N-dimethylmethanimidamide (prepared as described in WO00/46184). To a suspension of N′-(4-hydroxy-2,5-dimethylphenyl)-N,N-dimethylmethanimidamide (0.77 g, 4 mmol) in tetrahydrofuran (34 mL) under nitrogen at room temperature was added 60% sodium hydride in mineral oil (170 mg, 4.25 mmol). The mixture was then stirred at room temperature for about 45 minutes followed by addition of 4-bromo-2-methyl-2-butene (0.72 g, 4.8 mmol). The resulting reaction mixture was stirred at room temperature for 2 days and then poured into diethyl ether (250 mL). The organic layer was then washed with 1N aqueous sodium hydroxide solution (2×200 mL). The organic layer was then dried over MgSO₄ and filtered. The filtrate was concentrated to give the title compound (1.02 g), a compound of the present invention, as a brown oil.

¹H NMR (CDCl₃): δ 1.72 (s,3H), 1.78 (s,3H), 2.17 (s,3H), 2.24 (s,3H), 2.99 (s,6H), 4.46 (d,2H), 5.5 (t,1H), 6.55 (s,1H), 6.66 (s,1H), 7.38 (s,1H).

### EXAMPLE 2

### Preparation of N′-[2,5-Dimethyl-4-[(4-methylpentyl)oxy]-phenyl]-N,N-dimethylmethanimidamide

To a suspension of N′-(4-hydroxy-2,5-dimethylphenyl)-N,N-dimethyl-methanimidamide (0.52 g, 2.7 mmol) in tetrahydrofuran (10 mL) under nitrogen at room temperature was added 60% sodium hydride in mineral oil (120 mg, 3 mmol). After the addition, the mixture was stirred at room temperature for 30 minutes, and 1-bromo-4-methylpentane (0.55 g, 3.3 mmol) was added. The resulting reaction mixture was heated at reflux for 24 hours, cooled to room temperature and stirred at room temperature overnight. The reaction mixture was then poured into diethyl ether (100 mL). The organic layer was washed with 1N aqueous sodium hydroxide solution (3×100 mL), dried over MgSO₄ and filtered. The filtrate was concentrated to give the title compound (0.7 g), a compound of this invention, as an oil.

¹H NMR (CDCl₃): δ 0.91 (d,6H), 1.28-1.82 (m,5H), 2.16 (s,3H), 2.23 (s,3H), 2.98 (s,6H), 3.89 (t,2H), 6.54 (s,1H), 6.63 (s,1H), 7.37 (s,1H).

### EXAMPLE 3

### Preparation of N′-[2,5-Dimethyl-4-[3-(trimethylsilyl)propoxy]phenyl]-N,N-dimethylmethanimidamide

To a suspension of N′-(4-hydroxy-2,5-diethylphenyl)-N,N-dimethylmethanimidamide (0.52 g, 2.7 mmol) in p-dioxane (10 mL) under nitrogen at room temperature was added 60% sodium hydride in mineral oil (120 mg, 3 mmol). After the addition, the mixture was stirred at room temperature for 21 minutes, and (3-chloropropyl)trimethylsilane (0.5 g, 3.3 mmol) was added. The resulting reaction mixture was heated at reflux for 4 days and then cooled to room temperature. The reaction mixture was poured into diethyl ether (100 mL). The organic layer was washed with 1N aqueous sodium hydroxide solution (3×100 mL). The organic layer was then dried over MgSO₄ and filtered. The filtrate was concentrated and then dried in a vacuum oven at 90° C. overnight to give the title compound (0.16 g), a compound of this invention, as an oil.

¹H NMR (CDCl₃): δ 0.02 (t,9H), 0.6 (m,2H), 1.7-1.82 (m,2H), 2.17 (s,3H), 2.23 (s,3H), 2.98 (s,6H), 3.87 (t,2H), 6.54 (s,1H), 6.62 (s,1H), 7.38 (s,1H).

### EXAMPLE 4

### Preparation of N′-[4-[(1-Butylpentyl)oxy]-2,5-dimethylphenyl-N,N-dimethylmethanimidamide

### Step A: Preparation of 1-[(1-Butylpentyl)oxy]-2,5-dimethyl-4-nitrobenzene

Diisopropyl azodicarboxylate (0.570 g, 2.82 mmol) was added to the solution of triphenylphosphine (0.739 g, 2.82 mmol) in tetrahydrofuran (15 mL) at 0° C. dropwise. The mixture was stirred at the 0° C. for additional 30 minutes. A mixture of 2,5-dimethyl-4-nitrophenol (0.315 g, 1.9 mmol) and 5-nonanol (0.288 g, 2 mmol) in tetrahydrofuran (10 mL) was added dropwise to the above cold solution. Then the reaction mixture was stirred at 0° C. for 30 min and at room temperature for 1 hour. Tetrahydrofuran was removed under reduced pressure, and the residue was triturated with hexane (100 mL) and filtered. The precipitate was washed with hexane (50 mL). Hexane was removed under reduced pressure, and the residue was purified by column chromatography eluted with dichloromethane to give the title compound (0.4 g) as an oil.

¹H NMR (CDCl₃): δ 0.9 (t,6H), 1.2-1.4 (m,8H), 1.6-1.7 (m,4H), 2.15 (s,3H), 2.6 (s,3H), 4.35 (m,H), 6.6 (s,1H), 7.9 (s,1H).

### Step B: Preparation of 1-[(1-Butylpentyl)oxy]-2,5-dimethyl-4-benzenamine

1-[(1-Butylpentyl)oxy]-2,5-dimethylnitroberzene (i.e. the product from Step A) (0.4 g, 1.39 mmol) was reduced by catalytic hydrogenation using palladium charcoal catalyst (10 wt %, 0.2 g) in ethanol (20 mL) at 40 psi (276 KPa) hydrogen pressure above ambient for 8 hours. The catalyst was removed by filtration, and the filtrate was concentrated under reduced pressure. The residue was purified by column chromatography eluted with dichloromethane to give the title compound (0.35 g) as an oil.

¹H NMR (CDCl₃): δ 0.9 (t,6H), 1.2-1.4 (m,8H), 1.6-1.7 (m,4H), 2.15 (s,6H), 3.25 (m, 2H), 4.0 (m,1H), 6.42 (s,1H), 6.5 (s,1H).

### Step C: Preparation of N′-[4-[(1-Butylpentyl)oxy]-2,5-dimethylphenyl]-N,N-dimethylmethanimidamide

Dimethylformamide dimethyl acetal (5 mL) was added to 1-[(1-butylpentyl)oxy]-2,5-dimethyl-4-benzenamine (i.e. the product from Step B) (350 mg) under argon, and the mixture was heated to 100° C. for two hours. The reaction mixture was cooled to room temperature and partitioned between ether (50 mL) and water (50 mL). The organic layer was washed sequentially with water (50 mL) and brine, dried (Na₂SO₄), filtered and concentrated to give the title compound (300 mg), a compound of this invention, as a reddish oil.

¹H NMR (CDCl₃): δ 0.9 (t,6H), 1.2-1.4 (m,8H), 1.5-1.7 (m,4H), 2.15 (s,3H), 2.2 (s,3H), 3.0 (s,6H), 4.1 (m,H), 6.5 (s,1H), 6.6 (s,1H), 7.4 (s,1H).

### EXAMPLE 5

### Preparation of N′-[5-Chloro-2-methyl-4-[3-(trimethylsilyl)propoxy]phenyl]-N-ethyl-N-methylmethanimidamide

### Step A: Preparation of [3-(2-Chloro-5-methyl-4-nitrophenoxy)propyl]trimethylsilane

Diisopropyl azodicarboxylate (2.3 mL, 11.68 mmol), 3-trimethylsilylpropanol (1.41 g, 10.66 mmole), 2-chloro-5-methyl-4-nitrophenol (2.0 g, 10.64 mmol) and triphenylphosphine (3.24 g, 12.35 mmol) were added to tetrahydrofuran (55 mL) at −10° C. The mixture was then warmed up to room temperature and stirred at room temperature overnight. Tetrahydrofuran was removed under reduced pressure, and the residue was purified by column chromatography (silica gel; eluted with a solution of 5% ethyl acetate in hexanes) to give the title compound (2.68 g) as an yellow solid, mp 66-68° C.

¹H NMR (CDCl₃): δ 0.04 (s,9H), 0.64 (m,2H), 1.86 (m,2H), 2.64 (s,3H), 4.05 (t,2H), 6.76 (s,1H), 8.17 (s,1H).

### Step B: Preparation of 5-Chloro-2-methyl-4-[3-(trimethylsilyl)propoxy]benzenamine

To a mixture of [3-(2-chloro-5-methyl-4-nitrophenoxy)propyl]trimethylsilane (i.e. the product from Step A) (3.5 g, 11.6 mmol) and methanol (16 mL) at room temperature was added concentrated hydrochloric acid (16 mL) and tin(II) chloride (6.64 g, 35.02 mmol) with stirring. The reaction mixture was heated to reflux for 4 hours. Dichloromethane (320 mL) was added to the reaction mixture after it was cooled down to room temperature. The mixture was washed with 4 N sodium hydroxide aqueous solution (110 mL) followed by brine (3×320 mL). The organic layer was separated, dried over MgSO₄, and concentrated to give the title compound (2.97 g) as an oil.

¹H NMR (CDCl₃): δ 0.02 (s,9H), 0.61 (m,2H), 1.76 (m,2H), 2.13 (s,3H), 3.4 (br s,2H), 3.89 (t,2H), 6.69 (s,1H), 6.7 (s,1H).

### Step C: Preparation of N-[5-Chloro-2-methyl-4-[3-(trimethylsilyl]propoxy]phenyl]-N-cyanomethanimidamide

To a solution of N-cyanomethanimidic ethyl ester (1.21 g, 12.35 mmol) in ethanol (16 mL) at room temperature was added dropwise a solution of 5-chloro-2-methyl-4-[3-(trimethylsilyl)propoxy]benzenamine (i.e. the product from Step B) (2.93 g, 10.77 mmol) in ethanol (16 mL). After the addition, the reaction mixture was stirred at room temperature overnight and was then concentrated under reduced pressure. The residue was triturated in a solution of 25% ethyl acetate in hexanes, and the solid was collected by filtration to give the title compound (2.4 g) as an off-white solid, mp 143-144° C.

¹H NMR (CDCl₃): δ 0.03 (s,9H), 0.62 (m,2H), 1.82 (m,2H), 2.28 (m,3H), 3.96 (m,2H), 6.78-8.35 (m,3H).

### Step D: Preparation of N′-[5-Chloro-2-methyl-4-[3-(trimethylsilyl)propoxy]phenyl]-N-ethyl-N-methylmethanimidamide

To a suspension of N-[5-chloro-2-methyl-4-[3-(trimethylsilyl)propoxy]phenyl]-N′-cyanomethanimidamide (i.e. the product from Step C) (174 mg, 0.54 mmol) in acetonitrile (4 mL) at room temperature was added N-ethylmethylamine (0.23 mL, 2.68 mmol) dropwise. After the addition, the reaction mixture was stirred at room temperature overnight. Ether (40 mL) was then added to the reaction mixture. The resulting mixture was washed with water (40 mL) and then brine (40 mL). The organic layer was separated, dried over MgSO₄, and concentrated to give the title compound (160 mg), a compound of the present invention, as an oil.

¹H NMR (CDCl₃): δ 0.02 (s,9H), 0.6 (m,2H), 1.2 (t,3H), 1.8 (m,2H), 2.23 (s,3H), 2.98 (s,3H), 3.35 (br s, 2H), 3.93 (t,2H), 6.74 (s,1H), 6.77 (s,1H), 7.4 (s,1H).

### EXAMPLE 6

### Preparation of N′-[5-Chloro-2-methyl-4-[3-(trimethylsilyl)propoxy]phenyl]-N-ethyl-N-methylthiourea

### Step A: Preparation of [3-(2-Chloro-4-isothiocyanato-5-methylphenoxy)propyl]-trimethylsilane

To a solution of 5-chloro-2-methyl-4-[3-(trimethylsilyl)propoxy]benzenamine (i.e. the product of Example 5, Step B) (1.63 g, 6 mmol) in toluene (50 mL) at 25° C. was added diethylcarbamyl chloride (1.2 g, 7.8 mmol) followed by N,N-diisopropylethylamine (1.1 g, 9 mmol). The resulting homogeneous solution was heated to the reflux for 3 h. The solvent was evaporated, and the residue was chromatographed on flash silica gel using ethyl acetate/hexane (1:40) as eluent to give the title compound (1.19 g) as a pale yellow semi-solid.

¹H NMR (CDCl₃): δ 0.00 (s, 9H), 0.60 (m, 2H), 1.80 (m, 2H) 2.40 (s, 3H), 3.85 (t, 2H), 6.60 (s, 1H), 7.00 (s, 1H).

### Step B: Preparation of N′-[5-Chloro-2-methyl-4-[3-(trimethylsilyl)propoxy]phenyl]-N-ethyl-N-methylthiourea

To a solution of [3-(2-chloro-4-isothiocyanato-5-methylphenoxy)propyl]-trimethylsilane (i.e. the product from Step A) (310 mg, 1 mmol) in tetrahydrofuran (10 mL) at 25° C. was added N-ethylmethylamine (1 g, 17 mmol). The reaction solution was stirred at 25° C. for 30 minutes. The solvent was then evaporated, and hexane was added to the residue to induce crystallization. The solid was collected by filtration and washed with a solution of ether/hexane (1:5) (20 mL) to give the title compound (255 mg), a compound of the present invention, as an off-white solid, mp 71-72° C.

¹H NMR (CDCl₃): δ 0.00 (s, 9H), 0.60 (m, 2H), 1.25 (t, 3H), 1.80 (m, 2H) 2.20, (s, 3H), 3.20 (s, 3H), 3.85 (q, 2H), 3.90 (t, 2H), 6.70 (br s, 1H), 6.75 (s, 1H), 7.15 (s, 1H).

### EXAMPLE 7

### Preparation of N′-[5-Chloro-2-(methylthio)-4-[3-(trimethylsilyl)propoxy]phenyl]-N-cyclopropyl-N-methylmethanimidamide

### Step A: Preparation of [3-(2,5-Dichloro-4-nitrophenoxy)propyl]trimethylsilane

Diisopropyl azodicarboxylate (10.4 mL, 53 mmol), 3-trimethylsilylpropanol (6.4 g, 48 mmol), 2,5-dichloro-4-nitrophenol (10.0 g, 48 mmol) and triphenylphosphine (12.6 g, 48 mmol) were added to tetrahydrofuran (100 mL) at −10° C. The mixture was then warmed up to room temperature overnight. Tetrahydrofuran was removed under reduced pressure, and the residue was triturated with hexanes (200 mL). The solid was filtered off. The filtrate was then concentrated, and the residue was purified by silica gel column chromatography eluted with hexanes followed 2% ethyl acetate in hexanes to give the title compound (13.5 g) as a yellow solid, mp 45-48° C.

¹H NMR (CDCl₃): δ 0.05 (s,9H), 0.65 (m,2H), 1.89 (m,2H), 4.07 (t,2H), 7.00 (s,1H), 8.12 (s,1H).

### Step B: Preparation of [3-[2-Chloro-5-(methylthio)-4-nitrophenoxy]propyl]trimethylsilane

To a solution of [3-(2,5-dichloro-4-nitrophenoxy)propyl]trimethylsilane (4.6 g, 14.3 mmol) (i.e. the product from Step A) in N,N-dimethylformamide (40 mL) was added sodium thiomethoxide (1.3 g, 18.6 mmol) at room temperature. The reaction mixture was heated to 100° C. for 2 days. The reaction mixture was then partitioned between ether (100 mL) and water (150 mL). The organic layer was washed with water (3×50 mL), separated, dried over MgSO₄, filtered and concentrated. The residue was purified by silica gel column chromatography using hexanes/butyl chloride (3:1) as eluent to give the title compound (2.7 g) as an orange solid, mp 51-53° C.

¹H NMR (CDCl₃): δ 0.05 (s,9H), 0.65 (m,2H), 1.89 (m,2H), 2.49 (s,3H), 4.09 (t,2H), 6.69 (s,1H), 8.35 (s,1H).

### Step C: Preparation of 5-Chloro-2-(meth lthio)-4-[3-(trimethylsilyl)propoxy]benzenamine

To a solution of [3-[2-chloro-5-(methylthio)-4-nitrophenoxy]propyl]trimethylsilane (i.e. the product from Step B) (2.7 g, 8.91 mmol) in methanol (5 mL) and concentrated hydrochloric acid (5 mL) was added tin(II) chloride (5.1 g, 26.7 mmol). The reaction mixture was heated to reflux for 4 hours. The reaction mixture was cooled to room temperature, and the methanol solvent was removed under reduced pressure. The reaction mixture was partitioned between dichloromethane (−50 mL) and 4 N aqueous sodium hydroxide solution (4×50 mL). The organic layer was separated, dried over MgSO₄, and concentrated to give the title compound (2.0 g) as a brown oil.

¹H NMR (CDCl₃): δ 0.02 (s,9H), 0.61 (m,2H), 1.78 (m,2H), 2.35 (s,3H), 3.92 (t,2H), 4.04 (br s, 2H), 6.78 (s,1H), 6.98 (s,1H).

### Step D: Preparation of N-[5-Chloro-2-(methylthio)-4-[3-(trimethylsilyl)propoxy]phenyl]-N′-cyanomethanimidamide

To a solution of N-cyanomethanimidic ethyl ester (0.84 g, 8.6 mmol) in ethanol (5 mL) at room temperature was added to a solution of 5-chloro-2-(methylthio)-4-[3-(trimethylsilyl)propoxy]benzenamine (i.e. the product from Step C) (2.0 g, 6.6 mmol) in ethanol (10 mL) dropwise. After the addition, the reaction mixture was stirred at room temperature for 2 days and then concentrated under reduced pressure. The residue was purified by silica gel column chromatography using ethyl acetate/hexanes (1:2) as eluent to give the title compound (1.8 g) as an orange solid, mp 94-96° C.

¹H NMR (CDCl₃): δ 0.03 (s,9H), 0.62 (m,2H), 1.84 (m,2H), 2.39 (m,3H), 3.96 (t,2H), 6.97-8.37 (m,3H).

### Step E: Preparation of N′-[5-Chloro-2-(methylthio)-4-[3-(trimethylsilyl)propoxy]phenyl]-N-cyclopropyl-N-methylmethanimidamide

To a suspension of N-[5-chloro-2-(methylthio)-4-[3-(trimethylsilyl)propoxy]phenyl]-N′-cyanomethanimidamide (i.e. the product from Step D) (200 mg, 0.56 mmol) in acetonitrile (5 mL) at room temperature was added dropwise a solution of N-cyclopropylmethylamine in ether (7.6 mL, 0.74 M, 5.6 mmol). After the addition, the reaction mixture was stirred at room temperature overnight. The reaction mixture was then concentrated under reduced pressure, and the residue was purified by silica gel column chromatography using ethyl acetate/hexanes (1:2) as eluent to give the title compound (120 mg), a compound of the present invention, as a tan solid, mp 62-64 C.

¹H NMR (CDCl₃): δ 0.02 (s,9H), 0.6-0.8 (m,6H), 1.82 (m,2H), 2.4 (s,3H), 2.7 (m,1H), 3.23 (s,3H), 3.96 (t,2H), 6.69 (s,1H), 6.79 (s,1H), 7.64 (s,1H).

By the procedures described herein together with methods known in the art, the following compounds of Tables 1 to 13 can be prepared. The following abbreviations are used in the Tables which follow: t means tertiary, s means secondary, n means normal, i means iso, c means cyclo, Pr means propyl, i-Pr means isopropyl, c-Pr means cyclopropyl, Bu means butyl, and CN means cyano.

TABLE 1

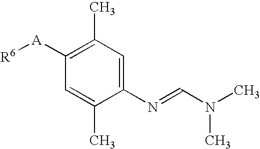

| A | R⁶ | A | R⁶ |
|---|---|---|---|
| O | (CH₂)₄CH₃ | S | (CH₂)₄CH₃ |
| O | (CH₂)₃C(CH₃)₂OC₂H₅ | S | (CH₂)₃C(CH₃)₂OC₂H₅ |
| O | (CH₂)₅CH₃ | S | (CH₂)₅CH₃ |
| O | (CH₂)₆CH₃ | S | (CH₂)₆CH₃ |
| O | (CH₂)₃C(CH₃)₂Br | S | (CH₂)₃C(CH₃)₂Br |
| O | (CH₂)₇CH₃ | S | (CH₂)₇CH₃ |
| O | (CH₂)₃CH(CH₃)₂ | S | (CH₂)₃CH(CH₃)₂ |
| O | (CH₂)₃C(CH₃)₃ | S | (CH₂)₃C(CH₃)₃ |
| O | (CH₂)₃Si(CH₃)₃ | S | (CH₂)₃Si(CH₃)₃ |
| O | (CH₂)₂CH(CH₃)CH₂C(CH₃)₃ | S | (CH₂)₂CH(CH₃)CH₂C(CH₃)₃ |
| O | (CH₂)₃C(═CH₂)CH(CH₃)₂ | S | (CH₂)₃C(═CH₂)CH(CH₃)₂ |
| O | (CH₂)₃CH(CH₃)C₂H₅ | S | (CH₂)₃CH(CH₃)C₂H₅ |
| O | (CH₂)₂OSi(CH₃)₂C(CH₃)₃ | S | (CH₂)₂OSi(CH₃)₂C(CH₃)₃ |
| O | (CH₂)₂OC(CH₃)₃ | S | (CH₂)₂OC(CH₃)₃ |
| O | (CH₂)₂SC(CH₃)₃ | S | (CH₂)₂SC(CH₃)₃ |
| O | (CH₂)₂SCH(CH₃)₂ | S | (CH₂)₂SCH(CH₃)₂ |
| O | CH₂CH═CHC(CH₃)₃ | S | CH₂CH═CHC(CH₃)₃ |
| O | CH₂CH═CHCH(CH₃)₂ | S | CH₂CH═CHCH(CH₃)₂ |
| O | (CH₂)₂S(═O)C(CH₃)₃ | S | (CH₂)₂S(═O)C(CH₃)₃ |
| O | (CH₂)₃OSi(CH₃)₂C(CH₃)₃ | S | (CH₂)₃OSi(CH₃)₂C(CH₃)₃ |
| O | (CH₂)₂OCH(CH₃)₂ | S | (CH₂)₂OCH(CH₃)₂ |
| O | (CH₂)₃OC(CH₃)₃ | S | (CH₂)₃OC(CH₃)₃ |
| O | (CH₂)₃P(═O)(CH₃)₂ | S | (CH₂)₃P(═O)(CH₃)₂ |
| O | CH₂C(═O)CH₂C(CH₃)₃ | S | CH₂C(═O)CH₂C(CH₃)₃ |
| O | CH(CH₃)(CH₂)₃CH₃ | S | CH(CH₃)(CH₂)₃CH₃ |
| O | CH(CH₃)CH₂CH₂CH(CH₃)₂ | S | CH(CH₃)CH₂CH₂CH(CH₃)₂ |
| O | CH(CH₃)CH₂CH₂C(CH₃)₃ | S | CH(CH₃)CH₂CH₂C(CH₃)₃ |
| O | CH(C₂H₅)CH₂CH₂CH(CH₃)₂ | S | CH(C₂H₅)CH₂CH₂CH(CH₃)₂ |
| O | CH(CH₂CH₂CH₃)CH₂CH₂CH(CH₃)₂ | S | CH(CH₂CH₂CH₃)CH₂CH₂CH(CH₃)₂ |
| O | CH(CH₂CH₂CH(CH₃)₂)₂ | S | CH(CH₂CH₂CH(CH₃)₂)₂ |
| O | CH₂CH₂CH₂N(CH₃)₂ | S | CH₂CH₂CH₂N(CH₃)₂ |
| O | CH₂CH₂N(CH₃)C(CH₃)₃ | S | CH₂CH₂N(CH₃)C(CH₃)₃ |
| O | CH₂CH₂N(CH₃)CH(CH₃)₂ | S | CH₂CH₂N(CH₃)CH(CH₃)₂ |
| O | CH₂CH═C(CH₃)₂ | S | CH₂CH═C(CH₃)₂ |
| O | (CH₂)₃C(CH₃)₂OCH₃ | S | (CH₂)₃C(CH₃)₂OCH₃ |
| O | (CH₂)₃C(CH₃)₂Cl | S | (CH₂)₃C(CH₃)₂Cl |
| O | CH₂CH₂CH═C(CH₃)₂ | S | CH₂CH₂CH═(CH₃)₂ |
| O | (CH₂)₈CH₃ | S | (CH₂)₈CH₃ |
| O | (CH₂)₉CH₃ | S | (CH₂)₉CH₃ |
| O | (CH₂)₁₁CH₃ | S | (CH₂)₁₁CH₃ |
| O | C(═O)OCH₂C(CH₃)₃ | S | C(═O)OCH₂C(CH₃)₃ |
| O | (CH₂)₄CH(CH₃)₂ | S | (CH₂)₄CH(CH₃)₂ |
| O | C(═O)OCH(C₂H₅)C(CH₃)₃ | S | C(═O)OCH(C₂H₅)C(CH₃)₃ |
| O | C(═O)OC(CH₃)₂C(CH₃)₃ | S | C(═O)OC(CH₃)₂C(CH₃)₃ |
| O | C(═O)NHCH₂C(CH₃)₃ | S | C(═O)NHCH₂C(CH₃)₃ |
| O | C(═O)N(CH₃)CH₂C(CH₃)₃ | S | C(═O)N(CH₃)CH₂C(CH₃)₃ |
| O | CH₂CH₂CH₂CH═C(CH₃)₂ | S | CH₂CH₂CH₂CH═C(CH₃)₂ |
| O | C(═O)CH₂SC(CH₃)₃ | S | C(═O)CH₂SC(CH₃)₃ |
| O | (CH₂)₄Cl | S | (CH₂)₄Cl |
| O | (CH₂)₅Cl | S | (CH₂)₅Cl |
| O | (CH₂)₂CH(CH₃)(CH₂)₃CH(CH₃)₂ | S | (CH₂)₂CH(CH₃)(CH₂)₃CH(CH₃)₂ |
| O | (S)-(CH₂)₂CH(CH₃)CH₂CH₂CH═C(CH₃)₂ | S | (S)-(CH₂)₂CH(CH₃)CH₂CH₂CH═C(CH₃)₂ |
| O | (R)-(CH₂)₂CH(CH₃)CH₂CH₂CH═C(CH₃)₂ | S | (R)-(CH₂)₂CH(CH₃)CH₂CH₂CH═C(CH₃)₂ |
| O | (CH₂)₂CH(CH₃)₂ | S | (CH₂)₂CH(CH₃)₂ |
| O | (CH₂)₂C(CH₃)₃ | S | (CH₂)₂C(CH₃)₃ |
| O | CH₂C(═O)C(CH₃)₃ | S | CH₂C(═O)C(CH₃)₃ |
| O | CH₂CH═C(CH₃)(CH₂)₂CH═C(CH₃)₂ | S | CH₂CH═C(CH₃)(CH₂)₂CH═C(CH₃)₂ |
| O | CH₂(CH═C(CH₃)(CH₂)₂)₂CH═C(CH₃)₂ | S | CH₂(CH═C(CH₃)(CH₂)₂)₂CH═C(CH₃)₂ |
| O | (CH₂)₃CH═CH₂ | S | (CH₂)₃CH═CH₂ |
| O | (CH₂)₄CH═CH₂ | S | (CH₂)₄CH═CH₂ |
| O | CH(C₂H₅)₂ | S | CH(C₂H₅)₂ |
| O | CH(CH₂CH₂CH₃)₂ | S | CH(CH₂CH₂CH₃)₂ |
| O | CH(CH₂CH₂CH₂CH₃)₂ | S | CH(CH₂CH₂CH₂CH₃)₂ |
| O | CH(CH₂CH₂CH₃)CH₂CH₂CH₂CH₃ | S | CH(CH₂CH₂CH₃)CH₂CH₂CH₂CH₃ |
| O | CH(CH₃)CH₂CH₂CH(CH₃)(C₂H₅) | S | CH(CH₃)CH₂CH₂CH(CH₃)(C₂H₅) |
| O | CH(CH₂CH₂CH₂CH₂CH₃)₂ | S | CH(CH₂CH₂CH₂CH₂CH₃)₂ |
| O | CH(CH₂CH₂CH₂CH₃)(CH₂)₅CH₃ | S | CH(CH₂CH₂CH₂CH₃)(CH₂)₆CH₃ |
| O | CH(C₂H₅)CH₂CH₂C(═CH₂)CH₃ | S | CH(C₂H₅)CH₂CH₂C(═CH₂)CH₃ |

TABLE 2

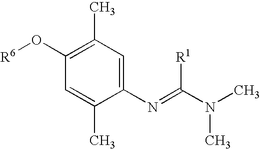

| R¹ | R⁶ | R¹ | R⁶ |
|---|---|---|---|
| CH₃ | (CH₂)₄CH₃ | OCH₃ | (CH₂)₄CH₃ |
| CH₃ | (CH₂)₃C(CH₃)₂OC₂H₅ | OCH₃ | (CH₂)₃C(CH₃)₂OC₂H₅ |
| CH₃ | (CH₂)₅CH₃ | OCH₃ | (CH₂)₅CH₃ |
| CH₃ | (CH₂)₆CH₃ | OCH₃ | (CH₂)₆CH₃ |
| CH₃ | (CH₂)₃C(CH₃)₂Br | OCH₃ | (CH₂)₃C(CH₃)₂Br |
| CH₃ | (CH₂)₇CH₃ | OCH₃ | (CH₂)₇CH₃ |
| CH₃ | (CH₂)₃CH(CH₃)₂ | OCH₃ | (CH₂)₃CH(CH₃)₂ |
| CH₃ | (CH₂)₃C(CH₃)₃ | OCH₃ | (CH₂)₃C(CH₃)₃ |
| CH₃ | (CH₂)₃Si(CH₃)₃ | OCH₃ | (CH₂)₃Si(CH₃)₃ |
| CH₃ | (CH₂)₂CH(CH₃)CH₂C(CH₃)₃ | OCH₃ | (CH₂)₂CH(CH₃)CH₂C(CH₃)₃ |
| CH₃ | (CH₂)₃C(═CH₂)CH(CH₃)₂ | OCH₃ | (CH₂)₃C(═CH₂)CH(CH₃)₂ |
| CH₃ | (CH₂)₃CH(CH₃)C₂H₅ | OCH₃ | (CH₂)₃CH(CH₃)C₂H₅ |
| CH₃ | (CH₂)₂OSi(CH₃)₂C(CH₃)₃ | OCH₃ | (CH₂)₂OSi(CH₃)₂O(CH₃)₃ |
| CH₃ | (CH₂)₂OC(CH₃)₃ | OCH₃ | (CH₂)₂OC(CH₃)₃ |
| CH₃ | (CH₂)₂SC(CH₃)₃ | OCH₃ | (CH₂)₂SC(CH₃)₃ |
| CH₃ | (CH₂)₂SCH(CH₃)₂ | OCH₃ | (CH₂)₂SCH(CH₃)₂ |
| CH₃ | CH₂CH═CHC(CH₃)₃ | OCH₃ | CH₂CH═CHC(CH₃)₃ |
| CH₃ | CH₂CH═CHCH(CH₃)₂ | OCH₃ | CH₂CH═CHCH(CH₃)₂ |
| CH₃ | (CH₂)₂S(═O)C(CH₃)₃ | OCH₃ | (CH₂)₂S(═O)C(CH₃)₃ |
| CH₃ | (CH₂)₃OSi(CH₃)₂C(CH₃)₃ | OCH₃ | (CH₂)₃OSi(CH₃)₂C(CH₃)₃ |
| CH₃ | (CH₂)₂OCH(CH₃)₂ | OCH₃ | (CH₂)₂OCH(CH₃)₂ |
| CH₃ | (CH₂)₃OC(CH₃)₃ | OCH₃ | (CH₂)₃OC(CH₃)₃ |
| CH₃ | (CH₂)₃P(═O)(CH₃)₂ | OCH₃ | (CH₂)₃P(═O)(CH₃)₂ |
| CH₃ | CH₂C(═O)CH₂C(CH₃)₃ | OCH₃ | CH₂C(═O)CH₂C(CH₃)₃ |
| CH₃ | CH(CH₃)(CH₂)₃CH₃ | OCH₃ | CH(CH₃)(CH₂)₃CH₃ |
| CH₃ | CH(CH₃)CH₂CH₂CH(CH₃)₂ | OCH₃ | CH(CH₃)CH₂CH₂CH(CH₃)₂ |
| CH₃ | CH(CH₃)CH₂CH₂C(CH₃)₃ | OCH₃ | CH(CH₃)CH₂CH₂C(CH₃)₃ |
| CH₃ | CH(C₂H₅)CH₂CH₂CH(CH₃)₂ | OCH₃ | CH(C₂H₅)CH₂CH₂CH(CH₃)₂ |
| CH₃ | CH(CH₂CH₂CH₃)CH₂CH₂CH(CH₃)₂ | OCH₃ | CH(CH₂CH₂CH₃)CH₂CH₂CH(CH₃)₂ |
| CH₃ | CH(CH₂CH₂CH(CH₃)₂)₂ | OCH₃ | CH(CH₂CH₂CH(CH₃)₂)₂ |
| CH₃ | CH₂CH₂CH₂N(CH₃)₂ | OCH₃ | CH₂CH₂CH₂N(CH₃)₂ |
| CH₃ | CH₂CH₂N(CH₃)C(CH₃)₃ | OCH₃ | CH₂CH₂N(CH₃)C(CH₃)₃ |
| CH₃ | CH₂CH₂N(CH₃)CH(CH₃)₂ | OCH₃ | CH₂CH₂N(CH₃)CH(CH₃)₂ |
| CH₃ | CH₂CH═C(CH₃)₂ | OCH₃ | CH₂CH═C(CH₃)₂ |
| CH₃ | (CH₂)₃C(CH₃)₂OCH₃ | OCH₃ | (CH₂)₃C(CH₃)₂OCH₃ |
| CH₃ | (CH₂)₃C(CH₃)₂Cl | OCH₃ | (CH₂)₃C(CH₃)₂Cl |
| CH₃ | CH₂CH₂CH═C(CH₃)₂ | OCH₃ | CH₂CH₂CH═C(CH₃)₂ |
| C₂H₅ | (CH₂)₄CH₃ | SCH₃ | (CH₂)₄CH₃ |
| C₂H₅ | (CH₂)₃C(CH₃)₂OC₂H₅ | SCH₃ | (CH₂)₃C(CH₃)₂OC₂H₅ |
| C₂H₅ | (CH₂)₅CH₃ | SCH₃ | (CH₂)₅CH₃ |
| C₂H₅ | (CH₂)₆CH₃ | SCH₃ | (CH₂)₆CH₃ |
| C₂H₅ | (CH₂)₃C(CH₃)₂Br | SCH₃ | (CH₂)₃C(CH₃)₂Br |
| C₂H₅ | (CH₂)₇CH₃ | SCH₃ | (CH₂)₇CH₃ |
| C₂H₅ | (CH₂)₃CH(CH₃)₂ | SCH₃ | (CH₂)₃CH(CH₃)₂ |
| C₂H₅ | (CH₂)₃C(CH₃)₃ | SCH₃ | (CH₂)₃C(CH₃)₃ |
| C₂H₅ | (CH₂)₃Si(CH₃)₃ | SCH₃ | (CH₂)₃Si(CH₃)₃ |
| C₂H₅ | (CH₂)₂CH(CH₃)CH₂C(CH₃)₃ | SCH₃ | (CH₂)₂CH(CH₃)CH₂C(CH₃)₃ |
| C₂H₅ | (CH₂)₃C(═CH₂)CH(CH₃)₂ | SCH₃ | (CH₂)₃C(═CH₂)CH(CH₃)₂ |
| C₂H₅ | (CH₂)₃CH(CH₃)C₂H₅ | SCH₃ | (CH₂)₃CH(CH₃)C₂H₅ |
| C₂H₅ | (CH₂)₂OSi(CH₃)₂C(CH₃)₃ | SCH₃ | (CH₂)₂OSi(CH₃)₂C(CH₃)₃ |
| C₂H₅ | (CH₂)₂OC(CH₃)₃ | SCH₃ | (CH₂)₂OC(CH₃)₃ |
| C₂H₅ | (CH₂)₂SC(CH₃)₃ | SCH₃ | (CH₂)₂SC(CH₃)₃ |
| C₂H₅ | (CH₂)₂SCH(CH₃)₂ | SCH₃ | (CH₂)₂SCH(CH₃)₂ |
| C₂H₅ | CH₂CH═CHC(CH₃)₃ | SCH₃ | CH₂CH═CHC(CH₃)₃ |
| C₂H₅ | CH₂CH═CHCH(CH₃)₂ | SCH₃ | CH₂CH═CHCH(CH₃)₂ |
| C₂H₅ | (CH₂)₂S(═O)C(CH₃)₃ | SCH₃ | (CH₂)₂S(═O)C(CH₃)₃ |
| C₂H₅ | (CH₂)₃OSi(CH₃)₂C(CH₃)₃ | SCH₃ | (CH₂)₃OSi(CH₃)₂C(CH₃)₃ |
| C₂H₅ | (CH₂)₂OCH(CH₃)₂ | SCH₃ | (CH₂)₂OCH(CH₃)₂ |
| C₂H₅ | (CH₂)₃OC(CH₃)₃ | SCH₃ | (CH₂)₃OC(CH₃)₃ |
| C₂H₅ | (CH₂)₃P(═O)(CH₃)₂ | SCH₃ | (CH₂)₃P(═O)(CH₃)₂ |
| C₂H₅ | CH₂C(═O)CH₂C(CH₃)₃ | SCH₃ | CH₂C(═O)CH₂C(CH₃)₃ |
| C₂H₅ | CH(CH₃)(CH₂)₃CH₃ | SCH₃ | CH(CH₃)(CH₂)₃CH₃ |
| C₂H₅ | CH(CH₃)CH₂CH₂CH(CH₃)₂ | SCH₃ | CH(CH₃)CH₂CH₂CH(CH₃)₂ |
| C₂H₅ | CH(CH₃)CH₂CH₂C(CH₃)₃ | SCH₃ | CH(CH₃)CH₂CH₂C(CH₃)₃ |
| C₂H₅ | CH(C₂H₅)CH₂CH₂CH(CH₃)₂ | SCH₃ | CH(C₂H₅)CH₂CH₂CH(CH₃)₂ |
| C₂H₅ | CH(CH₂CH₂CH₃)CH₂CH₂CH(CH₃)₂ | SCH₃ | CH(CH₂CH₂CH₃)CH₂CH₂CH(CH₃)₂ |
| C₂H₅ | CH(CH₂CH₂CH(CH₃)₂)₂ | SCH₃ | CH(CH₂CH₂CH(CH₃)₂)₂ |
| C₂H₅ | CH₂CH₂CH₂N(CH₃)₂ | SCH₃ | CH₂CH₂CH₂N(CH₃)₂ |
| C₂H₅ | CH₂CH₂N(CH₃)C(CH₃)₃ | SCH₃ | CH₂CH₂N(CH₃)C(CH₃)₃ |
| C₂H₅ | CH₂CH₂N(CH₃)CH(CH₃)₂ | SCH₃ | CH₂CH₂N(CH₃)CH(CH₃)₂ |
| C₂H₅ | CH₂CH═C(CH₃)₂ | SCH₃ | CH₂CH═C(CH₃)₂ |
| C₂H₅ | (CH₂)₃C(CH₃)₂OCH₃ | SCH₃ | (CH₂)₃C(CH₃)₂OCH₃ |
| C₂H₅ | (CH₂)₃C(CH₃)₂Cl | SCH₃ | (CH₂)₃C(CH₃)₂Cl |
| C₂H₅ | CH₂CH₂CH═C(CH₃)₂ | SCH₃ | CH₂CH₂CH═C(CH₃)₂ |

TABLE 3

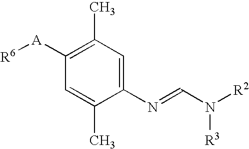

| A | R² | R³ | R⁶ |
|---|---|---|---|
| O | CH₃ | C₂H₅ | (CH₂)₄CH₃ |
| O | CH₃ | C₂H₅ | (CH₂)₃C(CH₃)₂OC₂H₅ |
| O | CH₃ | C₂H₅ | (CH₂)₅CH₃ |
| O | CH₃ | C₂H₅ | (CH₂)₆CH₃ |
| O | CH₃ | C₂H₅ | (CH₂)₃C(CH₃)₂Br |
| O | CH₃ | C₂H₅ | (CH₂)₇CH₃ |
| O | CH₃ | C₂H₅ | (CH₂)₃CH(CH₃)₂ |
| O | CH₃ | C₂H₅ | (CH₂)₃C(CH₃)₃ |
| O | CH₃ | C₂H₅ | (CH₂)₃Si(CH₃)₃ |
| O | CH₃ | C₂H₅ | (CH₂)₂CH(CH₃)CH₂C(CH₃)₃ |
| O | CH₃ | C₂H₅ | (CH₂)₃C(═CH₂)CH(CH₃)₂ |
| O | CH₃ | C₂H₅ | (CH₂)₃CH(CH₃)C₂H₅ |
| O | CH₃ | C₂H₅ | (CH₂)₂OSi(CH₃)₂C(CH₃)₃ |
| O | CH₃ | C₂H₅ | (CH₂)₂OC(CH₃)₃ |
| O | CH₃ | C₂H₅ | (CH₂)₂SC(CH₃)₃ |
| O | CH₃ | C₂H₅ | (CH₂)₂SCH(CH₃)₂ |
| O | CH₃ | C₂H₅ | CH₂CH═CHC(CH₃)₃ |
| O | CH₃ | C₂H₅ | CH₂CH═CHCH(CH₃)₂ |
| O | CH₃ | C₂H₅ | (CH₂)₂S(═O)C(CH₃)₃ |
| O | CH₃ | C₂H₅ | (CH₂)₃OSi(CH₃)₂C(CH₃)₃ |
| O | CH₃ | C₂H₅ | (CH₂)₂OCH(CH₃)₂ |
| O | CH₃ | C₂H₅ | (CH₂)₃OC(CH₃)₃ |
| O | CH₃ | C₂H₅ | (CH₂)₃P(═O)(CH₃)₂ |
| O | CH₃ | C₂H₅ | CH₂C(═O)CH₂C(CH₃)₃ |
| O | CH₃ | C₂H₅ | CH(CH₃)(CH₂)₃CH₃ |
| O | CH₃ | C₂H₅ | CH(CH₃)CH₂CH₂CH(CH₃)₂ |
| O | CH₃ | C₂H₅ | CH(CH₃)CH₂CH₂C(CH₃)₃ |
| O | CH₃ | C₂H₅ | CH(C₂H₅)CH₂CH₂CH(CH₃)₂ |
| O | CH₃ | C₂H₅ | CH(CH₂CH₂CH₃)CH₂CH₂CH(CH₃)₂ |
| O | CH₃ | C₂H₅ | CH(CH₂CH₂CH(CH₃)₂)₂ |
| O | CH₃ | C₂H₅ | CH₂CH₂CH₂N(CH₃)₂ |
| O | CH₃ | C₂H₅ | CH₂CH₂N(CH₃)C(CH₃)₃ |
| O | CH₃ | C₂H₅ | CH₂CH₂N(CH₃)CH(CH₃)₂ |
| O | CH₃ | C₂H₅ | CH₂CH═C(CH₃)₂ |
| O | CH₃ | C₂H₅ | (CH₂)₃C(CH₃)₂OCH₃ |
| O | CH₃ | C₂H₅ | (CH₂)₃C(CH₃)₂Cl |
| O | CH₃ | C₂H₅ | CH₂CH₂CH═C(CH₃)₂ |
| O | C₂H₅ | C₂H₅ | (CH₂)₄CH₃ |
| O | C₂H₅ | C₂H₅ | (CH₂)₃C(CH₃)₂OC₂H₅ |
| O | C₂H₅ | C₂H₅ | (CH₂)₅CH₃ |
| O | C₂H₅ | C₂H₅ | (CH₂)₆CH₃ |
| O | C₂H₅ | C₂H₅ | (CH₂)₃C(CH₃)₂Br |
| O | C₂H₅ | C₂H₅ | (CH₂)₇CH₃ |
| O | C₂H₅ | C₂H₅ | (CH₂)₃CH(CH₃)₂ |
| O | C₂H₅ | C₂H₅ | (CH₂)₃C(CH₃)₃ |
| O | C₂H₅ | C₂H₅ | (CH₂)₃Si(CH₃)₃ |
| O | C₂H₅ | C₂H₅ | (CH₂)₂CH(CH₃)CH₂C(CH₃)₃ |
| O | C₂H₅ | C₂H₅ | (CH₂)₃C(═CH₂)CH(CH₃)₂ |
| O | C₂H₅ | C₂H₅ | (CH₂)₃CH(CH₃)C₂H₅ |
| O | C₂H₅ | C₂H₅ | (CH₂)₂OSi(CH₃)₂C(CH₃)₃ |
| O | C₂H₅ | C₂H₅ | (CH₂)₂OC(CH₃)₃ |
| O | C₂H₅ | C₂H₅ | (CH₂)₂SC(CH₃)₃ |
| O | C₂H₅ | C₂H₅ | (CH₂)₂SCH(CH₃)₂ |
| O | C₂H₅ | C₂H₅ | CH₂CH═CHC(CH₃)₃ |
| O | C₂H₅ | C₂H₅ | CH₂CH═CHCH(CH₃)₂ |
| O | C₂H₅ | C₂H₅ | (CH₂)₂S(═O)C(CH₃)₃ |
| O | C₂H₅ | C₂H₅ | (CH₂)₃OSi(CH₃)₂C(CH₃)₃ |
| O | C₂H₅ | C₂H₅ | (CH₂)₂OCH(CH₃)₂ |
| O | C₂H₅ | C₂H₅ | (CH₂)₃OC(CH₃)₃ |
| O | C₂H₅ | C₂H₅ | (CH₂)₃P(═O)(CH₃)₂ |
| O | C₂H₅ | C₂H₅ | CH₂C(═O)CH₂C(CH₃)₃ |
| O | C₂H₅ | C₂H₅ | CH(CH₃)(CH₂)₃CH₃ |
| O | C₂H₅ | C₂H₅ | CH(CH₃)CH₂CH₂CH(CH₃)₂ |
| O | C₂H₅ | C₂H₅ | CH(CH₃)CH₂CH₂C(CH₃)₃ |
| O | C₂H₅ | C₂H₅ | CH(C₂H₅)CH₂CH₂CH(CH₃)₂ |
| O | C₂H₅ | C₂H₅ | CH(CH₂CH₂CH₃)CH₂CH₂CH(CH₃)₂ |
| O | C₂H₅ | C₂H₅ | CH(CH₂CH₂CH(CH₃)₂)₂ |
| O | C₂H₅ | C₂H₅ | CH₂CH₂CH₂N(CH₃)₂ |
| O | C₂H₅ | C₂H₅ | CH₂CH₂N(CH₃)C(CH₃)₃ |
| O | C₂H₅ | C₂H₅ | CH₂CH₂N(CH₃)CH(CH₃)₂ |
| O | C₂H₅ | C₂H₅ | CH₂CH═C(CH₃)₂ |
| O | C₂H₅ | C₂H₅ | (CH₂)₃C(CH₃)₂OCH₃ |
| O | C₂H₅ | C₂H₅ | (CH₂)₃C(CH₃)₂Cl |
| O | C₂H₅ | C₂H₅ | CH₂CH₂CH═C(CH₃)₂ |
| NCH₃ | CH₃ | CH₃ | (CH₂)₄CH₃ |
| NCH₃ | CH₃ | CH₃ | (CH₂)₃C(CH₃)₂OC₂H₅ |
| NCH₃ | CH₃ | CH₃ | (CH₂)₅CH₃ |
| NCH₃ | CH₃ | CH₃ | (CH₂)₆CH₃ |
| NCH₃ | CH₃ | CH₃ | (CH₂)₃C(CH₃)₂Br |
| NCH₃ | CH₃ | CH₃ | (CH₂)₇CH₃ |
| NCH₃ | CH₃ | CH₃ | (CH₂)₃CH(CH₃)₂ |
| NCH₃ | CH₃ | CH₃ | (CH₂)₃C(CH₃)₃ |
| NCH₃ | CH₃ | CH₃ | (CH₂)₃Si(CH₃)₃ |
| NCH₃ | CH₃ | CH₃ | (CH₂)₂CH(CH₃)CH₂C(CH₃)₃ |
| NCH₃ | CH₃ | CH₃ | (CH₂)₃C(═CH₂CH(CH₃)₂ |
| NCH₃ | CH₃ | CH₃ | (CH₂)₃CH(CH₃)C₂H₅ |
| NCH₃ | CH₃ | CH₃ | (CH₂)₂OSi(CH₃)₂C(CH₃)₃ |
| NCH₃ | CH₃ | CH₃ | (CH₂)₂OC(CH₃)₃ |
| NCH₃ | CH₃ | CH₃ | (CH₂)₂SC(CH₃)₃ |
| NCH₃ | CH₃ | CH₃ | (CH₂)₂SCH(CH₃)₂ |
| NCH₃ | CH₃ | CH₃ | CH₂CH═CHC(CH₃)₃ |
| NCH₃ | CH₃ | CH₃ | CH₂CH═CHCH(CH₃)₂ |
| NCH₃ | CH₃ | CH₃ | (CH₂)₂S(═O)C(CH₃)₃ |
| NCH₃ | CH₃ | CH₃ | (CH₂)₃OSi(CH₃)₂C(CH₃)₃ |
| NCH₃ | CH₃ | CH₃ | (CH₂)₂OCH(CH₃)₂ |
| NCH₃ | CH₃ | CH₃ | (CH₂)₃OC(CH₃)₃ |
| NCH₃ | CH₃ | CH₃ | (CH₂)₃P(═O)(CH₃)₂ |
| NCH₃ | CH₃ | CH₃ | CH₂C(═O)CH₂C(CH₃)₃ |
| NCH₃ | CH₃ | CH₃ | CH(CH₃)(CH₂)₃CH₃ |
| NCH₃ | CH₃ | CH₃ | CH(CH₃)CH₂CH₂CH(CH₃)₂ |
| NCH₃ | CH₃ | CH₃ | CH(CH₃)CH₂CH₂C(CH₃)₃ |
| NCH₃ | CH₃ | CH₃ | CH(C₂H₅)CH₂CH₂CH(CH₃)₂ |
| NCH₃ | CH₃ | CH₃ | CH(CH₂CH₂CH₃)CH₂CH₂CH(CH₃)₂ |
| NCH₃ | CH₃ | CH₃ | CH(CH₂CH₂CH(CH₃)₂)₂ |
| NCH₃ | CH₃ | CH₃ | CH₂CH₂CH₂N(CH₃)₂ |
| NCH₃ | CH₃ | CH₃ | CH₂CH₂N(CH₃)C(CH₃)₃ |
| NCH₃ | CH₃ | CH₃ | CH₂CH₂N(CH₃)CH(CH₃)₂ |
| NCH₃ | CH₃ | CH₃ | CH₂CH═C(CH₃)₂ |
| NCH₃ | CH₃ | CH₃ | (CH₂)₃C(CH₃)₂OCH₃ |
| NCH₃ | CH₃ | CH₃ | (CH₂)₃C(CH₃)₂C1 |
| NCH₃ | CH₃ | CH₃ | CH₂CH₂CH═C(CH₃)₂ |
| NH | CH₃ | CH₃ | (CH₂)₄CH₃ |
| NH | CH₃ | CH₃ | (CH₂)₃C(CH₃)₂OC₂H₅ |
| NH | CH₃ | CH₃ | (CH₂)₅CH₃ |
| NH | CH₃ | CH₃ | (CH₂)₆CH₃ |
| NH | CH₃ | CH₃ | (CH₂)₃C(CH₃)₂Br |
| NH | CH₃ | CH₃ | (CH₂)₇CH₃ |
| NH | CH₃ | CH₃ | (CH₂)₃CH(CH₃)₂ |
| NH | CH₃ | CH₃ | (CH₂)₃C(CH₃)₃ |
| NH | CH₃ | CH₃ | (CH₂)₃Si(CH₃)₃ |
| NH | CH₃ | CH₃ | (CH₂)₂CH(CH₃)CH₂C(CH₃)₃ |
| NH | CH₃ | CH₃ | (CH₂)₃C(═CH₂)CH(CH₃)₂ |
| NH | CH₃ | CH₃ | (CH₂)₃CH(CH₃)C₂H₅ |
| NH | CH₃ | CH₃ | (CH₂)₂OSi(CH₃)₂C(CH₃)₃ |
| NH | CH₃ | CH₃ | (CH₂)₂OC(CH₃)₃ |
| NH | CH₃ | CH₃ | (CH₂)₂SC(CH₃)₃ |
| NH | CH₃ | CH₃ | (CH₂)₂SCH(CH₃)₂ |
| NH | CH₃ | CH₃ | CH₂CH═CHC(CH₃)₃ |
| NH | CH₃ | CH₃ | CH₂CH═CHCH(CH₃)₂ |
| NH | CH₃ | CH₃ | (CH₂)₂S(═O)C(CH₃)₃ |
| NH | CH₃ | CH₃ | (CH₂)₃OSi(CH₃)₂C(CH₃)₃ |
| NH | CH₃ | CH₃ | (CH₂)₂OCH(CH₃)₂ |
| NH | CH₃ | CH₃ | (CH₂)₃OC(CH₃)₃ |
| NH | CH₃ | CH₃ | (CH₂)₃P(═O)(CH₃)₂ |
| NH | CH₃ | CH₃ | CH₂C(═O)CH₂C(CH₃)₃ |
| NH | CH₃ | CH₃ | CH(CH₃)(CH₂)₃CH₃ |
| NH | CH₃ | CH₃ | CH(CH₃)CH₂CH₂CH(CH₃)₂ |
| NH | CH₃ | CH₃ | CH(CH₃)CH₂CH₂C(CH₃)₃ |
| NH | CH₃ | CH₃ | CH(C₂H₅)CH₂CH₂CH(CH₃)₂ |
| NH | CH₃ | CH₃ | CH(CH₂CH₂CH₃)CH₂CH₂CH(CH₃)₂ |
| NH | CH₃ | CH₃ | CH(CH₂CH₂CH(CH₃)₂)₂ |
| NH | CH₃ | CH₃ | CH₂CH₂CH₂N(CH₃)₂ |
| NH | CH₃ | CH₃ | CH₂CH₂N(CH₃)C(CH₃)₃ |
| NH | CH₃ | CH₃ | CH₂CH₂N(CH₃)CH(CH₃)₂ |
| NH | CH₃ | CH₃ | CH₂CH═C(CH₃)₂ |
| NH | CH₃ | CH₃ | (CH₂)₃C(CH₃)₂OCH₃ |
| NH | CH₃ | CH₃ | (CH₂)₃C(CH₃)₂Cl |
| NH | CH₃ | CH₃ | CH₂CH₂CH═C(CH₃)₂ |
| NH | CH₃ | CH₃ | (CH₂)₈CH₃ |
| NH | CH₃ | CH₃ | (CH₂)₉CH₃ |
| NH | CH₃ | CH₃ | (CH₂)₁₁CH₃ |
| NH | CH₃ | CH₃ | (CH₂)₄CH(CH₃)₂ |
| NH | CH₃ | CH₃ | C(═O)OCH(C₂H₅)C(CH₃)₃ |
| NH | CH₃ | CH₃ | C(═O)OC(CH₃)₂C(CH₃)₃ |
| NH | CH₃ | CH₃ | CH₂CH₂CH₂CH═C(CH₃)₂ |
| NH | CH₃ | CH₃ | C(═O)CH₂SC(CH₃)₃ |
| NH | CH₃ | CH₃ | (CH₂)₄Cl |
| NH | CH₃ | CH₃ | (CH₂)₅Cl |
| NH | CH₃ | CH₃ | (CH₂)₂CH(CH₃)(CH₂)₃CH(CH₃)₂ |
| NH | CH₃ | CH₃ | (S)-(CH₂)₂CH(CH₃)CH₂CH₂CH═C(CH₃)₂ |
| NH | CH₃ | CH₃ | (R)-(CH₂)₂CH(CH₃)CH₂CH₂CH═C(CH₃)₂ |
| NH | CH₃ | CH₃ | (CH₂)₂CH(CH₃)₂ |
| NH | CH₃ | CH₃ | (CH₂)₂C(CH₃)₃ |
| NH | CH₃ | CH₃ | CH₂C(═O)C(CH₃)₃ |
| NH | CH₃ | CH₃ | CH₂CH═C(CH₃)(CH₂)₂CH═C(CH₃)₂ |
| NH | CH₃ | CH₃ | CH₂(CH═C(CH₃)(CH₂)₂)₂CH═C(CH₃)₂ |
| NH | CH₃ | CH₃ | (CH₂)₃CH═CH₂ |
| NH | CH₃ | CH₃ | (CH₂)₄CH═CH₂ |
| NH | CH₃ | CH₃ | CH(C₂H₅)₂ |
| NHI | CH₃ | CH₃ | CH(CH₂CH₂CH₃)₂ |
| NH | CH₃ | CH₃ | CH(CH₂CH₂CH₂CH₃)₂ |
| NH | CH₃ | CH₃ | CH(CH₂CH₂CH₃)CH₂CH₂CH₂CH₃ |
| NH | CH₃ | CH₃ | CH(CH₃)CH₂CH₂CH(CH₃)(C₂H₅) |
| NH | CH₃ | CH₃ | CH(CH₂CH₂CH₂CH₂CH₃)₂ |
| NH | CH₃ | CH₃ | CH(CH₂CH₂CH₂CH₃)(CH₂)₅CH₃ |
| NH | CH₃ | CH₃ | CH(C₂H₅)CH₂CH₂C(═CH₂)CH₃ |

TABLE 4

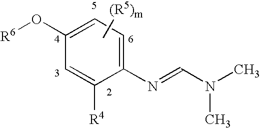

| R⁴ | m | R⁵ | R⁶ |
|---|---|---|---|
| CH₃ | 1 | 5-Cl | (CH₂)₄CH₃ |
| CH₃ | 1 | 5-Cl | (CH₂)₃C(CH₃)₂OC₂H₅ |
| CH₃ | 1 | 5-Cl | (CH₂)₅CH₃ |
| CH₃ | 1 | 5-Cl | (CH₂)₆CH₃ |
| CH₃ | 1 | 5-Cl | (CH₂)₃C(CH₃)₂Br |
| CH₃ | 1 | 5-Cl | (CH₂)₇CH₃ |
| CH₃ | 1 | 5-Cl | (CH₂)₃CH(CH₃)₂ |
| CH₃ | 1 | 5-Cl | (CH₂)₃C(CH₃)₃ |
| CH₃ | 1 | 5-Cl | (CH₂)₃Si(CH₃)₃ |
| CH₃ | 1 | 5-Cl | (CH₂)₂CH(CH₃)CH₂C(CH₃)₃ |
| CH₃ | 1 | 5-Cl | (CH₂)₃C(═CH₂)CH(CH₃)₂ |
| CH₃ | 1 | 5-Cl | (CH₂)₃CH(CH₃)C₂H₅ |
| CH₃ | 1 | 5-Cl | (CH₂)₂OSi(CH₃)₂C(CH₃)₃ |
| CH₃ | 1 | 5-Cl | (CH₂)₂OC(CH₃)₃ |
| CH₃ | 1 | 5-Cl | (CH₂)₂SC(CH₃)₃ |
| CH₃ | 1 | 5-Cl | (CH₂)₂SCH(CH₃)₂ |
| CH₃ | 1 | 5-Cl | CH₂CH═CHC(CH₃)₃ |
| CH₃ | 1 | 5-Cl | CH₂CH═CHCH(CH₃)₂ |
| CH₃ | 1 | 5-Cl | (CH₂)₂S(═O)C(CH₃)₃ |
| CH₃ | 1 | 5-Cl | (CH₂)₃OSi(CH₃)₂C(CH₃)₃ |
| CH₃ | 1 | 5-Cl | (CH₂)₂OCH(CH₃)₂ |
| CH₃ | 1 | 5-Cl | (CH₂)₃OCH(CH₃)₃ |
| CH₃ | 1 | 5-Cl | (CH₂)₃P(═O)(CH₃)₂ |
| CH₃ | 1 | 5-Cl | CH₂C(═O)CH₂C(CH₃)₃ |
| CH₃ | 1 | 5-Cl | CH(CH₃)(CH₂)₃CH₃ |
| CH₃ | 1 | 5-Cl | CH(CH₃)CH₂CH₂CH(CH₃)₂ |
| CH₃ | 1 | 5-Cl | CH(CH₃)CH₂CH₂C(CH₃)₃ |
| CH₃ | 1 | 5-Cl | CH(C₂H₅)CH₂CH₂CH(CH₃)₂ |
| CH₃ | 1 | 5-Cl | CH(CH₂CH₂CH₃)CH₂CH₂CH(CH₃)₂ |
| CH₃ | 1 | 5-Cl | CH(CH₂CH₂CH(CH₃)₂)₂ |
| CH₃ | 1 | 5-Cl | CH₂CH₂CH₂N(CH₃)₂ |
| CH₃ | 1 | 5-Cl | CH₂CH₂N(CH₃)C(CH₃)₃ |
| CH₃ | 1 | 5-Cl | CH₂CH₂N(CH₃)CH(CH₃)₂ |
| CH₃ | 1 | 5-Cl | CH₂CH═C(CH₃)₂ |
| CH₃ | 1 | 5-Cl | (CH₂)₃C(CH₃)₂OCH₃ |
| CH₃ | 1 | 5-Cl | (CH₂)₃C(CH₃)₂Cl |
| CH₃ | 1 | 5-Cl | CH₂CH₂CH═C(CH₃)₂ |
| Cl | 1 | 5-CH₃ | (CH₂)₄CH₃ |
| Cl | 1 | 5-CH₃ | (CH₂)₃C(CH₃)₂OC₂H₅ |
| Cl | 1 | 5-CH₃ | (CH₂)₅CH₃ |
| Cl | 1 | 5-CH₃ | (CH₂)₆CH₃ |
| Cl | 1 | 5-CH₃ | (CH₂)₃C(CH₃)₂Br |
| Cl | 1 | 5-CH₃ | (CH₂)₇CH₃ |
| Cl | 1 | 5-CH₃ | (CH₂)₃CH(CH₃)₂ |
| Cl | 1 | 5-CH₃ | (CH₂)₃C(CH₃)₃ |
| Cl | 1 | 5-CH₃ | (CH₂)₃Si(CH₃)₃ |
| Cl | 1 | 5-CH₃ | (CH₂)₂CH(CH₃)CH₂C(CH₃)₃ |
| Cl | 1 | 5-CH₃ | (CH₂)₃C(═CH₂)CH(CH₃)₂ |
| Cl | 1 | 5-CH₃ | (CH₂)₃CH(CH₃)C₂H₅ |
| Cl | 1 | 5-CH₃ | (CH₂)₂OSi(CH₃)₂O(CH₃)₃ |
| Cl | 1 | 5-CH₃ | (CH₂)₂OC(CH₃)₃ |
| Cl | 1 | 5-CH₃ | (CH₂)₂SC(CH₃)₃ |
| Cl | 1 | 5-CH₃ | (CH₂)₂SCH(CH₃)₂ |
| Cl | 1 | 5-CH₃ | CH₂CH═CHC(CH₃)₃ |
| Cl | 1 | 5-CH₃ | CH₂CH═CHCH(CH₃)₂ |
| Cl | 1 | 5-CH₃ | (CH₂)₂S(═O)C(CH₃)₃ |
| Cl | 1 | 5-CH₃ | (CH₂)₃OSi(CH₃)₂C(CH₃)₃ |
| Cl | 1 | 5-CH₃ | (CH₂)₂OCH(CH₃)₂ |
| Cl | 1 | 5-CH₃ | (CH₂)₃OC(CH₃)₃ |
| Cl | 1 | 5-CH₃ | (CH₂)₃P(═O)(CH₃)₂ |
| Cl | 1 | 5-CH₃ | CH₂C(═O)CH₂C(CH₃)₃ |
| Cl | 1 | 5-CH₃ | CH(CH₃)(CH₂)₃CH₃ |
| Cl | 1 | 5-CH₃ | CH(CH₃)CH₂CH₂CH(CH₃)₂ |
| Cl | 1 | 5-CH₃ | CH(CH₃)CH₂CH₂C(CH₃)₃ |
| Cl | 1 | 5-CH₃ | CH(C₂H₅)CH₂CH₂CH(CH₃)₂ |
| Cl | 1 | 5-CH₃ | CH(CH₂CH₂CH₃)CH₂CH₂CH(CH₃)₂ |
| Cl | 1 | 5-CH₃ | CH(CH₂CH₂CH(CH₃)₂)₂ |
| Cl | 1 | 5-CH₃ | CH₂CH₂CH₂N(CH₃)₂ |
| Cl | 1 | 5-CH₃ | CH₂CH₂N(CH₃)C(CH₃)₃ |
| Cl | 1 | 5-CH₃ | CH₂CH₂N(CH₃)CH(CH₃)₂ |
| Cl | 1 | 5-CH₃ | CH₂CH═C(CH₃)₂ |
| Cl | 1 | 5-CH₃ | (CH₂)₃C(CH₃)₂OCH₃ |
| Cl | 1 | 5-CH₃ | (CH₂)₃C(CH₃)₂Cl |
| Cl | 1 | 5-CH₃ | CH₂CH₂CH═C(CH₃)₂ |
| Cl | 1 | 5-Cl | (CH₂)₄CH₃ |
| Cl | 1 | 5-Cl | (CH₂)₃C(CH₃)₂OC₂H₅ |
| Cl | 1 | 5-Cl | (CH₂)₅CH₃ |
| Cl | 1 | 5-Cl | (CH₂)₆CH₃ |
| Cl | 1 | 5-Cl | (CH₂)₃C(CH₃)₂Br |
| CI | 1 | 5-Cl | (CH₂)₇CH₃ |
| Cl | 1 | 5-Cl | (CH₂)₃CH(CH₃)₂ |
| Cl | 1 | 5-Cl | (CH₂)₃C(CH₃)₃ |
| Cl | 1 | 5-Cl | (CH₂)₃Si(CH₃)₃ |
| Cl | 1 | 5-Cl | (CH₂)₂CH(CH₃)CH₂C(CH₃)₃ |
| Cl | 1 | 5-Cl | (CH₂)₃C(═CH₂)CH(CH₃)₂ |
| Cl | 1 | 5-Cl | (CH₂)₃CH(CH₃)C₂H₅ |
| Cl | 1 | 5-Cl | (CH₂)₂OSi(CH₃)₂C(CH₃)₃ |
| Cl | 1 | 5-Cl | (CH₂)₂OC(CH₃)₃ |
| Cl | 1 | 5-Cl | (CH₂)₂SC(CH₃)₃ |
| Cl | 1 | 5-Cl | (CH₂)₂SCH(CH₃)₂ |
| Cl | 1 | 5-Cl | CH₂CH═CHC(CH₃)₃ |
| Cl | 1 | 5-Cl | CH₂CH═CHCH(CH₃)₂ |
| Cl | 1 | 5-Cl | (CH₂)₂S(═O)C(CH₃)₃ |
| Cl | 1 | 5-Cl | (CH₂)₃OSi(CH₃)₂C(CH₃)₃ |
| Cl | 1 | 5-Cl | (CH₂)₂OCH(CH₃)₂ |
| Cl | 1 | 5-Cl | (CH₂)₃OC(CH₃)₃ |
| Cl | 1 | 5-Cl | (CH₂)₃P(═O)(CH₃)₂ |
| Cl | 1 | 5-Cl | CH₂C(═O)CH₂C(CH₃)₃ |
| Cl | 1 | 5-Cl | CH(CH₃)(CH₂)₃CH₃ |
| Cl | 1 | 5-Cl | CH(CH₃)CH₂CH₂CH(CH₃)₂ |
| Cl | 1 | 5-Cl | CH(CH₃)CH₂CH₂C(CH₃)₃ |
| Cl | 1 | 5-Cl | CH(C₂H₅)CH₂CH₂CH(CH₃)₂ |
| Cl | 1 | 5-Cl | CH(CH₂CH₂CH₃)CH₂CH₂CH(CH₃)₂ |
| Cl | 1 | 5-Cl | CH(CH₂CH₂CH(CH₃)₂)₂ |
| Cl | 1 | 5-Cl | CH₂CH₂CH₂N(CH₃)₂ |
| Cl | 1 | 5-Cl | CH₂CH₂N(CH₃)C(CH₃)₃ |
| Cl | 1 | 5-Cl | CH₂CH₂N(CH₃)CH(CH₃)₂ |
| Cl | 1 | 5-Cl | CH₂CH═C(CH₃)₂ |
| Cl | 1 | 5-Cl | (CH₂)₃C(CH₃)₂OCH₃ |
| Cl | 1 | 5-Cl | (CH₂)₃C(CH₃)₂Cl |
| Cl | 1 | 5-Cl | CH₂CH₂CH═C(CH₃)₂ |
| CH₃ | 0 | — | (CH₂)₄CH₃ |
| CH₃ | 0 | — | (CH₂)₃C(CH₃)₂OC₂H₅ |
| CH₃ | 0 | — | (CH₂)₅CH₃ |
| CH₃ | 0 | — | (CH₂)₆CH₃ |
| CH₃ | 0 | — | (CH₂)₃C(CH₃)₂Br |
| CH₃ | 0 | — | (CH₂)₇CH₃ |
| CH₃ | 0 | — | (CH₂)₃CH(CH₃)₂ |
| CH₃ | 0 | — | (CH₂)₃C(CH₃)₃ |
| CH₃ | 0 | — | (CH₂)₃Si(CH₃)₃ |
| CH₃ | 0 | — | (CH₂)₂CH(CH₃)CH₂C(CH₃)₃ |
| CH₃ | 0 | — | (CH₂)₃C(═CH₂)CH(CH₃)₂ |
| CH₃ | 0 | — | (CH₂)₃CH(CH₃)C₂H₅ |
| CH₃ | 0 | — | (CH₂)₂OSi(CH₃)₂C(CH₃)₃ |
| CH₃ | 0 | — | (CH₂)₂OC(CH₃)₃ |
| CH₃ | 0 | — | (CH₂)₂SC(CH₃)₃ |
| CH₃ | 0 | — | (CH₂)₂SCH(CH₃)₂ |
| CH₃ | 0 | — | CH₂CH═CHC(CH₃)₃ |
| CH₃ | 0 | — | CH₂CH═CHCH(CH₃)₂ |
| CH₃ | 0 | — | (CH₂)₂S(═O)C(CH₃)₃ |
| CH₃ | 0 | — | (CH₂)₃OSi(CH₃)₂C(CH₃)₃ |
| CH₃ | 0 | — | (CH₂)₂OCH(CH₃)₂ |
| CH₃ | 0 | — | (CH₂)₃OC(CH₃)₃ |
| CH₃ | 0 | — | (CH₂)₃P(═O)(CH₃)₂ |
| CH₃ | 0 | — | CH₂C(═O)CH₂C(CH₃)₃ |
| CH₃ | 0 | — | CH(CH₃)(CH₂)₃CH₃ |
| CH₃ | 0 | — | CH(CH₃)CH₂CH₂CH(CH₃)₂ |
| CH₃ | 0 | — | CH(CH₃)CH₂CH₂C(CH₃)₃ |
| CH₃ | 0 | — | CH(C₂H₅)CH₂CH₂CH(CH₃)₂ |
| CH₃ | 0 | — | CH(CH₂CH₂CH₃)CH₂CH₂CH(CH₃)₂ |
| CH₃ | 0 | — | CH(CH₂CH₂CH(CH₃)₂)₂ |
| CH₃ | 0 | — | CH₂CH₂CH₂N(CH₃)₂ |
| CH₃ | 0 | — | CH₂CH₂N(CH₃)C(CH₃)₃ |
| CH₃ | 0 | — | CH₂CH₂N(CH₃)CH(CH₃)₂ |
| CH₃ | 0 | — | CH₂CH═C(CH₃)₂ |
| CH₃ | 0 | — | (CH₂)₃C(CH₃)₂OCH₃ |
| CH₃ | 0 | — | (CH₂)₃C(CH₃)₂Cl |
| CH₃ | 0 | — | CH₂CH₂CH═O(CH₃)₂ |
| CF₃ | 1 | 5-CH₃ | (CH₂)₄CH₃ |
| CF₃ | 1 | 5-CH₃ | (CH₂)₃C(CH₃)₂OC₂H₅ |
| CF₃ | 1 | 5-CH₃ | (CH₂)₅CH₃ |
| CF₃ | 1 | 5-CH₃ | (CH₂)₆CH₃ |
| CF₃ | 1 | 5-CH₃ | (CH₂)₃C(CH₃)₂Br |
| CF₃ | 1 | 5-CH₃ | (CH₂)₇CH₃ |
| CF₃ | 1 | 5-CH₃ | (CH₂)₃CH(CH₃)₂ |
| CF₃ | 1 | 5-CH₃ | (CH₂)₃C(CH₃)₃ |
| CF₃ | 1 | 5-CH₃ | (CH₂)₃Si(CH₃)₃ |
| CF₃ | 1 | 5-CH₃ | (CH₂)₂CH(CH₃)CH₂C(CH₃)₃ |
| CF₃ | 1 | 5-CH₃ | (CH₂)₃C(═CH₂)CH(CH₃)₂ |
| CF₃ | 1 | 5-CH₃ | (CH₂)₃CH(CH₃)C₂H₅ |
| CF₃ | 1 | 5-CH₃ | (CH₂)₂OSi(CH₃)₂O(CH₃)₃ |
| CF₃ | 1 | 5-CH₃ | (CH₂)₂OC(CH₃)₃ |
| CF₃ | 1 | 5-CH₃ | (CH₂)₂SC(CH₃)₃ |
| CF₃ | 1 | 5-CH₃ | (CH₂)₂SCH(CH₃)₂ |
| CF₃ | 1 | 5-CH₃ | CH₂CH═CHC(CH₃)₃ |
| CF₃ | 1 | 5-CH₃ | CH₂CH═CHCH(CH₃)₂ |
| CF₃ | 1 | 5-CH₃ | (CH₂)₂S(═O)C(CH₃)₃ |
| CF₃ | 1 | 5-CH₃ | (CH₂)₃OSi(CH₃)₂O(CH₃)₃ |
| CF₃ | 1 | 5-CH₃ | (CH₂)₂OCH(CH₃)₂ |
| CF₃ | 1 | 5-CH₃ | (CH₂)₃OC(CH₃)₃ |
| CF₃ | 1 | 5-CH₃ | (CH₂)₃P(═O)(CH₃)₂ |
| CF₃ | 1 | 5-CH₃ | CH₂C(═O)CH₂C(CH₃)₃ |
| CF₃ | 1 | 5-CH₃ | CH(CH₃)(CH₂)₃CH₃ |
| CF₃ | 1 | 5-CH₃ | CH(CH₃)CH₂CH₂CH(CH₃)₂ |
| CF₃ | 1 | 5-CH₃ | CH(CH₃)CH₂CH₂C(CH₃)₃ |
| CF₃ | 1 | 5-CH₃ | CH(C₂H₅)CH₂CH₂CH(CH₃)₂ |
| CF₃ | 1 | 5-CH₃ | CH(CH₂CH₂CH₃)CH₂CH₂CH(CH₃)₂ |
| CF₃ | 1 | 5-CH₃ | CH(CH₂CH₂CH(CH₃)₂)₂ |
| CF₃ | 1 | 5-CH₃ | CH₂CH₂CH₂N(CH₃)₂ |
| CF₃ | 1 | 5-CH₃ | CH₂CH₂N(CH₃)C(CH₃)₃ |
| CF₃ | 1 | 5-CH₃ | CH₂CH₂N(CH₃)CH(CH₃)₂ |
| CF₃ | 1 | 5-CH₃ | CH₂CH═C(CH₃)₂ |
| CF₃ | 1 | 5-CH₃ | (CH₂)₃C(CH₃)₂OCH₃ |
| CF₃ | 1 | 5-CH₃ | (CH₂)₃C(CH₃)₂Cl |
| CF₃ | 1 | 5-CH₃ | CH₂CH₂CH═C(CH₃)₂ |
| CH₃ | 2 | 5-CH₃-6-Cl | (CH₂)₄CH₃ |
| CH₃ | 2 | 5-CH₃-6-Cl | (CH₂)₃C(CH₃)₂OC₂H₅ |
| CH₃ | 2 | 5-CH₃-6-Cl | (CH₂)₅CH₃ |
| CH₃ | 2 | 5-CH₃-6-Cl | (CH₂)₆CH₃ |
| CH₃ | 2 | 5-CH₃-6-Cl | (CH₂)₃C(CH₃)₂Br |
| CH₃ | 2 | 5-CH₃-6-Cl | (CH₂)₇CH₃ |
| CH₃ | 2 | 5-CH₃-6-Cl | (CH₂)₃CH(CH₃)₂ |
| CH₃ | 2 | 5-CH₃-6-Cl | (CH₂)₃C(CH₃)₃ |
| CH₃ | 2 | 5-CH₃-6-Cl | (CH₂)₃Si(CH₃)₃ |
| CH₃ | 2 | 5-CH₃-6-Cl | (CH₂)₂CH(CH₃)CH₂C(CH₃)₃ |
| CH₃ | 2 | 5-CH₃-6-Cl | (CH₂)₃C(═CH₂)CH(CH₃)₂ |
| CH₃ | 2 | 5-CH₃-6-Cl | (CH₂)₃CH(CH₃)C₂H₅ |
| CH₃ | 2 | 5-CH₃-6-Cl | (CH₂)₂OSi(CH₃)₂C(CH₃)₃ |
| CH₃ | 2 | 5-CH₃-6-Cl | (CH₂)₂OC(CH₃)₃ |
| CH₃ | 2 | 5-CH₃-6-Cl | (CH₂)₂SC(CH₃)₃ |
| CH₃ | 2 | 5-CH₃-6-Cl | (CH₂)₂SCH(CH₃)₂ |
| CH₃ | 2 | 5-CH₃-6-Cl | CH₂CH═CHC(CH₃)₃ |
| CH₃ | 2 | 5-CH₃-6-Cl | CH₂CH═CHCH(CH₃)₂ |
| CH₃ | 2 | 5-CH₃-6-Cl | (CH₂)₂S(═O)C(CH₃)₃ |
| CH₃ | 2 | 5-CH₃-6-Cl | (CH₂)₃OSi(CH₃)₂O(CH₃)₃ |
| CH₃ | 2 | 5-CH₃-6-Cl | (CH₂)₂OCH(CH₃)₂ |
| CH₃ | 2 | 5-CH₃-6-Cl | (CH₂)₃OC(CH₃)₃ |
| CH₃ | 2 | 5-CH₃-6-Cl | (CH₂)₃P(═O)(CH₃)₂ |
| CH₃ | 2 | 5-CH₃-6-Cl | CH₂C(═O)CH₂C(CH₃)₃ |
| CH₃ | 2 | 5-CH₃-6-Cl | CH(CH₃)(CH₂)₃CH₃ |
| CH₃ | 2 | 5-CH₃-6-Cl | CH(CH₃)CH₂CH₂CH(CH₃)₂ |
| CH₃ | 2 | 5-CH₃-6-Cl | CH(CH₃)CH₂CH₂C(CH₃)₃ |
| CH₃ | 2 | 5-CH₃-6-Cl | CH(C₂H₅)CH₂CH₂CH(CH₃)₂ |
| CH₃ | 2 | 5-CH₃-6-Cl | CH(CH₂CH₂CH₃)CH₂CH₂CH(CH₃)₂ |
| CH₃ | 2 | 5-CH₃-6-Cl | CH(CH₂CH₂CH(CH₃)₂)₂ |
| CH₃ | 2 | 5-CH₃-6-Cl | CH₂CH₂CH₂N(CH₃)₂ |
| CH₃ | 2 | 5-CH₃-6-Cl | CH₂CH₂N(CH₃)C(CH₃)₃ |
| CH₃ | 2 | 5-CH₃-6-Cl | CH₂CH₂N(CH₃)CH(CH₃)₂ |
| CH₃ | 2 | 5-CH₃-6-Cl | CH₂CH═C(CH₃)₂ |
| CH₃ | 2 | 5-CH₃-6-Cl | (CH₂)₃C(CH₃)₂OCH₃ |
| CH₃ | 2 | 5-CH₃-6-Cl | (CH₂)₃C(CH₃)₂Cl |
| CH₃ | 2 | 5-CH₃-6-Cl | CH₂CH₂CH═C(CH₃)₂ |
| CH₃ | 2 | 3,5-di-CH₃ | (CH₂)₄CH₃ |
| CH₃ | 2 | 3,5-di-CH₃ | (CH₂)₃C(CH₃)₂OC₂H₅ |
| CH₃ | 2 | 3,5-di-CH₃ | (CH₂)₅CH₃ |
| CH₃ | 2 | 3,5-di-CH₃ | (CH₂)₆CH₃ |
| CH₃ | 2 | 3,5-di-CH₃ | (CH₂)₃C(CH₃)₂Br |
| CH₃ | 2 | 3,5-di-CH₃ | (CH₂)₇CH₃ |
| CH₃ | 2 | 3,5-di-CH₃ | (CH₂)₃CH(CH₃)₂ |
| CH₃ | 2 | 3,5-di-CH₃ | (CH₂)₃C(CH₃)₃ |
| CH₃ | 2 | 3,5-di-CH₃ | (CH₂)₃Si(CH₃)₃ |
| CH₃ | 2 | 3,5-di-CH₃ | (CH₂)₂CH(CH₃)CH₂C(CH₃)₃ |
| CH₃ | 2 | 3,5-di-CH₃ | (CH₂)₃C(═CH₂)CH(CH₃)₂ |
| CH₃ | 2 | 3,5-di-CH₃ | (CH₂)₃CH(CH₃)C₂H₅ |
| CH₃ | 2 | 3,5-di-CH₃ | (CH₂)₂OSi(CH₃)₂C(CH₃)₃ |
| CH₃ | 2 | 3,5-di-CH₃ | (CH₂)₂OC(CH₃)₃ |
| CH₃ | 2 | 3,5-di-CH₃ | (CH₂)₂SC(CH₃)₃ |
| CH₃ | 2 | 3,5-di-CH₃ | (CH₂)₂SCH(CH₃)₂ |
| CH₃ | 2 | 3,5-di-CH₃ | CH₂CH═CHC(CH₃)₃ |
| CH₃ | 2 | 3,5-di-CH₃ | CH₂CH═CHCH(CH₃)₂ |
| CH₃ | 2 | 3,5-di-CH₃ | (CH₂)₂S(═O)C(CH₃)₃ |
| CH₃ | 2 | 3,5-di-CH₃ | (CH₂)3OSi(CH₃)₂C(CH₃)₃ |
| CH₃ | 2 | 3,5-di-CH₃ | (CH₂)₂OCH(CH₃)₂ |
| CH₃ | 2 | 3,5-di-CH₃ | (CH₂)₃OC(CH₃)₃ |
| CH₃ | 2 | 3,5-di-CH₃ | (CH₂)₃P(═O)(CH₃)₂ |
| CH₃ | 2 | 3,5-di-CH₃ | CH₂C(═O)CH₂C(CH₃)₃ |
| CH₃ | 2 | 3,5-di-CH₃ | CH(CH₃)(CH₂)₃CH₃ |
| CH₃ | 2 | 3,5-di-CH₃ | CH(CH₃)CH₂CH₂CH(CH₃)₂ |
| CH₃ | 2 | 3,5-di-CH₃ | CH(CH₃)CH₂CH₂C(CH₃)₃ |
| CH₃ | 2 | 3,5-di-CH₃ | CH(C₂H₅)CH₂CH₂CH(CH₃)₂ |
| CH₃ | 2 | 3,5-di-CH₃ | CH(CH₂CH₂CH₃)CH₂CH₂CH(CH₃)₂ |
| CH₃ | 2 | 3,5-di-CH₃ | CH(CH₂CH₂CH(CH₃)₂)₂ |
| CH₃ | 2 | 3,5-di-CH₃ | CH₂CH₂CH₂N(CH₃)₂ |
| CH₃ | 2 | 3,S-di-CH₃ | CH₂CH₂N(CH₃)C(CH₃)₃ |
| CH₃ | 2 | 3,5-di-CH₃ | CH₂CH₂N(CH₃)CH(CH₃)₂ |
| CH₃ | 2 | 3,5-di-CH₃ | CH₂CH═C(CH₃)₂ |
| CH₃ | 2 | 3,5-di-CH₃ | (CH₂)₃C(CH₃)₂OCH₃ |
| CH₃ | 2 | 3,5-di-CH₃ | (CH₂)₃C(CH₃)₂Cl |
| CH₃ | 2 | 3,5-di-CH₃ | CH₂CH₂CH═C(CH₃)₂ |
| CH₃ | 1 | 3-CH₃ | (CH₂)₄CH₃ |
| CH₃ | 1 | 3-CH₃ | (CH₂)₃C(CH₃)₂OC₂H₅ |
| CH₃ | 1 | 3-CH₃ | (CH₂)₅CH₃ |
| CH₃ | 1 | 3-CH₃ | (CH₂)₆CH₃ |
| CH₃ | 1 | 3-CH₃ | (CH₂)₃C(CH₃)₂Br |
| CH₃ | 1 | 3-CH₃ | (CH₂)₇CH₃ |
| CH₃ | 1 | 3-CH₃ | (CH₂)₃CH(CH₃)₂ |
| CH₃ | 1 | 3-CH₃ | (CH₂)₃C(CH₃)₃ |
| CH₃ | 1 | 3-CH₃ | (CH₂)₃Si(CH₃)₃ |
| CH₃ | 1 | 3-CH₃ | (CH₂)₂CH(CH₃)CH₂C(CH₃)₃ |
| CH₃ | 1 | 3-CH₃ | (CH₂)₃C(═CH₂)CH(CH₃)₂ |
| CH₃ | 1 | 3-CH₃ | (CH₂)₃CH(CH₃)C₂H₅ |
| CH₃ | 1 | 3-CH₃ | (CH₂)₂OSi(CH₃)₂O(CH₃)₃ |
| CH₃ | 1 | 3-CH₃ | (CH₂)₂OC(CH₃)₃ |
| CH₃ | 1 | 3-CH₃ | (CH₂)₂SC(CH₃)₃ |
| CH₃ | 1 | 3-CH₃ | (CH₂)₂SCH(CH₃)₂ |
| CH₃ | 1 | 3-CH₃ | CH₂CH═CHC(CH₃)₃ |
| CH₃ | 1 | 3-CH₃ | CH₂CH═CHCH(CH₃)₂ |
| CH₃ | 1 | 3-CH₃ | (CH₂)₂S(═O)C(CH₃)₃ |
| CH₃ | 1 | 3-CH₃ | (CH₂)₃OSi(CH₃)₂C(CH₃)₃ |
| CH₃ | 1 | 3-CH₃ | (CH₂)₂OCH(CH₃)₂ |
| CH₃ | 1 | 3-CH₃ | (CH₂)₃OC(CH₃)₃ |
| CH₃ | 1 | 3-CH₃ | (CH₂)₃P(═O)(CH₃)₂ |
| CH₃ | 1 | 3-CH₃ | CH₂C(═O)CH₂C(CH₃)₃ |
| CH₃ | 1 | 3-CH₃ | CH(CH₃)(CH₂)₃CH₃ |
| CH₃ | 1 | 3-CH₃ | CH(CH₃)CH₂CH₂CH(CH₃)₂ |
| CH₃ | 1 | 3-CH₃ | CH(CH₃)CH₂CH₂C(CH₃)₃ |
| CH₃ | 1 | 3-CH₃ | CH(C₂H₅)CH₂CH₂CH(CH₃)₂ |
| CH₃ | 1 | 3-CH₃ | CH(CH₂CH₂CH₃)CH₂CH₂CH(CH₃)₂ |
| CH₃ | 1 | 3-CH₃ | CH(CH₂CH₂CH(CH₃)₂)₂ |
| CH₃ | 1 | 3-CH₃ | CH₂CH₂CH₂N(CH₃)₂ |
| CH₃ | 1 | 3-CH₃ | CH₂CH₂N(CH₃)C(CH₃)₃ |
| CH₃ | 1 | 3-CH₃ | CH₂CH₂N(CH₃)CH(CH₃)₂ |
| CH₃ | 1 | 3-CH₃ | CH₂CH═C(CH₃)₂ |
| CH₃ | 1 | 3-CH₃ | (CH₂)₃C(CH₃)₂OCH₃ |
| CH₃ | 1 | 3-CH₃ | (CH₂)₃C(CH₃)₂Cl |
| CH₃ | 1 | 3-CH₃ | CH₂CH₂CH═C(CH₃)₂ |
| CH₃ | 3 | 3,6-di-Cl-5-CH₃ | (CH₂)₄CH₃ |
| CH₃ | 3 | 3,6-di-Cl-5 -CH₃ | (CH₂)₃C(CH₃)₂OC₂H₅ |
| CH₃ | 3 | 3,6-di-Cl-5-CH₃ | (CH₂)₅CH₃ |
| CH₃ | 3 | 3,6-di-Cl-5-CH₃ | (CH₂)₆CH₃ |
| CH₃ | 3 | 3,6-di-Cl-5-CH₃ | (CH₂)₃C(CH₃)₂Br |
| CH₃ | 3 | 3,6-di-Cl-5-CH₃ | (CH₂)₇CH₃ |
| CH₃ | 3 | 3,6-di-Cl-5-CH₃ | (CH₂)₃CH(CH₃)₂ |
| CH₃ | 3 | 3,6-di-Cl-5-CH₃ | (CH₂)₃C(CH₃)₃ |
| CH₃ | 3 | 3,6-di-Cl-5-CH₃ | (CH₂)₃Si(CH₃)₃ |
| CH₃ | 3 | 3,6-di-Cl-5-CH₃ | (CH₂)₂CH(CH₃)CH₂C(CH₃)₃ |
| CH₃ | 3 | 3,6-di-Cl-5-CH₃ | (CH₂)₃C(═CH₂)CH(CH₃)₂ |
| CH₃ | 3 | 3,6-di-Cl-5-CH₃ | (CH₂)₃CH(CH₃)C₂H₅ |
| CH₃ | 3 | 3,6-di-Cl-5-CH₃ | (CH₂)₂OSi(CH₃)₂C(CH₃)₃ |
| CH₃ | 3 | 3,6-di-Cl-5-CH₃ | (CH₂)₂OC(CH₃)₃ |
| CH₃ | 3 | 3,6-di-Cl-5-CH₃ | (CH₂)₂SC(CH₃)₃ |
| CH₃ | 3 | 3,6-di-Cl-5-CH₃ | (CH₂)₂SCH(CH₃)₂ |
| CH₃ | 3 | 3,6-di-Cl-5-CH₃ | CH₂CH═CHC(CH₃)₃ |
| CH₃ | 3 | 3,6-di-Cl-5-CH₃ | CH₂CH═CHCH(CH₃)₂ |
| CH₃ | 3 | 3,6-di-Cl-5-CH₃ | (CH₂)₂S(═O)C(CH₃)₃ |
| CH₃ | 3 | 3,6-di-Cl-5-CH₃ | (CH₂)₃OSi(CH₃)₂C(CH₃)₃ |
| CH₃ | 3 | 3,6-di-Cl-5-CH₃ | (CH₂)₂OCH(CH₃)₂ |
| CH₃ | 3 | 3,6-di-Cl-5-CH₃ | (CH₂)₃OC(CH₃)₃ |
| CH₃ | 3 | 3,6-di-Cl-5-CH₃ | (CH₂)₃P(═O)(CH₃)₂ |
| CH₃ | 3 | 3,6-di-Cl-5-CH₃ | CH₂C(═O)CH₂C(CH₃)₃ |
| CH₃ | 3 | 3,6-di-Cl-5-CH₃ | CH(CH₃)(CH₂)₃CH₃ |
| CH₃ | 3 | 3,6-di-Cl-5-CH₃ | CH(CH₃)CH₂CH₂CH(CH₃)₂ |
| CH₃ | 3 | 3,6-di-Cl-5-CH₃ | CH(CH₃)CH₂CH₂C(CH₃)₃ |
| CH₃ | 3 | 3,6-di-Cl-5-CH₃ | CH(C₂H₅)CH₂CH₂CH(CH₃)₂ |
| CH₃ | 3 | 3,6-di-Cl-5-CH₃ | CH(CH₂CH₂CH₃)CH₂CH₂CH(CH₃)₂ |
| CH₃ | 3 | 3,6-di-Cl-5-CH₃ | CH(CH₂CH₂CH(CH₃)₂)₂ |
| CH₃ | 3 | 3,6-di-Cl-5-CH₃ | CH₂CH₂CH₂N(CH₃)₂ |
| CH₃ | 3 | 3,6-di-Cl-5-CH₃ | CH₂CH₂N(CH₃)C(CH₃)₃ |
| CH₃ | 3 | 3,6-di-Cl-5-CH₃ | CH₂CH₂N(CH₃)CH(CH₃)₂ |
| CH₃ | 3 | 3,6-di-Cl-5-CH₃ | CH₂CH═C(CH₃)₂ |
| CH₃ | 3 | 3,6-di-Cl-5-CH₃ | (CH₂)₃C(CH₃)₂OCH₃ |
| CH₃ | 3 | 3,6-di-Cl-5-CH₃ | (CH₂)₃C(CH₃)₂Cl |
| CH₃ | 3 | 3,6-di-Cl-5-CH₃ | CH₂CH₂CH═C(CH₃)₂ |
| F | 3 | 3,5,6-tri-F | (CH₂)₄CH₃ |
| F | 3 | 3,5,6-tri-F | (CH₂)₃C(CH₃)₂OC₂H₅ |
| F | 3 | 3,5,6-tri-F | (CH₂)₅CH₃ |
| F | 3 | 3,5,6-tri-F | (CH₂)₆CH₃ |
| F | 3 | 3,5,6-tri-F | (CH₂)₃C(CH₃)₂Br |
| F | 3 | 3,5,6-tri-F | (CH₂)₇CH₃ |
| F | 3 | 3,5,6-tri-F | (CH₂)₃CH(CH₃)₂ |
| F | 3 | 3,5,6-tri-F | (CH₂)₃C(CH₃)₃ |
| F | 3 | 3,5,6-tri-F | (CH₂)₃Si(CH₃)₃ |
| F | 3 | 3,5,6-tri-F | (CH₂)₂CH(CH₃)CH₂C(CH₃)₃ |
| F | 3 | 3,5,6-tri-F | (CH₂)₃C(═CH₂)CH(CH₃)₂ |
| F | 3 | 3,5,6-tri-F | (CH₂)₃CH(CH₃)C₂H₅ |
| F | 3 | 3,5,6-tri-F | (CH₂)₂OSi(CH₃)₂C(CH₃)₃ |
| F | 3 | 3,5,6-tri-F | (CH₂)₂OC(CH₃)₃ |
| F | 3 | 3,5,6-tri-F | (CH₂)₂SC(CH₃)₃ |
| F | 3 | 3,5,6-tri-F | (CH₂)₂SCH(CH₃)₂ |
| F | 3 | 3,5,6-tri-F | CH₂CH═CHC(CH₃)₃ |
| F | 3 | 3,5,6-tri-F | CH₂CH═CHCH(CH₃)₂ |
| F | 3 | 3,5,6-tri-F | (CH₂)₂S(═O)C(CH₃)₃ |
| F | 3 | 3,5,6-tri-F | (CH₂)₃OSi(CH₃)₂C(CH₃)₃ |
| F | 3 | 3,5,6-tri-F | (CH₂)₂OCH(CH₃)₂ |
| F | 3 | 3,5,6-tri-F | (CH₂)₃OC(CH₃)₃ |
| F | 3 | 3,5,6-tri-F | (CH₂)₃P(═O)(CH₃)₂ |
| F | 3 | 3,5,6-tri-F | CH₂C(═O)CH₂C(CH₃)₃ |
| F | 3 | 3,5,6-tri-F | CH(CH₃)(CH₂)₃CH₃ |
| F | 3 | 3,5,6-tri-F | CH(CH₃)CH₂CH₂CH(CH₃)₂ |
| F | 3 | 3,5,6-tri-F | CH(CH₃)CH₂CH₂C(CH₃)₃ |
| F | 3 | 3,5,6-tri-F | CH(C₂H₅)CH₂CH₂CH(CH₃)₂ |
| F | 3 | 3,5,6-tri-F | CH(CH₂CH₂CH₃)CH₂CH₂CH(CH₃)₂ |
| F | 3 | 3,5,6-tri-F | CH(CH₂CH₂CH(CH₃)₂)₂ |
| F | 3 | 3,5,6-tri-F | CH₂CH₂CH₂N(CH₃)₂ |
| F | 3 | 3,5,6-tri-F | CH₂CH₂N(CH₃)C(CH₃)₃ |
| F | 3 | 3,5,6-tri-F | CH₂CH₂N(CH₃)CH(CH₃)₂ |
| F | 3 | 3,5,6-tri-F | CH₂CH═C(CH₃)₂ |
| F | 3 | 3,5,6-tri-F | (CH₂)₃C(CH₃)₂OCH₃ |
| F | 3 | 3,5,6-tri-F | (CH₂)₃C(CH₃)₂Cl |
| F | 3 | 3,5,6-tri-F | CH₂CH₂CH═C(CH₃)₂ |
| Cl | 3 | 3,5,6-tri-Cl | (CH₂)₄CH₃ |
| Cl | 3 | 3,5,6-tri-Cl | (CH₂)₃C(CH₃)₂OC₂H₅ |
| Cl | 3 | 3,5,6-tri-Cl | (CH₂)₅CH₃ |
| Cl | 3 | 3,5,6-tri-Cl | (CH₂)₆CH₃ |
| Cl | 3 | 3,5,6-tri-Cl | (CH₂)₃C(CH₃)₂Br |
| Cl | 3 | 3,5,6-tri-Cl | (CH₂)₇CH₃ |
| Cl | 3 | 3,5,6-tri-Cl | (CH₂)₃CH(CH₃)₂ |
| Cl | 3 | 3,5,6-tri-Cl | (CH₂)₃C(CH₃)₃ |
| Cl | 3 | 3,5,6-tri-Cl | (CH₂)₃Si(CH₃)₃ |
| Cl | 3 | 3,5,6-tri-Cl | (CH₂)₂CH(CH₃)CH₂C(CH₃)₃ |
| Cl | 3 | 3,5,6-tri-Cl | (CH₂)₃C(═CH₂)CH(CH₃)₂ |
| Cl | 3 | 3,5,6-tri-Cl | (CH₂)₃CH(CH₃)C₂H₅ |
| Cl | 3 | 3,5,6-tri-Cl | (CH₂)₂OSi(CH₃)₂C(CH₃)₃ |
| Cl | 3 | 3,5,6-tri-Cl | (CH₂)₂OC(CH₃)₃ |
| Cl | 3 | 3,5,6-tri-Cl | (CH₂)₂SC(CH₃)₃ |
| Cl | 3 | 3,5,6-tri-Cl | (CH₂)₂SCH(CH₃)₂ |
| Cl | 3 | 3,5,6-tri-Cl | CH₂CH═CHC(CH₃)₃ |
| Cl | 3 | 3,5,6-tri-Cl | CH₂CH═CHCH(CH₃)₂ |
| Cl | 3 | 3,5,6-tri-Cl | (CH₂)₂S(═O)C(CH₃)₃ |
| Cl | 3 | 3,5,6-tri-Cl | (CH₂)₃OSi(CH₃)₂C(CH₃)₃ |
| Cl | 3 | 3,5,6-tri-Cl | (CH₂)₂OCH(CH₃)₂ |
| Cl | 3 | 3,5,6-tri-Cl | (CH₂)₃OC(CH₃)₃ |
| Cl | 3 | 3,5,6-tri-Cl | (CH₂)₃P(═O)(CH₃)₂ |
| Cl | 3 | 3,5,6-tri-Cl | CH₂C(═O)CH₂C(CH₃)₃ |
| Cl | 3 | 3,5,6-tri-Cl | CH(CH₃)(CH₂)₃CH₃ |
| Cl | 3 | 3,5,6-tri-Cl | CH(CH₃)CH₂CH₂CH(CH₃)₂ |
| Cl | 3 | 3,5,6-tri-Cl | CH(CH₃)CH₂CH₂C(CH₃)₃ |
| Cl | 3 | 3,5,6-tri-Cl | CH(C₂H₅)CH₂CH₂CH(CH₃)₂ |
| Cl | 3 | 3,5,6-tri-Cl | CH(CH₂CH₂CH₃)CH₂CH₂CH(CH₃)₂ |
| Cl | 3 | 3,5,6-tri-Cl | CH(CH₂CH₂CH(CH₃)₂)₂ |
| Cl | 3 | 3,5,6-tri-Cl | CH₂CH₂CH₂N(CH₃)₂ |
| Cl | 3 | 3,5,6-tri-Cl | CH₂CH₂N(CH₃)C(CH₃)₃ |
| Cl | 3 | 3,5,6-tri-Cl | CH₂CH₂N(CH₃)CH(CH₃)₂ |
| Cl | 3 | 3,5,6-tri-Cl | CH₂CH═C(CH₃)₂ |
| Cl | 3 | 3,5,6-tri-Cl | (CH₂)₃C(CH₃)₂OCH₃ |
| Cl | 3 | 3,5,6-tri-Cl | (CH₂)₃C(CH₃)₂Cl |
| Cl | 3 | 3,5,6-tri-Cl | CH₂CH₂CH═C(CH₃)₂ |
| CH₃ | 1 | 5-CH(CH₃)₂ | (CH₂)₄CH₃ |
| CH₃ | 1 | 5-CH(CH₃)₂ | (CH₂)₃C(CH₃)₂OC₂H₅ |
| CH₃ | 1 | 5-CH(CH₃)₂ | (CH₂)₅CH₃ |
| CH₃ | 1 | 5-CH(CH₃)₂ | (CH₂)₆CH₃ |
| CH₃ | 1 | 5-CH(CH₃)₂ | (CH₂)₃C(CH₃)₂Br |
| CH₃ | 1 | 5-CH(CH₃)₂ | (CH₂)₇CH₃ |
| CH₃ | 1 | 5-CH(CH₃)₂ | (CH₂)₃CH(CH₃)₂ |
| CH₃ | 1 | 5-CH(CH₃)₂ | (CH₂)₃C(CH₃)₃ |
| CH₃ | 1 | 5-CH(CH₃)₂ | (CH₂)₃Si(CH₃)₃ |
| CH₃ | 1 | 5-CH(CH₃)₂ | (CH₂)₂CH(CH₃)CH₂C(CH₃)₃ |
| CH₃ | 1 | 5-CH(CH₃)₂ | (CH₂)₃C(═CH₂)CH(CH₃)₂ |
| CH₃ | 1 | 5-CH(CH₃)₂ | (CH₂)₃CH(CH₃)C₂H₅ |
| CH₃ | 1 | 5-CH(CH₃)₂ | (CH₂)₂OSi(CH₃)₂C(CH₃)₃ |
| CH₃ | 1 | 5-CH(CH₃)₂ | (CH₂)₂OC(CH₃)₃ |
| CH₃ | 1 | 5-CH(CH₃)₂ | (CH₂)₂SC(CH₃)₃ |
| CH₃ | 1 | 5-CH(CH₃)₂ | (CH₂)₂SCH(CH₃)₂ |
| CH₃ | 1 | 5-CH(CH₃)₂ | CH₂CH═CHC(CH₃)₃ |
| CH₃ | 1 | 5-CH(CH₃)₂ | CH₂CH═CHCH(CH₃)₂ |
| CH₃ | 1 | 5-CH(CH₃)₂ | (CH₂)₂S(═O)C(CH₃)₃ |
| CH₃ | 1 | 5-CH(CH₃)₂ | (CH₂)₃OSi(CH₃)₂C(CH₃)₃ |
| CH₃ | 1 | 5-CH(CH₃)₂ | (CH₂)₂OCH(CH₃)₂ |
| CH₃ | 1 | 5-CH(CH₃)₂ | (CH₂)₃OC(CH₃)₃ |
| CH₃ | 1 | 5-CH(CH₃)₂ | (CH₂)₃P(═O)(CH₃)₂ |
| CH₃ | 1 | 5-CH(CH₃)₂ | CH₂C(═O)CH₂C(CH₃)₃ |
| CH₃ | 1 | 5-CH(CH₃)₂ | CH(CH₃)(CH₂)₃CH₃ |
| CH₃ | 1 | 5-CH(CH₃)₂ | CH(CH₃)CH₂CH₂CH(CH₃)₂ |
| CH₃ | 1 | 5-CH(CH₃)₂ | CH(CH₃)CH₂CH₂C(CH₃)₃ |
| CH₃ | 1 | 5-CH(CH₃)₂ | CH(C₂H₅)CH₂CH₂CH(CH₃)₂ |
| CH₃ | 1 | 5-CH(CH₃)₂ | CH(CH₂CH₂CH₃)CH₂CH₂CH(CH₃)₂ |
| CH₃ | 1 | 5-CH(CH₃)₂ | CH(CH₂CH₂CH(CH₃)₂)₂ |
| CH₃ | 1 | 5-CH(CH₃)₂ | CH₂CH₂CH₂N(CH₃)₂ |
| CH₃ | 1 | 5-CH(CH₃)₂ | CH₂CH₂N(CH₃)C(CH₃)₃ |
| CH₃ | 1 | 5-CH(CH₃)₂ | CH₂CH₂N(CH₃)CH(CH₃)₂ |
| CH₃ | 1 | 5-CH(CH₃)₂ | CH₂CH═C(CH₃)₂ |
| CH₃ | 1 | 5-CH(CH₃)₂ | (CH₂)₃C(CH₃)₂OCH₃ |
| CH₃ | 1 | 5-CH(CH₃)₂ | (CH₂)₃C(CH₃)₂Cl |
| CH₃ | 1 | 5-C(CH₃)₃ | (CH₂)₄CH₃ |
| CH₃ | 1 | 5-C(CH₃)₃ | (CH₂)₃C(CH₃)₂OC₂H₅ |
| CH₃ | 1 | 5-C(CH₃)₃ | (CH₂)₅CH₃ |
| CH₃ | 1 | 5-C(CH₃)₃ | (CH₂)₆CH₃ |
| CH₃ | 1 | 5-C(CH₃)₃ | (CH₂)₃C(CH₃)₂Br |
| CH₃ | 1 | 5-C(CH₃)₃ | (CH₂)₇CH₃ |
| CH₃ | 1 | 5-C(CH₃)₃ | (CH₂)₃CH(CH₃)₂ |
| CH₃ | 1 | 5-C(CH₃)₃ | (CH₂)₃C(CH₃)₃ |
| CH₃ | 1 | 5-C(CH₃)₃ | (CH₂)₃Si(CH₃)₃ |
| CH₃ | 1 | 5-C(CH₃)₃ | (CH₂)₂CH(CH₃)CH₂C(CH₃)₃ |
| CH₃ | 1 | 5-C(CH₃)₃ | (CH₂)₃C(═CH₂)CH(CH₃)₂ |
| CH₃ | 1 | 5-C(CH₃)₃ | (CH₂)₃CH(CH₃)C₂H₅ |
| CH₃ | 1 | 5-C(CH₃)₃ | (CH₂)₂OSi(CH₃)₂C(CH₃)₃ |
| CH₃ | 1 | 5-C(CH₃)₃ | (CH₂)₂OC(CH₃)₃ |
| CH₃ | 1 | 5-C(CH₃)₃ | (CH₂)₂SC(CH₃)₃ |
| CH₃ | 1 | 5-C(CH₃)₃ | (CH₂)₂SCH(CH₃)₂ |
| CH₃ | 1 | 5-C(CH₃)₃ | CH₂CH═CHC(CH₃)₃ |
| CH₃ | 1 | 5-C(CH₃)₃ | CH₂CH═CHCH(CH₃)₂ |
| CH₃ | 1 | 5-C(CH₃)₃ | (CH₂)₂S(═O)C(CH₃)₃ |
| CH₃ | 1 | 5-C(CH₃)₃ | (CH₂)₃OSi(CH₃)₂C(CH₃)₃ |
| CH₃ | 1 | 5-C(CH₃)₃ | (CH₂)₂OCH(CH₃)₂ |
| CH₃ | 1 | 5-C(CH₃)₃ | (CH₂)₃OC(CH₃)₃ |
| CH₃ | 1 | 5-C(CH₃)₃ | (CH₂)₃P(═O)(CH₃)₂ |
| CH₃ | 1 | 5-C(CH₃)₃ | CH₂C(═O)CH₂C(CH₃)₃ |
| CH₃ | 1 | 5-C(CH₃)₃ | CH(CH₃)(CH₂)₃CH₃ |
| CH₃ | 1 | 5-C(CH₃)₃ | CH(CH₃)CH₂CH₂CH(CH₃)₂ |
| CH₃ | 1 | 5-C(CH₃)₃ | CH(CH₃)CH₂CH₂C(CH₃)₃ |
| CH₃ | 1 | 5-C(CH₃)₃ | CH(C₂H₅)CH₂CH₂CH(CH₃)₂ |
| CH₃ | 1 | 5-C(CH₃)₃ | CH(CH₂CH₂CH₃)CH₂CH₂CH(CH₃)₂ |
| CH₃ | 1 | 5-C(CH₃)₃ | CH(CH₂CH₂CH(CH₃)₂)₂ |
| CH₃ | 1 | 5-C(CH₃)₃ | CH₂CH₂CH₂N(CH₃)₂ |
| CH₃ | 1 | 5-C(CH₃)₃ | CH₂CH₂N(CH₃)C(CH₃)₃ |
| CH₃ | 1 | 5-C(CH₃)₃ | CH₂CH₂N(CH₃)CH(CH₃)₂ |
| CH₃ | 1 | 5-C(CH₃)₃ | CH₂CH═C(CH₃)₂ |
| CH₃ | 1 | 5-C(CH₃)₃ | (CH₂)₃C(CH₃)₂OCH₃ |
| CH₃ | 1 | 5-C(CH₃)₃ | (CH₂)₃C(CH₃)₂Cl |

TABLE 5

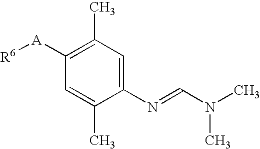

| A | R⁶ |
|---|---|
| NH | C(═O)CH₂SC(CH₃)₃ |
| NH | C(═O)CH₂S(═O)C(CH₃)₃ |
| NH | C(═O)CH₂S(═O)₂C(CH₃)₃ |
| NH | C(═O)OCH₂C(CH₃)₃ |
| NH | C(═O)NHCH₂C(CH₃)₃ |
| NH | C(═O)N(CH₃)CH₂C(CH₃)₃ |
| NH | C(═O)OCH₂CH(CH₃)₂ |
| NH | C(═O)NHCH₂CH(CH₃)₂ |
| NH | C(═O)N(CH₃)CH₂CH(CH₃)₂ |
| O | C(CH₃)₂CH₂CH₂CH(CH₃)₂ |
| O | C(CH₃)(CH₂CH₂CH₂CH₃)₂ |
| O | C(CH₃)(CH₂CH₂CH₃)₂ |

TABLE 6

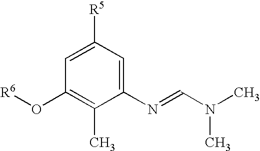

| R⁵ | R⁶ |
|---|---|
| 5-CH₃ | (CH₂)₄CH₃ |
| 5-CH₃ | (CH₂)₃C(CH₃)₂OC₂H₅ |
| 5-CH₃ | (CH₂)₅CH₃ |
| 5-CH₃ | (CH₂)₆CH₃ |
| 5-CH₃ | (CH₂)₃C(CH₃)₂Br |
| 5-CH₃ | (CH₂)₇CH₃ |
| 5-CH₃ | (CH₂)₃CH(CH₃)₂ |
| 5-CH₃ | (CH₂)₃C(CH₃)₃ |
| 5-CH₃ | (CH₂)₃Si(CH₃)₃ |
| 5-CH₃ | (CH₂)₂CH(CH₃)CH₂C(CH₃)₃ |
| 5-CH₃ | (CH₂)₃C(═CH₂)CH(CH₃)₂ |
| 5-CH₃ | (CH₂)₃CH(CH₃)C₂H₅ |
| 5-CH₃ | (CH₂)₂OSi(CH₃)₂C(CH₃)₃ |
| 5-CH₃ | (CH₂)₂OC(CH₃)₃ |
| 5-CH₃ | (CH₂)₂SC(CH₃)₃ |
| 5-CH₃ | (CH₂)₂SCH(CH₃)₂ |
| 5-CH₃ | CH₂CH═CHC(CH₃)₃ |
| 5-CH₃ | CH₂CH═CHCH(CH₃)₂ |
| 5-CH₃ | (CH₂)₂S(═O)C(CH₃)₃ |
| 5-CH₃ | (CH₂)₃OSi(CH₃)₂C(CH₃)₃ |
| 5-CH₃ | (CH₂)₂OCH(CH₃)₂ |
| 5-CH₃ | (CH₂)₃OC(CH₃)₃ |
| 5-CH₃ | (CH₂)₃P(═O)(CH₃)₂ |
| 5-CH₃ | CH₂C(═O)CH₂C(CH₃)₃ |
| 5-CH₃ | CH(CH₃)(CH₂)₃CH₃ |
| 5-CH₃ | CH(CH₃)CH₂CH₂CH(CH₃)₂ |
| 5-CH₃ | CH(CH₃)CH₂CH₂C(CH₃)₃ |
| 5-CH₃ | CH(C₂H₅)CH₂CH₂CH(CH₃)₂ |
| 5-CH₃ | CH(CH₂CH₂CH₃)CH₂CH₂CH(CH₃)₂ |
| 5-CH₃ | CH(CH₂CH₂CH(CH₃)₂)₂ |
| 5-CH₃ | CH₂CH₂CH₂N(CH₃)₂ |
| 5-CH₃ | CH₂CH₂N(CH₃)C(CH₃)₃ |
| 5-CH₃ | CH₂CH₂N(CH₃)CH(CH₃)₂ |
| 5-CH₃ | CH₂CH═C(CH₃)₂ |
| 5-CH₃ | (CH₂)₃C(CH₃)₂OCH₃ |
| 5-CH₃ | (CH₂)₃C(CH₃)₂Cl |
| 5-CH₃ | CH₂CH₂CH═C(CH₃)₂ |

TABLE 7

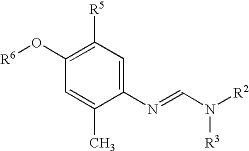

| R² + R³ | R⁶ |
|---|---|
| —(CH₂)₄— | (CH₂)₄CH₃ |
| —(CH₂)₄— | (CH₂)₃C(CH₃)₂OC₂H₅ |
| —(CH₂)₄— | (CH₂)₅CH₃ |
| —(CH₂)₄— | (CH₂)₆CH₃ |
| —(CH₂)₄— | (CH₂)₃C(CH₃)₂Br |
| —(CH₂)₄— | (CH₂)₇CH₃ |
| —(CH₂)₄— | (CH₂)₃CH(CH₃)₂ |
| —(CH₂)₄— | (CH₂)₃C(CH₃)₃ |
| —(CH₂)₄— | (CH₂)₃Si(CH₃)₃ |
| —(CH₂)₄— | (CH₂)₂CH(CH₃)CH₂C(CH₃)₃ |
| —(CH₂)₄— | (CH₂)₃C(═CH₂)CH(CH₃)₂ |
| —(CH₂)₄— | (CH₂)₃CH(CH₃)C₂H₅ |
| —(CH₂)₄— | (CH₂)₂OSi(CH₃)₂C(CH₃)₃ |
| —(CH₂)₄— | (CH₂)₂OC(CH₃)₃ |
| —(CH₂)₄— | (CH₂)₂SC(CH₃)₃ |
| —(CH₂)₄— | (CH₂)₂SCH(CH₃)₂ |
| —(CH₂)₄— | CH₂CH═CHC(CH₃)₃ |
| —(CH₂)₄— | CH₂CH═CHCH(CH₃)₂ |
| —(CH₂)₄— | (CH₂)₂S(═O)C(CH₃)₃ |
| —(CH₂)₄— | (CH₂)₃OSi(CH₃)₂C(CH₃)₃ |
| —(CH₂)₄— | (CH₂)₂OCH(CH₃)₂ |
| —(CH₂)₄— | (CH₂)₃OC(CH₃)₃ |
| —(CH₂)₄— | (CH₂)₃P(═O)(CH₃)₂ |
| —(CH₂)₄— | CH₂C(═O)CH₂C(CH₃)₃ |
| —(CH₂)₄— | CH(CH₃)(CH₂)₃CH₃ |
| —(CH₂)₄— | CH(CH₃)CH₂CH₂CH(CH₃)₂ |
| —(CH₂)₄— | CH(CH₃)CH₂CH₂C(CH₃)₃ |
| —(CH₂)₄— | CH(C₂H₅)CH₂CH₂CH(CH₃)₂ |
| —(CH₂)₄— | CH(CH₂CH₂CH₃)CH₂CH₂CH(CH₃)₂ |
| —(CH₂)₄— | CH(CH₂CH₂CH(CH₃)₂)₂ |
| —(CH₂)₄— | CH₂CH₂CH₂N(CH₃)₂ |
| —(CH₂)₄— | CH₂CH₂N(CH₃)C(CH₃)₃ |
| —(CH₂)₄— | CH₂CH₂N(CH₃)CH(CH₃)₂ |
| —(CH₂)₄— | CH₂CH═C(CH₃)₂ |
| —(CH₂)₄— | (CH₂)₃C(CH₃)₂OCH₃ |
| —(CH₂)₄— | (CH₂)₃C(CH₃)₂Cl |
| —(CH₂)₄— | CH₂CH₂CH═C(CH₃)₂ |
| —CH₂CH₂OCH₂CH₂— | (CH₂)₄CH₃ |
| —CH₂CH₂OCH₂CH₂— | (CH₂)₃C(CH₃)₂OC₂H₅ |
| —CH₂CH₂OCH₂CH₂— | (CH₂)₅CH₃ |
| —CH₂CH₂OCH₂CH₂— | (CH₂)₆CH₃ |
| —CH₂CH₂OCH₂CH₂— | (CH₂)₃C(CH₃)₂Br |
| —CH₂CH₂OCH₂CH₂— | (CH₂)₇CH₃ |
| —CH₂CH₂OCH₂CH₂— | (CH₂)₃CH(CH₃)₂ |
| —CH₂CH₂OCH₂CH₂— | (CH₂)₃C(CH₃)₃ |
| —CH₂CH₂OCH₂CH₂— | (CH₂)₃Si(CH₃)₃ |
| —CH₂CH₂OCH₂CH₂— | (CH₂)₂CH(CH₃)CH₂C(CH₃)₃ |
| —CH₂CH₂OCH₂CH₂— | (CH₂)₃C(═CH₂)CH(CH₃)₂ |
| —CH₂CH₂OCH₂CH₂— | (CH₂)₃CH(CH₃)C₂H₅ |
| —CH₂CH₂OCH₂CH₂— | (CH₂)₂OSi(CH₃)₂C(CH₃)₃ |
| —CH₂CH₂OCH₂CH₂— | (CH₂)₂OC(CH₃)₃ |
| —CH₂CH₂OCH₂CH₂— | (CH₂)₂SC(CH₃)₃ |
| —CH₂CH₂OCH₂CH₂— | (CH₂)₂SCH(CH₃)₂ |
| —CH₂CH₂OCH₂CH₂— | CH₂CH═CHC(CH₃)₃ |
| —CH₂CH₂OCH₂CH₂— | CH₂CH═CHCH(CH₃)₂ |
| —CH₂CH₂OCH₂CH₂— | (CH₂)₂S(═O)C(CH₃)₃ |
| —CH₂CH₂OCH₂CH₂— | (CH₂)₃OSi(CH₃)₂C(CH₃)₃ |
| —CH₂CH₂OCH₂CH₂— | (CH₂)₂OCH(CH₃)₂ |
| —CH₂CH₂OCH₂CH₂— | (CH₂)₃OC(CH₃)₃ |
| —CH₂CH₂OCH₂CH₂— | (CH₂)₃P(═O)(CH₃)₂ |
| —CH₂CH₂OCH₂CH₂— | CH₂C(═O)CH₂C(CH₃)₃ |
| —CH₂CH₂OCH₂CH₂— | CH(CH₃)(CH₂)₃CH₃ |
| —CH₂CH₂OCH₂CH₂— | CH(CH₃)CH₂CH₂CH(CH₃)₂ |
| —CH₂CH₂OCH₂CH₂— | CH(CH₃)CH₂CH₂C(CH₃)₃ |
| —CH₂CH₂OCH₂CH₂— | CH(C₂H₅)CH₂CH₂CH(CH₃)₂ |
| —CH₂CH₂OCH₂CH₂— | CH(CH₂CH₂CH₃)CH₂CH₂CH(CH₃)₂ |
| —CH₂CH₂OCH₂CH₂— | CH(CH₂CH₂CH(CH₃)₂)₂ |
| —CH₂CH₂OCH₂CH₂— | CH₂CH₂CH₂N(CH₃)₂ |
| —CH₂CH₂OCH₂CH₂— | CH₂CH₂N(CH₃)C(CH₃)₃ |
| —CH₂CH₂OCH₂CH₂— | CH₂CH₂N(CH₃)CH(CH₃)₂ |
| —CH₂CH₂OCH₂CH₂— | CH₂CH═C(CH₃)₂ |
| —CH₂CH₂OCH₂CH₂— | (CH₂)₃C(CH₃)₂OCH₃ |
| —CH₂CH₂OCH₂CH₂— | (CH₂)₃C(CH₃)₂Cl |
| —CH₂CH₂OCH₂CH₂— | CH₂CH₂CH═C(CH₃)₂ |
| —(CH₂)₅— | (CH₂)₄CH₃ |
| —(CH₂)₅— | (CH₂)₃C(CH₃)₂OC₂H₅ |
| —(CH₂)₅— | (CH₂)₅CH₃ |
| —(CH₂)₅— | (CH₂)₆CH₃ |
| —(CH₂)₅— | (CH₂)₃C(CH₃)₂Br |
| —(CH₂)₅— | (CH₂)₇CH₃ |
| —(CH₂)₅— | (CH₂)₃CH(CH₃)₂ |
| —(CH₂)₅— | (CH₂)₃C(CH₃)₃ |
| —(CH₂)₅— | (CH₂)₃Si(CH₃)₃ |
| —(CH₂)₅— | (CH₂)₂CH(CH₃)CH₂C(CH₃)₃ |
| —(CH₂)₅— | (CH₂)₃C(═CH₂)CH(CH₃)₂ |
| —(CH₂)₅— | (CH₂)₃CH(CH₃)C₂H₅ |
| —(CH₂)₅— | (CH₂)₂OSi(CH₃)₂C(CH₃)₃ |
| —(CH₂)₅— | (CH₂)₂OC(CH₃)₃ |
| —(CH₂)₅— | (CH₂)₂SC(CH₃)₃ |
| —(CH₂)₅— | (CH₂)₂SCH(CH₃)₂ |
| —(CH₂)₅— | CH₂CH═CHC(CH₃)₃ |
| —(CH₂)₅— | CH₂CH═CHCH(CH₃)₂ |
| —(CH₂)₅— | (CH₂)₂S(═O)C(CH₃)₃ |
| —(CH₂)₅— | (CH₂)₃OSi(CH₃)₂C(CH₃)₃ |
| —(CH₂)₅— | (CH₂)₂OCH(CH₃)₂ |
| —(CH₂)₅— | (CH₂)₃OC(CH₃)₃ |
| —(CH₂)₅— | (CH₂)₃P(═O)(CH₃)₂ |
| —(CH₂)₅— | CH₂C(═O)CH₂C(CH₃)₃ |
| —(CH₂)₅— | CH(CH₃)(CH₂)₃CH₃ |
| —(CH₂)₅— | CH(CH₃)CH₂CH₂CH(CH₃)₂ |
| —(CH₂)₅— | CH(CH₃)CH₂CH₂C(CH₃)₃ |
| —(CH₂)₅— | CH(C₂H₅)CH₂CH₂CH(CH₃)₂ |
| —(CH₂)₅— | CH(CH₂CH₂CH₃)CH₂CH₂CH(CH₃)₂ |
| —(CH₂)₅— | CH(CH₂CH₂CH(CH₃)₂)₂ |
| —(CH₂)₅— | CH₂CH₂CH₂N(CH₃)₂ |
| —(CH₂)₅— | CH₂CH₂N(CH₃)C(CH₃)₃ |
| —(CH₂)₅— | CH₂CH₂N(CH₃)CH(CH₃)₂ |
| —(CH₂)₅— | CH₂CH═C(CH₃)₂ |
| —(CH₂)₅— | (CH₂)₃C(CH₃)₂OCH₃ |
| —(CH₂)₅— | (CH₂)₃C(CH₃)₂Cl |
| —(CH₂)₅— | CH₂CH₂CH═C(CH₃)₂ |

TABLE 8

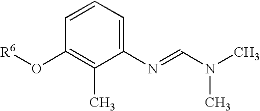

| R⁶ | R⁶ |
|---|---|
| (CH₂)₄CH₃ | (CH₂)₃OSi(CH₃)₂C(CH₃)₃ |
| (CH₂)₃C(CH₃)₂OC₂H₅ | (CH₂)₂OCH(CH₃)₂ |
| (CH₂)₅CH₃ | (CH₂)₃OC(CH₃)₃ |
| (CH₂)₆CH₃ | (CH₂)₃P(═O)(CH₃)₂ |
| (CH₂)₃C(CH₃)₂Br | CH₂C(═O)CH₂C(CH₃)₃ |
| (CH₂)₇CH₃ | CH(CH₃)(CH₂)₃CH₃ |
| (CH₂)₃CH(CH₃)₂ | CH(CH₃)CH₂CH₂CH(CH₃)₂ |
| (CH₂)₃C(CH₃)₃ | CH(CH₃)CH₂CH₂C(CH₃)₃ |
| (CH₂)₃Si(CH₃)₃ | CH(C₂H₅)CH₂CH₂CH(CH₃)₂ |
| (CH₂)₂CH(CH₃)CH₂C(CH₃)₃ | CH(CH₂CH₂CH₃)CH₂CH₂CH(CH₃)₂ |
| (CH₂)₃C(═CH₂)CH(CH₃)₂ | CH(CH₂CH₂CH(CH₃)₂)₂ |
| (CH₂)₃CH(CH₃)C₂H₅ | CH₂CH₂CH₂N(CH₃)₂ |
| (CH₂)₂OSi(CH₃)₂C(CH₃)₃ | CH₂CH₂N(CH₃)C(CH₃)₃ |
| (CH₂)₂OC(CH₃)₃ | CH₂CH₂N(CH₃)CH(CH₃)₂ |
| (CH₂)₂SC(CH₃)₃ | CH₂CH═C(CH₃)₂ |
| (CH₂)₂SCH(CH₃)₂ | (CH₂)₃C(CH₃)₂OCH₃ |
| CH₂CH═CHC(CH₃)₃ | (CH₂)₃C(CH₃)₂Cl |
| CH₂CH═CHCH(CH₃)₂ | CH₂CH₂CH═C(CH₃)₂ |
| (CH₂)₂S(═O)C(CH₃)₃ | |

TABLE 9

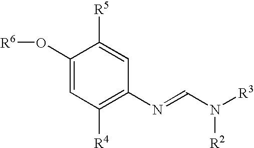

| R⁶ | R² | R³ | R⁴ | R⁵ |
|---|---|---|---|---|
| CH₂CH₂CH₂Si(CH₃)₃ | CH₃ | CH₃ | CH₃ | C₂H₅ |
| CH₂CH₂CH₂C(CH₃)₃ | CH₃ | CH₃ | CH₃ | C₂H₅ |
| CH₂CH₂CH₂CH(CH₃)₂ | CH₃ | CH₃ | CH₃ | C₂H₅ |
| CH₂CH₂CH₂Si(CH₃)₂(C₂H₅) | CH₃ | CH₃ | CH₃ | C₂H₅ |
| CH₂CH₂CH₂Si(CH₃)₃ | CH₃ | C₂H₅ | CH₃ | C₂H₅ |
| CH₂CH₂CH₂C(CH₃)₃ | CH₃ | C₂H₅ | CH₃ | C₂H₅ |
| CH₂CH₂CH₂CH(CH₃)₂ | CH₃ | C₂H₅ | CH₃ | C₂H₅ |
| CH₂CH₂CH₂Si(CH₃)₂(C₂H₅) | CH₃ | C₂H₅ | CH₃ | C₂H₅ |
| CH₂CH₂CH₂Si(CH₃)₃ | CH₃ | CH(CH₃)₂ | CH₃ | C₂H₅ |
| CH₂CH₂CH₂C(CH₃)₃ | CH₃ | CH(CH₃)₂ | CH₃ | C₂H₅ |
| CH₂CH₂CH₂CH(CH₃)₂ | CH₃ | CH(CH₃)₂ | CH₃ | C₂H₅ |
| CH₂CH₂CH₂Si(CH₃)₂(C₂H₅) | CH₃ | CH(CH₃)₂ | CH₃ | C₂H₅ |
| CH₂CH₂CH₂Si(CH₃)₃ | CH₃ | c-Pr | CH₃ | C₂H₅ |
| CH₂CH₂CH₂C(CH₃)₃ | CH₃ | c-Pr | CH₃ | C₂H₅ |
| CH₂CH₂CH₂CH(CH₃)₂ | CH₃ | c-Pr | CH₃ | C₂H₅ |
| CH₂CH₂CH₂Si(CH₃)₂(C₂H₅) | CH₃ | c-Pr | CH₃ | C₂H₅ |
| CH₂CH₂CH₂Si(CH₃)₃ | C₂H₅ | C₂H₅ | CH₃ | C₂H₅ |
| CH₂CH₂CH₂C(CH₃)₃ | C₂H₅ | C₂H₅ | CH₃ | C₂H₅ |
| CH₂CH₂CH₂CH(CH₃)₂ | C₂H₅ | C₂H₅ | CH₃ | C₂H₅ |
| CH₂CH₂CH₂Si(CH₃)₂(C₂H₅) | C₂H₅ | C₂H₅ | CH₃ | C₂H₅ |
| CH₂CH₂CH₂Si(CH₃)₃ | CH₃ | CH₂CH═CH₂ | CH₃ | C₂H₅ |
| CH₂CH₂CH₂C(CH₃)₃ | CH₃ | CH₂CH═CH₂ | CH₃ | C₂H₅ |
| CH₂CH₂CH₂CH(CH₃)₂ | CH₃ | CH₂CH═CH₂ | CH₃ | C₂H₅ |
| CH₂CH₂CH₂Si(CH₃)₂(C₂H₅) | CH₃ | CH₂CH═CH₂ | CH₃ | C₂H₅ |
| CH₂CH₂CH₂Si(CH₃)₃ | CH₃ | CH₂C≡CH | CH₃ | C₂H₅ |
| CH₂CH₂CH₂C(CH₃)₃ | CH₃ | CH₂C≡CH | CH₃ | C₂H₅ |
| CH₂CH₂CH₂CH(CH₃)₂ | CH₃ | CH₂C≡CH | CH₃ | C₂H₅ |
| CH₂CH₂CH₂Si(CH₃)₂(C₂H₅) | CH₃ | CH₂C≡CH | CH₃ | C₂H₅ |
| CH₂CH₂CH₂Si(CH₃)₃ | CH₃ | CH₂CH₂F | CH₃ | C₂H₅ |
| CH₂CH₂CH₂C(CH₃)₃ | CH₃ | CH₂CH₂F | CH₃ | C₂H₅ |
| CH₂CH₂CH₂Si(CH₃)₃ | CH₃ | CH₃ | CH₃ | Br |
| CH₂CH₂CH₂C(CH₃)₃ | CH₃ | CH₃ | CH₃ | Br |
| CH₂CH₂CH₂CH(CH₃)₂ | CH₃ | CH₃ | CH₃ | Br |
| CH₂CH₂CH₂Si(CH₃)₂(C₂H₅) | CH₃ | CH₃ | CH₃ | Br |
| CH₂CH₂CH₂Si(CH₃)₃ | CH₃ | C₂H₅ | CH₃ | Br |
| CH₂CH₂CH₂C(CH₃)₃ | CH₃ | C₂H₅ | CH₃ | Br |
| CH₂CH₂CH₂CH(CH₃)₂ | CH₃ | C₂H₅ | CH₃ | Br |
| CH₂CH₂CH₂Si(CH₃)₂(C₂H₅) | CH₃ | C₂H₅ | CH₃ | Br |
| CH₂CH₂CH₂Si(CH₃)₃ | CH₃ | CH(CH₃)₂ | CH₃ | Br |
| CH₂CH₂CH₂C(CH₃)₃ | CH₃ | CH(CH₃)₂ | CH₃ | Br |
| CH₂CH₂CH₂CH(CH₃)₂ | CH₃ | CH(CH₃)₂ | CH₃ | Br |
| CH₂CH₂CH₂Si(CH₃)₂(C₂H₅) | CH₃ | CH(CH₃)₂ | CH₃ | Br |
| CH₂CH₂CH₂Si(CH₃)₃ | CH₃ | c-Pr | CH₃ | Br |
| CH₂CH₂CH₂C(CH₃)₃ | CH₃ | c-Pr | CH₃ | Br |
| CH₂CH₂CH₂CH(CH₃)₂ | CH₃ | c-Pr | CH₃ | Br |
| CH₂CH₂CH₂Si(CH₃)₂(C₂H₅) | CH₃ | c-Pr | CH₃ | Br |
| CH₂CH₂CH₂Si(CH₃)₃ | C₂H₅ | C₂H₅ | CH₃ | Br |
| CH₂CH₂CH₂C(CH₃)₃ | C₂H₅ | C₂H₅ | CH₃ | Br |
| CH₂CH₂CH₂CH(CH₃)₂ | C₂H₅ | C₂H₅ | CH₃ | Br |
| CH₂CH₂CH₂Si(CH₃)₂(C₂H₅) | C₂H₅ | C₂H₅ | CH₃ | Br |
| CH₂CH₂CH₂Si(CH₃)₃ | CH₃ | CH₂CH═CH₂ | CH₃ | Br |
| CH₂CH₂CH₂C(CH₃)₃ | CH₃ | CH₂CH═CH₂ | CH₃ | Br |
| CH₂CH₂CH₂CH(CH₃)₂ | CH₃ | CH₂CH═CH₂ | CH₃ | Br |
| CH₂CH₂CH₂Si(CH₃)₂(C₂H₅) | CH₃ | CH₂CH═CH₂ | CH₃ | Br |
| CH₂CH₂CH₂Si(CH₃)₃ | CH₃ | CH₂C≡CH | CH₃ | Br |
| CH₂CH₂CH₂C(CH₃)₃ | CH₃ | CH₂C≡CH | CH₃ | Br |
| CH₂CH₂CH₂CH(CH₃)₂ | CH₃ | CH₂C≡CH | CH₃ | Br |
| CH₂CH₂CH₂Si(CH₃)₂(C₂H₅) | CH₃ | CH₂C≡CH | CH₃ | Br |
| CH₂CH₂CH₂Si(CH₃)₃ | CH₃ | CH₂CH₂F | CH₃ | Br |
| CH₂CH₂CH₂C(CH₃)₃ | CH₃ | CH₂CH₂F | CH₃ | Br |
| CH₂CH₂CH₂Si(CH₃)₃ | CH₃ | CH₃ | CH₃ | CH₂F |
| CH₂CH₂CH₂C(CH₃)₃ | CH₃ | CH₃ | CH₃ | CH₂F |
| CH₂CH₂CH₂CH(CH₃)₂ | CH₃ | CH₃ | CH₃ | CH₂F |
| CH₂CH₂CH₂Si(CH₃)₂(C₂H₅) | CH₃ | CH₃ | CH₃ | CH₂F |
| CH₂CH₂CH₂Si(CH₃)₃ | CH₃ | C₂H₅ | CH₃ | CH₂F |
| CH₂CH₂CH₂C(CH₃)₃ | CH₃ | C₂H₅ | CH₃ | CH₂F |
| CH₂CH₂CH₂CH(CH₃)₂ | CH₃ | C₂H₅ | CH₃ | CH₂F |
| CH₂CH₂CH₂Si(CH₃)₂(C₂H₅) | CH₃ | C₂H₅ | CH₃ | CH₂F |
| CH₂CH₂CH₂Si(CH₃)₃ | CH₃ | CH(CH₃)₂ | CH₃ | CH₂F |
| CH₂CH₂CH₂C(CH₃)₃ | CH₃ | CH(CH₃)₂ | CH₃ | CH₂F |
| CH₂CH₂CH₂CH(CH₃)₂ | CH₃ | CH(CH₃)₂ | CH₃ | CH₂F |
| CH₂CH₂CH₂Si(CH₃)₂(C₂H₅) | CH₃ | CH(CH₃)₂ | CH₃ | CH₂F |
| CH₂CH₂CH₂Si(CH₃)₃ | CH₃ | c-Pr | CH₃ | CH₂F |
| CH₂CH₂CH₂C(CH₃)₃ | CH₃ | c-Pr | CH₃ | CH₂F |
| CH₂CH₂CH₂CH(CH₃)₂ | CH₃ | c-Pr | CH₃ | CH₂F |
| CH₂CH₂CH₂Si(CH₃)₂(C₂H₅) | CH₃ | c-Pr | CH₃ | CH₂F |
| CH₂CH₂CH₂Si(CH₃)₃ | C₂H₅ | C₂H₅ | CH₃ | CH₂F |
| CH₂CH₂CH₂C(CH₃)₃ | C₂H₅ | C₂H₅ | CH₃ | CH₂F |
| CH₂CH₂CH₂CH(CH₃)₂ | C₂H₅ | C₂H₅ | CH₃ | CH₂F |
| CH₂CH₂CH₂Si(CH₃)₂(C₂H₅) | C₂H₅ | C₂H₅ | CH₃ | CH₂F |
| CH₂CH₂CH₂Si(CH₃)₃ | CH₃ | CH₂CH═CH₂ | CH₃ | CH₂F |
| CH₂CH₂CH₂C(CH₃)₃ | CH₃ | CH₂CH═CH₂ | CH₃ | CH₂F |
| CH₂CH₂CH₂CH(CH₃)₂ | CH₃ | CH₂CH═CH₂ | CH₃ | CH₂F |
| CH₂CH₂CH₂Si(CH₃)₂(C₂H₅) | CH₃ | CH₂CH═CH₂ | CH₃ | CH₂F |
| CH₂CH₂CH₂Si(CH₃)₃ | CH₃ | CH₂C≡CH | CH₃ | CH₂F |
| CH₂CH₂CH₂C(CH₃)₃ | CH₃ | CH₂C≡CH | CH₃ | CH₂F |
| CH₂CH₂CH₂CH(CH₃)₂ | CH₃ | CH₂C≡CH | CH₃ | CH₂F |
| CH₂CH₂CH₂Si(CH₃)₂(C₂H₅) | CH₃ | CH₂C≡CH | CH₃ | CH₂F |
| CH₂CH₂CH₂Si(CH₃)₃ | CH₃ | CH₂CH₂F | CH₃ | CH₂F |
| CH₂CH₂CH₂C(CH₃)₃ | CH₃ | CH₂CH₂F | CH₃ | CH₂F |
| CH₂CH₂CH₂Si(CH₃)₃ | CH₃ | CH₃ | CH₃ | CHF₂ |
| CH₂CH₂CH₂C(CH₃)₃ | CH₃ | CH₃ | CH₃ | CHF₂ |
| CH₂CH₂CH₂CH(CH₃)₂ | CH₃ | CH₃ | CH₃ | CHF₂ |
| CH₂CH₂CH₂Si(CH₃)₂(C₂H₅) | CH₃ | CH₃ | CH₃ | CHF₂ |
| CH₂CH₂CH₂Si(CH₃)₃ | CH₃ | C₂H₅ | CH₃ | CHF₂ |
| CH₂CH₂CH₂C(CH₃)₃ | CH₃ | C₂H₅ | CH₃ | CHF₂ |
| CH₂CH₂CH₂CH(CH₃)₂ | CH₃ | C₂H₅ | CH₃ | CHF₂ |
| CH₂CH₂CH₂Si(CH₃)₂(C₂H₅) | CH₃ | C₂H₅ | CH₃ | CHF₂ |
| CH₂CH₂CH₂Si(CH₃)₃ | CH₃ | CH(CH₃)₂ | CH₃ | CHF₂ |
| CH₂CH₂CH₂C(CH₃)₃ | CH₃ | CH(CH₃)₂ | CH₃ | CHF₂ |
| CH₂CH₂CH₂CH(CH₃)₂ | CH₃ | CH(CH₃)₂ | CH₃ | CHF₂ |
| CH₂CH₂CH₂Si(CH₃)₂(C₂H₅) | CH₃ | CH(CH₃)₂ | CH₃ | CHF₂ |
| CH₂CH₂CH₂Si(CH₃)₃ | CH₃ | c-Pr | CH₃ | CHF₂ |
| CH₂CH₂CH₂C(CH₃)₃ | CH₃ | c-Pr | CH₃ | CHF₂ |
| CH₂CH₂CH₂CH(CH₃)₂ | CH₃ | c-Pr | CH₃ | CHF₂ |
| CH₂CH₂CH₂Si(CH₃)₂(C₂H₅) | CH₃ | c-Pr | CH₃ | CHF₂ |
| CH₂CH₂CH₂Si(CH₃)₃ | C₂H₅ | C₂H₅ | CH₃ | CHF₂ |
| CH₂CH₂CH₂C(CH₃)₃ | C₂H₅ | C₂H₅ | CH₃ | CHF₂ |
| CH₂CH₂CH₂CH(CH₃)₂ | C₂H₅ | C₂H₅ | CH₃ | CHF₂ |
| CH₂CH₂CH₂Si(CH₃)₂(C₂H₅) | C₂H₅ | C₂H₅ | CH₃ | CHF₂ |
| CH₂CH₂CH₂Si(CH₃)₃ | CH₃ | CH₂CH═CH₂ | CH₃ | CHF₂ |
| CH₂CH₂CH₂C(CH₃)₃ | CH₃ | CH₂CH═CH₂ | CH₃ | CHF₂ |
| CH₂CH₂CH₂CH(CH₃)₂ | CH₃ | CH₂CH═CH₂ | CH₃ | CHF₂ |
| CH₂CH₂CH₂Si(CH₃)₂(C₂H₅) | CH₃ | CH₂CH═CH₂ | CH₃ | CHF₂ |
| CH₂CH₂CH₂Si(CH₃)₃ | CH₃ | CH₂C≡CH | CH₃ | CHF₂ |
| CH₂CH₂CH₂C(CH₃)₃ | CH₃ | CH₂C≡CH | CH₃ | CHF₂ |
| CH₂CH₂CH₂CH(CH₃)₂ | CH₃ | CH₂C≡CH | CH₃ | CHF₂ |
| CH₂CH₂CH₂Si(CH₃)₂(C₂H₅) | CH₃ | CH₂C≡CH | CH₃ | CHF₂ |
| CH₂CH₂CH₂Si(CH₃)₃ | CH₃ | CH₂CH₂F | CH₃ | CHF₂ |
| CH₂CH₂CH₂C(CH₃)₃ | CH₃ | CH₂CH₂F | CH₃ | CHF₂ |
| CH₂CH₂CH₂Si(CH₃)₃ | CH₃ | CH₃ | CH₃ | CF₃ |
| CH₂CH₂CH₂C(CH₃)₃ | CH₃ | CH₃ | CH₃ | CF₃ |
| CH₂CH₂CH₂CH(CH₃)₂ | CH₃ | CH₃ | CH₃ | CF₃ |
| CH₂CH₂CH₂Si(CH₃)₂(C₂H₅) | CH₃ | CH₃ | CH₃ | CF₃ |
| CH₂CH₂CH₂Si(CH₃)₃ | CH₃ | C₂H₅ | CH₃ | CF₃ |
| CH₂CH₂CH₂C(CH₃)₃ | CH₃ | C₂H₅ | CH₃ | CF₃ |
| CH₂CH₂CH₂CH(CH₃)₂ | CH₃ | C₂H₅ | CH₃ | CF₃ |
| CH₂CH₂CH₂Si(CH₃)₂(C₂H₅) | CH₃ | C₂H₅ | CH₃ | CF₃ |
| CH₂CH₂CH₂Si(CH₃)₃ | CH₃ | CH(CH₃)₂ | CH₃ | CF₃ |
| CH₂CH₂CH₂C(CH₃)₃ | CH₃ | CH(CH₃)₂ | CH₃ | CF₃ |
| CH₂CH₂CH₂CH(CH₃)₂ | CH₃ | CH(CH₃)₂ | CH₃ | CF₃ |
| CH₂CH₂CH₂Si(CH₃)₂(C₂H₅) | CH₃ | CH(CH₃)₂ | CH₃ | CF₃ |
| CH₂CH₂CH₂Si(CH₃)₃ | CH₃ | c-Pr | CH₃ | CF₃ |
| CH₂CH₂CH₂C(CH₃)₃ | CH₃ | c-Pr | CH₃ | CF₃ |
| CH₂CH₂CH₂CH(CH₃)₂ | CH₃ | c-Pr | CH₃ | CF₃ |
| CH₂CH₂CH₂Si(CH₃)₂(C₂H₅) | CH₃ | c-Pr | CH₃ | CF₃ |
| CH₂CH₂CH₂Si(CH₃)₃ | C₂H₅ | C₂H₅ | CH₃ | CF₃ |
| CH₂CH₂CH₂C(CH₃)₃ | C₂H₅ | C₂H₅ | CH₃ | CF₃ |
| CH₂CH₂CH₂CH(CH₃)₂ | C₂H₅ | C₂H₅ | CH₃ | CF₃ |
| CH₂CH₂CH₂Si(CH₃)₂(C₂H₅) | C₂H₅ | C₂H₅ | CH₃ | CF₃ |
| CH₂CH₂CH₂Si(CH₃)₃ | CH₃ | CH₂CH═CH₂ | CH₃ | CF₃ |
| CH₂CH₂CH₂C(CH₃)₃ | CH₃ | CH₂CH═CH₂ | CH₃ | CF₃ |
| CH₂CH₂CH₂CH(CH₃)₂ | CH₃ | CH₂CH═CH₂ | CH₃ | CF₃ |
| CH₂CH₂CH₂Si(CH₃)₂(C₂H₅) | CH₃ | CH₂CH═CH₂ | CH₃ | CF₃ |
| CH₂CH₂CH₂Si(CH₃)₃ | CH₃ | CH₂C≡CH | CH₃ | CF₃ |
| CH₂CH₂CH₂C(CH₃)₃ | CH₃ | CH₂C≡CH | CH₃ | CF₃ |
| CH₂CH₂CH₂CH(CH₃)₂ | CH₃ | CH₂C≡CH | CH₃ | CF₃ |
| CH₂CH₂CH₂Si(CH₃)₂(C₂H₅) | CH₃ | CH₂C≡CH | CH₃ | CF₃ |
| CH₂CH₂CH₂Si(CH₃)₃ | CH₃ | CH₂CH₂F | CH₃ | CF₃ |
| CH₂CH₂CH₂C(CH₃)₃ | CH₃ | CH₂CH₂F | CH₃ | CF₃ |
| CH₂CH₂CH₂Si(CH₃)₃ | CH₃ | CH₃ | CH₃ | CH₂Cl |
| CH₂CH₂CH₂C(CH₃)₃ | CH₃ | CH₃ | CH₃ | CH₂Cl |
| CH₂CH₂CH₂CH(CH₃)₂ | CH₃ | CH₃ | CH₃ | CH₂Cl |
| CH₂CH₂CH₂Si(CH₃)₂(C₂H₅) | CH₃ | CH₃ | CH₃ | CH₂Cl |
| CH₂CH₂CH₂Si(CH₃)₃ | CH₃ | C₂H₅ | CH₃ | CH₂Cl |
| CH₂CH₂CH₂C(CH₃)₃ | CH₃ | C₂H₅ | CH₃ | CH₂Cl |
| CH₂CH₂CH₂CH(CH₃)₂ | CH₃ | C₂H₅ | CH₃ | CH₂Cl |
| CH₂CH₂CH₂Si(CH₃)₂(C₂H₅) | CH₃ | C₂H₅ | CH₃ | CH₂Cl |
| CH₂CH₂CH₂Si(CH₃)₃ | CH₃ | CH(CH₃)₂ | CH₃ | CH₂Cl |
| CH₂CH₂CH₂C(CH₃)₃ | CH₃ | CH(CH₃)₂ | CH₃ | CH₂Cl |
| CH₂CH₂CH₂CH(CH₃)₂ | CH₃ | CH(CH₃)₂ | CH₃ | CH₂Cl |
| CH₂CH₂CH₂Si(CH₃)₂(C₂H₅) | CH₃ | CH(CH₃)₂ | CH₃ | CH₂Cl |
| CH₂CH₂CH₂Si(CH₃)₃ | CH₃ | c-Pr | CH₃ | CH₂Cl |
| CH₂CH₂CH₂C(CH₃)₃ | CH₃ | c-Pr | CH₃ | CH₂Cl |
| CH₂CH₂CH₂CH(CH₃)₂ | CH₃ | c-Pr | CH₃ | CH₂Cl |
| CH₂CH₂CH₂Si(CH₃)₂(C₂H₅) | CH₃ | c-Pr | CH₃ | CH₂Cl |
| CH₂CH₂CH₂Si(CH₃)₃ | C₂H₅ | C₂H₅ | CH₃ | CH₂Cl |
| CH₂CH₂CH₂C(CH₃)₃ | C₂H₅ | C₂H₅ | CH₃ | CH₂Cl |
| CH₂CH₂CH₂CH(CH₃)₂ | C₂H₅ | C₂H₅ | CH₃ | CH₂Cl |
| CH₂CH₂CH₂Si(CH₃)₂(C₂H₅) | C₂H₅ | C₂H₅ | CH₃ | CH₂Cl |
| CH₂CH₂CH₂Si(CH₃)₃ | CH₃ | CH₂CH═CH₂ | CH₃ | CH₂Cl |
| CH₂CH₂CH₂C(CH₃)₃ | CH₃ | CH₂CH═CH₂ | CH₃ | CH₂Cl |
| CH₂CH₂CH₂CH(CH₃)₂ | CH₃ | CH₂CH═CH₂ | CH₃ | CH₂Cl |
| CH₂CH₂CH₂Si(CH₃)₂(C₂H₅) | CH₃ | CH₂CH═CH₂ | CH₃ | CH₂Cl |
| CH₂CH₂CH₂Si(CH₃)₃ | CH₃ | CH₂C≡CH | CH₃ | CH₂Cl |
| CH₂CH₂CH₂C(CH₃)₃ | CH₃ | CH₂C≡CH | CH₃ | CH₂Cl |
| CH₂CH₂CH₂CH(CH₃)₂ | CH₃ | CH₂C≡CH | CH₃ | CH₂Cl |
| CH₂CH₂CH₂Si(CH₃)₂(C₂H₅) | CH₃ | CH₂C≡CH | CH₃ | CH₂Cl |
| CH₂CH₂CH₂Si(CH₃)₃ | CH₃ | CH₂CH₂F | CH₃ | CH₂Cl |
| CH₂CH₂CH₂C(CH₃)₃ | CH₃ | CH₂CH₂F | CH₃ | CH₂Cl |
| CH₂CH₂CH₂Si(CH₃)₃ | CH₃ | CH₃ | CH₃ | CH₂Br |
| CH₂CH₂CH₂C(CH₃)₃ | CH₃ | CH₃ | CH₃ | CH₂Br |
| CH₂CH₂CH₂CH(CH₃)₂ | CH₃ | CH₃ | CH₃ | CH₂Br |
| CH₂CH₂CH₂Si(CH₃)₂(C₂H₅) | CH₃ | CH₃ | CH₃ | CH₂Br |
| CH₂CH₂CH₂Si(CH₃)₃ | CH₃ | C₂H₅ | CH₃ | CH₂Br |
| CH₂CH₂CH₂C(CH₃)₃ | CH₃ | C₂H₅ | CH₃ | CH₂Br |
| CH₂CH₂CH₂CH(CH₃)₂ | CH₃ | C₂H₅ | CH₃ | CH₂Br |
| CH₂CH₂CH₂Si(CH₃)₂(C₂H₅) | CH₃ | C₂H₅ | CH₃ | CH₂Br |
| CH₂CH₂CH₂Si(CH₃)₃ | CH₃ | CH(CH₃)₂ | CH₃ | CH₂Br |
| CH₂CH₂CH₂C(CH₃)₃ | CH₃ | CH(CH₃)₂ | CH₃ | CH₂Br |
| CH₂CH₂CH₂CH(CH₃)₂ | CH₃ | CH(CH₃)₂ | CH₃ | CH₂Br |
| CH₂CH₂CH₂Si(CH₃)₂(C₂H₅) | CH₃ | CH(CH₃)₂ | CH₃ | CH₂Br |
| CH₂CH₂CH₂Si(CH₃)₃ | CH₃ | c-Pr | CH₃ | CH₂Br |
| CH₂CH₂CH₂C(CH₃)₃ | CH₃ | c-Pr | CH₃ | CH₂Br |
| CH₂CH₂CH₂CH(CH₃)₂ | CH₃ | c-Pr | CH₃ | CH₂Br |
| CH₂CH₂CH₂Si(CH₃)₂(C₂H₅) | CH₃ | c-Pr | CH₃ | CH₂Br |
| CH₂CH₂CH₂Si(CH₃)₃ | C₂H₅ | C₂H₅ | CH₃ | CH₂Br |
| CH₂CH₂CH₂C(CH₃)₃ | C₂H₅ | C₂H₅ | CH₃ | CH₂Br |
| CH₂CH₂CH₂CH(CH₃)₂ | C₂H₅ | C₂H₅ | CH₃ | CH₂Br |
| CH₂CH₂CH₂Si(CH₃)₂(C₂H₅) | C₂H₅ | C₂H₅ | CH₃ | CH₂Br |
| CH₂CH₂CH₂Si(CH₃)₃ | CH₃ | CH₂CH═CH₂ | CH₃ | CH₂Br |
| CH₂CH₂CH₂C(CH₃)₃ | CH₃ | CH₂CH═CH₂ | CH₃ | CH₂Br |
| CH₂CH₂CH₂CH(CH₃)₂ | CH₃ | CH₂CH═CH₂ | CH₃ | CH₂Br |
| CH₂CH₂CH₂Si(CH₃)₂(C₂H₅) | CH₃ | CH₂CH═CH₂ | CH₃ | CH₂Br |
| CH₂CH₂CH₂Si(CH₃)₃ | CH₃ | CH₂C≡CH | CH₃ | CH₂Br |
| CH₂CH₂CH₂C(CH₃)₃ | CH₃ | CH₂C≡CH | CH₃ | CH₂Br |
| CH₂CH₂CH₂CH(CH₃)₂ | CH₃ | CH₂C≡CH | CH₃ | CH₂Br |
| CH₂CH₂CH₂Si(CH₃)₂(C₂H₅) | CH₃ | CH₂C≡CH | CH₃ | CH₂Br |
| CH₂CH₂CH₂Si(CH₃)₃ | CH₃ | CH₂CH₂F | CH₃ | CH₂Br |
| CH₂CH₂CH₂C(CH₃)₃ | CH₃ | CH₂CH₂F | CH₃ | CH₂Br |
| CH₂CH₂CH₂Si(CH₃)₃ | CH₃ | CH₃ | C₂H₅ | Cl |
| CH₂CH₂CH₂C(CH₃)₃ | CH₃ | CH₃ | C₂H₅ | Cl |
| CH₂CH₂CH₂CH(CH₃)₂ | CH₃ | CH₃ | C₂H₅ | Cl |
| CH₂CH₂CH₂Si(CH₃)₂(C₂H₅) | CH₃ | CH₃ | C₂H₅ | Cl |
| CH₂CH₂CH₂Si(CH₃)₃ | CH₃ | C₂H₅ | C₂H₅ | Cl |
| CH₂CH₂CH₂C(CH₃)₃ | CH₃ | C₂H₅ | C₂H₅ | Cl |
| CH₂CH₂CH₂CH(CH₃)₂ | CH₃ | C₂H₅ | C₂H₅ | Cl |
| CH₂CH₂CH₂Si(CH₃)₂(C₂H₅) | CH₃ | C₂H₅ | C₂H₅ | Cl |
| CH₂CH₂CH₂Si(CH₃)₃ | CH₃ | CH(CH₃)₂ | C₂H₅ | Cl |
| CH₂CH₂CH₂C(CH₃)₃ | CH₃ | CH(CH₃)₂ | C₂H₅ | Cl |
| CH₂CH₂CH₂CH(CH₃)₂ | CH₃ | CH(CH₃)₂ | C₂H₅ | Cl |
| CH₂CH₂CH₂Si(CH₃)₂(C₂H₅) | CH₃ | CH(CH₃)₂ | C₂H₅ | Cl |
| CH₂CH₂CH₂Si(CH₃)₃ | CH₃ | c-Pr | C₂H₅ | Cl |
| CH₂CH₂CH₂C(CH₃)₃ | CH₃ | c-Pr | C₂H₅ | Cl |
| CH₂CH₂CH₂CH(CH₃)₂ | CH₃ | c-Pr | C₂H₅ | Cl |
| CH₂CH₂CH₂Si(CH₃)₂(C₂H₅) | CH₃ | c-Pr | C₂H₅ | Cl |
| CH₂CH₂CH₂Si(CH₃)₃ | C₂H₅ | C₂H₅ | C₂H₅ | Cl |
| CH₂CH₂CH₂C(CH₃)₃ | C₂H₅ | C₂H₅ | C₂H₅ | Cl |
| CH₂CH₂CH₂CH(CH₃)₂ | C₂H₅ | C₂H₅ | C₂H₅ | Cl |
| CH₂CH₂CH₂Si(CH₃)₂(C₂H₅) | C₂H₅ | C₂H₅ | C₂H₅ | Cl |
| CH₂CH₂CH₂Si(CH₃)₃ | CH₃ | CH₂CH═CH₂ | C₂H₅ | Cl |
| CH₂CH₂CH₂C(CH₃)₃ | CH₃ | CH₂CH═CH₂ | C₂H₅ | Cl |
| CH₂CH₂CH₂CH(CH₃)₂ | CH₃ | CH₂CH═CH₂ | C₂H₅ | Cl |
| CH₂CH₂CH₂Si(CH₃)₂(C₂H₅) | CH₃ | CH₂CH═CH₂ | C₂H₅ | Cl |
| CH₂CH₂CH₂Si(CH₃)₃ | CH₃ | CH₂C≡CH | C₂H₅ | Cl |
| CH₂CH₂CH₂C(CH₃)₃ | CH₃ | CH₂C≡CH | C₂H₅ | Cl |
| CH₂CH₂CH₂CH(CH₃)₂ | CH₃ | CH₂C≡CH | C₂H₅ | Cl |
| CH₂CH₂CH₂Si(CH₃)₂(C₂H₅) | CH₃ | CH₂C≡CH | C₂H₅ | Cl |
| CH₂CH₂CH₂Si(CH₃)₃ | CH₃ | CH₂CH₂F | C₂H₅ | Cl |
| CH₂CH₂CH₂C(CH₃)₃ | CH₃ | CH₂CH₂F | C₂H₅ | Cl |
| CH₂CH₂CH₂Si(CH₃)₃ | CH₃ | CH₃ | CH₂Br | Cl |
| CH₂CH₂CH₂C(CH₃)₃ | CH₃ | CH₃ | CH₂Br | Cl |
| CH₂CH₂CH₂CH(CH₃)₂ | CH₃ | CH₃ | CH₂Br | Cl |
| CH₂CH₂CH₂Si(CH₃)₂(C₂H₅) | CH₃ | CH₃ | CH₂Br | Cl |
| CH₂CH₂CH₂Si(CH₃)₃ | CH₃ | C₂H₅ | CH₂Br | Cl |
| CH₂CH₂CH₂C(CH₃)₃ | CH₃ | C₂H₅ | CH₂Br | Cl |
| CH₂CH₂CH₂CH(CH₃)₂ | CH₃ | C₂H₅ | CH₂Br | Cl |
| CH₂CH₂CH₂Si(CH₃)₂(C₂H₅) | CH₃ | C₂H₅ | CH₂Br | Cl |
| CH₂CH₂CH₂Si(CH₃)₃ | CH₃ | CH(CH₃)₂ | CH₂Br | Cl |
| CH₂CH₂CH₂C(CH₃)₃ | CH₃ | CH(CH₃)₂ | CH₂Br | Cl |
| CH₂CH₂CH₂CH(CH₃)₂ | CH₃ | CH(CH₃)₂ | CH₂Br | Cl |
| CH₂CH₂CH₂Si(CH₃)₂(C₂H₅) | CH₃ | CH(CH₃)₂ | CH₂Br | Cl |
| CH₂CH₂CH₂Si(CH₃)₃ | CH₃ | c-Pr | CH₂Br | Cl |
| CH₂CH₂CH₂C(CH₃)₃ | CH₃ | c-Pr | CH₂Br | Cl |
| CH₂CH₂CH₂CH(CH₃)₂ | CH₃ | c-Pr | CH₂Br | Cl |
| CH₂CH₂CH₂Si(CH₃)₂(C₂H₅) | CH₃ | c-Pr | CH₂Br | Cl |
| CH₂CH₂CH₂Si(CH₃)₃ | C₂H₅ | C₂H₅ | CH₂Br | Cl |
| CH₂CH₂CH₂C(CH₃)₃ | C₂H₅ | C₂H₅ | CH₂Br | Cl |
| CH₂CH₂CH₂CH(CH₃)₂ | C₂H₅ | C₂H₅ | CH₂Br | Cl |
| CH₂CH₂CH₂Si(CH₃)₂(C₂H₅) | C₂H₅ | C₂H₅ | CH₂Br | Cl |
| CH₂CH₂CH₂Si(CH₃)₃ | CH₃ | CH₂CH═CH₂ | CH₂Br | Cl |
| CH₂CH₂CH₂C(CH₃)₃ | CH₃ | CH₂CH═CH₂ | CH₂Br | Cl |
| CH₂CH₂CH₂CH(CH₃)₂ | CH₃ | CH₂CH═CH₂ | CH₂Br | Cl |
| CH₂CH₂CH₂Si(CH₃)₂(C₂H₅) | CH₃ | CH₂CH═CH₂ | CH₂Br | Cl |
| CH₂CH₂CH₂Si(CH₃)₃ | CH₃ | CH₂C≡CH | CH₂Br | Cl |
| CH₂CH₂CH₂C(CH₃)₃ | CH₃ | CH₂C≡CH | CH₂Br | Cl |
| CH₂CH₂CH₂CH(CH₃)₂ | CH₃ | CH₂C≡CH | CH₂Br | Cl |
| CH₂CH₂CH₂Si(CH₃)₂(C₂H₅) | CH₃ | CH₂C≡CH | CH₂Br | Cl |
| CH₂CH₂CH₂Si(CH₃)₃ | CH₃ | CH₂CH₂F | CH₂Br | Cl |
| CH₂CH₂CH₂C(CH₃)₃ | CH₃ | CH₂CH₂F | CH₂Br | Cl |
| CH₂CH₂CH₂Si(CH₃)₃ | CH₃ | CH₃ | CH₂Br | F |
| CH₂CH₂CH₂C(CH₃)₃ | CH₃ | CH₃ | CH₂Br | F |
| CH₂CH₂CH₂CH(CH₃)₂ | CH₃ | CH₃ | CH₂Br | F |
| CH₂CH₂CH₂Si(CH₃)₂(C₂H₅) | CH₃ | CH₃ | CH₂Br | F |
| CH₂CH₂CH₂Si(CH₃)₃ | CH₃ | C₂H₅ | CH₂Br | F |
| CH₂CH₂CH₂C(CH₃)₃ | CH₃ | C₂H₅ | CH₂Br | F |
| CH₂CH₂CH₂CH(CH₃)₂ | CH₃ | C₂H₅ | CH₂Br | F |
| CH₂CH₂CH₂Si(CH₃)₂(C₂H₅) | CH₃ | C₂H₅ | CH₂Br | F |
| CH₂CH₂CH₂Si(CH₃)₃ | CH₃ | CH(CH₃)₂ | CH₂Br | F |
| CH₂CH₂CH₂C(CH₃)₃ | CH₃ | CH(CH₃)₂ | CH₂Br | F |
| CH₂CH₂CH₂CH(CH₃)₂ | CH₃ | CH(CH₃)₂ | CH₂Br | F |
| CH₂CH₂CH₂Si(CH₃)₂(C₂H₅) | CH₃ | CH(CH₃)₂ | CH₂Br | F |
| CH₂CH₂CH₂Si(CH₃)₃ | CH₃ | c-Pr | CH₂Br | F |
| CH₂CH₂CH₂C(CH₃)₃ | CH₃ | c-Pr | CH₂Br | F |
| CH₂CH₂CH₂CH(CH₃)₂ | CH₃ | c-Pr | CH₂Br | F |
| CH₂CH₂CH₂Si(CH₃)₂(C₂H₅) | CH₃ | c-Pr | CH₂Br | F |
| CH₂CH₂CH₂Si(CH₃)₃ | C₂H₅ | C₂H₅ | CH₂Br | F |
| CH₂CH₂CH₂C(CH₃)₃ | C₂H₅ | C₂H₅ | CH₂Br | F |
| CH₂CH₂CH₂CH(CH₃)₂ | C₂H₅ | C₂H₅ | CH₂Br | F |
| CH₂CH₂CH₂Si(CH₃)₂(C₂H₅) | C₂H₅ | C₂H₅ | CH₂Br | F |
| CH₂CH₂CH₂Si(CH₃)₃ | CH₃ | CH₂CH═CH₂ | CH₂Br | F |
| CH₂CH₂CH₂C(CH₃)₃ | CH₃ | CH₂CH═CH₂ | CH₂Br | F |
| CH₂CH₂CH₂CH(CH₃)₂ | CH₃ | CH₂CH═CH₂ | CH₂Br | F |
| CH₂CH₂CH₂Si(CH₃)₂(C₂H₅) | CH₃ | CH₂CH═CH₂ | CH₂Br | F |
| CH₂CH₂CH₂Si(CH₃)₃ | CH₃ | CH₂C≡CH | CH₂Br | F |
| CH₂CH₂CH₂C(CH₃)₃ | CH₃ | CH₂C≡CH | CH₂Br | F |
| CH₂CH₂CH₂CH(CH₃)₂ | CH₃ | CH₂C≡CH | CH₂Br | F |
| CH₂CH₂CH₂Si(CH₃)₂(C₂H₅) | CH₃ | CH₂C≡CH | CH₂Br | F |
| CH₂CH₂CH₂Si(CH₃)₃ | CH₃ | CH₂CH₂F | CH₂Br | F |
| CH₂CH₂CH₂C(CH₃)₃ | CH₃ | CH₂CH₂F | CH₂Br | F |
| CH₂CH₂CH₂Si(CH₃)₃ | CH₃ | CH₃ | C₂H₅ | F |
| CH₂CH₂CH₂C(CH₃)₃ | CH₃ | CH₃ | C₂H₅ | F |
| CH₂CH₂CH₂CH(CH₃)₂ | CH₃ | CH₃ | C₂H₅ | F |
| CH₂CH₂CH₂Si(CH₃)₂(C₂H₅) | CH₃ | CH₃ | C₂H₅ | F |
| CH₂CH₂CH₂Si(CH₃)₃ | CH₃ | C₂H₅ | C₂H₅ | F |
| CH₂CH₂CH₂C(CH₃)₃ | CH₃ | C₂H₅ | C₂H₅ | F |
| CH₂CH₂CH₂CH(CH₃)₂ | CH₃ | C₂H₅ | C₂H₅ | F |
| CH₂CH₂CH₂Si(CH₃)₂(C₂H₅) | CH₃ | C₂H₅ | C₂H₅ | F |
| CH₂CH₂CH₂Si(CH₃)₃ | CH₃ | CH(CH₃)₂ | C₂H₅ | F |
| CH₂CH₂CH₂C(CH₃)₃ | CH₃ | CH(CH₃)₂ | C₂H₅ | F |
| CH₂CH₂CH₂CH(CH₃)₂ | CH₃ | CH(CH₃)₂ | C₂H₅ | F |
| CH₂CH₂CH₂Si(CH₃)₂(C₂H₅) | CH₃ | CH(CH₃)₂ | C₂H₅ | F |
| CH₂CH₂CH₂Si(CH₃)₃ | CH₃ | c-Pr | C₂H₅ | F |
| CH₂CH₂CH₂C(CH₃)₃ | CH₃ | c-Pr | C₂H₅ | F |
| CH₂CH₂CH₂CH(CH₃)₂ | CH₃ | c-Pr | C₂H₅ | F |
| CH₂CH₂CH₂Si(CH₃)₂(C₂H₅) | CH₃ | c-Pr | C₂H₅ | F |
| CH₂CH₂CH₂Si(CH₃)₃ | C₂H₅ | C₂H₅ | C₂H₅ | F |
| CH₂CH₂CH₂C(CH₃)₃ | C₂H₅ | C₂H₅ | C₂H₅ | F |
| CH₂CH₂CH₂CH(CH₃)₂ | C₂H₅ | C₂H₅ | C₂H₅ | F |
| CH₂CH₂CH₂Si(CH₃)₂(C₂H₅) | C₂H₅ | C₂H₅ | C₂H₅ | F |
| CH₂CH₂CH₂Si(CH₃)₃ | CH₃ | CH₂CH═CH₂ | C₂H₅ | F |
| CH₂CH₂CH₂C(CH₃)₃ | CH₃ | CH₂CH═CH₂ | C₂H₅ | F |
| CH₂CH₂CH₂CH(CH₃)₂ | CH₃ | CH₂CH═CH₂ | C₂H₅ | F |
| CH₂CH₂CH₂Si(CH₃)₂(C₂H₅) | CH₃ | CH₂CH═CH₂ | C₂H₅ | F |
| CH₂CH₂CH₂Si(CH₃)₃ | CH₃ | CH₂C≡CH | C₂H₅ | F |
| CH₂CH₂CH₂C(CH₃)₃ | CH₃ | CH₂C≡CH | C₂H₅ | F |
| CH₂CH₂CH₂CH(CH₃)₂ | CH₃ | CH₂C≡CH | C₂H₅ | F |
| CH₂CH₂CH₂Si(CH₃)₂(C₂H₅) | CH₃ | CH₂C≡CH | C₂H₅ | F |
| CH₂CH₂CH₂Si(CH₃)₃ | CH₃ | CH₂CH₂F | C₂H₅ | F |
| CH₂CH₂CH₂C(CH₃)₃ | CH₃ | CH₂CH₂F | C₂H₅ | F |
| CH₂CH₂CH₂Si(CH₃)₃ | CH₃ | CH₃ | CH₂SCH₃ | Cl |
| CH₂CH₂CH₂C(CH₃)₃ | CH₃ | CH₃ | CH₂SCH₃ | Cl |
| CH₂CH₂CH₂CH(CH₃)₂ | CH₃ | CH₃ | CH₂SCH₃ | Cl |
| CH₂CH₂CH₂Si(CH₃)₂(C₂H₅) | CH₃ | CH₃ | CH₂SCH₃ | Cl |
| CH₂CH₂CH₂Si(CH₃)₃ | CH₃ | C₂H₅ | CH₂SCH₃ | Cl |
| CH₂CH₂CH₂C(CH₃)₃ | CH₃ | C₂H₅ | CH₂SCH₃ | Cl |
| CH₂CH₂CH₂CH(CH₃)₂ | CH₃ | C₂H₅ | CH₂SCH₃ | Cl |
| CH₂CH₂CH₂Si(CH₃)₂(C₂H₅) | CH₃ | C₂H₅ | CH₂SCH₃ | Cl |
| CH₂CH₂CH₂Si(CH₃)₃ | CH₃ | CH(CH₃)₂ | CH₂SCH₃ | Cl |
| CH₂CH₂CH₂C(CH₃)₃ | CH₃ | CH(CH₃)₂ | CH₂SCH₃ | Cl |
| CH₂CH₂CH₂CH(CH₃)₂ | CH₃ | CH(CH₃)₂ | CH₂SCH₃ | Cl |
| CH₂CH₂CH₂Si(CH₃)₂(C₂H₅) | CH₃ | CH(CH₃)₂ | CH₂SCH₃ | Cl |
| CH₂CH₂CH₂Si(CH₃)₃ | CH₃ | c-Pr | CH₂SCH₃ | Cl |
| CH₂CH₂CH₂C(CH₃)₃ | CH₃ | c-Pr | CH₂SCH₃ | Cl |
| CH₂CH₂CH₂CH(CH₃)₂ | CH₃ | c-Pr | CH₂SCH₃ | Cl |
| CH₂CH₂CH₂Si(CH₃)₂(C₂H₅) | CH₃ | c-Pr | CH₂SCH₃ | Cl |
| CH₂CH₂CH₂Si(CH₃)₃ | C₂H₅ | C₂H₅ | CH₂SCH₃ | Cl |
| CH₂CH₂CH₂C(CH₃)₃ | C₂H₅ | C₂H₅ | CH₂SCH₃ | Cl |
| CH₂CH₂CH₂CH(CH₃)₂ | C₂H₅ | C₂H₅ | CH₂SCH₃ | Cl |
| CH₂CH₂CH₂Si(CH₃)₂(C₂H₅) | C₂H₅ | C₂H₅ | CH₂SCH₃ | Cl |
| CH₂CH₂CH₂Si(CH₃)₃ | CH₃ | CH₂CH═CH₂ | CH₂SCH₃ | Cl |
| CH₂CH₂CH₂C(CH₃)₃ | CH₃ | CH₂CH═CH₂ | CH₂SCH₃ | Cl |
| CH₂CH₂CH₂CH(CH₃)₂ | CH₃ | CH₂CH═CH₂ | CH₂SCH₃ | Cl |
| CH₂CH₂CH₂Si(CH₃)₂(C₂H₅) | CH₃ | CH₂CH═CH₂ | CH₂SCH₃ | Cl |
| CH₂CH₂CH₂Si(CH₃)₃ | CH₃ | CH₂C≡CH | CH₂SCH₃ | Cl |
| CH₂CH₂CH₂C(CH₃)₃ | CH₃ | CH₂C≡CH | CH₂SCH₃ | Cl |
| CH₂CH₂CH₂CH(CH₃)₂ | CH₃ | CH₂C≡CH | CH₂SCH₃ | Cl |
| CH₂CH₂CH₂Si(CH₃)₂(C₂H₅) | CH₃ | CH₂C≡CH | CH₂SCH₃ | Cl |
| CH₂CH₂CH₂Si(CH₃)₃ | CH₃ | CH₂CH₂F | CH₂SCH₃ | Cl |
| CH₂CH₂CH₂C(CH₃)₃ | CH₃ | CH₂CH₂F | CH₂SCH₃ | Cl |
| CH₂CH₂CH₂Si(CH₃)₃ | CH₃ | CH₃ | CH₂OCH₃ | Cl |
| CH₂CH₂CH₂C(CH₃)₃ | CH₃ | CH₃ | CH₂OCH₃ | Cl |
| CH₂CH₂CH₂CH(CH₃)₂ | CH₃ | CH₃ | CH₂OCH₃ | Cl |
| CH₂CH₂CH₂Si(CH₃)₂(C₂H₅) | CH₃ | CH₃ | CH₂OCH₃ | Cl |
| CH₂CH₂CH₂Si(CH₃)₃ | CH₃ | C₂H₅ | CH₂OCH₃ | Cl |
| CH₂CH₂CH₂C(CH₃)₃ | CH₃ | C₂H₅ | CH₂OCH₃ | Cl |
| CH₂CH₂CH₂CH(CH₃)₂ | CH₃ | C₂H₅ | CH₂OCH₃ | Cl |
| CH₂CH₂CH₂Si(CH₃)₂(C₂H₅) | CH₃ | C₂H₅ | CH₂OCH₃ | Cl |
| CH₂CH₂CH₂Si(CH₃)₃ | CH₃ | CH(CH₃)₂ | CH₂OCH₃ | Cl |
| CH₂CH₂CH₂C(CH₃)₃ | CH₃ | CH(CH₃)₂ | CH₂OCH₃ | Cl |
| CH₂CH₂CH₂CH(CH₃)₂ | CH₃ | CH(CH₃)₂ | CH₂OCH₃ | Cl |
| CH₂CH₂CH₂Si(CH₃)₂(C₂H₅) | CH₃ | CH(CH₃)₂ | CH₂OCH₃ | Cl |
| CH₂CH₂CH₂Si(CH₃)₃ | CH₃ | c-Pr | CH₂OCH₃ | Cl |
| CH₂CH₂CH₂C(CH₃)₃ | CH₃ | c-Pr | CH₂OCH₃ | Cl |
| CH₂CH₂CH₂CH(CH₃)₂ | CH₃ | c-Pr | CH₂OCH₃ | Cl |
| CH₂CH₂CH₂Si(CH₃)₂(C₂H₅) | CH₃ | c-Pr | CH₂OCH₃ | Cl |
| CH₂CH₂CH₂Si(CH₃)₃ | C₂H₅ | C₂H₅ | CH₂OCH₃ | Cl |
| CH₂CH₂CH₂C(CH₃)₃ | C₂H₅ | C₂H₅ | CH₂OCH₃ | Cl |
| CH₂CH₂CH₂CH(CH₃)₂ | C₂H₅ | C₂H₅ | CH₂OCH₃ | Cl |
| CH₂CH₂CH₂Si(CH₃)₂(C₂H₅) | C₂H₅ | C₂H₅ | CH₂OCH₃ | Cl |
| CH₂CH₂CH₂Si(CH₃)₃ | CH₃ | CH₂CH═CH₂ | CH₂OCH₃ | Cl |
| CH₂CH₂CH₂C(CH₃)₃ | CH₃ | CH₂CH═CH₂ | CH₂OCH₃ | Cl |
| CH₂CH₂CH₂CH(CH₃)₂ | CH₃ | CH₂CH═CH₂ | CH₂OCH₃ | Cl |
| CH₂CH₂CH₂Si(CH₃)₂(C₂H₅) | CH₃ | CH₂CH═CH₂ | CH₂OCH₃ | Cl |
| CH₂CH₂CH₂Si(CH₃)₃ | CH₃ | CH₂C≡CH | CH₂OCH₃ | Cl |
| CH₂CH₂CH₂C(CH₃)₃ | CH₃ | CH₂C≡CH | CH₂OCH₃ | Cl |
| CH₂CH₂CH₂CH(CH₃)₂ | CH₃ | CH₂C≡CH | CH₂COCH₃ | Cl |
| CH₂CH₂CH₂Si(CH₃)₂(C₂H₅) | CH₃ | CH₂C≡CH | CH₂OCH₃ | Cl |
| CH₂CH₂CH₂Si(CH₃)₃ | CH₃ | CH₂CH₂F | CH₂OCH₃ | Cl |
| CH₂CH₂CH₂C(CH₃)₃ | CH₃ | CH₂CH₂F | CH₂OCH₃ | Cl |
| CH₂CH₂CH₂Si(CH₃)₃ | CH₃ | CH₃ | CH₃ | CN |
| CH₂CH₂CH₂C(CH₃)₃ | CH₃ | CH₃ | CH₃ | CN |
| CH₂CH₂CH₂CH(CH₃)₂ | CH₃ | CH₃ | CH₃ | CN |
| CH₂CH₂CH₂Si(CH₃)₂(C₂H₅) | CH₃ | CH₃ | CH₃ | CN |
| CH₂CH₂CH₂Si(CH₃)₃ | CH₃ | C₂H₅ | CH₃ | CN |
| CH₂CH₂CH₂C(CH₃)₃ | CH₃ | C₂H₅ | CH₃ | CN |
| CH₂CH₂CH₂CH(CH₃)₂ | CH₃ | C₂H₅ | CH₃ | CN |
| CH₂CH₂CH₂Si(CH₃)₂(C₂H₅) | CH₃ | C₂H₅ | CH₃ | CN |
| CH₂CH₂CH₂Si(CH₃)₃ | CH₃ | CH(CH₃)₂ | CH₃ | CN |
| CH₂CH₂CH₂C(CH₃)₃ | CH₃ | CH(CH₃)₂ | CH₃ | CN |
| CH₂CH₂CH₂CH(CH₃)₂ | CH₃ | CH(CH₃)₂ | CH₃ | CN |
| CH₂CH₂CH₂Si(CH₃)₂(C₂H₅) | CH₃ | CH(CH₃)₂ | CH₃ | CN |
| CH₂CH₂CH₂Si(CH₃)₃ | CH₃ | c-Pr | CH₃ | CN |
| CH₂CH₂CH₂C(CH₃)₃ | CH₃ | c-Pr | CH₃ | CN |
| CH₂CH₂CH₂CH₂CH(CH₃)₂ | CH₃ | c-Pr | CH₃ | CN |
| CH₂CH₂CH₂Si(CH₃)₂(C₂H₅) | CH₃ | c-Pr | CH₃ | CN |
| CH₂CH₂CH₂Si(CH₃)₃ | C₂H₅ | C₂H₅ | CH₃ | CN |
| CH₂CH₂CH₂C(CH₃)₃ | C₂H₅ | C₂H₅ | CH₃ | CN |
| CH₂CH₂CH₂CH(CH₃)₂ | C₂H₅ | C₂H₅ | CH₃ | CN |
| CH₂CH₂CH₂Si(CH₃)₂(C₂H₅) | C₂H₅ | C₂H₅ | CH₃ | CN |
| CH₂CH₂CH₂Si(CH₃)₃ | CH₃ | CH₂CH═CH₂ | CH₃ | CN |
| CH₂CH₂CH₂C(CH₃)₃ | CH₃ | CH₂CH═CH₂ | CH₃ | CN |
| CH₂CH₂CH₂CH(CH₃)₂ | CH₃ | CH₂CH═CH₂ | CH₃ | CN |
| CH₂CH₂CH₂Si(CH₃)₂(C₂H₅) | CH₃ | CH₂CH═CH₂ | CH₃ | CN |
| CH₂CH₂CH₂Si(CH₃)₃ | CH₃ | CH₂C≡CH | CH₃ | CN |
| CH₂CH₂CH₂C(CH₃)₃ | CH₃ | CH₂C≡CH | CH₃ | CN |
| CH₂CH₂CH₂CH(CH₃)₂ | CH₃ | CH₂C≡CH | CH₃ | CN |
| CH₂CH₂CH₂Si(CH₃)₂(C₂H₅) | CH₃ | CH₂C≡CH | CH₃ | CN |
| CH₂CH₂CH₂Si(CH₃)₃ | CH₃ | CH₂CH₂F | CH₃ | CN |
| CH₂CH₂CH₂C(CH₃)₃ | CH₃ | CH₂CH₂F | CH₃ | CN |
| CH₂CH₂CH₂Si(CH₃)₃ | CH₃ | CH₃ | CH₃ | CHO |
| CH₂CH₂CH₂C(CH₃)₃ | CH₃ | CH₃ | CH₃ | CHO |
| CH₂CH₂CH₂CH(CH₃)₂ | CH₃ | CH₃ | CH₃ | CHO |
| CH₂CH₂CH₂Si(CH₃)₂(C₂H₅) | CH₃ | CH₃ | CH₃ | CHO |
| CH₂CH₂CH₂Si(CH₃)₃ | CH₃ | C₂H₅ | CH₃ | CHO |
| CH₂CH₂CH₂C(CH₃)₃ | CH₃ | C₂H₅ | CH₃ | CHO |
| CH₂CH₂CH₂CH(CH₃)₂ | CH₃ | C₂H₅ | CH₃ | CHO |
| CH₂CH₂CH₂Si(CH₃)₂(C₂H₅) | CH₃ | C₂H₅ | CH₃ | CHO |
| CH₂CH₂CH₂Si(CH₃)₃ | CH₃ | CH(CH₃)₂ | CH₃ | CHO |
| CH₂CH₂CH₂C(CH₃)₃ | CH₃ | CH(CH₃)₂ | CH₃ | CHO |
| CH₂CH₂CH₂CH(CH₃)₂ | CH₃ | CH(CH₃)₂ | CH₃ | CHO |
| CH₂CH₂CH₂Si(CH₃)₂(C₂H₅) | CH₃ | CH(CH₃)₂ | CH₃ | CHO |
| CH₂CH₂CH₂Si(CH₃)₃ | CH₃ | c-Pr | CH₃ | CHO |
| CH₂CH₂CH₂C(CH₃)₃ | CH₃ | c-Pr | CH₃ | CHO |
| CH₂CH₂CH₂CH(CH₃)₂ | CH₃ | c-Pr | CH₃ | CHO |
| CH₂CH₂CH₂Si(CH₃)₂(C₂H₅) | CH₃ | c-Pr | CH₃ | CHO |
| CH₂CH₂CH₂Si(CH₃)₃ | C₂H₅ | C₂H₅ | CH₃ | CHO |
| CH₂CH₂CH₂C(CH₃)₃ | C₂H₅ | C₂H₅ | CH₃ | CHO |
| CH₂CH₂CH₂CH(CH₃)₂ | C₂H₅ | C₂H₅ | CH₃ | CHO |
| CH₂CH₂CH₂Si(CH₃)₂(C₂H₅) | C₂H₅ | C₂H₅ | CH₃ | CHO |
| CH₂CH₂CH₂Si(CH₃)₃ | CH₃ | CH₂CH═CH₂ | CH₃ | CHO |
| CH₂CH₂CH₂C(CH₃)₃ | CH₃ | CH₂CH═CH₂ | CH₃ | CHO |
| CH₂CH₂CH₂CH(CH₃)₂ | CH₃ | CH₂CH═CH₂ | CH₃ | CHO |
| CH₂CH₂CH₂Si(CH₃)₂(C₂H₅) | CH₃ | CH₂CH═CH₂ | CH₃ | CHO |
| CH₂CH₂CH₂Si(CH₃)₃ | CH₃ | CH₂C≡CH | CH₃ | CHO |
| CH₂CH₂CH₂C(CH₃)₃ | CH₃ | CH₂C≡CH | CH₃ | CHO |
| CH₂CH₂CH₂CH(CH₃)₂ | CH₃ | CH₂C≡CH | CH₃ | CHO |
| CH₂CH₂CH₂Si(CH₃)₂(C₂H₅) | CH₃ | CH₂C≡CN | CH₃ | CHO |
| CH₂CH₂CH₂Si(CH₃)₃ | CH₃ | CH₂CH₂F | CH₃ | CHO |
| CH₂CH₂CH₂C(CH₃)₃ | CH₃ | CH₂CH₂F | CH₃ | CHO |
| CH₂CH₂CH₂Si(CH₃)₃ | CH₃ | CH₃ | CH₂Br | C≡N |
| CH₂CH₂CH₂C(CH₃)₃ | CH₃ | CH₃ | CH₂Br | C≡N |
| CH₂CH₂CH₂CH(CH₃)₂ | CH₃ | CH₃ | CH₂Br | C≡N |
| CH₂CH₂CH₂Si(CH₃)₂(C₂H₅) | CH₃ | CH₃ | CH₂Br | C≡N |
| CH₂CH₂CH₂Si(CH₃)₃ | CH₃ | C₂H₅ | CH₂Br | C≡N |
| CH₂CH₂CH₂C(CH₃)₃ | CH₃ | C₂H₅ | CH₂Br | C≡N |
| CH₂CH₂CH₂CH(CH₃)₂ | CH₃ | C₂H₅ | CH₂Br | C≡N |
| CH₂CH₂CH₂Si(CH₃)₂(C₂H₅) | CH₃ | C₂H₅ | CH₂Br | C≡N |
| CH₂CH₂CH₂Si(CH₃)₃ | CH₃ | CH(CH₃)₂ | CH₂Br | C≡N |
| CH₂CH₂CH₂C(CH₃)₃ | CH₃ | CH(CH₃)₂ | CH₂Br | C≡N |
| CH₂CH₂CH₂CH(CH₃)₂ | CH₃ | CH(CH₃)₂ | CH₂Br | C≡N |
| CH₂CH₂CH₂Si(CH₃)₂(C₂H₅) | CH₃ | CH(CH₃)₂ | CH₂Br | C≡N |
| CH₂CH₂CH₂Si(CH₃)₃ | CH₃ | c-Pr | CH₂Br | C≡N |
| CH₂CH₂CH₂C(CH₃)₃ | CH₃ | c-Pr | CH₂Br | C≡N |
| CH₂CH₂CH₂CH(CH₃)₂ | CH₃ | c-Pr | CH₂Br | C≡N |
| CH₂CH₂CH₂Si(CH₃)₂(C₂H₅) | CH₃ | c-Pr | CH₂Br | C≡N |
| CH₂CH₂CH₂Si(CH₃)₃ | C₂H₅ | C₂H₅ | CH₂Br | C≡N |
| CH₂CH₂CH₂C(CH₃)₃C₂H₅ | C₂H₅ | CH₂Br | C≡N | |
| CH₂CH₂CH₂CH(CH₃)₂ | C₂H₅ | C₂H₅ | CH₂Br | C≡N |
| CH₂CH₂CH₂Si(CH₃)₂(C₂H₅) | C₂H₅ | C₂H₅ | CH₂Br | C≡N |
| CH₂CH₂CH₂Si(CH₃)₃ | CH₃ | CH₂CH═CH₂ | CH₂Br | C≡N |
| CH₂CH₂CH₂C(CH₃)₃ | CH₃ | CH₂CH═CH₂ | CH₂Br | C≡N |
| CH₂CH₂CH₂CH(CH₃)₂ | CH₃ | CH₂CH═CH₂ | CH₂Br | C≡N |
| CH₂CH₂CH₂Si(CH₃)₂(C₂H₅) | CH₃ | CH₂CH═CH₂ | CH₂Br | C≡N |
| CH₂CH₂CH₂Si(CH₃)₃ | CH₃ | CH₂C≡CH | CH₂Br | C≡N |
| CH₂CH₂CH₂C(CH₃)₃ | CH₃ | CH₂C≡CH | CH₂Br | C≡N |
| CH₂CH₂CH₂CH(CH₃)₂ | CH₃ | CH₂C≡CH | CH₂Br | C≡N |
| CH₂CH₂CH₂Si(CH₃)₂(C₂H₅) | CH₃ | CH₂C≡CH | CH₂Br | C≡N |
| CH₂CH₂CH₂Si(CH₃)₃ | CH₃ | CH₂CH₂F | CH₂Br | C≡N |
| CH₂CH₂CH₂C(CH₃)₃ | CH₃ | CH₂CH₂F | CH₂Br | C≡N |

TABLE 10

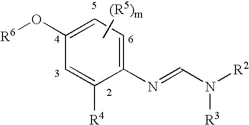

| R⁶ | R² | R³ | R⁴ | R⁵ | m |
|---|---|---|---|---|---|
| CH₂CH₂CH₂Si(CH₃)₃ | CH₃ | CH₃ | CH₃ | 5,6-di-Cl | 2 |
| CH₂CH₂CH₂C(CH₃)₃ | CH₃ | CH₃ | CH₃ | 5,6-di-Cl | 2 |
| CH₂CH₂CH₂CH(CH₃)₂ | CH₃ | CH₃ | CH₃ | 5,6-di-Cl | 2 |
| CH₂CH₂CH₂Si(CH₃)₂(C₂H₅) | CH₃ | CH₃ | CH₃ | 5,6-di-Cl | 2 |
| CH₂CH₂CH₂Si(CH₃)₃ | CH₃ | C₂H₅ | CH₃ | 5,6-di-Cl | 2 |
| CH₂CH₂CH₂C(CH₃)₃ | CH₃ | C₂H₅ | CH₃ | 5,6-di-Cl | 2 |
| CH₂CH₂CH₂CH(CH₃)₂ | CH₃ | C₂H₅ | CH₃ | 5,6-di-Cl | 2 |
| CH₂CH₂CH₂Si(CH₃)₂(C₂H₅) | CH₃ | C₂H₅ | CH₃ | 5,6-di-Cl | 2 |
| CH₂CH₂CH₂Si(CH₃)₃ | CH₃ | CH(CH₃)₂ | CH₃ | 5,6-di-Cl | 2 |
| CH₂CH₂CH₂C(CH₃)₃ | CH₃ | CH(CH₃)₂ | CH₃ | 5,6-di-Cl | 2 |
| CH₂CH₂CH₂CH(CH₃)₂ | CH₃ | CH(CH₃)₂ | CH₃ | 5,6-di-Cl | 2 |
| CH₂CH₂CH₂Si(CH₃)₂(C₂H₅) | CH₃ | CH(CH₃)₂ | CH₃ | 5,6-di-Cl | 2 |
| CH₂CH₂CH₂Si(CH₃)₃ | CH₃ | c-Pr | CH₃ | 5,6-di-Cl | 2 |
| CH₂CH₂CH₂C(CH₃)₃ | CH₃ | c-Pr | CH₃ | 5,6-di-Cl | 2 |
| CH₂CH₂CH₂CH(CH₃)₂ | CH₃ | c-Pr | CH₃ | 5,6-di-Cl | 2 |
| CH₂CH₂CH₂Si(CH₃)₂(C₂H₅) | CH₃ | c-Pr | CH₃ | 5,6-di-Cl | 2 |
| CH₂CH₂CH₂Si(CH₃)₃ | C₂H₅ | C₂H₅ | CH₃ | 5,6-di-Cl | 2 |
| CH₂CH₂CH₂C(CH₃)₃ | C₂H₅ | C₂H₅ | CH₃ | 5,6-di-Cl | 2 |
| CH₂CH₂CH₂CH(CH₃)₂ | C₂H₅ | C₂H₅ | CH₃ | 5,6-di-Cl | 2 |
| CH₂CH₂CH₂Si(CH₃)₂(C₂H₅) | C₂H₅ | C₂H₅ | CH₃ | 5,6-di-Cl | 2 |
| CH₂CH₂CH₂Si(CH₃)₃ | CH₃ | CH₂CH═CH₂ | CH₃ | 5,6-di-Cl | 2 |
| CH₂CH₂CH₂C(CH₃)₃ | CH₃ | CH₂CH═CH₂ | CH₃ | 5,6-di-Cl | 2 |
| CH₂CH₂CH₂CH(CH₃)₂ | CH₃ | CH₂CH═CH₂ | CH₃ | 5,6-di-Cl | 2 |
| CH₂CH₂CH₂Si(CH₃)₂(C₂H₅) | CH₃ | CH₂CH═CH₂ | CH₃ | 5,6-di-Cl | 2 |
| CH₂CH₂CH₂Si(CH₃)₃ | CH₃ | CH₂C≡CH | CH₃ | 5,6-di-Cl | 2 |
| CH₂CH₂CH₂C(CH₃)₃ | CH₃ | CH₂C≡CH | CH₃ | 5,6-di-Cl | 2 |
| CH₂CH₂CH₂CH(CH₃)₂ | CH₃ | CH₂C≡CH | CH₃ | 5,6-di-Cl | 2 |
| CH₂CH₂CH₂Si(CH₃)₂(C₂H₅) | CH₃ | CH₂C≡CH | CH₃ | 5,6-di-Cl | 2 |
| CH₂CH₂CH₂Si(CH₃)₃ | CH₃ | CH₂CH₂F | CH₃ | 5,6-di-Cl | 2 |
| CH₂CH₂CH₂C(CH₃)₃ | CH₃ | CH₂CH₂F | CH₃ | 5,6-di-Cl | 2 |
| CH₂CH₂CH₂Si(CH₃)₃ | CH₃ | CH₂CH₂CH₃ | CH₃ | 5-Cl | 1 |
| CH₂CH₂CH₂C(CH₃)₃ | CH₃ | CH₂CH₂CH₃ | CH₃ | 5-Cl | 1 |
| CH₂CH₂CH₂Si(CH₃)₂(C₂H₅) | CH₃ | CH₂CH₂CH₃ | CH₃ | 5-Cl | 1 |
| CH₂CH₂CH₂Si(CH₃)₃ | CH₃ | CH₂CH₂CH₂CH₃ | CH₃ | 5-Cl | 1 |
| CH₂CH₂CH₂C(CH₃)₃ | CH₃ | CH₂CH₂CH₂CH₃ | CH₃ | 5-Cl | 1 |
| CH₂CH₂CH₂Si(CH₃)₂(C₂H₅) | CH₃ | CH₂CH₂CH₂CH₃ | CH₃ | 5-Cl | 1 |
| CH₂CH₂CH₂Si(CH₃)₃ | CH₃ | C₂H₅ | CH₃ | 5-Cl | 1 |
| CH₂CH₂CH₂C(CH₃)₃ | CH₃ | C₂H₅ | CH₃ | 5-Cl | 1 |
| CH₂CH₂CH₂CH(CH₃)₂ | CH₃ | C₂H₅ | CH₃ | 5-Cl | 1 |
| CH₂CH₂CH₂Si(CH₃)₂(C₂H₅) | CH₃ | C₂H₅ | CH₃ | 5-Cl | 1 |
| CH₂CH₂CH₂Si(CH₃)₃ | CH₃ | CH(CH₃)₂ | CH₃ | 5-Cl | 1 |
| CH₂CH₂CH₂C(CH₃)₃ | CH₃ | CH(CH₃)₂ | CH₃ | 5-Cl | 1 |
| CH₂CH₂CH₂CH(CH₃)₂ | CH₃ | CH(CH₃)₂ | CH₃ | 5-Cl | 1 |
| CH₂CH₂CH₂Si(CH₃)₂(C₂H₅) | CH₃ | CH(CH₃)₂ | CH₃ | 5-Cl | 1 |
| CH₂CH₂CH₂Si(CH₃)₃ | CH₃ | c-Pr | CH₃ | 5-Cl | 1 |
| CH₂CH₂CH₂C(CH₃)₃ | CH₃ | c-Pr | CH₃ | 5-Cl | 1 |
| CH₂CH₂CH₂CH(CH₃)₂ | CH₃ | c-Pr | CH₃ | 5-Cl | 1 |
| CH₂CH₂CH₂Si(CH₃)₂(C₂H₅) | CH₃ | c-Pr | CH₃ | 5-Cl | 1 |
| CH₂CH₂CH₂Si(CH₃)₃ | C₂H₅ | C₂H₅ | CH₃ | 5-Cl | 1 |
| CH₂CH₂CH₂C(CH₃)₃ | C₂H₅ | C₂H₅ | CH₃ | 5-Cl | 1 |
| CH₂CH₂CH₂CH(CH₃)₂ | C₂H₅ | C₂H₅ | CH₃ | 5-Cl | 1 |
| CH₂CH₂CH₂Si(CH₃)₂(C₂H₅) | C₂H₅ | C₂H₅ | CH₃ | 5-Cl | 1 |
| CH₂CH₂CH₂Si(CH₃)₃ | CH₃ | CH₂CH═CH₂ | CH₃ | 5-Cl | 1 |
| CH₂CH₂CH₂C(CH₃)₃ | CH₃ | CH₂CH═CH₂ | CH₃ | 5-Cl | 1 |
| CH₂CH₂CH₂CH(CH₃)₂ | CH₃ | CH₂CH═CH₂ | CH₃ | 5-Cl | 1 |
| CH₂CH₂CH₂Si(CH₃)₂(C₂H₅) | CH₃ | CH₂CH═CH₂ | CH₃ | 5-Cl | 1 |
| CH₂CH₂CH₂Si(CH₃)₃ | CH₃ | CH₂C≡CH | CH₃ | 5-Cl | 1 |
| CH₂CH₂CH₂C(CH₃)₃ | CH₃ | CH₂C≡CH | CH₃ | 5-Cl | 1 |
| CH₂CH₂CH₂Si(CH₃)₂ | CH₃ | CH₂C≡CH | CH₃ | 5-Cl | 1 |
| CH₂CH₂CH₂Si(CH₃)₂(C₂H₅) | CH₃ | CH₂C≡CH | CH₃ | 5-Cl | 1 |
| CH₂CH₂CH₂Si(CH₃)₃ | CH₃ | CH₂CH₂F | CH₃ | 5-Cl | 1 |
| CH₂CH₂CH₂C(CH₃)₃ | CH₃ | CH₂CH₂F | CH₃ | 5-Cl | 1 |
| CH(CH₃)CH₂CH₂CH(CH₃)₂ | CH₃ | C₂H₅ | CH₃ | 5-Cl | 1 |
| CH₂CH₂CH₂Si(CH₃)₃ | CH₃ | CH₃ | CH₃ | 5-F | 1 |
| CH₂CH₂CH₂C(CH₃)₃ | CH₃ | CH₃ | CH₃ | 5-F | 1 |
| CH₂CH₂CH₂Si(CH₃)₂(C₂H₅) | CH₃ | CH₃ | CH₃ | 5-F | 1 |
| CH₂CH₂CH₂Si(CH₃)₃ | CH₃ | C₂H₅ | CH₃ | 5-F | 1 |
| CH₂CH₂CH₂C(CH₃)₃ | CH₃ | C₂H₅ | CH₃ | 5-F | 1 |
| CH₂CH₂CH₂CH(CH₃)₂ | CH₃ | C₂H₅ | CH₃ | 5-F | 1 |
| CH₂CH₂CH₂Si(CH₃)₂(C₂H₅) | CH₃ | C₂H₅ | CH₃ | 5-F | 1 |
| CH₂CH₂CH₂Si(CH₃)₃ | CH₃ | CH(CH₃)₂ | CH₃ | 5-F | 1 |
| CH₂CH₂CH₂C(CH₃)₃ | CH₃ | CH(CH₃)₂ | CH₃ | 5-F | 1 |
| CH₂CH₂CH₂Si(CH₃)₂(C₂H₅) | CH₃ | CH(CH₃)₂ | CH₃ | 5-F | 1 |
| CH₂CH₂CH₂Si(CH₃)₃ | CH₃ | c-Pr | CH₃ | 5-F | 1 |
| CH₂CH₂CH₂C(CH₃)₃ | CH₃ | c-Pr | CH₃ | 5-F | 1 |
| CH₂CH₂CH₂CH(CH₃)₂ | CH₃ | c-Pr | CH₃ | 5-F | 1 |
| CH₂CH₂CH₂Si(CH₃)₂(C₂H₅) | CH₃ | c-Pr | CH₃ | 5-F | 1 |
| CH₂CH₂CH₂Si(CH₃)₃ | C₂H₅ | C₂H₅ | CH₃ | 5-F | 1 |
| CH₂CH₂CH₂C(CH₃)₃ | C₂H₅ | C₂H₅ | CH₃ | 5-F | 1 |
| CH₂CH₂CH₂Si(CH₃)₂(C₂H₅) | C₂H₅ | C₂H₅ | CH₃ | 5-F | 1 |
| CH₂CH₂CH₂Si(CH₃)₃ | CH₃ | CH₂CH═CH₂ | CH₃ | 5-F | 1 |
| CH₂CH₂CH₂C(CH₃)₃ | CH₃ | CH₂CH═CH₂ | CH₃ | 5-F | 1 |
| CH₂CH₂CH₂Si(CH₃)₂(C₂H₅) | CH₃ | CH₂CH═CH₂ | CH₃ | 5-F | 1 |
| CH₂CH₂CH₂Si(CH₃)₃ | CH₃ | CH₂C≡CH | CH₃ | 5-F | 1 |
| CH₂CH₂CH₂C(CH₃)₃ | CH₃ | CH₂C≡CH | CH₃ | 5-F | 1 |
| CH₂CH₂CH₂Si(CH₃)₂(C₂H₅) | CH₃ | CH₂C≡CH | CH₃ | 5-F | 1 |
| CH₂CH₂CH₂Si(CH₃)₃ | CH₃ | CH₂CH₂CH₃ | CH₃ | 5-F | 1 |
| CH₂CH₂CH₂Si(CH₃)₂(C₂H₅) | CH₃ | CH₂CH₂CH₃ | CH₃ | 5-F | 1 |
| CH₂CH₂CH₂C(CH₃)₃ | CH₃ | CH₂CH₂CH₃ | CH₃ | 5-F | 1 |
| CH₂CH₂CH₂Si(CH₃)₃ | CH₃ | CH₂CH₂CH₂CH₃ | CH₃ | 5-F | 1 |
| CH₂CH₂CH₂C(CH₃)₃ | CH₃ | CH₂CH₂CH₂CH₃ | CH₃ | 5-F | 1 |
| CH₂CH₂CH₂Si(CH₃)₂(C₂H₅) | CH₃ | CH₂CH₂CH₂CH₃ | CH₃ | 5-F | 1 |
| CH₂CH₂CH₂Si(CH₃)₃ | CH₃ | CH₂CH₂F | CH₃ | 5-F | 1 |
| CH₂CH₂CH₂C(CH₃)₃ | CH₃ | CH₂CH₂F | CH₃ | 5-F | 1 |
| CH₂CH₂CH₂Si(CH₃)₃ | CH₃ | CH₂CH₂CH₃ | CH₃ | 5-i-Pr | 1 |
| CH₂CH₂CH₂Si(CH₃)₃ | CH₃ | CH₂CH₂CH₂CH₃ | CH₃ | 5-i-Pr | 1 |
| CH₂CH₂CH₂Si(CH₃)₂(C₂H₅) | CH₃ | CH₂CH₂CH₃ | CH₃ | 5-i-Pr | 1 |
| CH₂CH₂CH₂Si(CH₃)₂(C₂H₅) | CH₃ | CH₂CH₂CH₂CH₃ | CH₃ | 5-i-Pr | 1 |
| CH₂CH₂CH₂Si(CH₃)₃ | CH₃ | C₂H₅ | CH₃ | 5-i-Pr | 1 |
| CH₂CH₂CH₂C(CH₃)₃ | CH₃ | C₂H₅ | CH₃ | 5-i-Pr | 1 |
| CH₂CH₂CH₂CH(CH₃)₂ | CH₃ | C₂H₅ | CH₃ | 5-i-Pr | 1 |
| CH₂CH₂CH₂Si(CH₃)₂(C₂H₅) | CH₃ | C₂H₅ | CH₃ | 5-i-Pr | 1 |
| CH₂CH₂CH₂Si(CH₃)₃ | CH₃ | CH(CH₃)₂ | CH₃ | 5-i-Pr | 1 |
| CH₂CH₂CH₂C(CH₃)₃ | CH₃ | CH(CH₃)₂ | CH₃ | 5-i-Pr | 1 |
| CH₂CH₂CH₂CH(CH₃)₂ | CH₃ | CH(CH₃)₂ | CH₃ | 5-i-Pr | 1 |
| CH₂CH₂CH₂Si(CH₃)₂(C₂H₅) | CH₃ | CH(CH₃)₂ | CH₃ | 5-i-Pr | 1 |
| CH₂CH₂CH₂Si(CH₃)₃ | CH₃ | c-Pr | CH₃ | 5-i-Pr | 1 |
| CH₂CH₂CH₂C(CH₃)₃ | CH₃ | c-Pr | CH₃ | 5-i-Pr | 1 |
| CH₂CH₂CH₂CH(CH₃)₂ | CH₃ | c-Pr | CH₃ | 5-i-Pr | 1 |
| CH₂CH₂CH₂Si(CH₃)₂(C₂H₅) | CH₃ | c-Pr | CH₃ | 5-i-Pr | 1 |
| CH₂CH₂CH₂Si(CH₃)₃ | C₂H₅ | C₂H₅ | CH₃ | 5-i-Pr | 1 |
| CH₂CH₂CH₂C(CH₃)₃ | C₂H₅ | C₂H₅ | CH₃ | 5-i-Pr | 1 |
| CH₂CH₂CH₂CH(CH₃)₂ | C₂H₅ | C₂H₅ | CH₃ | 5-i-Pr | 1 |
| CH₂CH₂CH₂Si(CH₃)₂(C₂H₅) | C₂H₅ | C₂H₅ | CH₃ | 5-i-Pr | 1 |
| CH₂CH₂CH₂Si(CH₃)₃ | CH₃ | CH₂CH═CH₂ | CH₃ | 5-i-Pr | 1 |
| CH₂CH₂CH₂C(CH₃)₃ | CH₃ | CH₂CH═CH₂ | CH₃ | 5-i-Pr | 1 |
| CH₂CH₂CH₂CH(CH₃)₂ | CH₃ | CH₂CH═CH₂ | CH₃ | 5-i-Pr | 1 |
| CH₂CH₂CH₂Si(CH₃)₂(C₂H₅) | CH₃ | CH₂CH═CH₂ | CH₃ | 5-i-Pr | 1 |
| CH₂CH₂CH₂Si(CH₃)₃ | CH₃ | CH₂C≡CH | CH₃ | 5-i-Pr | 1 |
| CH₂CH₂CH₂C(CH₃)₃ | CH₃ | CH₂C≡CH | CH₃ | 5-i-Pr | 1 |
| CH₂CH₂CH₂CH(CH₃)₃ | CH₃ | CH₂C≡CH | CH₃ | 5-i-Pr | 1 |
| CH₂CH₂CH₂Si(CH₃)₂(C₂H₅) | CH₃ | CH₂C≡CH | CH₃ | 5-i-Pr | 1 |
| CH₂CH₂CH₂Si(CH₃)₃ | CH₃ | CH₂CH₂F | CH₃ | 5-i-Pr | 1 |
| CH₂CH₂CH₂C(CH₃)₃ | CH₃ | CH₂CH₂F | CH₃ | 5-i-Pr | 1 |
| CH₂CH₂CH₂Si(CH₃)₃ | CH₃ | CH₃ | SCH₃ | 5-Cl | 1 |
| CH₂CH₂CH₂C(CH₃)₃ | CH₃ | CH₃ | SCH₃ | 5-Cl | 1 |
| CH₂CH₂CH₂Si(CH₃)₂(C₂H₅) | CH₃ | CH₃ | SCH₃ | 5-Cl | 1 |
| CH₂CH₂CH₂Si(CH₃)₃ | CH₃ | C₂H₅ | SCH₃ | 5-Cl | 1 |
| CH₂CH₂CH₂C(CH₃)₃ | CH₃ | C₂H₅ | SCH₃ | 5-Cl | 1 |
| CH₂CH₂CH₂CH(CH₃)₂ | CH₃ | C₂H₅ | SCH₃ | 5-Cl | 1 |
| CH₂CH₂CH₂Si(CH₃)₂(C₂H₅) | CH₃ | C₂H₅ | SCH₃ | 5-Cl | 1 |
| CH₂CH₂CH₂Si(CH₃)₃ | CH₃ | CH(CH₃)₂ | SCH₃ | 5-Cl | 1 |
| CH₂CH₂CH₂C(CH₃)₃ | CH₃ | CH(CH₃)₂ | SCH₃ | 5-Cl | 1 |
| CH₂CH₂CH₂Si(CH₃)₂(C₂H₅) | CH₃ | CH(CH₃)₂ | SCH₃ | 5-Cl | 1 |
| CH₂CH₂CH₂Si(CH₃)₃ | CH₃ | c-Pr | SCH₃ | 5-Cl | 1 |
| CH₂CH₂CH₂C(CH₃)₃ | CH₃ | c-Pr | SCH₃ | 5-Cl | 1 |
| CH₂CH₂CH₂CH(CH₃)₂ | CH₃ | c-Pr | SCH₃ | 5-Cl | 1 |
| CH₂CH₂CH₂Si(CH₃)₂(C₂H₅) | CH₃ | c-Pr | SCH₃ | 5-Cl | 1 |
| CH₂CH₂CH₂Si(CH₃)₃ | C₂H₅ | C₂H₅ | SCH₃ | 5-Cl | 1 |
| CH₂CH₂CH₂C(CH₃)₃ | C₂H₅ | C₂H₅ | SCH₃ | 5-Cl | 1 |
| CH₂CH₂CH₂Si(CH₃)₂(C₂H₅) | C₂H₅ | C₂H₅ | SCH₃ | 5-Cl | 1 |
| CH₂CH₂CH₂Si(CH₃)₃ | CH₃ | CH₂CH═CH₂ | SCH₃ | 5-Cl | 1 |
| CH₂CH₂CH₂C(CH₃)₃ | CH₃ | CH₂CH═CH₂ | SCH₃ | 5-Cl | 1 |
| CH₂CH₂CH₂Si(CH₃)₂(C₂H₅) | CH₃ | CH₂CH═CH₂ | SCH₃ | 5-Cl | 1 |
| CH₂CH₂CH₂Si(CH₃)₃ | CH₃ | CH₂C≡CH | SCH₃ | 5-Cl | 1 |
| CH₂CH₂CH₂C(CH₃)₃ | CH₃ | CH₂C≡CH | SCH₃ | 5-Cl | 1 |
| CH₂CH₂CH₂Si(CH₃)₂(C₂H₅) | CH₃ | CH₂C≡CH | SCH₃ | 5-Cl | 1 |
| CH₂CH₂CH₂Si(CH₃)₃ | CH₃ | CH₂CH₂CH₃ | SCH₃ | 5-Cl | 1 |
| CH₂CH₂CH₂Si(CH₃)₂(C₂H₅) | CH₃ | CH₂CH₂CH₃ | SCH₃ | 5-Cl | 1 |
| CH₂CH₂CH₂C(CH₃)₃ | CH₃ | CH₂CH₂CH₃ | SCH₃ | 5-Cl | 1 |
| CH₂CH₂CH₂Si(CH₃)₃ | CH₃ | CH₂CH₂CH₂CH₃ | SCH₃ | 5-Cl | 1 |
| CH₂CH₂CH₂C(CH₃)₃ | CH₃ | CH₂CH₂CH₂CH₃ | SCH₃ | 5-Cl | 1 |
| CH₂CH₂CH₂Si(CH₃)₂(C₂H₅) | CH₃ | CH₂CH₂CH₂CH₃ | SCH₃ | 5-Cl | 1 |
| CH₂CH₂CH₂Si(CH₃)₃ | CH₃ | CH₂CH₂F | SCH₃ | 5-Cl | 1 |
| CH₂CH₂CH₂C(CH₃)₃ | CH₃ | CH₂CH₂F | SCH₃ | 5-Cl | 1 |
| CH₂CH₂CH₂Si(CH₃)₃ | CH₃ | CH₃ | OCH₃ | 5-Cl | 1 |
| CH₂CH₂CH₂C(CH₃)₃ | CH₃ | CH₃ | OCH₃ | 5-Cl | 1 |
| CH₂CH₂CH₂Si(CH₃)₂(C₂H₅) | CH₃ | CH₃ | OCH₃ | 5-Cl | 1 |
| CH₂CH₂CH₂Si(CH₃)₃ | CH₃ | C₂H₅ | OCH₃ | 5-Cl | 1 |
| CH₂CH₂CH₂C(CH₃)₃ | CH₃ | C₂H₅ | OCH₃ | 5-Cl | 1 |
| CH₂CH₂CH₂CH(CH₃)₂ | CH₃ | C₂H₅ | OCH₃ | 5-Cl | 1 |
| CH₂CH₂CH₂Si(CH₃)₂(C₂H₅) | CH₃ | C₂H₅ | OCH₃ | 5-Cl | 1 |
| CH₂CH₂CH₂Si(CH₃)₃ | CH₃ | CH(CH₃)₂ | OCH₃ | 5-Cl | 1 |
| CH₂CH₂CH₂C(CH₃)₃ | CH₃ | CH(CH₃)₂ | OCH₃ | 5-Cl | 1 |
| CH₂CH₂CH₂Si(CH₃)₂(C₂H₅) | CH₃ | CH(CH₃)₂ | OCH₃ | 5-Cl | 1 |
| CH₂CH₂CH₂Si(CH₃)₃ | CH₃ | c-Pr | OCH₃ | 5-Cl | 1 |
| CH₂CH₂CH₂C(CH₃)₃ | CH₃ | c-Pr | OCH₃ | 5-Cl | 1 |
| CH₂CH₂CH₂CH(CH₃)₂ | CH₃ | c-Pr | OCH₃ | 5-Cl | 1 |
| CH₂CH₂CH₂Si(CH₃)₂(C₂H₅) | CH₃ | c-Pr | OCH₃ | 5-Cl | 1 |
| CH₂CH₂CH₂Si(CH₃)₃ | C₂H₅ | C₂H₅ | OCH₃ | 5-Cl | 1 |
| CH₂CH₂CH₂C(CH₃)₃ | C₂H₅ | C₂H₅ | OCH₃ | 5-Cl | 1 |
| CH₂CH₂CH₂Si(CH₃)₂(C₂H₅) | C₂H₅ | C₂H₅ | OCH₃ | 5-Cl | 1 |
| CH₂CH₂CH₂Si(CH₃)₃ | CH₃ | CH₂CH═CH₂ | OCH₃ | 5-Cl | 1 |
| CH₂CH₂CH₂C(CH₃)₃ | CH₃ | CH₂CH═CH₂ | OCH₃ | 5-Cl | 1 |
| CH₂CH₂CH₂Si(CH₃)₂(C₂H₅) | CH₃ | CH₂CH═CH₂ | OCH₃ | 5-Cl | 1 |
| CH₂CH₂CH₂Si(CH₃)₃ | CH₃ | CH₂C≡CH | OCH₃ | 5-Cl | 1 |
| CH₂CH₂CH₂C(CH₃)₃ | CH₃ | CH₂C≡CH | OCH₃ | 5-Cl | 1 |
| CH₂CH₂CH₂Si(CH₃)₂(C₂H₅) | CH₃ | CH₂C≡CH | OCH₃ | 5-Cl | 1 |
| CH₂CH₂CH₂Si(CH₃)₃ | CH₃ | CH₂CH₂CH₃ | OCH₃ | 5-Cl | 1 |
| CH₂CH₂CH₂Si(CH₃)₂(C₂H₅) | CH₃ | CH₂CH₂CH₃ | OCH₃ | 5-Cl | 1 |
| CH₂CH₂CH₂C(CH₃)₃ | CH₃ | CH₂CH₂CH₃ | OCH₃ | 5-Cl | 1 |
| CH₂CH₂CH₂Si(CH₃)₃ | CH₃ | CH₂CH₂CH₂CH₃ | OCH₃ | 5-Cl | 1 |
| CH₂CH₂CH₂C(CH₃)₃ | CH₃ | CH₂CH₂CH₂CH₃ | OCH₃ | 5-Cl | 1 |
| CH₂CH₂CH₂Si(CH₃)₂(C₂H₅) | CH₃ | CH₂CH₂CH₂CH₃ | OCH₃ | 5-Cl | 1 |
| CH₂CH₂CH₂Si(CH₃)₃ | CH₃ | CH₂CH₂F | OCH₃ | 5-Cl | 1 |
| CH₂CH₂CH₂C(CH₃)₃ | CH₃ | CH₂CH₂F | OCH₃ | 5-Cl | 1 |
| CH₂CH₂CH₂Si(CH₃)₃ | CH₃ | CH₃ | OC₂H₅ | 5-Cl | 1 |
| CH₂CH₂CH₂C(CH₃)₃ | CH₃ | CH₃ | OC₂H₅ | 5-Cl | 1 |
| CH₂CH₂CH₂Si(CH₃)₂(C₂H₅) | CH₃ | CH₃ | OC₂H₅ | 5-Cl | 1 |
| CH₂CH₂CH₂Si(CH₃)₃ | CH₃ | C₂H₅ | OC₂H₅ | 5-Cl | 1 |
| CH₂CH₂CH₂C(CH₃)₃ | CH₃ | C₂H₅ | OC₂H₅ | 5-Cl | 1 |
| CH₂CH₂CH₂CH(CH₃)₂ | CH₃ | C₂H₅ | OC₂H₅ | 5-Cl | 1 |
| CH₂CH₂CH₂Si(CH₃)₂(C₂H₅) | CH₃ | C₂H₅ | OC₂H₅ | 5-Cl | 1 |
| CH₂CH₂CH₂Si(CH₃)₃ | CH₃ | CH(CH₃)₂ | OC₂H₅ | 5-Cl | 1 |
| CH₂CH₂CH₂C(CH₃)₃ | CH₃ | CH(CH₃)₂ | OC₂H₅ | 5-Cl | 1 |
| CH₂CH₂CH₂Si(CH₃)₂(C₂H₅) | CH₃ | CH(CH₃)₂ | OC₂H₅ | 5-Cl | 1 |
| CH₂CH₂CH₂Si(CH₃)₃ | CH₃ | c-Pr | OC₂H₅ | 5-Cl | 1 |
| CH₂CH₂CH₂C(CH₃)₃ | CH₃ | c-Pr | OC₂H₅ | 5-Cl | 1 |
| CH₂CH₂CH₂CH(CH₃)₂ | CH₃ | c-Pr | OC₂H₅ | 5-Cl | 1 |
| CH₂CH₂CH₂Si(CH₃)₂(C₂H₅) | CH₃ | c-Pr | OC₂H₅ | 5-Cl | 1 |
| CH₂CH₂CH₂Si(CH₃)₃ | C₂H₅ | C₂H₅ | OC₂H₅ | 5-Cl | 1 |
| CH₂CH₂CH₂C(CH₃)₃ | C₂H₅ | C₂H₅ | OC₂H₅ | 5-Cl | 1 |
| CH₂CH₂CH₂Si(CH₃)₂(C₂H₅) | C₂H₅ | C₂H₅ | OC₂H₅ | 5-Cl | 1 |
| CH₂CH₂CH₂Si(CH₃)₃ | CH₃ | CH₂CH═CH₂ | OC₂H₅ | 5-Cl | 1 |
| CH₂CH₂CH₂C(CH₃)₃ | CH₃ | CH₂CH═CH₂ | OC₂H₅ | 5-Cl | 1 |
| CH₂CH₂CH₂Si(CH₃)₂(C₂H₅) | CH₃ | CH₂CH═CH₂ | OC₂H₅ | 5-Cl | 1 |
| CH₂CH₂CH₂Si(CH₃)₃ | CH₃ | CH₂C≡CH | OC₂H₅ | 5-Cl | 1 |
| CH₂CH₂CH₂C(CH₃)₃ | CH₃ | CH₂C≡CH | OC₂H₅ | 5-Cl | 1 |
| CH₂CH₂CH₂Si(CH₃)₂(C₂H₅) | CH₃ | CH₂C≡CH | OC₂H₅ | 5-Cl | 1 |
| CH₂CH₂CH₂Si(CH₃)₃ | CH₃ | CH₂CH₂CH₃ | OC₂H₅ | 5-Cl | 1 |
| CH₂CH₂CH₂Si(CH₃)₂(C₂H₅) | CH₃ | CH₂CH₂CH₃ | OC₂H₅ | 5-Cl | 1 |
| CH₂CH₂CH₂C(CH₃)₃ | CH₃ | CH₂CH₂CH₃ | OC₂H₅ | 5-Cl | 1 |
| CH₂CH₂CH₂Si(CH₃)₃ | CH₃ | CH₂CH₂CH₂CH₃ | OC₂H₅ | 5-Cl | 1 |
| CH₂CH₂CH₂C(CH₃)₃ | CH₃ | CH₂CH₂CH₂CH₃ | OC₂H₅ | 5-Cl | 1 |
| CH₂CH₂CH₂Si(CH₃)₂(C₂H₅) | CH₃ | CH₂CH₂CH₂CH₃ | OC₂H₅ | 5-Cl | 1 |
| CH₂CH₂CH₂Si(CH₃)₃ | CH₃ | CH₂CH₂F | OC₂H₅ | 5-Cl | 1 |
| CH₂CH₂CH₂C(CH₃)₃ | CH₃ | CH₂CH₂F | OC₂H₅ | 5-Cl | 1 |
| CH₂CH₂CH₂Si(CH₃)₃ | CH₃ | CH₃ | SCH₃ | 5-F | 1 |
| CH₂CH₂CH₂C(CH₃)₃ | CH₃ | CH₃ | SCH₃ | 5-F | 1 |
| CH₂CH₂CH₂Si(CH₃)₂(C₂H₅) | CH₃ | CH₃ | SCH₃ | 5-F | 1 |
| CH₂CH₂CH₂Si(CH₃)₃ | CH₃ | C₂H₅ | SCH₃ | 5-F | 1 |
| CH₂CH₂CH₂C(CH₃)₃ | CH₃ | C₂H₅ | SCH₃ | 5-F | 1 |
| CH₂CH₂CH₂CH(CH₃)₂ | CH₃ | C₂H₅ | SCH₃ | 5-F | 1 |
| CH₂CH₂CH₂Si(CH₃)₂(C₂H₅) | CH₃ | C₂H₅ | SCH₃ | 5-F | 1 |
| CH₂CH₂CH₂Si(CH₃)₃ | CH₃ | CH(CH₃)₂ | SCH₃ | 5-F | 1 |
| CH₂CH₂CH₂C(CH₃)₃ | CH₃ | CH(CH₃)₂ | SCH₃ | 5-F | 1 |
| CH₂CH₂CH₂Si(CH₃)₂(C₂H₅) | CH₃ | CH(CH₃)₂ | SCH₃ | 5-F | 1 |
| CH₂CH₂CH₂Si(CH₃)₃ | CH₃ | c-Pr | SCH₃ | 5-F | 1 |
| CH₂CH₂CH₂C(CH₃)₃ | CH₃ | c-Pr | SCH₃ | 5-F | 1 |
| CH₂CH₂CH₂CH(CH₃)₂ | CH₃ | c-Pr | SCH₃ | 5-F | 1 |
| CH₂CH₂CH₂Si(CH₃)₂(C₂H₅) | CH₃ | c-Pr | SCH₃ | 5-F | 1 |
| CH₂CH₂CH₂Si(CH₃)₃ | C₂H₅ | C₂H₅ | SCH₃ | 5-F | 1 |
| CH₂CH₂CH₂C(CH₃)₃ | C₂H₅ | C₂H₅ | SCH₃ | 5-F | 1 |
| CH₂CH₂CH₂Si(CH₃)₂(C₂H₅) | C₂H₅ | C₂H₅ | SCH₃ | 5-F | 1 |
| CH₂CH₂CH₂Si(CH₃)₃ | CH₃ | CH₂CH═CH₂ | SCH₃ | 5-F | 1 |
| CH₂CH₂CH₂C(CH₃)₃ | CH₃ | CH₂CH═CH₂ | SCH₃ | 5-F | 1 |
| CH₂CH₂CH₂Si(CH₃)₂(C₂H₅) | CH₃ | CH₂CH═CH₂ | SCH₃ | 5-F | 1 |
| CH₂CH₂CH₂Si(CH₃)₃ | CH₃ | CH₂C≡CH | SCH₃ | 5-F | 1 |
| CH₂CH₂CH₂C(CH₃)₃ | CH₃ | CH₂C≡CH | SCH₃ | 5-F | 1 |
| CH₂CH₂CH₂Si(CH₃)₂(C₂H₅) | CH₃ | CH₂C≡CH | SCH₃ | 5-F | 1 |
| CH₂CH₂CH₂Si(CH₃)₃ | CH₃ | CH₂CH₂CH₃ | SCH₃ | 5-F | 1 |
| CH₂CH₂CH₂Si(CH₃)₂(C₂H₅) | CH₃ | CH₂CH₂CH₃ | SCH₃ | 5-F | 1 |
| CH₂CH₂CH₂C(CH₃)₃ | CH₃ | CH₂CH₂CH₃ | SCH₃ | 5-F | 1 |
| CH₂CH₂CH₂Si(CH₃)₃ | CH₃ | CH₂CH₂CH₂CH₃ | SCH₃ | 5-F | 1 |
| CH₂CH₂CH₂C(CH₃)₃ | CH₃ | CH₂CH₂CH₂CH₃ | SCH₃ | 5-F | 1 |
| CH₂CH₂CH₂Si(CH₃)₂(C₂H₅) | CH₃ | CH₂CH₂CH₂CH₃ | SCH₃ | 5-F | 1 |
| CH₂CH₂CH₂Si(CH₃)₃ | CH₃ | CH₂CH₂F | SCH₃ | 5-F | 1 |
| CH₂CH₂CH₂C(CH₃)₃ | CH₃ | CH₂CH₂F | SCH₃ | 5-F | 1 |
| CH₂CH₂CH₂Si(CH₃)₃ | CH₃ | CH₃ | OCH₃ | 5-F | 1 |
| CH₂CH₂CH₂C(CH₃)₃ | CH₃ | CH₃ | OCH₃ | 5-F | 1 |
| CH₂CH₂CH₂Si(CH₃)₂(C₂H₅) | CH₃ | CH₃ | OCH₃ | 5-F | 1 |
| CH₂CH₂CH₂Si(CH₃)₃ | CH₃ | C₂H₅ | OCH₃ | 5-F | 1 |
| CH₂CH₂CH₂C(CH₃)₃ | CH₃ | C₂H₅ | OCH₃ | 5-F | 1 |
| CH₂CH₂CH₂CH(CH₃)₂ | CH₃ | C₂H₅ | OCH₃ | 5-F | 1 |
| CH₂CH₂CH₂Si(CH₃)₂(C₂H₅) | CH₃ | C₂H₅ | OCH₃ | 5-F | 1 |
| CH₂CH₂CH₂Si(CH₃)₃ | CH₃ | CH(CH₃)₂ | OCH₃ | 5-F | 1 |
| CH₂CH₂CH₂C(CH₃)₃ | CH₃ | CH(CH₃)₂ | OCH₃ | 5-F | 1 |
| CH₂CH₂CH₂Si(CH₃)₂(C₂H₅) | CH₃ | CH(CH₃)₂ | OCH₃ | 5-F | 1 |
| CH₂CH₂CH₂Si(CH₃)₃ | CH₃ | c-Pr | OCH₃ | 5-F | 1 |
| CH₂CH₂CH₂C(CH₃)₃ | CH₃ | c-Pr | OCH₃ | 5-F | 1 |
| CH₂CH₂CH₂CH(CH₃)₂ | CH₃ | c-Pr | OCH₃ | 5-F | 1 |
| CH₂CH₂CH₂Si(CH₃)₂(C₂H₅) | CH₃ | c-Pr | OCH₃ | 5-F | 1 |
| CH₂CH₂CH₂Si(CH₃)₃ | C₂H₅ | C₂H₅ | OCH₃ | 5-F | 1 |
| CH₂CH₂CH₂C(CH₃)₃ | C₂H₅ | C₂H₅ | OCH₃ | 5-F | 1 |
| CH₂CH₂CH₂Si(CH₃)₂(C₂H₅) | C₂H₅ | C₂H₅ | OCH₃ | 5-F | 1 |
| CH₂CH₂CH₂Si(CH₃)₃ | CH₃ | CH₂CH═CH₂ | OCH₃ | 5-F | 1 |
| CH₂CH₂CH₂C(CH₃)₃ | CH₃ | CH₂CH═CH₂ | OCH₃ | 5-F | 1 |
| CH₂CH₂CH₂Si(CH₃)₂(C₂H₅) | CH₃ | CH₂CH═CH₂ | OCH₃ | 5-F | 1 |
| CH₂CH₂CH₂Si(CH₃)₃ | CH₃ | CH₂C≡CH | OCH₃ | 5-F | 1 |
| CH₂CH₂CH₂C(CH₃)₃ | CH₃ | CH₂C≡CH | OCH₃ | 5-F | 1 |
| CH₂CH₂CH₂Si(CH₃)₂(C₂H₅) | CH₃ | CH₂C≡CH | OCH₃ | 5-F | 1 |
| CH₂CH₂CH₂Si(CH₃)₃ | CH₃ | CH₂CH₂CH₃ | OCH₃ | 5-F | 1 |
| CH₂CH₂CH₂Si(CH₃)₂(C₂H₅) | CH₃ | CH₂CH₂CH₃ | OCH₃ | 5-F | 1 |
| CH₂CH₂CH₂C(CH₃)₃ | CH₃ | CH₂CH₂CH₃ | OCH₃ | 5-F | 1 |
| CH₂CH₂CH₂Si(CH₃)₃ | CH₃ | CH₂CH₂CH₂CH₃ | OCH₃ | 5-F | 1 |
| CH₂CH₂CH₂C(CH₃)₃ | CH₃ | CH₂CH₂CH₂CH₃ | OCH₃ | 5-F | 1 |
| CH₂CH₂CH₂Si(CH₃)₂(C₂H₅) | CH₃ | CH₂CH₂CH₂CH₃ | OCH₃ | 5-F | 1 |
| CH₂CH₂CH₂Si(CH₃)₃ | CH₃ | CH₂CH₂F | OCH₃ | 5-F | 1 |
| CH₂CH₂CH₂C(CH₃)₃ | CH₃ | CH₂CH₂F | OCH₃ | 5-F | 1 |
| CH₂CH₂CH₂Si(CH₃)₃ | CH₃ | CH₃ | OC₂H₅ | 5-F | 1 |
| CH₂CH₂CH₂C(CH₃)₃ | CH₃ | CH₃ | OC₂H₅ | 5-F | 1 |
| CH₂CH₂CH₂Si(CH₃)₂(C₂H₅) | CH₃ | CH₃ | OC₂H₅ | 5-F | 1 |
| CH₂CH₂CH₂Si(CH₃)₃ | CH₃ | C₂H₅ | OC₂H₅ | 5-F | 1 |
| CH₂CH₂CH₂C(CH₃)₃ | CH₃ | C₂H₅ | OC₂H₅ | 5-F | 1 |
| CH₂CH₂CH₂CH(CH₃)₂ | CH₃ | C₂H₅ | OC₂H₅ | 5-F | 1 |
| CH₂CH₂CH₂Si(CH₃)₂(C₂H₅) | CH₃ | C₂H₅ | OC₂H₅ | 5-F | 1 |
| CH₂CH₂CH₂Si(CH₃)₃ | CH₃ | CH(CH₃)₂ | OC₂H₅ | 5-F | 1 |
| CH₂CH₂CH₂C(CH₃)₃ | CH₃ | CH(CH₃)₂ | OC₂H₅ | 5-F | 1 |
| CH₂CH₂CH₂Si(CH₃)₂(C₂H₅) | CH₃ | CH(CH₃)₂ | OC₂H₅ | 5-F | 1 |
| CH₂CH₂CH₂Si(CH₃)₃ | CH₃ | c-Pr | OC₂H₅ | 5-F | 1 |
| CH₂CH₂CH₂C(CH₃)₃ | CH₃ | c-Pr | OC₂H₅ | 5-F | 1 |
| CH₂CH₂CH₂CH(CH₃)₂ | CH₃ | c-Pr | OC₂H₅ | 5-F | 1 |
| CH₂CH₂CH₂Si(CH₃)₂(C₂H₅) | CH₃ | c-Pr | OC₂H₅ | 5-F | 1 |
| CH₂CH₂CH₂Si(CH₃)₃ | C₂H₅ | C₂H₅ | OC₂H₅ | 5-F | 1 |
| CH₂CH₂CH₂C(CH₃)₃ | C₂H₅ | C₂H₅ | OC₂H₅ | 5-F | 1 |
| CH₂CH₂CH₂Si(CH₃)₂(C₂H₅) | C₂H₅ | C₂H₅ | OC₂H₅ | 5-F | 1 |
| CH₂CH₂CH₂Si(CH₃)₃ | CH₃ | CH₂CH═CH₂ | OC₂H₅ | 5-F | 1 |
| CH₂CH₂CH₂C(CH₃)₃ | CH₃ | CH₂CH═CH₂ | OC₂H₅ | 5-F | 1 |
| CH₂CH₂CH₂Si(CH₃)₂(C₂H₅) | CH₃ | CH₂CH═CH₂ | OC₂H₅ | 5-F | 1 |
| CH₂CH₂CH₂Si(CH₃)₃ | CH₃ | CH₂C≡CH | OC₂H₅ | 5-F | 1 |
| CH₂CH₂CH₂C(CH₃)₃ | CH₃ | CH₂C≡CH | OC₂H₅ | 5-F | 1 |
| CH₂CH₂CH₂Si(CH₃)₂(C₂H₅) | CH₃ | CH₂C≡CH | OC₂H₅ | 5-F | 1 |
| CH₂CH₂CH₂Si(CH₃)₃ | CH₃ | CH₂CH₂CH₃ | OC₂H₅ | 5-F | 1 |
| CH₂CH₂CH₂Si(CH₃)₂(C₂H₅) | CH₃ | CH₂CH₂CH₃ | OC₂H₅ | 5-F | 1 |
| CH₂CH₂CH₂C(CH₃)₃ | CH₃ | CH₂CH₂CH₃ | OC₂H₅ | 5-F | 1 |
| CH₂CH₂CH₂Si(CH₃)₃ | CH₃ | CH₂CH₂CH₂CH₃ | OC₂H₅ | 5-F | 1 |
| CH₂CH₂CH₂C(CH₃)₃ | CH₃ | CH₂CH₂CH₂CH₃ | OC₂H₅ | 5-F | 1 |
| CH₂CH₂CH₂Si(CH₃)₂(C₂H₅) | CH₃ | CH₂CH₂CH₂CH₃ | OC₂H₅ | 5-F | 1 |
| CH₂CH₂CH₂Si(CH₃)₃ | CH₃ | CH₂CH₂F | OC₂H₅ | 5-F | 1 |
| CH₂CH₂CH₂C(CH₃)₃ | CH₃ | CH₂CH₂F | OC₂H₅ | 5-F | 1 |
| CH₂CH₂CH₂Si(CH₃)₃ | CH₃ | CH₃ | SC₂H₅ | 5-F | 1 |
| CH₂CH₂CH₂C(CH₃)₃ | CH₃ | CH₃ | SC₂H₅ | 5-F | 1 |
| CH₂CH₂CH₂Si(CH₃)₂(C₂H₅) | CH₃ | CH₃ | SC₂H₅ | 5-F | 1 |
| CH₂CH₂CH₂Si(CH₃)₃ | CH₃ | C₂H₅ | SC₂H₅ | 5-F | 1 |
| CH₂CH₂CH₂C(CH₃)₃ | CH₃ | C₂H₅ | SC₂H₅ | 5-F | 1 |
| CH₂CH₂CH₂CH(CH₃)₂ | CH₃ | C₂H₅ | SC₂H₅ | 5-F | 1 |
| CH₂CH₂CH₂Si(CH₃)₂(C₂H₅) | CH₃ | C₂H₅ | SC₂H₅ | 5-F | 1 |
| CH₂CH₂CH₂Si(CH₃)₃ | CH₃ | CH(CH₃)₂ | SC₂H₅ | 5-F | 1 |
| CH₂CH₂CH₂C(CH₃)₃ | CH₃ | CH(CH₃)₂ | SC₂H₅ | 5-F | 1 |
| CH₂CH₂CH₂Si(CH₃)₂(C₂H₅) | CH₃ | CH(CH₃)₂ | SC₂H₅ | 5-F | 1 |
| CH₂CH₂CH₂Si(CH₃)₃ | CH₃ | c-Pr | SC₂H₅ | 5-F | 1 |
| CH₂CH₂CH₂C(CH₃)₃ | CH₃ | c-Pr | SC₂H₅ | 5-F | 1 |
| CH₂CH₂CH₂CH(CH₃)₂ | CH₃ | c-Pr | SC₂H₅ | 5-F | 1 |
| CH₂CH₂CH₂Si(CH₃)₂(C₂H₅) | CH₃ | c-Pr | SC₂H₅ | 5-F | 1 |
| CH₂CH₂CH₂Si(CH₃)₃ | C₂H₅ | C₂H₅ | SC₂H₅ | 5-F | 1 |
| CH₂CH₂CH₂C(CH₃)₃ | C₂H₅ | C₂H₅ | SC₂H₅ | 5-F | 1 |
| CH₂CH₂CH₂Si(CH₃)₂(C₂H₅) | C₂H₅ | C₂H₅ | SC₂H₅ | 5-F | 1 |
| CH₂CH₂CH₂Si(CH₃)₃ | CH₃ | CH₂CH═CH₂ | SC₂H₅ | 5-F | 1 |
| CH₂CH₂CH₂C(CH₃)₃ | CH₃ | CH₂CH═CH₂ | SC₂H₅ | 5-F | 1 |
| CH₂CH₂CH₂Si(CH₃)₂(C₂H₅) | CH₃ | CH₂CH═CH₂ | SC₂H₅ | 5-F | 1 |
| CH₂CH₂CH₂Si(CH₃)₃ | CH₃ | CH₂C≡CH | SC₂H₅ | 5-F | 1 |
| CH₂CH₂CH₂C(CH₃)₃ | CH₃ | CH₂C≡CH | SC₂H₅ | 5-F | 1 |
| CH₂CH₂CH₂Si(CH₃)₂(C₂H₅) | CH₃ | CH₂C≡CH | SC₂H₅ | 5-F | 1 |
| CH₂CH₂CH₂Si(CH₃)₃ | CH₃ | CH₂CH₂CH₃ | SC₂H₅ | 5-F | 1 |
| CH₂CH₂CH₂Si(CH₃)₂(C₂H₅) | CH₃ | CH₂CH₂CH₃ | SC₂H₅ | 5-F | 1 |
| CH₂CH₂CH₂C(CH₃)₃ | CH₃ | CH₂CH₂CH₃ | SC₂H₅ | 5-F | 1 |
| CH₂CH₂CH₂Si(CH₃)₃ | CH₃ | CH₂CH₂CH₂CH₃ | SC₂H₅ | 5-F | 1 |
| CH₂CH₂CH₂C(CH₃)₃ | CH₃ | CH₂CH₂CH₂CH₃ | SC₂H₅ | 5-F | 1 |
| CH₂CH₂CH₂Si(CH₃)₂(C₂H₅) | CH₃ | CH₂CH₂CH₂CH₃ | SC₂H₅ | 5-F | 1 |
| CH₂CH₂CH₂Si(CH₃)₃ | CH₃ | CH₂CH₂F | SC₂H₅ | 5-F | 1 |
| CH₂CH₂CH₂C(CH₃)₃ | CH₃ | CH₂CH₂F | SC₂H₅ | 5-F | 1 |
| CH₂CH₂CH₂Si(CH₃)₃ | CH₃ | CH₃ | SC₂H₅ | 5-Cl | 1 |
| CH₂CH₂CH₂C(CH₃)₃ | CH₃ | CH₃ | SC₂H₅ | 5-Cl | 1 |
| CH₂CH₂CH₂Si(CH₃)₂(C₂H₅) | CH₃ | CH₃ | SC₂H₅ | 5-Cl | 1 |
| CH₂CH₂CH₂Si(CH₃)₃ | CH₃ | C₂H₅ | SC₂H₅ | 5-Cl | 1 |
| CH₂CH₂CH₂C(CH₃)₃ | CH₃ | C₂H₅ | SC₂H₅ | 5-Cl | 1 |
| CH₂CH₂CH₂CH(CH₃)₂ | CH₃ | C₂H₅ | SC₂H₅ | 5-Cl | 1 |
| CH₂CH₂CH₂Si(CH₃)₂(C₂H₅) | CH₃ | C₂H₅ | SC₂H₅ | 5-Cl | 1 |
| CH₂CH₂CH₂Si(CH₃)₃ | CH₃ | CH(CH₃)₂ | SC₂H₅ | 5-Cl | 1 |
| CH₂CH₂CH₂C(CH₃)₃ | CH₃ | CH(CH₃)₂ | SC₂H₅ | 5-Cl | 1 |
| CH₂CH₂CH₂Si(CH₃)₂(C₂H₅) | CH₃ | CH(CH₃)₂ | SC₂H₅ | 5-Cl | 1 |
| CH₂CH₂CH₂Si(CH₃)₃ | CH₃ | c-Pr | SC₂H₅ | 5-Cl | 1 |
| CH₂CH₂CH₂C(CH₃)₃ | CH₃ | c-Pr | SC₂H₅ | 5-Cl | 1 |
| CH₂CH₂CH₂CH(CH₃)₂ | CH₃ | c-Pr | SC₂H₅ | 5-Cl | 1 |
| CH₂CH₂CH₂Si(CH₃)₂(C₂H₅) | CH₃ | c-Pr | SC₂H₅ | 5-Cl | 1 |
| CH₂CH₂CH₂Si(CH₃)₃ | C₂H₅ | C₂H₅ | SC₂H₅ | 5-Cl | 1 |
| CH₂CH₂CH₂C(CH₃)₃ | C₂H₅ | C₂H₅ | SC₂H₅ | 5-Cl | 1 |
| CH₂CH₂CH₂Si(CH₃)₂(C₂H₅) | C₂H₅ | C₂H₅ | SC₂H₅ | 5-Cl | 1 |
| CH₂CH₂CH₂Si(CH₃)₃ | CH₃ | CH₂CH═CH₂ | SC₂H₅ | 5-Cl | 1 |
| CH₂CH₂CH₂C(CH₃)₃ | CH₃ | CH₂CH═CH₂ | SC₂H₅ | 5-Cl | 1 |
| CH₂CH₂CH₂Si(CH₃)₂(C₂H₅) | CH₃ | CH₂CH═CH₂ | SC₂H₅ | 5-Cl | 1 |
| CH₂CH₂CH₂Si(CH₃)₃ | CH₃ | CH₂C≡CH | SC₂H₅ | 5-Cl | 1 |
| CH₂CH₂CH₂C(CH₃)₃ | CH₃ | CH₂C≡CH | SC₂H₅ | 5-Cl | 1 |
| CH₂CH₂CH₂Si(CH₃)₂(C₂H₅) | CH₃ | CH₂C≡CH | SC₂H₅ | 5-Cl | 1 |
| CH₂CH₂CH₂Si(CH₃)₃ | CH₃ | CH₂CH₂CH₃ | SC₂H₅ | 5-Cl | 1 |
| CH₂CH₂CH₂Si(CH₃)₂(C₂H₅) | CH₃ | CH₂CH₂CH₃ | SC₂H₅ | 5-Cl | 1 |
| CH₂CH₂CH₂C(CH₃)₃ | CH₃ | CH₂CH₂CH₃ | SC₂H₅ | 5-Cl | 1 |
| CH₂CH₂CH₂CH₂Si(CH₃)₃ | CH₃ | CH₂CH₂CH₂CH₃ | SC₂H₅ | 5-Cl | 1 |
| CH₂CH₂CH₂C(CH₃)₃ | CH₃ | CH₂CH₂CH₂CH₃ | SC₂H₅ | 5-Cl | 1 |
| CH₂CH₂CH₂Si(CH₃)₂(C₂H₅) | CH₃ | CH₂CH₂CH₂CH₃ | SC₂H₅ | 5-Cl | 1 |
| CH₂CH₂CH₂Si(CH₃)₃ | CH₃ | CH₂CH₂F | SC₂H₅ | 5-Cl | 1 |
| CH₂CH₂CH₂C(CH₃)₃ | CH₃ | CH₂CH₂F | SC₂H₅ | 5-Cl | 1 |
| CH₂CH₂CH₂Si(CH₃)₃ | CH₃ | C₂H₅ | CH₃ | 5,6-di-CH₃ | 2 |
| CH₂CH₂CH₂C(CH₃)₃ | CH₃ | C₂H₅ | CH₃ | 5,6-di-CH₃ | 2 |
| CH₂CH₂CH₂CH(CH₃)₂ | CH₃ | C₂H₅ | CH₃ | 5,6-di-CH₃ | 2 |
| CH₂CH₂CH₂Si(CH₃)₂(C₂H₅) | CH₃ | C₂H₅ | CH₃ | 5,6-di-CH₃ | 2 |
| CH₂CH₂CH₂Si(CH₃)₃ | CH₃ | CH(CH₃)₂ | CH₃ | 5,6-di-CH₃ | 2 |
| CH₂CH₂CH₂C(CH₃)₃ | CH₃ | CH(CH₃)₂ | CH₃ | 5,6-di-CH₃ | 2 |
| CH₂CH₂CH₂CH(CH₃)₂ | CH₃ | CH(CH₃)₂ | CH₃ | 5,6-di-CH₃ | 2 |
| CH₂CH₂CH₂Si(CH₃)₂(C₂H₅) | CH₃ | CH(CH₃)₂ | CH₃ | 5,6-di-CH₃ | 2 |
| CH₂CH₂CH₂Si(CH₃)₃ | CH₃ | c-Pr | CH₃ | 5,6-di-CH₃ | 2 |
| CH₂CH₂CH₂C(CH₃)₃ | CH₃ | c-Pr | CH₃ | 5,6-di-CH₃ | 2 |
| CH₂CH₂CH₂CH(CH₃)₂ | CH₃ | c-Pr | CH₃ | 5,6-di-CH₃ | 2 |
| CH₂CH₂CH₂Si(CH₃)₂(C₂H₅) | CH₃ | c-Pr | CH₃ | 5,6-di-CH₃ | 2 |
| CH₂CH₂CH₂Si(CH₃)₃ | C₂H₅ | C₂H₅ | CH₃ | 5,6-di-CH₃ | 2 |
| CH₂CH₂CH₂C(CH₃)₃ | C₂H₅ | C₂H₅ | CH₃ | 5,6-di-CH₃ | 2 |
| CH₂CH₂CH₂CH(CH₃)₂ | C₂H₅ | C₂H₅ | CH₃ | 5,6-di-CH₃ | 2 |
| CH₂CH₂CH₂Si(CH₃)₂(C₂H₅) | C₂H₅ | C₂H₅ | CH₃ | 5,6-di-CH₃ | 2 |
| CH₂CH₂CH₂Si(CH₃)₃ | CH₃ | CH₂CH═CH₂ | CH₃ | 5,6-di-CH₃ | 2 |
| CH₂CH₂CH₂C(CH₃)₃ | CH₃ | CH₂CH═CH₂ | CH₃ | 5,6-di-CH₃ | 2 |
| CH₂CH₂CH₂CH(CH₃)₂ | CH₃ | CH₂CH═CH₂ | CH₃ | 5,6-di-CH₃ | 2 |
| CH₂CH₂CH₂Si(CH₃)₂(C₂H₅) | CH₃ | CH₂CH═CH₂ | CH₃ | 5,6-di-CH₃ | 2 |
| CH₂CH₂CH₂Si(CH₃)₃ | CH₃ | CH₂C≡CH | CH₃ | 5,6-di-CH₃ | 2 |
| CH₂CH₂CH₂C(CH₃)₃ | CH₃ | CH₂C≡CH | CH₃ | 5,6-di-CH₃ | 2 |
| CH₂CH₂CH₂CH(CH₃)₂ | CH₃ | CH₂C≡CH | CH₃ | 5,6-di-CH₃ | 2 |
| CH₂CH₂CH₂Si(CH₃)₂(C₂H₅) | CH₃ | CH₂C≡CH | CH₃ | 5,6-di-CH₃ | 2 |
| CH₂CH₂CH₂Si(CH₃)₃ | CH₃ | CH₂CH₂F | CH₃ | 5,6-di-CH₃ | 2 |
| CH₂CH₂CH₂C(CH₃)₃ | CH₃ | CH₂CH₂F | CH₃ | 5,6-di-CH₃ | 2 |
| CH₂CH₂CH₂Si(CH₃)₃ | CH₃ | C₂H₅ | Cl | 5-CH₃ | 1 |
| CH₂CH₂CH₂C(CH₃)₃ | CH₃ | C₂H₅ | Cl | 5-CH₃ | 1 |
| CH₂CH₂CH₂CH(CH₃)₂ | CH₃ | C₂H₅ | Cl | 5-CH₃ | 1 |
| CH₂CH₂CH₂Si(CH₃)₂(C₂H₅) | CH₃ | C₂H₅ | Cl | 5-CH₃ | 1 |
| CH₂CH₂CH₂Si(CH₃)₃ | CH₃ | CH(CH₃)₂ | Cl | 5-CH₃ | 1 |
| CH₂CH₂CH₂C(CH₃)₃ | CH₃ | CH(CH₃)₂ | Cl | 5-CH₃ | 1 |
| CH₂CH₂CH₂CH(CH₃)₂ | CH₃ | CH(CH₃)₂ | Cl | 5-CH₃ | 1 |
| CH₂CH₂CH₂Si(CH₃)₂(C₂H₅) | CH₃ | CH(CH₃)₂ | Cl | 5-CH₃ | 1 |
| CH₂CH₂CH₂Si(CH₃)₃ | CH₃ | c-Pr | Cl | 5-CH₃ | 1 |
| CH₂CH₂CH₂C(CH₃)₃ | CH₃ | c-Pr | Cl | 5-CH₃ | 1 |
| CH₂CH₂CH₂CH(CH₃)₂ | CH₃ | c-Pr | Cl | 5-CH₃ | 1 |
| CH₂CH₂CH₂Si(CH₃)₂(C₂H₅) | CH₃ | c-Pr | Cl | 5-CH₃ | 1 |
| CH₂CH₂CH₂Si(CH₃)₃ | C₂H₅ | C₂H₅ | Cl | 5-CH₃ | 1 |
| CH₂CH₂CH₂C(CH₃)₃ | C₂H₅ | C₂H₅ | Cl | 5-CH₃ | 1 |
| CH₂CH₂CH₂CH(CH₃)₂ | C₂H₅ | C₂H₅ | Cl | 5-CH₃ | 1 |
| CH₂CH₂CH₂Si(CH₃)₂(C₂H₅) | C₂H₅ | C₂H₅ | Cl | 5-CH₃ | 1 |
| CH₂CH₂CH₂Si(CH₃)₃ | CH₃ | CH₂CH═CH₂ | Cl | 5-CH₃ | 1 |
| CH₂CH₂CH₂C(CH₃)₃ | CH₃ | CH₂CH═CH₂ | Cl | 5-CH₃ | 1 |
| CH₂CH₂CH₂CH(CH₃)₂ | CH₃ | CH₂CH═CH₂ | Cl | 5-CH₃ | 1 |
| CH₂CH₂CH₂Si(CH₃)₂(C₂H₅) | CH₃ | CH₂CH═CH₂ | Cl | 5-CH₃ | 1 |
| CH₂CH₂CH₂Si(CH₃)₃ | CH₃ | CH₂C≡CH | Cl | 5-CH₃ | 1 |
| CH₂CH₂CH₂C(CH₃)₃ | CH₃ | CH₂C≡CH | Cl | 5-CH₃ | 1 |
| CH₂CH₂CH₂CH(CH₃)₂ | CH₃ | CH₂C≡CH | Cl | 5-CH₃ | 1 |
| CH₂CH₂CH₂Si(CH₃)₂(C₂H₅) | CH₃ | CH₂C═CH | Cl | 5-CH₃ | 1 |
| CH₂CH₂CH₂Si(CH₃)₃ | CH₃ | CH₂CH₂F | Cl | 5-CH₃ | 1 |
| CH₂CH₂CH₂C(CH₃)₃ | CH₃ | CH₂CH₂F | Cl | 5-CH₃ | 1 |
| CH₂CH₂CH₂Si(CH₃)₃ | CH₃ | C₂H₅ | Cl | 5-Cl | 1 |
| CH₂CH₂CH₂C(CH₃)₃ | CH₃ | C₂H₅ | Cl | 5-Cl | 1 |
| CH₂CH₂CH₂CH(CH₃)₂ | CH₃ | C₂H₅ | Cl | 5-Cl | 1 |
| CH₂CH₂CH₂Si(CH₃)₂(C₂H₅) | CH₃ | C₂H₅ | Cl | 5-Cl | 1 |
| CH₂CH₂CH₂Si(CH₃)₃ | CH₃ | CH(CH₃)₂ | Cl | 5-Cl | 1 |
| CH₂CH₂CH₂C(CH₃)₃ | CH₃ | CH(CH₃)₂ | Cl | 5-Cl | 1 |
| CH₂CH₂CH₂CH(CH₃)₂ | CH₃ | CH(CH₃)₂ | Cl | 5-Cl | 1 |
| CH₂CH₂CH₂Si(CH₃)₂(C₂H₅) | CH₃ | CH(CH₃)₂ | Cl | 5-Cl | 1 |
| CH₂CH₂CH₂Si(CH₃)₃ | CH₃ | c-Pr | Cl | 5-Cl | 1 |
| CH₂CH₂CH₂C(CH₃)₃ | CH₃ | c-Pr | Cl | 5-Cl | 1 |
| CH₂CH₂CH₂CH(CH₃)₂ | CH₃ | c-Pr | Cl | 5-Cl | 1 |
| CH₂CH₂CH₂Si(CH₃)₂(C₂H₅) | CH₃ | c-Pr | Cl | 5-Cl | 1 |
| CH₂CH₂CH₂Si(CH₃)₃ | C₂H₅ | C₂H₅ | Cl | 5-Cl | 1 |
| CH₂CH₂CH₂C(CH₃)₃ | C₂H₅ | C₂H₅ | Cl | 5-Cl | 1 |
| CH₂CH₂CH₂CH(CH₃)₂ | C₂H₅ | C₂H₅ | Cl | 5-Cl | 1 |
| CH₂CH₂CH₂Si(CH₃)₂(C₂H₅) | C₂H₅ | C₂H₅ | Cl | 5-Cl | 1 |
| CH₂CH₂CH₂Si(CH₃)₃ | CH₃ | CH₂CH═CH₂ | Cl | 5-Cl | 1 |
| CH₂CH₂CH₂C(CH₃)₃ | CH₃ | CH₂CH═CH₂ | Cl | 5-Cl | 1 |
| CH₂CH₂CH₂CH(CH₃)₂ | CH₃ | CH₂CH═CH₂ | Cl | 5-Cl | 1 |
| CH₂CH₂CH₂Si(CH₃)₂(C₂H₅) | CH₃ | CH₂CH═CH₂ | Cl | 5-Cl | 1 |
| CH₂CH₂CH₂Si(CH₃)₃ | CH₃ | CH₂C≡CH | Cl | 5-Cl | 1 |
| CH₂CH₂CH₂C(CH₃)₃ | CH₃ | CH₂C≡CH | Cl | 5-Cl | 1 |
| CH₂CH₂CH₂CH(CH₃)₂ | CH₃ | CH₂C≡CH | Cl | 5-Cl | 1 |
| CH₂CH₂CH₂Si(CH₃)₂(C₂H₅) | CH₃ | CH₂C≡CH | Cl | 5-Cl | 1 |
| CH₂CH₂CH₂Si(CH₃)₃ | CH₃ | CH₂CH₂F | Cl | 5-Cl | 1 |
| CH₂CH₂CH₂C(CH₃)₃ | CH₃ | CH₂CH₂F | Cl | 5-Cl | 1 |
| CH₂CH₂CH₂Si(CH₃)₃ | CH₃ | C₂H₅ | CH₃ | 5-CH₃-6-Cl | 2 |
| CH₂CH₂CH₂C(CH₃)₃ | CH₃ | C₂H₅ | CH₃ | 5-CH₃-6-Cl | 2 |
| CH₂CH₂CH₂CH(CH₃)₂ | CH₃ | C₂H₅ | CH₃ | 5-CH₃-6-Cl | 2 |
| CH₂CH₂CH₂Si(CH₃)₂(C₂H₅) | CH₃ | C₂H₅ | CH₃ | 5-CH₃-6-Cl | 2 |
| CH₂CH₂CH₂Si(CH₃)₃ | CH₃ | CH(CH₃)₂ | CH₃ | 5-CH₃-6-Cl | 2 |
| CH₂CH₂CH₂C(CH₃)₃ | CH₃ | CH(CH₃)₂ | CH₃ | 5-CH₃-6-Cl | 2 |
| CH₂CH₂CH₂CH(CH₃)₂ | CH₃ | CH(CH₃)₂ | CH₃ | 5-CH₃-6-Cl | 2 |
| CH₂CH₂CH₂Si(CH₃)₂(C₂H₅) | CH₃ | CH(CH₃)₂ | CH₃ | 5-CH₃-6-Cl | 2 |
| CH₂CH₂CH₂Si(CH₃)₃ | CH₃ | c-Pr | CH₃ | 5-CH₃-6-Cl | 2 |
| CH₂CH₂CH₂C(CH₃)₃ | CH₃ | c-Pr | CH₃ | 5-CH₃-6-Cl | 2 |
| CH₂CH₂CH₂CH(CH₃)₂ | CH₃ | c-Pr | CH₃ | 5-CH₃-6-Cl | 2 |
| CH₂CH₂CH₂Si(CH₃)₂(C₂H₅) | CH₃ | c-Pr | CH₃ | 5-CH₃-6-Cl | 2 |
| CH₂CH₂CH₂Si(CH₃)₃ | C₂H₅ | C₂H₅ | CH₃ | 5-CH₃-6-Cl | 2 |
| CH₂CH₂CH₂C(CH₃)₃ | C₂H₅ | C₂H₅ | CH₃ | 5-CH₃-6-Cl | 2 |
| CH₂CH₂CH₂CH(CH₃)₂ | C₂H₅ | C₂H₅ | CH₃ | 5-CH₃-6-Cl | 2 |
| CH₂CH₂CH₂Si(CH₃)₂(C₂H₅) | C₂H₅ | C₂H₅ | CH₃ | 5-CH₃-6-Cl | 2 |
| CH₂CH₂CH₂Si(CH₃)₃ | CH₃ | CH₂CH═CH₂ | CH₃ | 5-CH₃-6-Cl | 2 |
| CH₂CH₂CH₂C(CH₃)₃ | CH₃ | CH₂CH═CH₂ | CH₃ | 5-CH₃-6-Cl | 2 |
| CH₂CH₂CH₂CH(CH₃)₂ | CH₃ | CH₂CH═CH₂ | CH₃ | 5-CH₃-6-Cl | 2 |
| CH₂CH₂CH₂Si(CH₃)₂(C₂H₅) | CH₃ | CH₂CH═CH₂ | CH₃ | 5-CH₃-6-Cl | 2 |
| CH₂CH₂CH₂Si(CH₃)₃ | CH₃ | CH₂C≡CH | CH₃ | 5-CH₃-6-Cl | 2 |
| CH₂CH₂CH₂C(CH₃)₃ | CH₃ | CH₂C≡CH | CH₃ | 5-CH₃-6-Cl | 2 |
| CH₂CH₂CH₂CH(CH₃)₂ | CH₃ | CH₂C≡CH | CH₃ | 5-CH₃-6-Cl | 2 |
| CH₂CH₂CH₂Si(CH₃)₂(C₂H₅) | CH₃ | CH₂C≡CH | CH₃ | 5-CH₃-6-Cl | 2 |
| CH₂CH₂CH₂Si(CH₃)₃ | CH₃ | CH₂CH₂F | CH₃ | 5-CH₃-6-Cl | 2 |
| CH₂CH₂CH₂C(CH₃)₃ | CH₃ | CH₂CH₂F | CH₃ | 5-CH₃-6-Cl | 2 |
| CH₂CH₂CH₂Si(CH₃)₃ | CH₃ | CH₃ | CH₃ | 3-Cl-5-CH₃ | 2 |
| CH₂CH₂CH₂C(CH₃)₃ | CH₃ | CH₃ | CH₃ | 3-Cl-5-CH₃ | 2 |
| CH₂CH₂CH₂CH(CH₃)₂ | CH₃ | CH₃ | CH₃ | 3-Cl-5-CH₃ | 2 |
| CH₂CH₂CH₂Si(CH₃)₂(C₂H₅) | CH₃ | CH₃ | CH₃ | 3-Cl-5-CH₃ | 2 |
| CH₂CH₂CH₂Si(CH₃)₃ | CH₃ | CH₃ | CH₃ | 3,5-di-Cl | 2 |
| CH₂CH₂CH₂C(CH₃)₃ | CH₃ | CH₃ | CH₃ | 3,5-di-Cl | 2 |
| CH₂CH₂CH₂CH(CH₃)₂ | CH₃ | CH₃ | CH₃ | 3,5-di-Cl | 2 |
| CH₂CH₂CH₂Si(CH₃)₂(C₂H₅) | CH₃ | CH₃ | CH₃ | 3,5-di-Cl | 2 |
| CH₂CH₂CH₂Si(CH₃)₃ | CH₃ | CH₃ | Cl | 3,5-di-Cl | 2 |
| CH₂CH₂CH₂C(CH₃)₃ | CH₃ | CH₃ | Cl | 3,5-di-Cl | 2 |
| CH₂CH₂CH₂CH(CH₃)₂ | CH₃ | CH₃ | Cl | 3,5-di-Cl | 2 |
| CH₂CH₂CH₂Si(CH₃)₂(C₂H₅) | CH₃ | CH₃ | Cl | 3,5-di-Cl | 2 |
| CH₂CH₂CH₂Si(CH₃)₃ | CH₃ | CH₃ | CH₃ | 5-CH₃-6-Br | 2 |
| CH₂CH₂CH₂C(CH₃)₃ | CH₃ | CH₃ | CH₃ | 5-CH₃-6-Br | 2 |
| CH₂CH₂CH₂CH(CH₃)₂ | CH₃ | CH₃ | CH₃ | 5-CH₃-6-Br | 2 |
| CH₂CH₂CH₂Si(CH₃)₂(C₂H₅) | CH₃ | CH₃ | CH₃ | 5-CH₃-6-Br | 2 |
| CH₂CH₂CH₂Si(CH₃)₃ | CH₃ | C₂H₅ | CH₃ | 5-CH₃-6-Br | 2 |
| CH₂CH₂CH₂C(CH₃)₃ | CH₃ | C₂H₅ | CH₃ | 5-CH₃-6-Br | 2 |
| CH₂CH₂CH₂CH(CH₃)₂ | CH₃ | C₂H₅ | CH₃ | 5-CH₃-6-Br | 2 |
| CH₂CH₂CH₂Si(CH₃)₂(C₂H₅) | CH₃ | C₂H₅ | CH₃ | 5-CH₃-6-Br | 2 |
| CH₂CH₂CH₂Si(CH₃)₃ | CH₃ | CH(CH₃)₂ | CH₃ | 5-CH₃-6-Br | 2 |
| CH₂CH₂CH₂C(CH₃)₃ | CH₃ | CH(CH₃)₂ | CH₃ | 5-CH₃-6-Br | 2 |
| CH₂CH₂CH₂CH(CH₃)₂ | CH₃ | CH(CH₃)₂ | CH₃ | 5-CH₃-6-Br | 2 |
| CH₂CH₂CH₂Si(CH₃)₂(C₂H₅) | CH₃ | CH(CH₃)₂ | CH₃ | 5-CH₃-6-Br | 2 |
| CH₂CH₂CH₂Si(CH₃)₃ | CH₃ | c-Pr | CH₃ | 5-CH₃-6-Br | 2 |
| CH₂CH₂CH₂C(CH₃)₃ | CH₃ | c-Pr | CH₃ | 5-CH₃-6-Br | 2 |
| CH₂CH₂CH₂CH(CH₃)₂ | CH₃ | c-Pr | CH₃ | 5-CH₃-6-Br | 2 |
| CH₂CH₂CH₂Si(CH₃)₂(C₂H₅) | CH₃ | c-Pr | CF₃ | 5-CH₃-6-Br | 2 |
| CH₂CH₂CH₂Si(CH₃)₃ | C₂H₅ | C₂H₅ | CF₃ | 5-CH₃-6-Br | 2 |
| CH₂CH₂CH₂C(CH₃)₃ | C₂H₅ | C₂H₅ | CF₃ | 5-CH₃-6-Br | 2 |
| CH₂CH₂CH₂CH(CH₃)₂ | C₂H₅ | C₂H₅ | CH₃ | 5-CH₃-6-Br | 2 |
| CH₂CH₂CH₂Si(CH₃)₂(C₂H₅) | C₂H₅ | C₂H₅ | CH₃ | 5-CH₃-6-Br | 2 |
| CH₂CH₂CH₂Si(CH₃)₃ | CH₃ | CH₂CH═CH₂ | CH₃ | 5-CH₃-6-Br | 2 |
| CH₂CH₂CH₂C(CH₃)₃ | CH₃ | CH₂CH═CH₂ | CH₃ | 5-CH₃-6-Br | 2 |
| CH₂CH₂CH₂CH(CH₃)₂ | CH₃ | CH₂CH═CH₂ | CH₃ | 5-CH₃-6-Br | 2 |
| CH₂CH₂CH₂Si(CH₃)₂(C₂H₅) | CH₃ | CH₂CH═CH₂ | CH₃ | 5-CH₃-6-Br | 2 |
| CH₂CH₂CH₂Si(CH₃)₃ | CH₃ | CH₂C≡CH | CH₃ | 5-CH₃-6-Br | 2 |
| CH₂CH₂CH₂C(CH₃)₃ | CH₃ | CH₂C≡CH | CH₃ | 5-CH₃-6-Br | 2 |
| CH₂CH₂CH₂CH(CH₃)₂ | CH₃ | CH₂C≡CH | CH₃ | 5-CH₃-6-Br | 2 |
| CH₂CH₂CH₂Si(CH₃)₂(C₂H₅) | CH₃ | CH₂C≡CH | CH₃ | 5-CH₃-6-Br | 2 |
| CH₂CH₂CH₂Si(CH₃)₃ | CH₃ | CH₂CH₂F | CH₃ | 5-CH₃-6-Br | 2 |
| CH₂CH₂CH₂C(CH₃)₃ | CH₃ | CH₂CH₂F | CH₃ | 5-CH₃-6-Br | 2 |
| CH₂CH₂CH₂Si(CH₃)₃ | CH₃ | CH₃ | CH₃ | 5-Cl-6-Br | 2 |
| CH₂CH₂CH₂C(CH₃)₃ | CH₃ | CH₃ | CH₃ | 5-Cl-6-Br | 2 |
| CH₂CH₂CH₂CH(CH₃)₂ | CH₃ | CH₃ | CH₃ | 5-Cl-6-Br | 2 |
| CH₂CH₂CH₂Si(CH₃)₂(C₂H₅) | CH₃ | CH₃ | CH₃ | 5-Cl-6-Br | 2 |
| CH₂CH₂CH₂Si(CH₃)₃ | CH₃ | C₂H₅ | CH₃ | 5-Cl-6-Br | 2 |
| CH₂CH₂CH₂C(CH₃)₃ | CH₃ | C₂H₅ | CH₃ | 5-Cl-6-Br | 2 |
| CH₂CH₂CH₂CH(CH₃)₂ | CH₃ | C₂H₅ | CH₃ | 5-Cl-6-Br | 2 |
| CH₂CH₂CH₂Si(CH₃)₂(C₂H₅) | CH₃ | C₂H₅ | CH₃ | 5-Cl-6-Br | 2 |
| CH₂CH₂CH₂Si(CH₃)₃ | CH₃ | CH(CH₃)₂ | CH₃ | 5-Cl-6-Br | 2 |
| CH₂CH₂CH₂C(CH₃)₃ | CH₃ | CH(CH₃)₂ | CH₃ | 5-Cl-6-Br | 2 |
| CH₂CH₂CH₂CH(CH₃)₂ | CH₃ | CH(CH₃)₂ | CH₃ | 5-Cl-6-Br | 2 |
| CH₂CH₂CH₂Si(CH₃)₂(C₂H₅) | CH₃ | CH(CH₃)₂ | CH₃ | 5-Cl-6-Br | 2 |
| CH₂CH₂CH₂Si(CH₃)₃ | CH₃ | c-Pr | CH₃ | 5-Cl-6-Br | 2 |
| CH₂CH₂CH₂C(CH₃)₃ | CH₃ | C-Pr | CH₃ | 5-Cl-6-Br | 2 |
| CH₂CH₂CH₂CH(CH₃)₂ | CH₃ | c-Pr | CH₃ | 5-Cl-6-Br | 2 |
| CH₂CH₂CH₂Si(CH₃)₂(C₂H₅) | CH₃ | c-Pr | CH₃ | 5-Cl-6-Br | 2 |
| CH₂CH₂CH₂Si(CH₃)₃ | C₂H₅ | C₂H₅ | CH₃ | 5-Cl-6-Br | 2 |
| CH₂CH₂CH₂C(CH₃)₃ | C₂H₅ | C₂H₅ | CH₃ | 5-Cl-6-Br | 2 |
| CH₂CH₂CH₂CH(CH₃)₂ | C₂H₅ | C₂H₅ | CH₃ | 5-Cl-6-Br | 2 |
| CH₂CH₂CH₂Si(CH₃)₂(C₂H₅) | C₂H₅ | C₂H₅ | CH₃ | 5-Cl-6-Br | 2 |
| CH₂CH₂CH₂Si(CH₃)₃ | CH₃ | CH₂CH═CH₂ | CH₃ | 5-Cl-6-Br | 2 |
| CH₂CH₂CH₂C(CH₃)₃ | CH₃ | CH₂CH═CH₂ | CH₃ | 5-Cl-6-Br | 2 |
| CH₂CH₂CH₂CH(CH₃)₂ | CH₃ | CH₂CH═CH₂ | CH₃ | 5-Cl-6-Br | 2 |
| CH₂CH₂CH₂Si(CH₃)₂(C₂H₅) | CH₃ | CH₂CH═CH₂ | CH₃ | 5-Cl-6-Br | 2 |
| CH₂CH₂CH₂Si(CH₃)₃ | CH₃ | CH₂C≡CH | CH₃ | 5-Cl-6-Br | 2 |
| CH₂CH₂CH₂C(CH₃)₃ | CH₃ | CH₂C≡CH | CH₃ | 5-Cl-6-Br | 2 |
| CH₂CH₂CH₂CH(CH₃)₂ | CH₃ | CH₂C≡CH | CH₃ | 5-Cl-6-Br | 2 |
| CH₂CH₂CH₂Si(CH₃)₂(C₂H₅) | CH₃ | CH₂C≡CH | CH₃ | 5-Cl-6-Br | 2 |
| CH₂CH₂CH₂Si(CH₃)₃ | CH₃ | CH₂CH₂F | CH₃ | 5-Cl-6-Br | 2 |
| CH₂CH₂CH₂C(CH₃)₃ | CH₃ | CH₂CH₂F | CH₃ | 5-Cl-6-Br | 2 |
| CH₂CH₂CH₂Si(CH₃)₃ | CH₃ | CH₃ | CH₃ | 5-F-6-Cl | 2 |
| CH₂CH₂CH₂C(CH₃)₃ | CH₃ | CH₃ | CH₃ | 5-F-6-Cl | 2 |
| CH₂CH₂CH₂CH(CH₃)₂ | CH₃ | CH₃ | CH₃ | 5-F-6-Cl | 2 |
| CH₂CH₂CH₂Si(CH₃)₂(C₂H₅) | CH₃ | CH₃ | CH₃ | 5-F-6-Cl | 2 |
| CH₂CH₂CH₂Si(CH₃)₃ | CH₃ | C₂H₅ | CH₃ | 5-F-6-Cl | 2 |
| CH₂CH₂CH₂C(CH₃)₃ | CH₃ | C₂H₅ | CH₃ | 5-F-6-Cl | 2 |
| CH₂CH₂CH₂CH(CH₃)₂ | CH₃ | C₂H₅ | CH₃ | 5-F-6-Cl | 2 |
| CH₂CH₂CH₂Si(CH₃)₂(C₂H₅) | CH₃ | C₂H₅ | CH₃ | 5-F-6-Cl | 2 |
| CH₂CH₂CH₂Si(CH₃)₃ | CH₃ | CH(CH₃)₂ | CH₃ | 5-F-6-Cl | 2 |
| CH₂CH₂CH₂C(CH₃)₃ | CH₃ | CH(CH₃)₂ | CH₃ | 5-F-6-Cl | 2 |
| CH₂CH₂CH₂CH(CH₃)₂ | CH₃ | CH(CH₃)₂ | CH₃ | 5-F-6-Cl | 2 |
| CH₂CH₂CH₂Si(CH₃)₂(C₂H₅) | CH₃ | CH(CH₃)₂ | CH₃ | 5-F-6-Cl | 2 |
| CH₂CH₂CH₂Si(CH₃)₃ | CH₃ | c-Pr | CH₃ | 5-F-6-Cl | 2 |
| CH₂CH₂CH₂C(CH₃)₃ | CH₃ | c-Pr | CH₃ | 5-F-6-Cl | 2 |
| CH₂CH₂CH₂CH(CH₃)₂ | CH₃ | c-Pr | CH₃ | 5-F-6-Cl | 2 |
| CH₂CH₂CH₂Si(CH₃)₂(C₂H₅) | CH₃ | c-Pr | CH₃ | 5-F-6-Cl | 2 |
| CH₂CH₂CH₂Si(CH₃)₃ | C₂H₅ | C₂H₅ | CH₃ | 5-F-6-Cl | 2 |
| CH₂CH₂CH₂C(CH₃)₃ | C₂H₅ | C₂H₅ | CH₃ | 5-F-6-Cl | 2 |
| CH₂CH₂CH₂CH(CH₃)₂ | C₂H₅ | C₂H₅ | CH₃ | 5-F-6-Cl | 2 |
| CH₂CH₂CH₂Si(CH₃)₂(C₂H₅) | C₂H₅ | C₂H₅ | CH₃ | 5-F-6-Cl | 2 |
| CH₂CH₂CH₂Si(CH₃)₃ | CH₃ | CH₂CH═CH₂ | CH₃ | 5-F-6-Cl | 2 |
| CH₂CH₂CH₂C(CH₃)₃ | CH₃ | CH₂CH═CH₂ | CH₃ | 5-F-6-Cl | 2 |
| CH₂CH₂CH₂CH(CH₃)₂ | CH₃ | CH₂CH═CH₂ | CH₃ | 5-F-6-Cl | 2 |
| CH₂CH₂CH₂Si(CH₃)₂(C₂H₅) | CH₃ | CH₂CH═CH₂ | CH₃ | 5-F-6-Cl | 2 |
| CH₂CH₂CH₂Si(CH₃)₃ | CH₃ | CH₂C≡CH | CH₃ | 5-F-6-Cl | 2 |
| CH₂CH₂CH₂C(CH₃)₃ | CH₃ | CH₂C≡CH | CH₃ | 5-F-6-Cl | 2 |
| CH₂CH₂CH₂CH(CH₃)₂ | CH₃ | CH₂C≡CH | CH₃ | 5-F-6-Cl | 2 |
| CH₂CH₂CH₂Si(CH₃)₂(C₂H₅) | CH₃ | CH₂C≡CH | CH₃ | 5-F-6-Cl | 2 |
| CH₂CH₂CH₂Si(CH₃)₃ | CH₃ | CH₂CH₂F | CH₃ | 5-F-6-Cl | 2 |
| CH₂CH₂CH₂C(CH₃)₃ | CH₃ | CH₂CH₂F | CH₃ | 5-F-6-Cl | 2 |
| CH₂CH₂CH₂Si(CH₃)₃ | CH₃ | CH₃ | CH₃ | 5-F-6-Br | 2 |
| CH₂CH₂CH₂C(CH₃)₃ | CH₃ | CH₃ | CH₃ | 5-F-6-Br | 2 |
| CH₂CH₂CH₂CH(CH₃)₂ | CH₃ | CH₃ | CH₃ | 5-F-6-Br | 2 |
| CH₂CH₂CH₂Si(CH₃)₂(C₂H₅) | CH₃ | CH₃ | CH₃ | 5-F-6-Br | 2 |
| CH₂CH₂CH₂Si(CH₃)₃ | CH₃ | C₂H₅ | CH₃ | 5-F-6-Br | 2 |
| CH₂CH₂CH₂C(CH₃)₃ | CH₃ | C₂H₅ | CH₃ | 5-F-6-Br | 2 |
| CH₂CH₂CH₂CH(CH₃)₂ | CH₃ | C₂H₅ | CH₃ | 5-F-6-Br | 2 |
| CH₂CH₂CH₂Si(CH₃)₂(C₂H₅) | CH₃ | C₂H₅ | CH₃ | 5-F-6-Br | 2 |
| CH₂CH₂CH₂Si(CH₃)₃ | CH₃ | CH(CH₃)₂ | CH₃ | 5-F-6-Br | 2 |
| CH₂CH₂CH₂C(CH₃)₃ | CH₃ | CH(CH₃)₂ | CH₃ | 5-F-6-Br | 2 |
| CH₂CH₂CH₂CH(CH₃)₂ | CH₃ | CH(CH₃)₂ | CH₃ | 5-F-6-Br | 2 |
| CH₂CH₂CH₂Si(CH₃)₂(C₂H₅) | CH₃ | CH(CH₃)₂ | CH₃ | 5-F-6-Br | 2 |
| CH₂CH₂CH₂Si(CH₃)₃ | CH₃ | c-Pr | CH₃ | 5-F-6-Br | 2 |
| CH₂CH₂CH₂C(CH₃)₃ | CH₃ | c-Pr | CH₃ | 5-F-6-Br | 2 |
| CH₂CH₂CH₂CH(CH₃)₂ | CH₃ | c-Pr | CH₃ | 5-F-6-Br | 2 |
| CH₂CH₂CH₂Si(CH₃)₂(C₂H₅) | CH₃ | c-Pr | CH₃ | 5-F-6-Br | 2 |
| CH₂CH₂CH₂CH₂Si(CH₃)₃ | C₂H₅ | C₂H₅ | CH₃ | 5-F-6-Br | 2 |
| CH₂CH₂CH₂C(CH₃)₃ | C₂H₅ | C₂H₅ | CH₃ | 5-F-6-Br | 2 |
| CH₂CH₂CH₂CH(CH₃)₂ | C₂H₅ | C₂H₅ | CH₃ | 5-F-6-Br | 2 |
| CH₂CH₂CH₂Si(CH₃)₂(C₂H₅) | C₂H₅ | C₂H₅ | CH₃ | 5-F-6-Br | 2 |
| CH₂CH₂CH₂Si(CH₃)₃ | CH₃ | CH₂CH═CH₂ | CH₃ | 5-F-6-Br | 2 |
| CH₂CH₂CH₂C(CH₃)₃ | CH₃ | CH₂CH═CH₂ | CH₃ | 5-F-6-Br | 2 |
| CH₂CH₂CH₂CH(CH₃)₂ | CH₃ | CH₂CH═CH₂ | CH₃ | 5-F-6-Br | 2 |
| CH₂CH₂CH₂Si(CH₃)₂(C₂H₅) | CH₃ | CH₂CH═CH₂ | CH₃ | 5-F-6-Br | 2 |
| CH₂CH₂CH₂Si(CH₃)₃ | CH₃ | CH₂C≡CH | CH₃ | 5-F-6-Br | 2 |
| CH₂CH₂CH₂C(CH₃)₃ | CH₃ | CH₂C≡CH | CH₃ | 5-F-6-Br | 2 |
| CH₂CH₂CH₂CH(CH₃)₂ | CH₃ | CH₂C≡CH | CH₃ | 5-F-6-Br | 2 |
| CH₂CH₂CH₂Si(CH₃)₂(C₂H₅) | CH₃ | CH₂C≡CH | CH₃ | 5-F-6-Br | 2 |
| CH₂CH₂CH₂Si(CH₃)₃ | CH₃ | CH₂CH₂F | CH₃ | 5-F-6-Br | 2 |
| CH₂CH₂CH₂C(CH₃)₃ | CH₃ | CH₂CH₂F | CH₃ | 5-F-6-Br | 2 |

TABLE 11

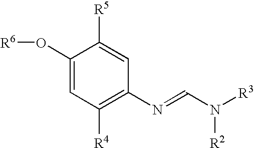

| R⁶ | R² + R³ | R³ | R⁵ |
|---|---|---|---|
| CH₂CH₂CH₂Si(CH₃)₃ | —CH₂CH₂CH₂— | CH₃ | CH₃ |
| CH₂CH₂CH₂C(CH₃)₃ | —CH₂CH₂CH₂— | CH₃ | CH₃ |
| CH₂CH₂CH₂CH(CH₃)₂ | —CH₂CH₂CH₂— | CH₃ | CH₃ |
| CH₂CH₂CH₂Si(CH₃)₂(C₂H₅) | —CH₂CH₂CH₂— | CH₃ | CH₃ |
| CH₂CH₂CH₂Si(CH₃)₃ | —CH₂CHCH₃— | CH₃ | CH₃ |
| CH₂CH₂CH₂C(CH₃)₃ | —CH₂CHCH₃— | CH₃ | CH₃ |
| CH₂CH₂CH₂CH(CH₃)₂ | —CH₂CHCH₃— | CH₃ | CH₃ |
| CH₂CH₂CH₂Si(CH₃)₂(C₂H₅) | —CH₂CHCH₃— | CH₃ | CH₃ |
| CH₂CH₂CH₂Si(CH₃)₃ | —CH₂CH═CHCH₂— | CH₃ | CH₃ |
| CH₂CH₂CH₂C(CH₃)₃ | —CH₂CH═CHCH₂— | CH₃ | CH₃ |
| CH₂CH₂CH₂CH(CH₃)₂ | —CH₂CH═CHCH₂— | CH₃ | CH₃ |
| CH₂CH₂CH₂Si(CH₃)₂(C₂H₅) | —CH₂CH═CHCH₂— | CH₃ | CH₃ |
| CH₂CH₂CH₂Si(CH₃)₃ | —CH₂SCH₂CH₂— | CH₃ | CH₃ |
| CH₂CH₂CH₂C(CH₃)₃ | —CH₂SCH₂CH₂— | CH₃ | CH₃ |
| CH₂CH₂CH₂CH(CH₃)₂ | —CH₂SCH₂CH₂— | CH₃ | CH₃ |
| CH₂CH₂CH₂Si(CH₃)₂(C₂H₅) | —CH₂SCH₂CH₂— | CH₃ | CH₃ |
| CH₂CH₂CH₂Si(CH₃)₃ | —CH₂CH₂CH₂CH₂— | CH₃ | Cl |
| CH₂CH₂CH₂C(CH₃)₃ | —CH₂CH₂CH₂CH₂— | CH₃ | Cl |
| CH₂CH₂CH₂CH(CH₃)₂ | —CH₂CH₂CH₂CH₂— | CH₃ | Cl |
| CH₂CH₂CH₂Si(CH₃)₂(C₂H₅) | —CH₂CH₂CH₂CH₂— | CH₃ | Cl |
| CH₂CH₂CH₂Si(CH₃)₃ | —CH₂CH₂CH₂— | CH₃ | Cl |
| CH₂CH₂CH₂C(CH₃)₃ | —CH₂CH₂CH₂— | CH₃ | Cl |
| CH₂CH₂CH₂CH(CH₃)₂ | —CH₂CH₂CH₂— | CH₃ | Cl |
| CH₂CH₂CH₂Si(CH₃)₂(C₂H₅) | —CH₂CH₂CH₂— | CH₃ | Cl |
| CH₂CH₂CH₂Si(CH₃)₃ | —CH₂CHCH₃— | CH₃ | Cl |
| CH₂CH₂CH₂C(CH₃)₃ | —CH₂CHCH₃— | CH₃ | Cl |
| CH₂CH₂CH₂CH(CH₃)₂ | —CH₂CHCH₃— | CH₃ | Cl |
| CH₂CH₂CH₂Si(CH₃)₂(C₂H₅) | —CH₂CHCH₃— | CH₃ | Cl |
| CH₂CH₂CH₂Si(CH₃)₃ | —CH₂CH═CHCH₂— | CH₃ | Cl |
| CH₂CH₂CH₂C(CH₃)₃ | —CH₂CH═CHCH₂— | CH₃ | Cl |
| CH₂CH₂CH₂CH(CH₃)₂ | —CH₂CH═CHCH₂— | CH₃ | Cl |
| CH₂CH₂CH₂Si(CH₃)₂(C₂H₅) | —CH₂CH═CHCH₂— | CH₃ | Cl |
| CH₂CH₂CH₂Si(CH₃)₃ | —CH₂SCH₂CH₂— | CH₃ | Cl |
| CH₂CH₂CH₂C(CH₃)₃ | —CH₂SCH₂CH₂— | CH₃ | Cl |
| CH₂CH₂CH₂CH(CH₃)₂ | —CH₂SCH₂CH₂— | CH₃ | Cl |
| CH₂CH₂CH₂Si(CH₃)₂(C₂H₅) | —CH₂SCH₂CH₂— | CH₃ | Cl |
| CH₂CH₂CH₂Si(CH₃)₃ | —CH₂CH₂CH₂CH₂— | CH₃ | Br |
| CH₂CH₂CH₂C(CH₃)₃ | —CH₂CH₂CH₂CH₂— | CH₃ | Br |
| CH₂CH₂CH₂CH(CH₃)₂ | —CH₂CH₂CH₂CH₂— | CH₃ | Br |
| CH₂CH₂CH₂Si(CH₃)₂(C₂H₅) | —CH₂CH₂CH₂CH₂— | CH₃ | Br |
| CH₂CH₂CH₂Si(CH₃)₃ | —CH₂CH₂CH₂— | CH₃ | Br |
| CH₂CH₂CH₂C(CH₃)₃ | —CH₂CH₂CH₂— | CH₃ | Br |
| CH₂CH₂CH₂CH(CH₃)₂ | —CH₂CH₂CH₂— | CH₃ | Br |
| CH₂CH₂CH₂Si(CH₃)₂(C₂H₅) | —CH₂CH₂CH₂— | CH₃ | Br |
| CH₂CH₂CH₂Si(CH₃)₃ | —CH₂CHCH₃— | CH₃ | Br |
| CH₂CH₂CH₂C(CH₃)₃ | —CH₂CHCH₃— | CH₃ | Br |
| CH₂CH₂CH₂CH(CH₃)₂ | —CH₂CHCH₃— | CH₃ | Br |
| CH₂CH₂CH₂Si(CH₃)₂(C₂H₅) | —CH₂CHCH₃— | CH₃ | Br |
| CH₂CH₂CH₂Si(CH₃)₃ | —CH₂CH═CHCH₂— | CH₃ | Br |
| CH₂CH₂CH₂C(CH₃)₃ | —CH₂CH═CHCH₂— | CH₃ | Br |
| CH₂CH₂CH₂CH(CH₃)₂ | —CH₂CH═CHCH₂— | CH₃ | Br |
| CH₂CH₂CH₂Si(CH₃)₂(C₂H₅) | —CH₂CH═CHCH₂— | CH₃ | Br |
| CH₂CH₂CH₂Si(CH₃)₃ | —CH₂SCH₂CH₂— | CH₃ | Br |
| CH₂CH₂CH₂C(CH₃)₃ | —CH₂SCH₂CH₂— | CH₃ | Br |
| CH₂CH₂CH₂CH(CH₃)₂ | —CH₂SCH₂CH₂— | CH₃ | Br |
| CH₂CH₂CH₂Si(CH₃)₂(C₂H₅) | —CH₂SCH₂CH₂— | CH₃ | Br |
| CH₂CH₂CH₂Si(CH₃)₃ | —CH₂CH₂CH₂CH₂— | CH₃ | i-Pr |
| CH₂CH₂CH₂C(CH₃)₃ | —CH₂CH₂CH₂CH₂— | CH₃ | i-Pr |
| CH₂CH₂CH₂CH(CH₃)₂ | —CH₂CH₂CH₂CH₂— | CH₃ | i-Pr |
| CH₂CH₂CH₂Si(CH₃)₂(C₂H₅) | —CH₂CH₂CH₂CH₂— | CH₃ | i-Pr |
| CH₂CH₂CH₂Si(CH₃)₃ | —CH₂CH₂CH₂— | CH₃ | i-Pr |
| CH₂CH₂CH₂C(CH₃)₃ | —CH₂CH₂CH₂— | CH₃ | i-Pr |
| CH₂CH₂CH₂CH(CH₃)₂ | —CH₂CH₂CH₂— | CH₃ | i-Pr |
| CH₂CH₂CH₂Si(CH₃)₂(C₂H₅) | —CH₂CH₂CH₂— | CH₃ | i-Pr |
| CH₂CH₂CH₂Si(CH₃)₃ | —CH₂CHCH₃— | CH₃ | i-Pr |
| CH₂CH₂CH₂C(CH₃)₃ | —CH₂CHCH₃— | CH₃ | i-Pr |
| CH₂CH₂CH₂CH(CH₃)₂ | —CH₂CHCH₃— | CH₃ | i-Pr |
| CH₂CH₂CH₂Si(CH₃)₂(C₂H₅) | —CH₂CHCH₃— | CH₃ | i-Pr |
| CH₂CH₂CH₂Si(CH₃)₃ | —CH₂CH═CHCH₂— | CH₃ | i-Pr |
| CH₂CH₂CH₂C(CH₃)₃ | —CH₂CH═CHCH₂— | CH₃ | i-Pr |
| CH₂CH₂CH₂CH(CH₃)₂ | —CH₂CH═CHCH₂— | CH₃ | i-Pr |
| CH₂CH₂CH₂Si(CH₃)₂(C₂H₅) | —CH₂CH═CHCH₂— | CH₃ | i-Pr |
| CH₂CH₂CH₂Si(CH₃)₃ | —CH₂SCH₂CH₂— | CH₃ | i-Pr |
| CH₂CH₂CH₂C(CH₃)₃ | —CH₂SCH₂CH₂— | CH₃ | i-Pr |
| CH₂CH₂CH₂CH(CH₃)₂ | —CH₂SCH₂CH₂— | CH₃ | i-Pr |
| CH₂CH₂CH₂Si(CH₃)₂(C₂H₅) | —CH₂SCH₂CH₂— | CH₃ | i-Pr |
| CH₂CH₂CH₂Si(CH₃)₃ | —CH₂CH₂CH₂CH₂— | CH₃ | F |
| CH₂CH₂CH₂C(CH₃)₃ | —CH₂CH₂CH₂CH₂— | CH₃ | F |
| CH₂CH₂CH₂CH(CH₃)₂ | —CH₂CH₂CH₂CH₂— | CH₃ | F |
| CH₂CH₂CH₂Si(CH₃)₂(C₂H₅) | —CH₂CH₂CH₂CH₂— | CH₃ | F |
| CH₂CH₂CH₂Si(CH₃)₃ | —CH₂CH₂CH₂— | CH₃ | F |
| CH₂CH₂CH₂C(CH₃)₃ | —CH₂CH₂CH₂— | CH₃ | F |
| CH₂CH₂CH₂CH(CH₃)₂ | —CH₂CH₂CH₂— | CH₃ | F |
| CH₂CH₂CH₂Si(CH₃)₂(C₂H₅) | —CH₂CH₂CH₂— | CH₃ | F |
| CH₂CH₂CH₂Si(CH₃)₃ | —CH₂CHCH₃— | CH₃ | F |
| CH₂CH₂CH₂C(CH₃)₃ | —CH₂CHCH₃— | CH₃ | F |
| CH₂CH₂CH₂CH(CH₃)₂ | —CH₂CHCH₃— | CH₃ | F |
| CH₂CH₂CH₂Si(CH₃)₂(C₂H₅) | —CH₂CHCH₃— | CH₃ | F |
| CH₂CH₂CH₂Si(CH₃)₃ | —CH₂CH═CHCH₂— | CH₃ | F |
| CH₂CH₂CH₂C(CH₃)₃ | —CH₂CH═CHCH₂— | CH₃ | F |
| CH₂CH₂CH₂CH(CH₃)₂ | —CH₂CH═CHCH₂— | CH₃ | F |
| CH₂CH₂CH₂Si(CH₃)₂(C₂H₅) | —CH₂CH═CHCH₂— | CH₃ | F |
| CH₂CH₂CH₂Si(CH₃)₃ | —CH₂SCH₂CH₂— | CH₃ | F |
| CH₂CH₂CH₂C(CH₃)₃ | —CH₂SCH₂CH₂— | CH₃ | F |
| CH₂CH₂CH₂CH(CH₃)₂ | —CH₂SCH₂CH₂— | CH₃ | F |
| CH₂CH₂CH₂Si(CH₃)₂(C₂H₅) | —CH₂SCH₂CH₂— | CH₃ | F |
| CH₂CH₂CH₂Si(CH₃)₃ | —CH₂CH₂CH₂CH₂— | OCH₃ | Cl |
| CH₂CH₂CH₂C(CH₃)₃ | —CH₂CH₂CH₂CH₂— | OCH₃ | Cl |
| CH₂CH₂CH₂CH(CH₃)₂ | —CH₂CH₂CH₂CH₂— | OCH₃ | Cl |
| CH₂CH₂CH₂Si(CH₃)₂(C₂H₅) | —CH₂CH₂CH₂CH₂— | OCH₃ | Cl |
| CH₂CH₂CH₂Si(CH₃)₃ | —CH₂CH₂CH₂— | OCH₃ | Cl |
| CH₂CH₂CH₂C(CH₃)₃ | —CH₂CH₂CH₂— | OCH₃ | Cl |
| CH₂CH₂CH₂CH(CH₃)₂ | —CH₂CH₂CH₂— | OCH₃ | Cl |
| CH₂CH₂CH₂Si(CH₃)₂(C₂H₅) | —CH₂CH₂CH₂— | OCH₃ | Cl |
| CH₂CH₂CH₂Si(CH₃)₃ | —CH₂CHCH₃— | OCH₃ | Cl |
| CH₂CH₂CH₂C(CH₃)₃ | —CH₂CHCH₃— | OCH₃ | Cl |
| CH₂CH₂CH₂CH(CH₃)₂ | —CH₂CHCH₃— | OCH₃ | Cl |
| CH₂CH₂CH₂Si(CH₃)₂(C₂H₅) | —CH₂CHCH₃— | OCH₃ | Cl |
| CH₂CH₂CH₂Si(CH₃)₃ | —CH₂CH═CHCH₂— | OCH₃ | Cl |
| CH₂CH₂CH₂C(CH₃)₃ | —CH₂CH═CHCH₂— | OCH₃ | Cl |
| CH₂CH₂CH₂CH(CH₃)₂ | —CH₂CH═CHCH₂— | OCH₃ | Cl |
| CH₂CH₂CH₂Si(CH₃)₂(C₂H₅) | —CH₂CH═CHCH₂— | OCH₃ | Cl |
| CH₂CH₂CH₂Si(CH₃)₃ | —CH₂SCH₂CH₂— | OCH₃ | Cl |
| CH₂CH₂CH₂C(CH₃)₃ | —CH₂SCH₂CH₂— | OCH₃ | Cl |
| CH₂CH₂CH₂CH(CH₃)₂ | —CH₂SCH₂CH₂— | OCH₃ | Cl |
| CH₂CH₂CH₂Si(CH₃)₂(C₂H₅) | —CH₂SCH₂CH₂— | OCH₃ | Cl |
| CH₂CH₂CH₂Si(CH₃)₃ | —CH₂CH₂CH₂CH₂— | OC₂H₅ | Cl |
| CH₂CH₂CH₂C(CH₃)₃ | —CH₂CH₂CH₂CH₂— | OC₂H₅ | Cl |
| CH₂CH₂CH₂CH(CH₃)₂ | —CH₂CH₂CH₂CH₂— | OC₂H₅ | Cl |
| CH₂CH₂CH₂Si(CH₃)₂(C₂H₅) | —CH₂CH₂CH₂CH₂— | OC₂H₅ | Cl |
| CH₂CH₂CH₂Si(CH₃)₃ | —CH₂CH₂CH₂— | OC₂H₅ | Cl |
| CH₂CH₂CH₂C(CH₃)₃ | —CH₂CH₂CH₂— | OC₂H₅ | Cl |
| CH₂CH₂CH₂CH(CH₃)₂ | —CH₂CH₂CH₂— | OC₂H₅ | Cl |
| CH₂CH₂CH₂Si(CH₃)₂(C₂H₅) | —CH₂CH₂CH₂— | OC₂H₅ | Cl |
| CH₂CH₂CH₂Si(CH₃)₃ | —CH₂CHCH₃— | OC₂H₅ | Cl |
| CH₂CH₂CH₂C(CH₃)₃ | —CH₂CHCH₃— | OC₂H₅ | Cl |
| CH₂CH₂CH₂CH(CH₃)₂ | —CH₂CHCH₃— | OC₂H₅ | Cl |
| CH₂CH₂CH₂Si(CH₃)₂(C₂H₅) | —CH₂CHCH₃— | OC₂H₅ | Cl |
| CH₂CH₂CH₂Si(CH₃)₃ | —CH₂CH═CHCH₂— | OC₂H₅ | Cl |
| CH₂CH₂CH₂C(CH₃)₃ | —CH₂CH═CHCH₂— | OC₂H₅ | Cl |
| CH₂CH₂CH₂CH(CH₃)₂ | —CH₂CH═CHCH₂— | OC₂H₅ | Cl |
| CH₂CH₂CH₂Si(CH₃)₂(C₂H₅) | —CH₂CH═CHCH₂— | OC₂H₅ | Cl |
| CH₂CH₂CH₂Si(CH₃)₃ | —CH₂SCH₂CH₂— | OC₂H₅ | Cl |
| CH₂CH₂CH₂C(CH₃)₃ | —CH₂SCH₂CH₂— | OC₂H₅ | Cl |
| CH₂CH₂CH₂CH(CH₃)₂ | —CH₂SCH₂CH₂— | OC₂H₅ | Cl |
| CH₂CH₂CH₂Si(CH₃)₂(C₂H₅) | —CH₂SCH₂CH₂— | OC₂H₅ | Cl |
| CH₂CH₂CH₂Si(CH₃)₃ | —CH₂CH₂CH₂CH₂— | SCH₃ | Cl |
| CH₂CH₂CH₂C(CH₃)₃ | —CH₂CH₂CH₂CH₂— | SCH₃ | Cl |
| CH₂CH₂CH₂CH(CH₃)₂ | —CH₂CH₂CH₂CH₂— | SCH₃ | Cl |
| CH₂CH₂CH₂Si(CH₃)₂(C₂H₅) | —CH₂CH₂CH₂CH₂— | SCH₃ | Cl |
| CH₂CH₂CH₂Si(CH₃)₃ | —CH₂CH₂CH₂— | SCH₃ | Cl |
| CH₂CH₂CH₂C(CH₃)₃ | —CH₂CH₂CH₂— | SCH₃ | Cl |
| CH₂CH₂CH₂CH(CH₃)₂ | —CH₂CH₂CH₂— | SCH₃ | Cl |
| CH₂CH₂CH₂Si(CH₃)₂(C₂H₅) | —CH₂CH₂CH₂— | SCH₃ | Cl |
| CH₂CH₂CH₂Si(CH₃)₃ | —CH₂CHCH₃— | SCH₃ | Cl |
| CH₂CH₂CH₂C(CH₃)₃ | —CH₂CHCH₃— | SCH₃ | Cl |
| CH₂CH₂CH₂CH(CH₃)₂ | —CH₂CHCH₃— | SCH₃ | Cl |
| CH₂CH₂CH₂Si(CH₃)₂(C₂H₅) | —CH₂CHCH₃— | SCH₃ | Cl |
| CH₂CH₂CH₂Si(CH₃)₃ | —CH₂CH═CHCH₂— | SCH₃ | Cl |
| CH₂CH₂CH₂C(CH₃)₃ | —CH₂CH═CHCH₂— | SCH₃ | Cl |
| CH₂CH₂CH₂CH(CH₃)₂ | —CH₂CH═CHCH₂— | SCH₃ | Cl |
| CH₂CH₂CH₂Si(CH₃)₂(C₂H₅) | —CH₂CH═CHCH₂— | SCH₃ | Cl |
| CH₂CH₂CH₂Si(CH₃)₃ | —CH₂SCH₂CH₂— | SCH₃ | Cl |
| CH₂CH₂CH₂C(CH₃)₃ | —CH₂SCH₂CH₂— | SCH₃ | Cl |
| CH₂CH₂CH₂CH(CH₃)₂ | —CH₂SCH₂CH₂— | SCH₃ | Cl |
| CH₂CH₂CH₂Si(CH₃)₂(C₂H₅) | —CH₂SCH₂CH₂— | SCH₃ | Cl |
| CH₂CH₂CH₂Si(CH₃)₃ | —CH₂CH₂CH₂CH₂— | SC₂H₅ | Cl |
| CH₂CH₂CH₂C(CH₃)₃ | —CH₂CH₂CH₂CH₂— | SC₂H₅ | Cl |
| CH₂CH₂CH₂CH(CH₃)₂ | —CH₂CH₂CH₂CH₂— | SC₂H₅ | Cl |
| CH₂CH₂CH₂Si(CH₃)₂(C₂H₅) | —CH₂CH₂CH₂CH₂— | SC₂H₅ | Cl |
| CH₂CH₂CH₂Si(CH₃)₃ | —CH₂CH₂CH₂— | SC₂H₅ | Cl |
| CH₂CH₂CH₂C(CH₃)₃ | —CH₂CH₂CH₂— | SC₂H₅ | Cl |
| CH₂CH₂CH₂CH(CH₃)₂ | —CH₂CH₂CH₂— | SC₂H₅ | Cl |
| CH₂CH₂CH₂Si(CH₃)₂(C₂H₅) | —CH₂CH₂CH₂— | SC₂H₅ | Cl |
| CH₂CH₂CH₂Si(CH₃)₃ | —CH₂CHCH₃— | SC₂H₅ | Cl |
| CH₂CH₂CH₂C(CH₃)₃ | —CH₂CHCH₃— | SC₂H₅ | Cl |
| CH₂CH₂CH₂CH(CH₃)₂ | —CH₂CHCH₃— | SC₂H₅ | Cl |
| CH₂CH₂CH₂Si(CH₃)₂(C₂H₅) | —CH₂CHCH₃— | SC₂H₅ | Cl |
| CH₂CH₂CH₂Si(CH₃)₃ | —CH₂CH═CHCH₂— | SC₂H₅ | Cl |
| CH₂CH₂CH₂C(CH₃)₃ | —CH₂CH═CHCH₂— | SC₂H₅ | Cl |
| CH₂CH₂CH₂CH(CH₃)₂ | —CH₂CH═CHCH₂— | SC₂H₅ | Cl |
| CH₂CH₂CH₂Si(CH₃)₂(C₂H₅) | —CH₂CH═CHCH₂— | SC₂H₅ | Cl |
| CH₂CH₂CH₂Si(CH₃)₃ | —CH₂SCH₂CH₂— | SC₂H₅ | Cl |
| CH₂CH₂CH₂C(CH₃)₃ | —CH₂SCH₂CH₂— | SC₂H₅ | Cl |
| CH₂CH₂CH₂CH(CH₃)₂ | —CH₂SCH₂CH₂— | SC₂H₅ | Cl |
| CH₂CH₂CH₂Si(CH₃)₂(C₂H₅) | —CH₂SCH₂CH₂— | SC₂H₅ | Cl |
| CH₂CH₂CH₂Si(CH₃)₃ | —CH₂CH₂CH₂CH₂— | C₂H₅ | Cl |
| CH₂CH₂CH₂C(CH₃)₃ | —CH₂CH₂CH₂CH₂— | C₂H₅ | Cl |
| CH₂CH₂CH₂CH(CH₃)₂ | —CH₂CH₂CH₂CH₂— | C₂H₅ | Cl |
| CH₂CH₂CH₂Si(CH₃)₂(C₂H₅) | —CH₂CH₂CH₂CH₂— | C₂H₅ | Cl |
| CH₂CH₂CH₂Si(CH₃)₃ | —CH₂CH₂CH₂— | C₂H₅ | Cl |
| CH₂CH₂CH₂C(CH₃)₃ | —CH₂CH₂CH₂— | C₂H₅ | Cl |
| CH₂CH₂CH₂CH(CH₃)₂ | —CH₂CH₂CH₂— | C₂H₅ | Cl |
| CH₂CH₂CH₂Si(CH₃)₂(C₂H₅) | —CH₂CH₂CH₂— | C₂H₅ | Cl |
| CH₂CH₂CH₂Si(CH₃)₃ | —CH₂CHCH₃— | C₂H₅ | Cl |
| CH₂CH₂CH₂C(CH₃)₃ | —CH₂CHCH₃— | C₂H₅ | Cl |
| CH₂CH₂CH₂CH(CH₃)₂ | —CH₂CHCH₃— | C₂H₅ | Cl |
| CH₂CH₂CH₂Si(CH₃)₂(C₂H₅) | —CH₂CHCH₃— | C₂H₅ | Cl |
| CH₂CH₂CH₂Si(CH₃)₃ | —CH₂CH═CHCH₂— | C₂H₅ | Cl |
| CH₂CH₂CH₂C(CH₃)₃ | —CH₂CH═CHCH₂— | C₂H₅ | Cl |
| CH₂CH₂CH₂CH(CH₃)₂ | —CH₂CH═CHCH₂— | C₂H₅ | Cl |
| CH₂CH₂CH₂Si(CH₃)₂(C₂H₅) | —CH₂CH═CHCH₂— | C₂H₅ | Cl |
| CH₂CH₂CH₂Si(CH₃)₃ | —CH₂SCH₂CH₂— | C₂H₅ | Cl |
| CH₂CH₂CH₂C(CH₃)₃ | —CH₂SCH₂CH₂— | C₂H₅ | Cl |
| CH₂CH₂CH₂CH(CH₃)₂ | —CH₂SCH₂CH₂— | C₂H₅ | Cl |
| CH₂CH₂CH₂Si(CH₃)₂(C₂H₅) | —CH₂SCH₂CH₂— | C₂H₅ | Cl |
| CH₂CH₂CH₂Si(CH₃)₃ | —CH₂CH₂CH₂CH₂— | OCH₃ | F |
| CH₂CH₂CH₂C(CH₃)₃ | —CH₂CH₂CH₂CH₂— | OCH₃ | F |
| CH₂CH₂CH₂CH(CH₃)₂ | —CH₂CH₂CH₂CH₂— | OCH₃ | F |
| CH₂CH₂CH₂Si(CH₃)₂(C₂H₅) | —CH₂CH₂CH₂CH₂— | OCH₃ | F |
| CH₂CH₂CH₂Si(CH₃)₃ | —CH₂CH₂CH₂— | OCH₃ | F |
| CH₂CH₂CH₂C(CH₃)₃ | —CH₂CH₂CH₂— | OCH₃ | F |
| CH₂CH₂CH₂CH(CH₃)₂ | —CH₂CH₂CH₂— | OCH₃ | F |
| CH₂CH₂CH₂Si(CH₃)₂(C₂H₅) | —CH₂CH₂CH₂— | OCH₃ | F |
| CH₂CH₂CH₂Si(CH₃)₃ | —CH₂CHCH₃— | OCH₃ | F |
| CH₂CH₂CH₂C(CH₃)₃ | —CH₂CHCH₃— | OCH₃ | F |
| CH₂CH₂CH₂CH(CH₃)₂ | —CH₂CHCH₃— | OCH₃ | F |
| CH₂CH₂CH₂Si(CH₃)₂(C₂H₅) | —CH₂CHCH₃— | OCH₃ | F |
| CH₂CH₂CH₂Si(CH₃)₃ | —CH₂CH═CHCH₂— | OCH₃ | F |
| CH₂CH₂CH₂C(CH₃)₃ | —CH₂CH═CHCH₂— | OCH₃ | F |
| CH₂CH₂CH₂CH(CH₃)₂ | —CH₂CH═CHCH₂— | OCH₃ | F |
| CH₂CH₂CH₂Si(CH₃)₂(C₂H₅) | —CH₂CH═CHCH₂— | OCH₃ | F |
| CH₂CH₂CH₂Si(CH₃)₃ | —CH₂SCH₂CH₂— | OCH₃ | F |
| CH₂CH₂CH₂C(CH₃)₃ | —CH₂SCH₂CH₂— | OCH₃ | F |
| CH₂CH₂CH₂CH(CH₃)₂ | —CH₂SCH₂CH₂— | OCH₃ | F |
| CH₂CH₂CH₂Si(CH₃)₂(C₂H₅) | —CH₂SCH₂CH₂— | OCH₃ | F |
| CH₂CH₂CH₂Si(CH₃)₃ | —CH₂CH₂CH₂CH₂— | OC₂H₅ | F |
| CH₂CH₂CH₂C(CH₃)₃ | —CH₂CH₂CH₂CH₂— | OC₂H₅ | F |
| CH₂CH₂CH₂CH(CH₃)₂ | —CH₂CH₂CH₂CH₂— | OC₂H₅ | F |
| CH₂CH₂CH₂Si(CH₃)₂(C₂H₅) | —CH₂CH₂CH₂CH₂— | OC₂H₅ | F |
| CH₂CH₂CH₂Si(CH₃)₃ | —CH₂CH₂CH₂— | OC₂H₅ | F |
| CH₂CH₂CH₂C(CH₃)₃ | —CH₂CH₂CH₂— | OC₂H₅ | F |
| CH₂CH₂CH₂CH(CH₃)₂ | —CH₂CH₂CH₂— | OC₂H₅ | F |
| CH₂CH₂CH₂Si(CH₃)₂(C₂H₅) | —CH₂CH₂CH₂— | OC₂H₅ | F |
| CH₂CH₂CH₂Si(CH₃)₃ | —CH₂CHCH₃— | OC₂H₅ | F |
| CH₂CH₂CH₂C(CH₃)₃ | —CH₂CHCH₃— | OC₂H₅ | F |
| CH₂CH₂CH₂CH(CH₃)₂ | —CH₂CHCH₃— | OC₂H₅ | F |
| CH₂CH₂CH₂Si(CH₃)₂(C₂H₅) | —CH₂CHCH₃— | OC₂H₅ | F |
| CH₂CH₂CH₂Si(CH₃)₃ | —CH₂CH═CHCH₂— | OC₂H₅ | F |
| CH₂CH₂CH₂C(CH₃)₃ | —CH₂CH═CHCH₂— | OC₂H₅ | F |
| CH₂CH₂CH₂CH(CH₃)₂ | —CH₂CH═CHCH₂— | OC₂H₅ | F |
| CH₂CH₂CH₂Si(CH₃)₂(C₂H₅) | —CH₂CH═CHCH₂— | OC₂H₅ | F |
| CH₂CH₂CH₂Si(CH₃)₃ | —CH₂SCH₂CH₂— | OC₂H₅ | F |
| CH₂CH₂CH₂C(CH₃)₃ | —CH₂SCH₂CH₂— | OC₂H₅ | F |
| CH₂CH₂CH₂CH(CH₃)₂ | —CH₂SCH₂CH₂— | OC₂H₅ | F |
| CH₂CH₂CH₂Si(CH₃)₂(C₂H₅) | —CH₂SCH₂CH₂— | OC₂H₅ | F |
| CH₂CH₂CH₂Si(CH₃)₃ | —CH₂CH₂CH₂CH₂— | SCH₃ | F |
| CH₂CH₂CH₂C(CH₃)₃ | —CH₂CH₂CH₂CH₂— | SCH₃ | F |
| CH₂CH₂CH₂CH(CH₃)₂ | —CH₂CH₂CH₂CH₂— | SCH₃ | F |
| CH₂CH₂CH₂Si(CH₃)₂(C₂H₅) | —CH₂CH₂CH₂CH₂— | SCH₃ | F |
| CH₂CH₂CH₂Si(CH₃)₃ | —CH₂CH₂CH₂— | SCH₃ | F |
| CH₂CH₂CH₂C(CH₃)₃ | —CH₂CH₂CH₂— | SCH₃ | F |
| CH₂CH₂CH₂CH(CH₃)₂ | —CH₂CH₂CH₂— | SCH₃ | F |
| CH₂CH₂CH₂Si(CH₃)₂(C₂H₅) | —CH₂CH₂CH₂— | SCH₃ | F |
| CH₂CH₂CH₂Si(CH₃)₃ | —CH₂CHCH₃— | SCH₃ | F |
| CH₂CH₂CH₂C(CH₃)₃ | —CH₂CHCH₃— | SCH₃ | F |
| CH₂CH₂CH₂CH(CH₃)₂ | —CH₂CHCH₃— | SCH₃ | F |
| CH₂CH₂CH₂Si(CH₃)₂(C₂H₅) | —CH₂CHCH₃— | SCH₃ | F |
| CH₂CH₂CH₂Si(CH₃)₃ | —CH₂CH═CHCH₂— | SCH₃ | F |
| CH₂CH₂CH₂C(CH₃)₃ | —CH₂CH═CHCH₂— | SCH₃ | F |
| CH₂CH₂CH₂CH(CH₃)₂ | —CH₂CH═CHCH₂— | SCH₃ | F |
| CH₂CH₂CH₂Si(CH₃)₂(C₂H₅) | —CH₂CH═CHCH₂— | SCH₃ | F |
| CH₂CH₂CH₂Si(CH₃)₃ | —CH₂SCH₂CH₂— | SCH₃ | F |
| CH₂CH₂CH₂C(CH₃)₃ | —CH₂SCH₂CH₂— | SCH₃ | F |
| CH₂CH₂CH₂CH(CH₃)₂ | —CH₂SCH₂CH₂— | SCH₃ | F |
| CH₂CH₂CH₂Si(CH₃)₂(C₂H₅) | —CH₂SCH₂CH₂— | SCH₃ | F |
| CH₂CH₂CH₂Si(CH₃)₃ | —CH₂CH₂CH₂CH₂— | SC₂H₅ | F |
| CH₂CH₂CH₂C(CH₃)₃ | —CH₂CH₂CH₂CH₂— | SC₂H₅ | F |
| CH₂CH₂CH₂CH(CH₃)₂ | —CH₂CH₂CH₂CH₂— | SC₂H₅ | F |
| CH₂CH₂CH₂Si(CH₃)₂(C₂H₅) | —CH₂CH₂CH₂CH₂— | SC₂H₅ | F |
| CH₂CH₂CH₂Si(CH₃)₃ | —CH₂CH₂CH₂— | SC₂H₅ | F |
| CH₂CH₂CH₂C(CH₃)₃ | —CH₂CH₂CH₂— | SC₂H₅ | F |
| CH₂CH₂CH₂CH(CH₃)₂ | —CH₂CH₂CH₂— | SC₂H₅ | F |
| CH₂CH₂CH₂Si(CH₃)₂(C₂H₅) | —CH₂CH₂CH₂— | SC₂H₅ | F |
| CH₂CH₂CH₂Si(CH₃)₃ | —CH₂CHCH₃— | SC₂H₅ | F |
| CH₂CH₂CH₂C(CH₃)₃ | —CH₂CHCH₃— | SC₂H₅ | F |
| CH₂CH₂CH₂CH(CH₃)₂ | —CH₂CHCH₃— | SC₂H₅ | F |
| CH₂CH₂CH₂Si(CH₃)₂(C₂H₅) | —CH₂CHCH₃— | SC₂H₅ | F |
| CH₂CH₂CH₂Si(CH₃)₃ | —CH₂CH═CHCH₂— | SC₂H₅ | F |
| CH₂CH₂CH₂C(CH₃)₃ | —CH₂CH═CHCH₂— | SC₂H₅ | F |
| CH₂CH₂CH₂CH(CH₃)₂ | —CH₂CH═CHCH₂— | SC₂H₅ | F |
| CH₂CH₂CH₂Si(CH₃)₂(C₂H₅) | —CH₂CH═CHCH₂— | SC₂H₅ | F |
| CH₂CH₂CH₂Si(CH₃)₃ | —CH₂SCH₂CH₂— | S02H5 | F |
| CH₂CH₂CH₂C(CH₃)₃ | —CH₂SCH₂CH₂— | SC₂H₅ | F |
| CH₂CH₂CH₂CH(CH₃)₂ | —CH₂SCH₂CH₂— | SC₂H₅ | F |
| CH₂CH₂CH₂Si(CH₃)₂(C₂H₅) | —CH₂SCH₂CH₂— | SC₂H₅ | F |
| CH₂CH₂CH₂Si(CH₃)₃ | —CH₂CH₂CH₂CH₂— | C₂H₅ | F |
| CH₂CH₂CH₂C(CH₃)₃ | —CH₂CH₂CH₂CH₂— | C₂H₅ | F |
| CH₂CH₂CH₂CH(CH₃)₂ | —CH₂CH₂CH₂CH₂— | C₂H₅ | F |
| CH₂CH₂CH₂Si(CH₃)₂(C₂H₅) | —CH₂CH₂CH₂CH₂— | C₂H₅ | F |
| CH₂CH₂CH₂Si(CH₃)₃ | —CH₂CH₂CH₂— | C₂H₅ | F |
| CH₂CH₂CH₂C(CH₃)₃ | —CH₂CH₂CH₂— | C₂H₅ | F |
| CH₂CH₂CH₂CH(CH₃)₂ | —CH₂CH₂CH₂— | C₂H₅ | F |
| CH₂CH₂CH₂Si(CH₃)₂(C₂H₅) | —CH₂CH₂CH₂— | C₂H₅ | F |
| CH₂CH₂CH₂Si(CH₃)₃ | —CH₂CHCH₃— | C₂H₅ | F |
| CH₂CH₂CH₂C(CH₃)₃ | —CH₂CHCH₃— | C₂H₅ | F |
| CH₂CH₂CH₂CH(CH₃)₂ | —CH₂CHCH₃— | C₂H₅ | F |
| CH₂CH₂CH₂Si(CH₃)₂(C₂H₅) | —CH₂CHCH₃— | C₂H₅ | F |
| CH₂CH₂CH₂Si(CH₃)₃ | —CH₂CH═CHCH₂— | C₂H₅ | F |
| CH₂CH₂CH₂C(CH₃)₃ | —CH₂CH═CHCH₂— | C₂H₅ | F |
| CH₂CH₂CH₂CH(CH₃)₂ | —CH₂CH═CHCH₂— | C₂H₅ | F |
| CH₂CH₂CH₂Si(CH₃)₂(C₂H₅) | —CH₂CH═CHCH₂— | C₂H₅ | F |
| CH₂CH₂CH₂Si(CH₃)₃ | —CH₂SCH₂CH₂— | C₂H₅ | F |
| CH₂CH₂CH₂C(CH₃)₃ | —CH₂SCH₂CH₂— | C₂H₅ | F |
| CH₂CH₂CH₂CH(CH₃)₂ | —CH₂SCH₂CH₂— | C₂H₅ | F |
| CH₂CH₂CH₂Si(CH₃)₂(C₂H₅) | —CH₂SCH₂CH₂— | C₂H₅ | F |
| CH₂CH₂CH₂Si(CH₃)₃ | —CH₂CH₂CH₂CH₂— | CH₃ | CN |
| CH₂CH₂CH₂C(CH₃)₃ | —CH₂CH₂CH₂CH₂— | CH₃ | CN |
| CH₂CH₂CH₂CH(CH₃)₂ | —CH₂CH₂CH₂CH₂— | CH₃ | CN |
| CH₂CH₂CH₂Si(CH₃)₂(C₂H₅) | —CH₂CH₂CH₂CH₂— | CH₃ | CN |
| CH₂CH₂CH₂Si(CH₃)₃ | —CH₂CH₂CH₂— | CH₃ | CN |
| CH₂CH₂CH₂C(CH₃)₃ | —CH₂CH₂CH₂— | CH₃ | CN |
| CH₂CH₂CH₂CH(CH₃)₂ | —CH₂CH₂CH₂— | CH₃ | CN |
| CH₂CH₂CH₂Si(CH₃)₂(C₂H₅) | —CH₂CH₂CH₂— | CH₃ | CN |
| CH₂CH₂CH₂Si(CH₃)₃ | —CH₂CHCH₃— | CH₃ | CN |
| CH₂CH₂CH₂C(CH₃)₃ | —CH₂CHCH₃— | CH₃ | CN |
| CH₂CH₂CH₂CH(CH₃)₂ | —CH₂CHCH₃— | CH₃ | CN |
| CH₂CH₂CH₂Si(CH₃)₂(C₂H₅) | —CH₂CHCH₃— | CH₃ | CN |
| CH₂CH₂CH₂Si(CH₃)₃ | —CH₂CH═CHCH₂— | CH₃ | CN |
| CH₂CH₂CH₂C(CH₃)₃ | —CH₂CH═CHCH₂— | CH₃ | CN |
| CH₂CH₂CH₂CH(CH₃)₂ | —CH₂CH═CHCH₂— | CH₃ | CN |
| CH₂CH₂CH₂Si(CH₃)₂(C₂H₅) | —CH₂CH═CHCH₂— | CH₃ | CN |
| CH₂CH₂CH₂Si(CH₃)₃ | —CH₂SCH₂CH₂— | CH₃ | CN |
| CH₂CH₂CH₂C(CH₃)₃ | —CH₂SCH₂CH₂— | CH₃ | CN |
| CH₂CH₂CH₂C(CH₃)₂ | —CH₂SCH₂CH₂— | CH₃ | CN |
| CH₂CH₂CH₂Si(CH₃)₂(C₂H₅) | —CH₂SCH₂CH₂— | CH₃ | CN |
| CH₂CH₂CH₂Si(CH₃)₃ | —CH₂CH₂CH₂CH₂— | CH₃ | CHO |
| CH₂CH₂CH₂C(CH₃)₃ | —CH₂CH₂CH₂CH₂— | CH₃ | CHO |
| CH₂CH₂CH₂CH(CH₃)₂ | —CH₂CH₂CH₂CH₂— | CH₃ | CHO |
| CH₂CH₂CH₂Si(CH₃)₂(C₂H₅) | —CH₂CH₂CH₂CH₂— | CH₃ | CHO |
| CH₂CH₂CH₂Si(CH₃)₃ | —CH₂CH₂CH₂— | CH₃ | CHO |
| CH₂CH₂CH₂C(CH₃)₃ | —CH₂CH₂CH₂— | CH₃ | CHO |
| CH₂CH₂CH₂CH(CH₃)₃ | —CH₂CH₂CH₂— | CH₃ | CHO |
| CH₂CH₂CH₂Si(CH₃)₂(C₂H₅) | —CH₂CH₂CH₂— | CH₃ | CHO |
| CH₂CH₂CH₂Si(CH₃)₃ | —CH₂CHCH₃— | CH₃ | CHO |
| CH₂CH₂CH₂C(CH₃)₃ | —CH₂CHCH₃— | CH₃ | CHO |
| CH₂CH₂CH₂CH(CH₃)₂ | —CH₂CHCH₃— | CH₃ | CHO |
| CH₂CH₂CH₂Si(CH₃)₂(C₂H₅) | —CH₂CHCH₃— | CH₃ | CHO |
| CH₂CH₂CH₂Si(CH₃)₃ | —CH₂CH═CHCH₂— | CH₃ | CHO |
| CH₂CH₂CH₂C(CH₃)₃ | —CH₂CH═CHCH₂— | CH₃ | CHO |
| CH₂CH₂CH₂CH(CH₃)₂ | —CH₂CH═CHCH₂— | CH₃ | CHO |
| CH₂CH₂CH₂Si(CH₃)₂(C₂H₅) | —CH₂CH═CHCH₂— | CH₃ | CHO |
| CH₂CH₂CH₂Si(CH₃)₃ | —CH₂SCH₂CH₂— | CH₃ | CHO |
| CH₂CH₂CH₂C(CH₃)₃ | —CH₂SCH₂CH₂— | CH₃ | CHO |
| CH₂CH₂CH₂CH(CH₃)₂ | —CH₂SCH₂CH₂— | CH₃ | CHO |
| CH₂CH₂CH₂Si(CH₃)₂(C₂H₅) | —CH₂SCH₂CH₂— | CH₃ | CHO |
| CH₂CH₂CH₂Si(CH₃)₃ | —CH₂CH₂CH₂CH₂— | CH₂Br | Cl |
| CH₂CH₂CH₂C(CH₃)₃ | —CH₂CH₂CH₂CH₂— | CH₂Br | Cl |
| CH₂CH₂CH₂CH(CH₃)₂ | —CH₂CH₂CH₂CH₂— | CH₂Br | Cl |
| CH₂CH₂CH₂Si(CH₃)₂(C₂H₅) | —CH₂CH₂CH₂CH₂— | CH₂Br | Cl |
| CH₂CH₂CH₂Si(CH₃)₃ | —CH₂CH₂CH₂— | CH₂Br | Cl |
| CH₂CH₂CH₂C(CH₃)₃ | —CH₂CH₂CH₂— | CH₂Br | Cl |
| CH₂CH₂CH₂CH(CH₃)₂ | —CH₂CH₂CH₂— | CH₂Br | Cl |
| CH₂CH₂CH₂Si(CH₃)₂(C₂H₅) | —CH₂CH₂CH₂— | CH₂Br | Cl |
| CH₂CH₂CH₂Si(CH₃)₃ | —CH₂CHCH3— | CH₂Br | Cl |
| CH₂CH₂CH₂C(CH₃)₃ | —CH₂CHCH₃— | CH₂Br | Cl |
| CH₂CH₂CH₂CH(CH₃)₂ | —CH₂CHCH₃— | CH₂Br | Cl |
| CH₂CH₂CH₂Si(CH₃)₂(C₂H₅) | —CH₂CHCH₃— | CH₂Br | Cl |
| CH₂CH₂CH₂Si(CH₃)₃ | —CH₂CH═CHCH₂— | CH₂Br | Cl |
| CH₂CH₂CH₂C(CH₃)₃ | —CH₂CH═CHCH₂— | CH₂Br | Cl |
| CH₂CH₂CH₂CH(CH₃)₂ | —CH₂CH═CHCH₂— | CH₂Br | Cl |
| CH₂CH₂CH₂Si(CH₃)₂(C₂H₅) | —CH₂CH═CHCH₂— | CH₂Br | Cl |
| CH₂CH₂CH₂Si(CH₃)₃ | —CH₂SCH₂CH₂— | CH₂Br | Cl |
| CH₂CH₂CH₂C(CH₃)₃ | —CH₂SCH₂CH₂— | CH₂Br | Cl |
| CH₂CH₂CH₂CH(CH₃)₂ | —CH₂SCH₂CH₂— | CH₂Br | Cl |
| CH₂CH₂CH₂Si(CH₃)₂(C₂H₅) | —CH₂SCH₂CH₂— | CH₂Br | Cl |

TABLE 12

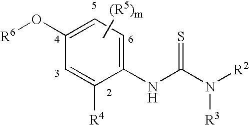

| R⁶ | R² | R³ | R⁴ | R⁵ | m |
|---|---|---|---|---|---|
| CH₂CH₂CH₂Si(CH₃)₃ | CH₃ | CH₃ | CH₃ | 5-CH₃ | 1 |
| CH₂CH₂CH₂C(CH₃)₃ | CH₃ | CH₃ | CH₃ | 5-CH₃ | 1 |
| CH₂CH₂CH₂CH(CH₃)₂ | CH₃ | CH₃ | CH₃ | 5-CH₃ | 1 |
| CH₂CH₂CH₂Si(CH₃)₃ | CH₃ | C₂H₅ | CH₃ | 5-CH₃ | 1 |
| CH₂CH₂CH₂C(CH₃)₃ | CH₃ | C₂H₅ | CH₃ | 5-CH₃ | 1 |
| CH₂CH₂CH₂CH(CH₃)₂ | CH₃ | C₂H₅ | CH₃ | 5-CH₃ | 1 |
| CH₂CH₂CH₂Si(CH₃)₃ | CH₃ | i-Pr | CH₃ | 5-CH₃ | 1 |
| CH₂CH₂CH₂C(CH₃)₃ | CH₃ | i-Pr | CH₃ | 5-CH₃ | 1 |
| CH₂CH₂CH₂CH(CH₃)₂ | CH₃ | i-Pr | CH₃ | 5-CH₃ | 1 |
| CH₂CH₂CH₂Si(CH₃)₃ | CH₃ | c-Pr | CH₃ | 5-CH₃ | 1 |
| CH₂CH₂CH₂C(CH₃)₃ | CH₃ | c-Pr | CH₃ | 5-CH₃ | 1 |
| CH₂CH₂CH₂CH(CH₃)₂ | CH₃ | c-Pr | CH₃ | 5-CH₃ | 1 |
| CH₂CH₂CH₂Si(CH₃)₃ | CH₃ | n-Pr | CH₃ | 5-CH₃ | 1 |
| CH₂CH₂CH₂C(CH₃)₃ | CH₃ | n-Pr | CH₃ | 5-CH₃ | 1 |
| CH₂CH₂CH₂CH(CH₃)₂ | CH₃ | n-Pr | CH₃ | 5-CH₃ | 1 |
| CH₂CH₂CH₂Si(CH₃)₃ | CH₃ | n-Bu | CH₃ | 5-CH₃ | 1 |
| CH₂CH₂CH₂C(CH₃)₃ | CH₃ | n-Bu | CH₃ | 5-CH₃ | 1 |
| CH₂CH₂CH₂CH(CH₃)₂ | CH₃ | n-Bu | CH₃ | 5-CH₃ | 1 |
| CH₂CH₂CH₂Si(CH₃)₃ | CH₃ | CH₂CH═CH₂ | CH₃ | 5-CH₃ | 1 |
| CH₂CH₂CH₂C(CH₃)₃ | CH₃ | CH₂CH═CH₂ | CH₃ | 5-CH₃ | 1 |
| CH₂CH₂CH₂CH(CH₃)₂ | CH₃ | CH₂CH═CH₂ | CH₃ | 5-CH₃ | 1 |
| CH₂CH₂CH₂Si(CH₃)₃ | C₂H₅ | C₂H₅ | CH₃ | 5-CH₃ | 1 |
| CH₂CH₂CH₂C(CH₃)₃ | C₂H₅ | C₂H₅ | CH₃ | 5-CH₃ | 1 |
| CH₂CH₂CH₂CH(CH₃)₂ | C₂H₅ | C₂H₅ | CH₃ | 5-CH₃ | 1 |
| CH₂CH₂CH₂Si(CH₃)₃ | CH₃ | CH₃ | CH₃ | 5-Cl | 1 |
| CH₂CH₂CH₂C(CH₃)₃ | CH₃ | CH₃ | CH₃ | 5-Cl | 1 |
| CH₂CH₂CH₂CH(CH₃)₂ | CH₃ | CH₃ | CH₃ | 5-Cl | 1 |
| CH₂CH₂CH₂Si(CH₃)₃ | CH₃ | C₂H₅ | CH₃ | 5-Cl | 1 |
| CH₂CH₂CH₂C(CH₃)₃ | CH₃ | C₂H₅ | CH₃ | 5-Cl | 1 |
| CH₂CH₂CH₂CH(CH₃)₂ | CH₃ | C₂H₅ | CH₃ | 5-Cl | 1 |
| CH₂CH₂CH₂Si(CH₃)₃ | CH₃ | i-Pr | CH₃ | 5-Cl | 1 |
| CH₂CH₂CH₂C(CH₃)₃ | CH₃ | i-Pr | CH₃ | 5-Cl | 1 |
| CH₂CH₂CH₂CH(CH₃)₂ | CH₃ | i-Pr | CH₃ | 5-Cl | 1 |
| CH₂CH₂CH₂Si(CH₃)₃ | CH₃ | c-Pr | CH₃ | 5-Cl | 1 |
| CH₂CH₂CH₂C(CH₃)₃ | CH₃ | c-Pr | CH₃ | 5-Cl | 1 |
| CH₂CH₂CH₂CH(CH₃)₂ | CH₃ | c-Pr | CH₃ | 5-Cl | 1 |
| CH₂CH₂CH₂Si(CH₃)₃ | CH₃ | n-Pr | CH₃ | 5-Cl | 1 |
| CH₂CH₂CH₂C(CH₃)₃ | CH₃ | n-Pr | CH₃ | 5-Cl | 1 |
| CH₂CH₂CH₂CH(CH₃)₂ | CH₃ | n-Pr | CH₃ | 5-Cl | 1 |
| CH₂CH₂CH₂Si(CH₃)₃ | CH₃ | n-Bu | CH₃ | 5-Cl | 1 |
| CH₂CH₂CH₂C(CH₃)₃ | CH₃ | n-Bu | CH₃ | 5-Cl | 1 |
| CH₂CH₂CH₂CH(CH₃)₂ | CH₃ | n-Bu | CH₃ | 5-Cl | 1 |
| CH₂CH₂CH₂Si(CH₃)₃ | CH₃ | CH₂CH═CH₂ | CH₃ | 5-Cl | 1 |
| CH₂CH₂CH₂C(CH₃)₃ | CH₃ | CH₂CH═CH₂ | CH₃ | 5-Cl | 1 |
| CH₂CH₂CH₂CH(CH₃)₂ | CH₃ | CH₂CH═CH₂ | CH₃ | 5-Cl | 1 |
| CH₂CH₂CH₂Si(CH₃)₃ | C₂H₅ | C₂H₅ | CH₃ | 5-Cl | 1 |
| CH₂CH₂CH₂C(CH₃)₃ | C₂H₅ | C₂H₅ | CH₃ | 5-Cl | 1 |
| CH₂CH₂CH₂CH(CH₃)₂ | C₂H₅ | C₂H₅ | CH₃ | 5-Cl | 1 |
| CH₂CH₂CH₂Si(CH₃)₃ | CH₃ | CH₃ | OCH₃ | 5-Cl | 1 |
| CH₂CH₂CH₂C(CH₃)₃ | CH₃ | CH₃ | OCH₃ | 5-Cl | 1 |
| CH₂CH₂CH₂CH(CH₃)₂ | CH₃ | CH₃ | OCH₃ | 5-Cl | 1 |
| CH₂CH₂CH₂Si(CH₃)₃ | CH₃ | C₂H₅ | OCH₃ | 5-Cl | 1 |
| CH₂CH₂CH₂C(CH₃)₃ | CH₃ | C₂H₅ | OCH₃ | 5-Cl | 1 |
| CH₂CH₂CH₂CH(CH₃)₂ | CH₃ | C₂H₅ | OCH₃ | 5-Cl | 1 |
| CH₂CH₂CH₂Si(CH₃)₃ | CH₃ | i-Pr | OCH₃ | 5-Cl | 1 |
| CH₂CH₂CH₂C(CH₃)₃ | CH₃ | i-Pr | OCH₃ | 5-Cl | 1 |
| CH₂CH₂CH₂CH(CH₃)₂ | CH₃ | i-Pr | OCH₃ | 5-Cl | 1 |
| CH₂CH₂CH₂Si(CH₃)₃ | CH₃ | c-Pr | OCH₃ | 5-Cl | 1 |
| CH₂CH₂CH₂C(CH₃)₃ | CH₃ | c-Pr | OCH₃ | 5-Cl | 1 |
| CH₂CH₂CH₂CH(CH₃)₂ | CH₃ | c-Pr | OCH₃ | 5-Cl | 1 |
| CH₂CH₂CH₂Si(CH₃)₃ | CH₃ | n-Pr | OCH₃ | 5-Cl | 1 |
| CH₂CH₂CH₂C(CH₃)₃ | CH₃ | n-Pr | OCH₃ | 5-Cl | 1 |
| CH₂CH₂CH₂CH(CH₃)₂ | CH₃ | n-Pr | OCH₃ | 5-Cl | 1 |
| CH₂CH₂CH₂Si(CH₃)₃ | CH₃ | n-Bu | OCH₃ | 5-Cl | 1 |
| CH₂CH₂CH₂C(CH₃)₃ | CH₃ | n-Bu | OCH₃ | 5-Cl | 1 |
| CH₂CH₂CH₂CH(CH₃)₂ | CH₃ | n-Bu | OCH₃ | 5-Cl | 1 |
| CH₂CH₂CH₂Si(CH₃)₃ | CH₃ | CH₂CH═CH₂ | OCH₃ | 5-Cl | 1 |
| CH₂CH₂CH₂C(CH₃)₃ | CH₃ | CH₂CH═CH₂ | OCH₃ | 5-Cl | 1 |
| CH₂CH₂CH₂CH(CH₃)₂ | CH₃ | CH₂CH═CH₂ | OCH₃ | 5-Cl | 1 |
| CH₂CH₂CH₂Si(CH₃)₃ | C₂H₅ | C₂H₅ | OCH₃ | 5-Cl | 1 |
| CH₂CH₂CH₂C(CH₃)₃ | C₂H₅ | C₂H₅ | OCH₃ | 5-Cl | 1 |
| CH₂CH₂CH₂CH(CH₃)₂ | C₂H₅ | C₂H₅ | OCH₃ | 5-Cl | 1 |
| CH₂CH₂CH₂Si(CH₃)₃ | CH₃ | CH₃ | OC₂H₅ | 5-Cl | 1 |
| CH₂CH₂CH₂C(CH₃)₃ | CH₃ | CH₃ | OC₂H₅ | 5-Cl | 1 |
| CH₂CH₂CH₂CH(CH₃)₂ | CH₃ | CH₃ | OC₂H₅ | 5-Cl | 1 |
| CH₂CH₂CH₂Si(CH₃)₃ | CH₃ | C₂H₅ | OC₂H₅ | 5-Cl | 1 |
| CH₂CH₂CH₂C(CH₃)₃ | CH₃ | C₂H₅ | OC₂H₅ | 5-Cl | 1 |
| CH₂CH₂CH₂CH(CH₃)₂ | CH₃ | C₂H₅ | OC₂H₅ | 5-Cl | 1 |
| CH₂CH₂CH₂Si(CH₃)₃ | CH₃ | i-Pr | OC₂H₅ | 5-Cl | 1 |
| CH₂CH₂CH₂C(CH₃)₃ | CH₃ | i-Pr | OC₂H₅ | 5-Cl | 1 |
| CH₂CH₂CH₂CH(CH₃)₂ | CH₃ | i-Pr | OC₂H₅ | 5-Cl | 1 |
| CH₂CH₂CH₂Si(CH₃)₃ | CH₃ | c-Pr | OC₂H₅ | 5-Cl | 1 |
| CH₂CH₂CH₂C(CH₃)₃ | CH₃ | c-Pr | OC₂H₅ | 5-Cl | 1 |
| CH₂CH₂CH₂CH(CH₃)₂ | CH₃ | c-Pr | OC₂H₅ | 5-Cl | 1 |
| CH₂CH₂CH₂Si(CH₃)₃ | CH₃ | n-Pr | OC₂H₅ | 5-Cl | 1 |
| CH₂CH₂CH₂C(CH₃)₃ | CH₃ | n-Pr | OC₂H₅ | 5-Cl | 1 |
| CH₂CH₂CH₂CH(CH₃)₂ | CH₃ | n-Pr | OC₂H₅ | 5-Cl | 1 |
| CH₂CH₂CH₂Si(CH₃)₃ | CH₃ | n-Bu | OC₂H₅ | 5-Cl | 1 |
| CH₂CH₂CH₂C(CH₃)₃ | CH₃ | n-Bu | OC₂H₅ | 5-Cl | 1 |
| CH₂CH₂CH₂CH(CH₃)₂ | CH₃ | n-Bu | OC₂H₅ | 5-Cl | 1 |
| CH₂CH₂CH₂Si(CH₃)₃ | CH₃ | CH₂CH═CH₂ | OC₂H₅ | 5-Cl | 1 |
| CH₂CH₂CH₂C(CH₃)₃ | CH₃ | CH₂CH═CH₂ | OC₂H₅ | 5-Cl | 1 |
| CH₂CH₂CH₂CH(CH₃)₂ | CH₃ | CH₂CH═CH₂ | OC₂H₅ | 5-Cl | 1 |
| CH₂CH₂CH₂Si(CH₃)₃ | C₂H₅ | C₂H₅ | OC₂H₅ | 5-Cl | 1 |
| CH₂CH₂CH₂C(CH₃)₃ | C₂H₅ | C₂H₅ | OC₂H₅ | 5-Cl | 1 |
| CH₂CH₂CH₂CH(CH₃)₂ | C₂H₅ | C₂H₅ | OC₂H₅ | 5-Cl | 1 |
| CH₂CH₂CH₂Si(CH₃)₃ | CH₃ | CH₃ | SCH₃ | 5-Cl | 1 |
| CH₂CH₂CH₂C(CH₃)₃ | CH₃ | CH₃ | SCH₃ | 5-Cl | 1 |
| CH₂CH₂CH₂CH(CH₃)₂ | CH₃ | CH₃ | SCH₃ | 5-Cl | 1 |
| CH₂CH₂CH₂Si(CH₃)₃ | CH₃ | C₂H₅ | SCH₃ | 5-Cl | 1 |
| CH₂CH₂CH₂C(CH₃)₃ | CH₃ | C₂H₅ | SCH₃ | 5-Cl | 1 |
| CH₂CH₂CH₂CH(CH₃)₂ | CH₃ | C₂H₅ | SCH₃ | 5-Cl | 1 |
| CH₂CH₂CH₂Si(CH₃)₃ | CH₃ | i-Pr | SCH₃ | 5-Cl | 1 |
| CH₂CH₂CH₂C(CH₃)₃ | CH₃ | i-Pr | SCH₃ | 5-Cl | 1 |
| CH₂CH₂CH₂CH(CH₃)₂ | CH₃ | i-Pr | SCH₃ | 5-Cl | 1 |
| CH₂CH₂CH₂Si(CH₃)₃ | CH₃ | c-Pr | SCH₃ | 5-Cl | 1 |
| CH₂CH₂CH₂C(CH₃)₃ | CH₃ | c-Pr | SCH₃ | 5-Cl | 1 |
| CH₂CH₂CH₂CH(CH₃)₂ | CH₃ | c-Pr | SCH₃ | 5-Cl | 1 |
| CH₂CH₂CH₂Si(CH₃)₃ | CH₃ | n-Pr | SCH₃ | 5-Cl | 1 |
| CH₂CH₂CH₂C(CH₃)₃ | CH₃ | n-Pr | SCH₃ | 5-Cl | 1 |
| CH₂CH₂CH₂CH(CH₃)₂ | CH₃ | n-Pr | SCH₃ | 5-Cl | 1 |
| CH₂CH₂CH₂Si(CH₃)₃ | CH₃ | n-Bu | SCH₃ | 5-Cl | 1 |
| CH₂CH₂CH₂C(CH₃)₃ | CH₃ | n-Bu | SCH₃ | 5-Cl | 1 |
| CH₂CH₂CH₂CH(CH₃)₂ | CH₃ | n-Bu | SCH₃ | 5-Cl | 1 |
| CH₂CH₂CH₂Si(CH₃)₃ | CH₃ | CH₂CH═CH₂ | SCH₃ | 5-Cl | 1 |
| CH₂CH₂CH₂C(CH₃)₃ | CH₃ | CH₂CH═CH₂ | SCH₃ | 5-Cl | 1 |
| CH₂CH₂CH₂CH(CH₃)₂ | CH₃ | CH₂CH═CH₂ | SCH₃ | 5-Cl | 1 |
| CH₂CH₂CH₂Si(CH₃)₃ | C₂H₅ | C₂H₅ | SCH₃ | 5-Cl | 1 |
| CH₂CH₂CH₂C(CH₃)₃ | C₂H₅ | C₂H₅ | SCH₃ | 5-Cl | 1 |
| CH₂CH₂CH₂CH(CH₃)₂ | C₂H₅ | C₂H₅ | SCH₃ | 5-Cl | 1 |
| CH₂CH₂CH₂Si(CH₃)₃ | CH₃ | CH₃ | SC₂H₅ | 5-Cl | 1 |
| CH₂CH₂CH₂C(CH₃)₃ | CH₃ | CH₃ | SC₂H₅ | 5-Cl | 1 |
| CH₂CH₂CH₂CH(CH₃)₂ | CH₃ | CH₃ | SC₂H₅ | 5-Cl | 1 |
| CH₂CH₂CH₂Si(CH₃)₃ | CH₃ | C₂H₅ | SC₂H₅ | 5-Cl | 1 |
| CH₂CH₂CH₂C(CH₃)₃ | CH₃ | C₂H₅ | SC₂H₅ | 5-Cl | 1 |
| CH₂CH₂CH₂CH(CH₃)₂ | CH₃ | C₂H₅ | SC₂H₅ | 5-Cl | 1 |
| CH₂CH₂CH₂Si(CH₃)₃ | CH₃ | i-Pr | SC₂H₅ | 5-Cl | 1 |
| CH₂CH₂CH₂C(CH₃)₃ | CH₃ | i-Pr | SC₂H₅ | 5-Cl | 1 |
| CH₂CH₂CH₂CH(CH₃)₂ | CH₃ | i-Pr | SC₂H₅ | 5-Cl | 1 |
| CH₂CH₂CH₂Si(CH₃)₃ | CH₃ | c-Pr | SC₂H₅ | 5-Cl | 1 |
| CH₂CH₂CH₂C(CH₃)₃ | CH₃ | c-Pr | SC₂H₅ | 5-Cl | 1 |
| CH₂CH₂CH₂CH(CH₃)₂ | CH₃ | c-Pr | SC₂H₅ | 5-Cl | 1 |
| CH₂CH₂CH₂Si(CH₃)₃ | CH₃ | n-Pr | SC₂H₅ | 5-Cl | 1 |
| CH₂CH₂CH₂C(CH₃)₃ | CH₃ | n-Pr | SC₂H₅ | 5-Cl | 1 |
| CH₂CH₂CH₂CH(CH₃)₂ | CH₃ | n-Pr | SC₂H₅ | 5-Cl | 1 |
| CH₂CH₂CH₂Si(CH₃)₃ | CH₃ | n-Bu | SC₂H₅ | 5-Cl | 1 |
| CH₂CH₂CH₂C(CH₃)₃ | CH₃ | n-Bu | SC₂H₅ | 5-Cl | 1 |
| CH₂CH₂CH₂CH(CH₃)₂ | CH₃ | n-Bu | SC₂H₅ | 5-Cl | 1 |
| CH₂CH₂CH₂Si(CH₃)₃ | CH₃ | CH₂CH═CH₂ | SC₂H₅ | 5-Cl | 1 |
| CH₂CH₂CH₂C(CH₃)₃ | CH₃ | CH₂CH═CH₂ | SC₂H₅ | 5-Cl | 1 |
| CH₂CH₂CH₂CH(CH₃)₂ | CH₃ | CH₂CH═CH₂ | SC₂H₅ | 5-Cl | 1 |
| CH₂CH₂CH₂Si(CH₃)₃ | C₂H₅ | C₂H₅ | SC₂H₅ | 5-Cl | 1 |
| CH₂CH₂CH₂C(CH₃)₃ | C₂H₅ | C₂H₅ | SC₂H₅ | 5-Cl | 1 |
| CH₂CH₂CH₂CH(CH₃)₂ | C₂H₅ | C₂H₅ | SC₂H₅ | 5-Cl | 1 |
| CH₂CH₂CH₂Si(CH₃)₃ | CH₃ | CH₃ | OCH₃ | 5-F | 1 |
| CH₂CH₂CH₂C(CH₃)₃ | CH₃ | CH₃ | OCH₃ | 5-F | 1 |
| CH₂CH₂CH₂CH(CH₃)₂ | CH₃ | CH₃ | OCH₃ | 5-F | 1 |
| CH₂CH₂CH₂Si(CH₃)₃ | CH₃ | C₂H₅ | OCH₃ | 5-F | 1 |
| CH₂CH₂CH₂C(CH₃)₃ | CH₃ | C₂H₅ | OCH₃ | 5-F | 1 |
| CH₂CH₂CH₂CH(CH₃)₂ | CH₃ | C₂H₅ | OCH₃ | 5-F | 1 |
| CH₂CH₂CH₂Si(CH₃)₃ | CH₃ | i-Pr | OCH₃ | 5-F | 1 |
| CH₂CH₂CH₂C(CH₃)₃ | CH₃ | i-Pr | OCH₃ | 5-F | 1 |
| CH₂CH₂CH₂CH(CH₃)₂ | CH₃ | i-Pr | OCH₃ | 5-F | 1 |
| CH₂CH₂CH₂Si(CH₃)₃ | CH₃ | c-Pr | OCH₃ | 5-F | 1 |
| CH₂CH₂CH₂C(CH₃)₃ | CH₃ | c-Pr | OCH₃ | 5-F | 1 |
| CH₂CH₂CH₂CH(CH₃)₂ | CH₃ | c-Pr | OCH₃ | 5-F | 1 |
| CH₂CH₂CH₂Si(CH₃)₃ | CH₃ | n-Pr | OCH₃ | 5-F | 1 |
| CH₂CH₂CH₂C(CH₃)₃ | CH₃ | n-Pr | OCH₃ | 5-F | 1 |
| CH₂CH₂CH₂CH(CH₃)₂ | CH₃ | n-Pr | OCH₃ | 5-F | 1 |
| CH₂CH₂CH₂Si(CH₃)₃ | CH₃ | n-Bu | OCH₃ | 5-F | 1 |
| CH₂CH₂CH₂C(CH₃)₃ | CH₃ | n-Bu | OCH₃ | 5-F | 1 |
| CH₂CH₂CH₂CH(CH₃)₂ | CH₃ | n-Bu | OCH₃ | 5-F | 1 |
| CH₂CH₂CH₂Si(CH₃)₃ | CH₃ | CH₂CH═CH₂ | OCH₃ | 5-F | 1 |
| CH₂CH₂CH₂C(CH₃)₃ | CH₃ | CH₂CH═CH₂ | OCH₃ | 5-F | 1 |
| CH₂CH₂CH₂CH(CH₃)₂ | CH₃ | CH₂CH═CH₂ | OCH₃ | 5-F | 1 |
| CH₂CH₂CH₂Si(CH₃)₃ | C₂H₅ | C₂H₅ | OCH₃ | 5-F | 1 |
| CH₂CH₂CH₂C(CH₃)₃ | C₂H₅ | C₂H₅ | OCH₃ | 5-F | 1 |
| CH₂CH₂CH₂CH(CH₃)₂ | C₂H₅ | C₂H₅ | OCH₃ | 5-F | 1 |
| CH₂CH₂CH₂Si(CH₃)₃ | CH₃ | CH₃ | OC₂H₅ | 5-F | 1 |
| CH₂CH₂CH₂C(CH₃)₃ | CH₃ | CH₃ | OC₂H₅ | 5-F | 1 |
| CH₂CH₂CH₂CH(CH₃)₂ | CH₃ | CH₃ | OC₂H₅ | 5-F | 1 |
| CH₂CH₂CH₂Si(CH₃)₃ | CH₃ | C₂H₅ | OC₂H₅ | 5-F | 1 |
| CH₂CH₂CH₂C(CH₃)₃ | CH₃ | C₂H₅ | OC₂H₅ | 5-F | 1 |
| CH₂CH₂CH₂CH(CH₃)₂ | CH₃ | C₂H₅ | OC₂H₅ | 5-F | 1 |
| CH₂CH₂CH₂Si(CH₃)₃ | CH₃ | i-Pr | OC₂H₅ | 5-F | 1 |
| CH₂CH₂CH₂C(CH₃)₃ | CH₃ | i-Pr | OC₂H₅ | 5-F | 1 |
| CH₂CH₂CH₂CH(CH₃)₂ | CH₃ | i-Pr | OC₂H₅ | 5-F | 1 |
| CH₂CH₂CH₂Si(CH₃)₃ | CH₃ | c-Pr | OC₂H₅ | 5-F | 1 |
| CH₂CH₂CH₂C(CH₃)₃ | CH₃ | c-Pr | OC₂H₅ | 5-F | 1 |
| CH₂CH₂CH₂CH(CH₃)₂ | CH₃ | c-Pr | OC₂H₅ | 5-F | 1 |
| CH₂CH₂CH₂Si(CH₃)₃ | CH₃ | n-Pr | OC₂H₅ | 5-F | 1 |
| CH₂CH₂CH₂C(CH₃)₃ | CH₃ | n-Pr | OC₂H₅ | 5-F | 1 |
| CH₂CH₂CH₂CH(CH₃)₂ | CH₃ | n-Pr | OC₂H₅ | 5-F | 1 |
| CH₂CH₂CH₂Si(CH₃)₃ | CH₃ | n-Bu | OC₂H₅ | 5-F | 1 |
| CH₂CH₂CH₂C(CH₃)₃ | CH₃ | n-Bu | OC₂H₅ | 5-F | 1 |
| CH₂CH₂CH₂CH(CH₃)₂ | CH₃ | n-Bu | OC₂H₅ | 5-F | 1 |
| CH₂CH₂CH₂Si(CH₃)₃ | CH₃ | CH₂CH═CH₂ | OC₂H₅ | 5-F | 1 |
| CH₂CH₂CH₂C(CH₃)₃ | CH₃ | CH₂CH═CH₂ | OC₂H₅ | 5-F | 1 |
| CH₂CH₂CH₂CH(CH₃)₂ | CH₃ | CH₂CH═CH₂ | OC₂H₅ | 5-F | 1 |
| CH₂CH₂CH₂Si(CH₃)₃ | C₂H₅ | C₂H₅ | OC₂H₅ | 5-F | 1 |
| CH₂CH₂CH₂C(CH₃)₃ | C₂H₅ | C₂H₅ | OC₂H₅ | 5-F | 1 |
| CH₂CH₂CH₂CH(CH₃)₂ | C₂H₅ | C₂H₅ | OC₂H₅ | 5-F | 1 |
| CH₂CH₂CH₂Si(CH₃)₃ | CH₃ | CH₃ | SCH₃ | 5-F | 1 |
| CH₂CH₂CH₂C(CH₃)₃ | CH₃ | CH₃ | SCH₃ | 5-F | 1 |
| CH₂CH₂CH₂CH(CH₃)₂ | CH₃ | CH₃ | SCH₃ | 5-F | 1 |
| CH₂CH₂CH₂Si(CH₃)₃ | CH₃ | C₂H₅ | SCH₃ | 5-F | 1 |
| CH₂CH₂CH₂C(CH₃)₃ | CH₃ | C₂H₅ | SCH₃ | 5-F | 1 |
| CH₂CH₂CH₂CH(CH₃)₂ | CH₃ | C₂H₅ | SCH₃ | 5-F | 1 |
| CH₂CH₂CH₂Si(CH₃)₃ | CH₃ | i-Pr | SCH₃ | 5-F | 1 |
| CH₂CH₂CH₂C(CH₃)₃ | CH₃ | i-Pr | SCH₃ | 5-F | 1 |
| CH₂CH₂CH₂CH(CH₃)₂ | CH₃ | i-Pr | SCH₃ | 5-F | 1 |
| CH₂CH₂CH₂Si(CH₃)₃ | CH₃ | c-Pr | SCH₃ | 5-F | 1 |
| CH₂CH₂CH₂C(CH₃)₃ | CH₃ | c-Pr | SCH₃ | 5-F | 1 |
| CH₂CH₂CH₂CH(CH₃)₂ | CH₃ | c-Pr | SCH₃ | 5-F | 1 |
| CH₂CH₂CH₂Si(CH₃)₃ | CH₃ | n-Pr | SCH₃ | 5-F | 1 |
| CH₂CH₂CH₂C(CH₃)₃ | CH₃ | n-Pr | SCH₃ | 5-F | 1 |
| CH₂CH₂CH₂CH(CH₃)₂ | CH₃ | n-Pr | SCH₃ | 5-F | 1 |
| CH₂CH₂CH₂Si(CH₃)₃ | CH₃ | n-Bu | SCH₃ | 5-F | 1 |
| CH₂CH₂CH₂C(CH₃)₃ | CH₃ | n-Bu | SCH₃ | 5-F | 1 |
| CH₂CH₂CH₂CH(CH₃)₂ | CH₃ | n-Bu | SCH₃ | 5-F | 1 |
| CH₂CH₂CH₂Si(CH₃)₃ | CH₃ | CH₂CH═CH₂ | SCH₃ | 5-F | 1 |
| CH₂CH₂CH₂C(CH₃)₃ | CH₃ | CH₂CH═CH₂ | SCH₃ | 5-F | 1 |
| CH₂CH₂CH₂CH(CH₃)₂ | CH₃ | CH₂CH═CH₂ | SCH₃ | 5-F | 1 |
| CH₂CH₂CH₂Si(CH₃)₃ | C₂H₅ | C₂H₅ | SCH₃ | 5-F | 1 |
| CH₂CH₂CH₂C(CH₃)₃ | C₂H₅ | C₂H₅ | SCH₃ | 5-F | 1 |
| CH₂CH₂CH₂CH(CH₃)₂ | C₂H₅ | C₂H₅ | SCH₃ | 5-F | 1 |
| CH₂CH₂CH₂Si(CH₃)₃ | CH₃ | CH₃ | SC₂H₅ | 5-F | 1 |
| CH₂CH₂CH₂C(CH₃)₃ | CH₃ | CH₃ | SC₂H₅ | 5-F | 1 |
| CH₂CH₂CH₂CH(CH₃)₂ | CH₃ | CH₃ | SC₂H₅ | 5-F | 1 |
| CH₂CH₂CH₂Si(CH₃)₃ | CH₃ | C₂H₅ | SC₂H₅ | 5-F | 1 |
| CH₂CH₂CH₂C(CH₃)₃ | CH₃ | C₂H₅ | SC₂H₅ | 5-F | 1 |
| CH₂CH₂CH₂CH(CH₃)₂ | CH₃ | C₂H₅ | SC₂H₅ | 5-F | 1 |
| CH₂CH₂CH₂Si(CH₃)₃ | CH₃ | i-Pr | SC₂H₅ | 5-F | 1 |
| CH₂CH₂CH₂C(CH₃)₃ | CH₃ | i-Pr | SC₂H₅ | 5-F | 1 |
| CH₂CH₂CH₂CH(CH₃)₂ | CH₃ | i-Pr | SC₂H₅ | 5-F | 1 |
| CH₂CH₂CH₂Si(CH₃)₃ | CH₃ | c-Pr | SC₂H₅ | 5-F | 1 |
| CH₂CH₂CH₂C(CH₃)₃ | CH₃ | c-Pr | SC₂H₅ | 5-F | 1 |
| CH₂CH₂CH₂CH(CH₃)₂ | CH₃ | c-Pr | SC₂H₅ | 5-F | 1 |
| CH₂CH₂CH₂Si(CH₃)₃ | CH₃ | n-Pr | SC₂H₅ | 5-F | 1 |
| CH₂CH₂CH₂C(CH₃)₃ | CH₃ | n-Pr | SC₂H₅ | 5-F | 1 |
| CH₂CH₂CH₂CH(CH₃)₂ | CH₃ | n-Pr | SC₂H₅ | 5-F | 1 |
| CH₂CH₂CH₂Si(CH₃)₃ | CH₃ | n-Bu | SC₂H₅ | 5-F | 1 |
| CH₂CH₂CH₂C(CH₃)₃ | CH₃ | n-Bu | SC₂H₅ | 5-F | 1 |
| CH₂CH₂CH₂CH(CH₃)₂ | CH₃ | n-Bu | SC₂H₅ | 5-F | 1 |
| CH₂CH₂CH₂Si(CH₃)₃ | CH₃ | CH₂CH═CH₂ | SC₂H₅ | 5-F | 1 |
| CH₂CH₂CH₂C(CH₃)₃ | CH₃ | CH₂CH═CH₂ | SC₂H₅ | 5-F | 1 |
| CH₂CH₂CH₂CH(CH₃)₂ | CH₃ | CH₂CH═CH₂ | SC₂H₅ | 5-F | 1 |
| CH₂CH₂CH₂Si(CH₃)₃ | C₂H₅ | C₂H₅ | SC₂H₅ | 5-F | 1 |
| CH₂CH₂CH₂C(CH₃)₃ | C₂H₅ | C₂H₅ | SC₂H₅ | 5-F | 1 |
| CH₂CH₂CH₂CH(CH₃)₂ | C₂H₅ | C₂H₅ | SC₂H₅ | 5-F | 1 |
| CH₂CH₂CH₂Si(CH₃)₃ | CH₃ | CH₃ | Cl | 5-Cl | 1 |
| CH₂CH₂CH₂C(CH₃)₃ | CH₃ | CH₃ | Cl | 5-Cl | 1 |
| CH₂CH₂CH₂CH(CH₃)₂ | CH₃ | CH₃ | Cl | 5-Cl | 1 |
| CH₂CH₂CH₂Si(CH₃)₃ | CH₃ | C₂H₅ | Cl | 5-Cl | 1 |
| CH₂CH₂CH₂C(CH₃)₃ | CH₃ | C₂H₅ | Cl | 5-Cl | 1 |
| CH₂CH₂CH₂CH(CH₃)₂ | CH₃ | C₂H₅ | Cl | 5-Cl | 1 |
| CH₂CH₂CH₂Si(CH₃)₃ | CH₃ | i-Pr | Cl | 5-Cl | 1 |
| CH₂CH₂CH₂C(CH₃)₃ | CH₃ | i-Pr | Cl | 5-Cl | 1 |
| CH₂CH₂CH₂CH(CH₃)₂ | CH₃ | i-Pr | Cl | 5-Cl | 1 |
| CH₂CH₂CH₂Si(CH₃)₃ | CH₃ | c-Pr | Cl | 5-Cl | 1 |
| CH₂CH₂CH₂C(CH₃)₃ | CH₃ | c-Pr | Cl | 5-Cl | 1 |
| CH₂CH₂CH₂CH(CH₃)₂ | CH₃ | c-Pr | Cl | 5-Cl | 1 |
| CH₂CH₂CH₂Si(CH₃)₃ | CH₃ | n-Pr | Cl | 5-Cl | 1 |
| CH₂CH₂CH₂C(CH₃)₃ | CH₃ | n-Pr | Cl | 5-Cl | 1 |
| CH₂CH₂CH₂CH(CH₃)₂ | CH₃ | n-Pr | Cl | 5-Cl | 1 |
| CH₂CH₂CH₂Si(CH₃)₃ | CH₃ | n-Bu | Cl | 5-Cl | 1 |
| CH₂CH₂CH₂C(CH₃)₃ | CH₃ | n-Bu | Cl | 5-Cl | 1 |
| CH₂CH₂CH₂CH(CH₃)₂ | CH₃ | n-Bu | Cl | 5-Cl | 1 |
| CH₂CH₂CH₂Si(CH₃)₃ | CH₃ | CH₂CH═CH₂ | Cl | 5-Cl | 1 |
| CH₂CH₂CH₂C(CH₃)₃ | CH₃ | CH₂CH═CH₂ | Cl | 5-Cl | 1 |
| CH₂CH₂CH₂CH(CH₃)₂ | CH₃ | CH₂CH═CH₂ | Cl | 5-Cl | 1 |
| CH₂CH₂CH₂Si(CH₃)₃ | C₂H₅ | C₂H₅ | Cl | 5-Cl | 1 |
| CH₂CH₂CH₂C(CH₃)₃ | C₂H₅ | C₂H₅ | Cl | 5-Cl | 1 |
| CH₂CH₂CH₂CH(CH₃)₂ | C₂H₅ | C₂H₅ | C | 5-Cl | 1 |
| CH₂CH₂CH₂Si(CH₃)₃ | CH₃ | CH₃ | CH₃ | 3,5-di-Cl | 2 |
| CH₂CH₂CH₂C(CH₃)₃ | CH₃ | CH₃ | CH₃ | 3,5-di-Cl | 2 |
| CH₂CH₂CH₂CH(CH₃)₂ | CH₃ | CH₃ | CH₃ | 3,5-di-Cl | 2 |
| CH₂CH₂CH₂Si(CH₃)₃ | CH₃ | C₂H₅ | CH₃ | 3,5-di-Cl | 2 |
| CH₂CH₂CH₂C(CH₃)₃ | CH₃ | C₂H₅ | CH₃ | 3,5-di-Cl | 2 |
| CH₂CH₂CH₂CH(CH₃)₂ | CH₃ | C₂H₅ | CH₃ | 3,5-di-Cl | 2 |
| CH₂CH₂CH₂Si(CH₃)₃ | CH₃ | i-Pr | CH₃ | 3,5-di-Cl | 2 |
| CH₂CH₂CH₂C(CH₃)₃ | CH₃ | i-Pr | CH₃ | 3,5-di-Cl | 2 |
| CH₂CH₂CH₂CH(CH₃)₂ | CH₃ | i-Pr | CH₃ | 3,5-di-Cl | 2 |
| CH₂CH₂CH₂Si(CH₃)₃ | CH₃ | c-Pr | CH₃ | 3,5-di-Cl | 2 |
| CH₂CH₂CH₂C(CH₃)₃ | CH₃ | c-Pr | CH₃ | 3,5-di-Cl | 2 |
| CH₂CH₂CH₂CH(CH₃)₂ | CH₃ | c-Pr | CH₃ | 3,5-di-Cl | 2 |
| CH₂CH₂CH₂Si(CH₃)₃ | CH₃ | n-Pr | CH₃ | 3,5-di-Cl | 2 |
| CH₂CH₂CH₂C(CH₃)₃ | CH₃ | n-Pr | CH₃ | 3,5-di-Cl | 2 |
| CH₂CH₂CH₂CH(CH₃)₂ | CH₃ | n-Pr | CH₃ | 3,5-di-Cl | 2 |
| CH₂CH₂CH₂Si(CH₃)₃ | CH₃ | n-Bu | CH₃ | 3,5-di-Cl | 2 |
| CH₂CH₂CH₂C(CH₃)₃ | CH₃ | n-Bu | CH₃ | 3,5-di-Cl | 2 |
| CH₂CH₂CH₂CH(CH₃)₂ | CH₃ | n-Bu | CH₃ | 3,5-di-Cl | 2 |
| CH₂CH₂CH₂Si(CH₃)₃ | CH₃ | CH₂CH═CH₂ | CH₃ | 3,5-di-Cl | 2 |
| CH₂CH₂CH₂C(CH₃)₃ | CH₃ | CH₂CH═CH₂ | CH₃ | 3,5-di-Cl | 2 |
| CH₂CH₂CH₂CH(CH₃)₂ | CH₃ | CH₂CH═CH₂ | CH₃ | 3,5-di-Cl | 2 |
| CH₂CH₂CH₂Si(CH₃)₃ | C₂H₅ | C₂H₅ | CH₃ | 3,5-di-Cl | 2 |
| CH₂CH₂CH₂C(CH₃)₃ | C₂H₅ | C₂H₅ | CH₃ | 3,5-di-Cl | 2 |
| CH₂CH₂CH₂CH(CH₃)₂ | C₂H₅ | C₂H₅ | CH₃ | 3,5-di-Cl | 2 |
| CH₂CH₂CH₂Si(CH₃)₃ | CH₃ | CH₃ | CH₃ | 3-Cl-5-CH₃ | 2 |
| CH₂CH₂CH₂C(CH₃)₃ | CH₃ | CH₃ | CH₃ | 3-Cl-5-CH₃ | 2 |
| CH₂CH₂CH₂CH(CH₃)₂ | CH₃ | CH₃ | CH₃ | 3-Cl-5-CH₃ | 2 |
| CH₂CH₂CH₂Si(CH₃)₃ | CH₃ | C₂H₅ | CH₃ | 3-Cl-5-CH₃ | 2 |
| CH₂CH₂CH₂C(CH₃)₃ | CH₃ | C₂H₅ | CH₃ | 3-Cl-5-CH₃ | 2 |
| CH₂CH₂CH₂CH(CH₃)₂ | CH₃ | C₂H₅ | CH₃ | 3-Cl-5-CH₃ | 2 |
| CH₂CH₂CH₂Si(CH₃)₃ | CH₃ | i-Pr | CH₃ | 3-Cl-5-CH₃ | 2 |
| CH₂CH₂CH₂C(CH₃)₃ | CH₃ | i-Pr | CH₃ | 3-Cl-5-CH₃ | 2 |
| CH₂CH₂CH₂CH(CH₃)₂ | CH₃ | i-Pr | CH₃ | 3-Cl-5-CH₃ | 2 |
| CH₂CH₂CH₂Si(CH₃)₃ | CH₃ | c-Pr | CH₃ | 3-Cl-5-CH₃ | 2 |
| CH₂CH₂CH₂C(CH₃)₃ | CH₃ | c-Pr | CH₃ | 3-Cl-5-CH₃ | 2 |
| CH₂CH₂CH₂CH(CH₃)₂ | CH₃ | c-Pr | CH₃ | 3-Cl-5-CH₃ | 2 |
| CH₂CH₂CH₂Si(CH₃)₃ | CH₃ | n-Pr | CH₃ | 3-Cl-5-CH₃ | 2 |
| CH₂CH₂CH₂C(CH₃)₃ | CH₃ | n-Pr | CH₃ | 3-Cl-5-CH₃ | 2 |
| CH₂CH₂CH₂CH(CH₃)₂ | CH₃ | n-Pr | CH₃ | 3-Cl-5-CH₃ | 2 |
| CH₂CH₂CH₂Si(CH₃)₃ | CH₃ | n-Bu | CH₃ | 3-Cl-5-CH₃ | 2 |
| CH₂CH₂CH₂C(CH₃)₃ | CH₃ | n-Bu | CH₃ | 3-Cl-5-CH₃ | 2 |
| CH₂CH₂CH₂CH(CH₃)₂ | CH₃ | n-Bu | CH₃ | 3-Cl-5-CH₃ | 2 |
| CH₂CH₂CH₂Si(CH₃)₃ | CH₃ | CH₂CH═CH₂ | CH₃ | 3-Cl-5-CH₃ | 2 |
| CH₂CH₂CH₂C(CH₃)₃ | CH₃ | CH₂CH═CH₂ | CH₃ | 3-Cl-5-CH₃ | 2 |
| CH₂CH₂CH₂CH(CH₃)₂ | CH₃ | CH₂CH═CH₂ | CH₃ | 3-Cl-5-CH₃ | 2 |
| CH₂CH₂CH₂Si(CH₃)₃ | C₂H₅ | C₂H₅ | CH₃ | 3-Cl-5-CH₃ | 2 |
| CH₂CH₂CH₂C(CH₃)₃ | C₂H₅ | C₂H₅ | CH₃ | 3-Cl-5-CH₃ | 2 |
| CH₂CH₂CH₂CH(CH₃)₂ | C₂H₅ | C₂H₅ | CH₃ | 3-Cl-5-CH₃ | 2 |
| CH₂CH₂CH₂Si(CH₃)₃ | CH₃ | CH₃ | Cl | 3,5-di-Cl | 2 |
| CH₂CH₂CH₂C(CH₃)₃ | CH₃ | CH₃ | Cl | 3,5-di-Cl | 2 |
| CH₂CH₂CH₂CH(CH₃)₂ | CH₃ | CH₃ | Cl | 3,5-di-Cl | 2 |
| CH₂CH₂CH₂Si(CH₃)₃ | CH₃ | C₂H₅ | Cl | 3,5-di-Cl | 2 |
| CH₂CH₂CH₂C(CH₃)₃ | CH₃ | C₂H₅ | Cl | 3,5-di-Cl | 2 |
| CH₂CH₂CH₂CH(CH₃)₂ | CH₃ | C₂H₅ | Cl | 3,5-di-Cl | 2 |
| CH₂CH₂CH₂Si(CH₃)₃ | CH₃ | i-Pr | Cl | 3,5-di-Cl | 2 |
| CH₂CH₂CH₂C(CH₃)₃ | CH₃ | i-Pr | Cl | 3,5-di-Cl | 2 |
| CH₂CH₂CH₂CH(CH₃)₂ | CH₃ | i-Pr | Cl | 3,5-di-Cl | 2 |
| CH₂CH₂CH₂Si(CH₃)₃ | CH₃ | c-Pr | Cl | 3,5-di-Cl | 2 |
| CH₂CH₂CH₂C(CH₃)₃ | CH₃ | c-Pr | Cl | 3,5-di-Cl | 2 |
| CH₂CH₂CH₂CH(CH₃)₂ | CH₃ | c-Pr | Cl | 3,5-di-Cl | 2 |
| CH₂CH₂CH₂Si(CH₃)₃ | CH₃ | n-Pr | Cl | 3,5-di-Cl | 2 |
| CH₂CH₂CH₂C(CH₃)₃ | CH₃ | n-Pr | Cl | 3,5-di-Cl | 2 |
| CH₂CH₂CH₂CH(CH₃)₃ | CH₃ | n-Pr | Cl | 3,5-di-Cl | 2 |
| CH₂CH₂CH₂Si(CH₃)₃ | CH₃ | n-Bu | Cl | 3,5-di-Cl | 2 |
| CH₂CH₂CH₂C(CH₃)₃ | CH₃ | n-Bu | Cl | 3,5-di-Cl | 2 |
| CH₂CH₂CH₂CH(CH₃)₂ | CH₃ | n-Bu | Cl | 3,5-di-Cl | 2 |
| CH₂CH₂CH₂Si(CH₃)₃ | CH₃ | CH₂CH═CH₂ | Cl | 3,5-di-Cl | 2 |
| CH₂CH₂CH₂C(CH₃)₃ | CH₃ | CH₂CH═CH₂ | Cl | 3,5-di-Cl | 2 |
| CH₂CH₂CH₂CH(CH₃)₂ | CH₃ | CH₂CH═CH₂ | Cl | 3,5-di-Cl | 2 |
| CH₂CH₂CH₂Si(CH₃)₃ | C₂H₅ | C₂H₅ | Cl | 3,5-di-Cl | 2 |
| CH₂CH₂CH₂C(CH₃)₃ | C₂H₅ | C₂H₅ | Cl | 3,5-di-Cl | 2 |
| CH₂CH₂CH₂CH(CH₃)₂ | C₂H₅ | C₂H₅ | Cl | 3,5-di-Cl | 2 |

TABLE 13

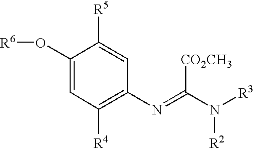

| R⁶ | R² | R³ | R⁴ | R⁵ |
|---|---|---|---|---|
| CH₂CH₂CH₂Si(CH₃)₃ | CH₃ | CH₃ | CH₃ | CH₃ |
| CH₂CH₂CH₂C(CH₃)₃ | CH₃ | CH₃ | CH₃ | CH₃ |
| CH₂CH₂CH₂CH(CH₃)₂ | CH₃ | CH₃ | CH₃ | CH₃ |
| CH₂CH₂CH₂Si(CH₃)₂(C₂H₅) | CH₃ | CH₃ | CH₃ | CH₃ |
| CH₂CH₂CH₂Si(CH₃)₃ | CH₃ | C₂H₅ | CH₃ | CH₃ |
| CH₂CH₂CH₂C(CH₃)₃ | CH₃ | C₂H₅ | CH₃ | CH₃ |
| CH₂CH₂CH₂CH(CH₃)₂ | CH₃ | C₂H₅ | CH₃ | CH₃ |
| CH₂CH₂CH₂Si(CH₃)₂(C₂H₅) | CH₃ | C₂H₅ | CH₃ | CH₃ |
| CH₂CH₂CH₂Si(CH₃)₃ | CH₃ | CH₃ | CH₃ | Cl |
| CH₂CH₂CH₂C(CH₃)₃ | CH₃ | CH₃ | CH₃ | Cl |
| CH₂CH₂CH₂CH(CH₃)₂ | CH₃ | CH₃ | CH₃ | Cl |
| CH₂CH₂CH₂Si(CH₃)₂(C₂H₅) | CH₃ | CH₃ | CH₃ | Cl |
| CH₂CH₂CH₂Si(CH₃)₃ | CH₃ | C₂H₅ | CH₃ | Cl |
| CH₂CH₂C(CH₃)₃ | CH₃ | C₂H₅ | CH₃ | Cl |
| CH₂CH₂CH₂CH(CH₃)₂ | CH₃ | C₂H₅ | CH₃ | Cl |
| CH₂CH₂CH₂Si(CH₃)₂(C₂H₅) | CH₃ | C₂H₅ | CH₃ | Cl |
| CH₂CH₂CH₂Si(CH₃)₃C₂H₅ | C₂H₅ | CH₃ | Cl | |
| CH₂CH₂CH₂C(CH₃)₃C₂H₅ | C₂H₅ | CH₃ | Cl | |
| CH₂CH₂CH₂CH(CH₃)₂ | C₂H₅ | C₂H₅ | CH₃ | Cl |
| CH₂CH₂CH₂Si(CH₃)₂(C₂H₅₎ | C₂H₅ | C₂H₅ | CH₃ | Cl |
| CH₂CH₂CH₂Si(CH₃)₃ | CH₃ | CH₂CH═CH₂ | CH₃ | Cl |
| CH₂CH₂CH₂C(CH₃)₃ | CH₃ | CH₂CH═CH₂ | CH₃ | Cl |
| CH₂CH₂CH₂CH(CH₃)₂ | CH₃ | CH₂CH═CH₂ | CH₃ | Cl |
| CH₂CH₂CH₂Si(CH₃)₂(C₂H₅) | CH₃ | CH₂CH═CH₂ | CH₃ | Cl |
| CH₂CH₂CH₂Si(CH₃)₃ | CH₃ | CH₂C═CH | CH₃ | Cl |
| CH₂CH₂CH₂C(CH₃)₃ | CH₃ | CH₂C═CH | CH₃ | Cl |
| CH₂CH₂CH₂CH(CH₃)₂ | CH₃ | CH₂C═CH | CH₃ | Cl |
| CH₂CH₂CH₂Si(CH₃)₂(C₂H₅) | CH₃ | CH₂C═CH | CH₃ | Cl |
| CH₂CH₂CH₂Si(CH₃)₃ | CH₃ | CH₂CH₂F | CH₃ | Cl |
| CH₂CH₂CH₂C(CH₃)₃ | CH₃ | CH₂CH₂F | CH₃ | Cl |

Formulation/Utility

Compounds of this invention will generally be used as a formulation or composition with an agriculturally suitable carrier comprising at least one of a liquid diluent, a solid diluent or a surfactant. Accordingly, compositions are provided which comprise, in addition to a fungicidally effective amount of the active compound(s), at least one additional component selected from the group consisting surfactants, solid diluents and liquid diluents. The formulation or composition ingredients are selected to be consistent with the physical properties of the active ingredient, mode of application and environmental factors such as soil type, moisture and temperature. Useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and/or surfactant within the following approximate ranges which add up to 100 percent by weight.

| | Weight Percent | | |
|---|---|---|---|
| | Active | | |
| | Ingredient | Diluent | Surfactant |
| Water-Dispersible and | 5-90 | 0-94 | 1-15 |
| Water-soluble Granules, | | | |
| Tablets and Powders. | | | |
| Suspensions, Emulsions, | 5-50 | 40-95 | 0-15 |
| Solutions (including | | | |
| Emulsifiable Concentrates) | | | |
| Dusts | 1-25 | 70-99 | 0-5 |
| Granules and Pellets | 0.01-99 | 5-99.99 | 0-15 |
| High Strength Compositions | 90-99 | 0-10 | 0-2 |

Typical solid diluents are described in Watkins, et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon 's Detergents and Emulsifiers Annual, Allured Publ. Corp., Ridgewood, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, polyethoxylated alcohols, polyethoxylated alkylphenols, polyethoxylated sorbitan fatty acid esters, dialkyl sulfosuccinates, alkyl sulfates, alkylbenzene sulfonates, organosilicones, N,N-dialkyltaurates, lignin sulfonates, naphthalene sulfonate formaldehyde condensates, polycarboxylates, and polyoxyethylene/polyoxypropylene block copolymers. Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp 14748, Perry's Chemical Engineer's Handbook, 4th Ed., McGraw-Hill, New York, 1963, pages 8-57 and following, and WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 1041; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 14; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

In the following Examples, all percentages are by weight and all formulations are prepared in conventional ways. Compound numbers refer to compounds in Index Table A.

### EXAMPLE A

Wettable Powder

| | |
|---|---|
| Compound 13 | 65.0% |
| dodecylphenol polyethylene glycol ether | 2.0% |
| sodium ligninsulfonate | 4.0% |
| sodium silicoaluminate | 6.0% |
| montmorillonite (calcined) | 23.0%. |

### EXAMPLE B

Granule

| | |
|---|---|
| Compound 13 | 10.0% |
| attapulgite granules (low volatile matter, | 90.0%. |
| 0.71/0.30 mm; U.S.S. No. 25-50 sieves) | |

### EXAMPLE C

Extruded Pellet

| | |
|---|---|
| Compound 13 | 25.0% |
| anhydrous sodium sulfate | 10.0% |
| crude calcium ligninsulfonate | 5.0% |
| sodium alkylnaphthalenesulfonate | 1.0% |
| calcium/magnesium bentonite | 59.0%. |

### EXAMPLE D

Emulsifiable Concentrate

| | |
|---|---|
| Compound 13 | 20.0% |
| blend of oil soluble sulfonates | 10.0% |
| and polyoxyethylene ethers | |
| isophorone | 70.0%. |

The compounds of this invention are useful as plant disease control agents. The present invention therefore further comprises a method for controlling plant diseases caused by fungal plant pathogens comprising applying to the plant or portion thereof to be protected, or to the plant seed or seedling to be protected, an effective amount of a compound of the invention or a fungicidal composition containing said compound. The compounds and compositions of this invention provide control of diseases caused by a broad spectrum of fungal plant pathogens in the Basidiomycete, Ascomycete, Oomycete and Deuteromycete classes. They are effective in controlling a broad spectrum of plant diseases, particularly foliar pathogens of ornamental, vegetable, field, cereal, and fruit crops. These pathogens include Plasmopara viticola, Phytophthora infestans, Peronospora tabacina, Pseudoperonospora cubensis, Pythium aphanidermatum, Alternaria brassicae, Septoria nodorum, Septoria tritici, Cercosporidium personatum, Cercospora arachidicola, Pseudocercosporella herpotrichoides, Cercospora beticola, Botrytis cinerea, Monilinia fructicola, Pyricularia oryzae, Podosphaera leucotricha, Venturia inaequalis, Erysiphe graminis, Uncinula necatur, Puccinia recondita, Puccinia graminis, Hemileia vastatrix, Puccinia striiformis, Puccinia arachidis, Rhizoctonia solani, Sphaerotheca fuliginea, Fusarium oxysporum, Verticillium dahliae, Pythium aphanidermatum, Phytophthora megasperma, Sclerotinia scierotiorum, Sclerotium rolfsii, Erysiphepolygon, Pyrenophora teres, Gaeumannomyces graminis, Rynchosporium secalis, Fusarium roseum, Bremia lactucae and other generea and species closely related to these pathogens.

Compounds of this invention can also be mixed with one or more other insecticides, fungicides, nematocides, bactericides, acaricides, growth regulators, chemosterilants, semiochemicals, repellents, attractants, pheromones, feeding stimulants or other biologically active compounds to form a multi-component pesticide giving an even broader spectrum of agricultural protection. Examples of such agricultural protectants with which compounds of this invention can be formulated are: insecticides such as abamectin, acephate, azinphos-methyl, bifenthrin, buprofezin, carbofuran, chlorfenapyr, chlorpyrifos, chlorpyrifos-methyl, cyfluthrin, beta-cyfluthrin, cyhalothrin, lambda-cyhalothrin, deltamethrin, diafenthiuron, diazinon, diflubenzuron, dimethoate, esfenvalerate, fenoxycarb, fenpropathrin, fenvalerate, fipronil, flucythrinate, tau-fluvalinate, fonophos, imidacloprid, indoxacarb, isofenphos, malathion, metaldehyde, methamidophos, methidathion, methomyl, methoprene, methoxychlor, monocrotophos, oxamyl, parathion, parathion-methyl, permethrin, phorate, phosalone, phosmet, phosphamidon, pirimicarb, profenofos, rotenone, sulprofos, tebufenozide, tefluthrin, terbufos, tetrachlorvinphos, thiodicarb, tralomethrin, trichlorfon and triflumuron; fungicides such as acibenzolar, azoxystrobin, binomial, blasticidin-S, Bordeaux mixture (Tribasic copper sulfate), boscalid/nicobifen, bromuconazole, buthiobate, carpropamidii (KTU 3616), captafol, captan, carbendazim, chloroneb, chlorothalonil, clotrimazole, copper oxychloride, copper salts, cymoxanil, cyproconazole, cyprodinil (CGA 219417), (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin (SSF-126), diniconazole, diniconazole-M, dodine, econazole, edifenphos, epoxiconazole (BAS 480F), famoxadone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), fluquinconazole, flusilazole, flutolanil, flutriafol, folpet, fosetyl-aluminum, furalaxyl, furametapyr (S-82658), hexaconazole, imazalil, 6-iodo-3-propyl-2-propyloxy-4(3H)-quinazolinone, ipconazole, iprobenfos, iprodione, isoconazole, isoprothiolane, kasugamycin, kresoxim-methyl, mancozeb, maneb, mefenoxam, mepronil, metalaxyl, metconazole, metominostrobin/fenominostrobin (SSF-126), miconazole, myclobutanil, neo-asozin (ferric methanearsonate), nuarimol, oxadixyl, penconazole, pencycuron, picoxystrobin, probenazole, prochloraz, propamocarb, propiconazole, pyraclostrobin, pyrifenox, pyrimethanil, prochloraz, pyrifenox, pyroquilon, quinoxyfen, spiroxamine, sulfur, tebuconazole, tetraconazole, thiabendazole, thifluzamide, thiophanate-methyl, thiram, triadimefon, triadimenol, triarimol, tricyclazole, trifloxystrobin, triforine, triticonazole, uniconazole, validamycin and vinclozolin; nematocides such as aldoxycarb and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents such as Bacillus thuringiensis, Bacillus thuringiensis delta endotoxin, baculovirus, and entomopathogenic bacteria, virus and fungi. The weight ratios of these various mixing partners to compounds of this invention typically are between 100:1 and 1:100, preferably between 30:1 and 1:30, more preferably between 10:1 and 1:10, and most preferably between 4:1 and 1:4.

Compounds such as Compound 1 of this invention are considered to inhibit C24 transmethylase in the ergosterol biosynthesis pathway. In certain instances, combinations with other fungicides having a similar spectrum of control but a different mode of action will be particularly advantageous for resistance management (especially if the other fungicide also has a similar spectrum of control). Examples of other fungicides having different mode of actions include compounds acting at the bc₁ complex of the fungal mitochondrial respiratory electron transfer site, compounds acting at the demethylase enzyme of the sterol biosynthesis pathway, morpholine and piperidine compounds that act on the sterol biosynthesis pathway and pyrimidinone fungicides.

The bc₁ Complex Fungicides

Strobilurin fungicides such as azoxystrobin, kresoxim-methyl, metominostrobin/fenominostrobin (SSF-126), picoxystrobin, pyraclostrobin and trifloxystrobin are known to have a fungicidal mode of action which inhibits the bc₁ complex in the mitochondrial respiration chain (Angew. Chem. Int. Ed., 1999, 38, 1328-1349). Methyl (E)-2-[[6-(2-cyanophenoxy)-4-pyrimidinyl]oxy]-α-(methoxyimino)benzeneacetate (also known as azoxystrobin) is described as a bc₁ complex inhibitor in Biochemical Society Transactions 1993, 22, 68S. Methyl (E)-α-(methoxyimino)-2-[(2-methylphenoxy)methyl]benzeneacetate (also known as kresoxim-methyl) is described as a bc₁ complex inhibitor in Biochemical Society Transactions 1993, 22, 64S. (E)-2-[(2,5-Dimethylphenoxy)methyl]-α-(methoxyimino)-N-methylbenzeneacetamide is described as a bc₁ complex inhibitor in Biochemistry and Cell Biology 1995, 85(3), 306-311. Other compounds that inhibit the bc₁ complex in the mitochondrial respiration chain include famoxadone and fenamidone.

The bc₁ complex is sometimes referred to by other names in the biochemical literature, including complex III of the electron transfer chain, and ubihydroquinone:cytochrome c oxidoreductase. It is uniquely identified by the Enzyme Commission number EC 1.10.2.2. The bc₁ complex is described in, for example, J. Biol. Chem. 1989, 264, 14543-38; Methods Enzymol. 1986, 126, 253-71; and references cited therein.

The Sterol Biosynthesis Inhibitor Fungicides

The class of sterol biosynthesis inhibitors includes DMI and non-DMI compounds, that control fungi by inhibiting enzymes in the sterol biosynthesis pathway. DMI fungicides have a common site of action within the fungal sterol biosynthesis pathway; that is, an inhibition of demethylation at position 14 of lanosterol or 24-methylene dihydrolanosterol, which are precursors to sterols in fingi. Compounds acting at this site are often referred to as demethylase inhibitors, DMI fungicides, or DMIs. The demethylase enzyme is sometimes referred to by other names in the biochemical literature, including cytochrome P-450 (14DM). The demethylase enzyme is described in, for example, J. Biol. Chem. 1992, 267, 13175-79 and references cited therein. DMI fungicides fall into several classes: azoles (including triazoles and imidazoles), pyrimidines, piperazines and pyridines. The triazoles includes bromuconazole, cyproconazole, difenoconazole, diniconazole, epoxiconazole, fenbuconazole, fluquinconazole, flusilazole, flutriafol, hexaconazole, ipconazole, metconazole, penconazole, propiconazole, tebuconazole, tetraconazole, triadimefon, triadimenol, triticonazole and uniconazole. The imidazoles include clotrimazole, econazole, imazalil, isoconazole, miconazole and prochloraz. The pyrimidines include fenarimol, nuarimol and triarimol. The piperazines include triforine. The pyridines include buthiobate and pyrifenox. Biochemical investigations have shown that all of the above mentioned fungicides are DMI fungicides as described by K. H. Kuck, et al. in Modern Selective Fungicides—Properties, Applications and Mechanisms of Action, Lyr, H., Ed.; Gustav Fischer Verlag: New York, 1995, 205-258.

The DMI fungicides have been grouped together to distinguish them from other sterol biosynthesis inhibitors, such as the morpholine and piperidine fungicides. The morpholines and piperidines are also sterol biosynthesis inhibitors but have been shown to inhibit other steps in the sterol biosynthesis pathway. The morpholines include aldimorph, dodemorph, fenpropimorph, tridemorph and trimorphamide. The piperidines include fenpropidin. Biochemical investigations have shown that all of the above mentioned morpholine and piperidine fungicides are sterol biosynthesis inhibitor fungicides as described by K. H. Kuck, et al. in Modern Selective Fungicides—Properties, Applications and Mechanisms of Action, Lyr, H., Ed.; Gustav Fischer Verlag: New York, 1995, 185-204.

Pyrimidinone Fungicides

Pyrimidinone fungicides include compounds of Formula II 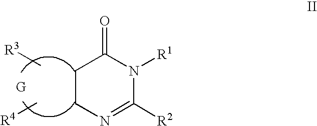
wherein
G is a fused phenyl, thiophene or pyridine ring;
R¹ is C₁-C₆ alkyl;
R² is C₁-C₆ alkyl or C₁-C₆ alkoxy;
R³ is halogen; and

R⁴ is hydrogen or halogen.

Pyrimidinone fungicides are described in International Patent Application WO94/26722, U.S. Pat. No. 6,066,638, U.S. Pat. No. 6,245,770, U.S. Pat. No. 6,262,058 and U.S. Pat. No. 6,277,858.

Of note are pyrimidinone fungicides selected from the group:
6-bromo-3-propyl-2-propyloxy-4(3H)quinazolinone,
6,8-diiodo-3-propyl-2-propyloxy-4(3H)-quinazolinone,
6-iodo-3-propyl-2-propyloxy-4(3H)-quinazolinone,
6-chloro-2-propoxy-3-propylthieno[2,3-d]pyrimidin-4(3H)-one,
6-bromo-2-propoxy-3-propylthieno[2,3-d]pyrimidin-4(3H)-one,
7-bromo-2-propoxy-3-propylthieno[3,2-d]pyrimidin-4(3H)-one,
6-bromo-2-propoxy-3-propylpyrido[2,3-d]pyrimidin-4(3H)-one,
6,7-dibromo-2-propoxy-3-propylthieno[3,2-d]pyrimidin-4(3H)-one, and
3-(cyclopropylmethyl)-6-iodo-2-(propylthio)pyrido[2,3-d]pyrimidin-4(3H)-one.

Of note are combinations of compounds of Formula I (e.g. Compound 13) with azoxystrobin, kesoxim-methyl, trifloxystrobin, pyraclostrobin, picoxystrobin, dimoxystrobin (SSF-129), metominostrobin/fenominostrobin (SSF-126), carbendazim, chlorothalonil, quinoxyfen, metrafenone, cyflufenamid, fenpropidine, fenpropimorph, bromuconazole, cyproconazole, difenoconazole, epoxiconazole, fenbuconazole, flusilazole, hexaconazole, ipconazole, metconazole, penconazole, propiconazole, proquinazid, tebuconazole, triticonazole, prochloraz, boscalid/nicobifen.

Preferred for better control of plant diseases caused by fungal plant pathogens (e.g., lower use rate or broader spectrum of plant pathogens controlled) or resistance management are mixtures of a compound of this invention with a fungicide selected from the group: azoxystrobin, kesoxim-methyl, trifloxystrobin, pyraclostrobin, picoxystrobin, dimoxystrobin (SSF-129), metominostrobin/fenominostrobin (SSF-126), quinoxyfen, metrafenone, cyflufenamid, fenpropidine, fenpropimorph, cyproconazole, epoxiconazole, flusilazole, metconazole, propiconazole, proquinazid, tebuconazole, triticonazole.

Specifically preferred mixtures (compound numbers refer to compounds in Index Tables A) are selected from the group: combinations of Compound 11, Compounds 13, Compound 17 or Compound 27 with azoxystrobin, combinations of Compound 11, Compound 13, Compound 17 or Compound 27 with kesoxim-methyl, combinations of Compound 11, Compound 13, Compound 17 or Compound 27 with trifloxystrobin, combinations of Compound 11, Compound 13, Compound 17 or Compound 27 with pyraclostrobin, combinations of Compound 11, Compound 13, Compound 17 or Compound 27 with picoxystrobin, combinations of Compound 11, Compound 13, Compound 17 or Compound 27 with dimoxystrobin (SSF-129), combinations of Compound 11, Compound 13, Compound 17 or Compound 27 with metominostrobin/fenominostrobin (SSF-126), combinations of Compound 11, Compound 13, Compound 17 or Compound 27 with quinoxyfen, combinations of Compound 11, Compound 13, Compound 17 or Compound 27 with metrafenone, combinations of Compound 11, Compound 13, Compound 17 or Compound 27 with cyflufenamid, combinations of Compound 11, Compound 13, Compound 17 or Compound 27 with fenpropidine, combinations of Compound 11, Compound 13, Compound 17 or Compound 27 with fenpropimorph, combinations of Compound 11, Compound 13, Compound 17 or Compound 27 with cyproconazole, combinations of Compound 11, Compound 13, Compound 17 or Compound 27 with epoxiconazole, combinations of Compound 11, Compound 13, Compound 17 or Compound 27 with flusilazole, combinations of Compound 11, Compound 13, Compound 17 or Compound 27 with metconazole, combinations of Compound 11, Compound 13, Compound 17 or Compound 27 with propiconazole, combinations of Compound 11, Compound 13, Compound 17 or Compound 27 with proquinazid, combinations of Compound 11, Compound 13, Compound 17 or Compound 27 with tebuconazole, combinations of Compound 11, Compound 13, Compound 17 or Compound 27 with triticonazole.

Also specifically preferred mixtures (compound numbers refer to compounds in Index Tables B) are selected from the group: combinations of Compound 54 with azoxystrobin, combinations of Compound 54 with kesoxim-methyl, combinations of Compound 54 with trifloxystrobin, combinations of Compound 54 with pyraclostrobin, combinations of Compound 54 with picoxystrobin, combinations of Compound 54 with dimoxystrobin (SSF-129), combinations of Compound 54 with metominostrobin/fenominostrobin (SSF-126), combinations of Compound 54 with quinoxyfen, combinations of Compound 54 with metrafenone, combinations of Compound 54 with cyflufenamid, combinations of Compound 54 with fenpropidine, combinations of Compound 54 with fenpropimorph, combinations of Compound 54 with cyproconazole, combinations of Compound 54 with epoxiconazole, combinations of Compound 54 with flusilazole, combinations of Compound 54 with metconazole, combinations of Compound 54 with propiconazole, combinations of Compound 54 with proquinazid, combinations of Compound 54 with tebuconazole, combinations of Compound 54 with triticonazole.

Plant disease control is ordinarily accomplished by applying an effective amount of a compound of this invention either pre- or post-infection, to the portion of the plant to be protected such as the roots, stems, foliage, fruit, seeds, tubers or bulbs, or to the media (soil or sand) in which the plants to be protected are growing. The compounds can also be applied to the seed to protect the seed and seedling.

Rates of application for these compounds can be influenced by many factors of the environment and should be determined under actual use conditions. Foliage can normally be protected when treated at a rate of from less than 1 g/ha to 5,000 g/ha of active ingredient. Seed and seedlings can normally be protected when seed is treated at a rate of from 0.1 to 10 g per kilogram of seed.

The following TESTS demonstrate the control efficacy of compounds of this invention on specific pathogens. The pathogen control protection afforded by the compounds is not limited, however, to these species. See Index Tables A-E for compound descriptions. The following abbreviations are used in the Index Tables which follow: t means tertiary, s means secondary, n means normal, i means iso, c means cyclo, Pr means propyl, i-Pr means isopropyl, c-Pr means cyclopropyl, Bu means butyl, CN means cyano, and “Ex.” stands for “Example” and is followed by a number indicating in which example the compound is prepared.

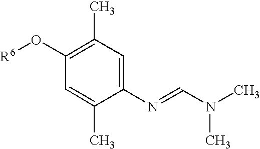

INDEX TABLE A

| Compound | R⁶ | m.p. (° C.) |
|---|---|---|
| 1 (Ex. 1) | CH₂CH═C(CH₃)₂ | * |
| 2 | CH₂CH═C(CH₃)(CH₂)₂CH═C(CH₃)₂ | * |
| 3 | CH₂(CH═C(CH₃)(CH₂)₂)₂CH═C(CH₃)₂ | * |
| 4 | CH₂C(═O)C(CH₃)₃ | * |
| 5 | (CH₂)₄CH═CH₂ | * |
| 6 | (CH₂)₃CH═CH₂ | * |
| 7 | (CH₂)₄C(OCH₃)₃ | |
| 8 | (CH₂)₂CH(CH₃)₂ | * |
| 9 | (CH₂)₃C(═CH₂)CH(CH₃)₂ | * |
| 10 | (CH₂)₂CH(CH₃)(CH₂)₃CH(CH₃)₂ | |
| 11 | (CH₂)₂CH(CH₃)CH₂C(CH₃)₃ | * |
| 12 | (CH₂)₂C(CH₃)₃ | |
| 13 (Ex. 2) | (CH₂)₃CH(CH₃)₂ | * |
| 14 | (S)-(CH₂)₂CH(CH₃)CH₂CH₂CH═C(CH₃)₂ | |
| 15 | (R)-(CH₂)₂CH(CH₃)CH₂CH₂CH═C(CH₃)₂ | * |
| 16 | (CH₂)₃CH₂Cl | * |
| 17 | (CH₂)₄CH₂Cl | * |
| 18 | CH(CH₃)(CH₂)₃CH₃ | * |
| 19 | (CH₂)₄CH₃ | * |
| 20 | (CH₂)₅CH₃ | * |
| 21 | (CH₂)₆CH₃ | * |
| 22 | (CH₂)₇CH₃ | * |
| 23 | (CH₂)₈CH₃ | * |
| 24 | (CH₂)₉CH₃ | * |
| 25 | (CH₂)₁₁CH₃ | 53-54* |
| 26 (Ex. 3) | (CH₂)₃Si(CH₃)₃ | * |
| 27 | (CH₂)₃OSi(CH₃)₂C(CH₃)₃ | * |
| 28 (Ex. 4) | CH(CH₂CH₂CH₂CH₃)₂ | * |
| 29 | CH(CH₂CH₂CH₃)CH₂CH₂CH₂CH₃ | * |
| 30 | CH(CH₂CH₂CH₂CH₂CH₃)₂ | * |
| 31 | CH(C₂H₅)CH₂CH₂CH(CH₃)₂ | * |
| 32 | CH(CH₃)CH₂CH₂CH(CH₃)₂ | * |
| 33 | CH(CH₂CH₂CH₃)CH₂CH₂CH(CH₃)₂ | * |
| 34 | CH(C₂H₅)₂ | |
| 35 | CH(CH₂CH₂CH(CH₃)₂)₂ | * |
| 36 | CH(CH₂CH₂CH₃)₂ | * |
| 37 | CH(CH₂CH₂CH₂CH₃)(CH₂)₅CH₃ | * |
| 38 | CH₂C(═CH₂)CH₂Si(CH₃)₃ | * |
| 39 | CH₂CH₂CH═CH(CH₃)₂ | * |
| 40 | CH₂CH═CHC(CH₃)₃ | |
| 41 | CH₂CH₂OC(CH₃)3 | * |
| 42 | (CH₂)₃C(Cl)₂(CH₃)₂ | * |
| 43 | (CH₂)₃C(CH₃)₂(OCH₃) | * |
| 44 | (CH₂)₃C(CH₃)₂(OC₂H₅) | * |
| 45 | (CH₂)₃C(CH₃)₂OH | * |
| 46 | (CH₂)₃C(Cl)(CH₃)(CH(CH₃)₂) | * |
| 47 | (CH₂)₄C(CH₃)₂(CN) | * |
| 48 | (CH₂)₄CH(CH₃)₂ | * |
| 49 | (CH₂)₃CH(CH₃)(CH(CH₃)₂) | * |
| 50 | (CH₂)₃C(CH₃)₃ | * |
| 51 | (CH₂)₃Si(CH₃)₂(C₂H₅) | * |
| 52 | (CH₂)₃Si(CH₃)₂(CH₂CH₂CH₃) | * |
| 53 | (CH₂)₃Si(CH₃)(C₂H₅)₂ | * |

INDEX TABLE B

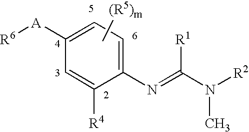

| Compound | m | A | R¹ | R² | R⁴ | R⁵ | R⁶ | m.p. (° C.) |
|---|---|---|---|---|---|---|---|---|
| 54 (Ex. 5) | 1 | O | H | C₂H₅ | CH₃ | 5-Cl | (CH₂)₃Si(CH₃)₃ | * |
| 55 | 2 | O | H | CH₃ | Cl | 3,5-di-Cl | (CH₂)₃Si(CH₃)₃ | * |
| 56 | 1 | O | H | CH₂CH═CH₂ | CH₃ | 5-Cl | (CH₂)₃Si(CH₃)₃ | * |
| 57 | 1 | O | H | C₂H₅ | CH₃ | 5-Cl | (CH₂)₃Si(CH₃)₂(C₂H₅) | * |
| 58 | 1 | O | H | n-Pr | CH₃ | 5-Cl | (CH₂)₃Si(CH₃)₃ | * |
| 59 | 1 | O | H | C₂H₅ | CH₃ | 5-F | (CH₂)₃Si(CH₃)₃ | * |
| 60 | 1 | O | H | n-Pr | CH₃ | 5-F | (CH₂)₃Si(CH₃)₃ | |
| 61 | 1 | O | H | c-Pr | CH₃ | 5-Cl | (CH₂)₃Si(CH₃)₃ | * |
| 62 | 1 | O | H | n-Bu | CH₃ | 5-F | (CH₂)₃Si(CH₃)₃ | * |
| 63 | 1 | O | H | i-Pr | CH₃ | 5-F | (CH₂)₃Si(CH₃)₃ | * |
| 64 | 1 | O | H | CH₂CH═CH₂ | CH₃ | 5-F | (CH₂)₃Si(CH₃)₃ | * |
| 65 | 1 | O | H | c-Pr | CH₃ | 5-Cl | (CH₂)₃Si(CH₃)₂(C₂H₅) | * |
| 66 | 1 | O | H | C₂H₅ | CH₃ | 5-F | (CH₂)₃Si(CH₃)₂(C₂H₅) | * |
| 67 | 1 | O | H | n-Pr | CH₃ | 5-F | (CH₂)₃Si(CH₃)₂(C₂H₅) | * |
| 68 | 1 | O | H | n-Bu | CH₃ | 5-F | (CH₂)₃Si(CH₃)₂(C₂H₅) | * |
| 69 | 1 | O | H | i-Pr | CH₃ | 5-F | (CH₂)₃Si(CH₃)₂(C₂H₅) | * |
| 70 | 1 | O | H | CH₂CH═CH₂ | CH₃ | 5-F | (CH₂)₃Si(CH₃)₂(C₂H₅) | * |
| 71 | 1 | O | H | c-Pr | CH₃ | 5-F | (CH₂)₃Si(CH₃)₂(C₂H₅) | * |
| 72 | 1 | O | H | c-Pr | CH₃ | 5-F | (CH₂)₃Si(CH₃)₃ | * |
| 73 | 1 | O | H | n-Bu | CH₃ | 5-i-Pr | (CH₂)₃Si(CH₃)₃ | * |
| 74 | 1 | O | H | i-Pr | CH₃ | 5-i-Pr | (CH₂)₃Si(CH₃)₃ | * |
| 75 | 1 | O | H | n-Pr | CH₃ | 5-i-Pr | (CH₂)₃Si(CH₃)₃ | * |
| 76 | 1 | O | H | C₂H₅ | CH₃ | 5-i-Pr | (CH₂)₃Si(CH₃)₃ | * |
| 96 | 1 | O | CH₃ | CH₃ | CH₃ | 5-CH₃ | (CH₂)₃CH(CH₃)₂ | * |
| 97 | 1 | O | CH₃ | CH₃ | CH₃ | 5-CH₃ | CH(n-Pr)(CH₂)₂CH(CH₃)₂ | * |
| 98 | 1 | O | CH₃ | CH₃ | CH₃ | 5-CH₃ | (CH₂)₂CH(CH₃)CH₂C(CH₃)₃ | * |
| 99 | 1 | O | CH₃ | CH₃ | CH₃ | 5-CH₃ | CH((CH₂)₄CH₃)₂ | * |
| 100 | 1 | O | CH₃ | CH₃ | CH₃ | 5-CH₃ | CH(C₂H₅)CH₂CH₂CH(CH₃)₂ | * |
| 101 | 1 | O | CH₃ | CH₃ | CH₃ | 5-CH₃ | CH(n-Pr)₂ | * |
| 102 | 1 | O | CH₃ | CH₃ | CH₃ | 5-CH₃ | CH(CH₃)CH₂CH₂CH(CH₃)₂ | * |
| 103 | 1 | O | CH₃ | CH₃ | CH₃ | 5-CH₃ | CH(CH₂CH₂CH(CH₃)₂)₂ | * |
| 104 | 1 | O | CH₃ | CH₃ | CH₃ | 5-CH₃ | CH(C₂H₅)CH₂CH₂C(═CH₂)CH₃ | * |
| 105 | 1 | S | H | CH₃ | CH₃ | 5-CH₃ | CH(CH₃)CH₂CH₂CH(CH₃)₂ | * |
| 110 | 1 | O | CH₃ | CH₃ | CH₃ | 5-Cl | (CH₂)₃CH(CH₃)₂ | * |
| 111 | 1 | O | CH₃ | CH₃ | CH₃ | 5-Cl | (CH₂)₃CH(CH₃)₂ | * |
| 115 | 2 | O | H | CH₃ | CH₃ | 3,5-di-Cl | (CH₂)₃CH(CH₃)₂ | * |
| 116 | 2 | O | CH₃ | CH₃ | CH₃ | 3,5-di-Cl | (CH₂)₃CH(CH₃)₂ | * |
| 126 | 1 | O | H | CH₃ | Cl | 5-Cl | (CH₂)₃CH(CH₃)₂ | * |
| 128 | 1 | O | CO₂CH₃ | CH₃ | CH₃ | 5-CH₃ | (CH₂)₃Si(CH₃)₃ | * |
| 129 | 1 | O | CO₂CH₃ | C₂H₅ | CH₃ | 5-Cl | (CH₂)₃Si(CH₃)₃ | |
| 130 | 1 | O | CO₂CH₃ | CH₃ | CH₃ | 5-Cl | (CH₂)₃Si(CH₃)₃ | * |
| 131 | 1 | O | CO₂CH₃ | C₂H₅ | CH₃ | 5-CH₃ | (CH₂)₃Si(CH₃)₃ | * |
| 132 | 1 | O | H | CH₃ | CH₃ | 5-CH₃ | (CH₂)₃CH(CH₃)₂ | * |
| 140 | 2 | O | H | C₂H₅ | CH₃ | 3-Cl-5-CH₃ | (CH₂)₃Si(CH₃)₃ | * |
| 141 | 1 | S | H | CH₃ | CH₃ | 5-CH₃ | CH(n-Pr)(n-Bu) | * |
| 142 | 1 | S | CH₃ | CH₃ | CH₃ | 5-CH₃ | CH(n-Pr)(n-Bu) | * |
| 143 | 1 | S | CH₃ | CH₃ | CH₃ | 5-CH₃ | CH(n-Bu)₂ | * |
| 144 | 1 | NH | CH₃ | CH₃ | CH₃ | 5-CH₃ | CH(CH₃)CH₂CH₂CH(CH₃)₂ | * |
| 145 | 1 | NH | H | CH₃ | CH₃ | 5-CH₃ | CH((CH₂)₄CH₃)₂ | * |
| 146 | 1 | NH | H | CH₃ | CH₃ | 5-CH₃ | CH(n-Pr)(n-Bu) | * |
| 147 | 1 | NH | H | CH₃ | CH₃ | 5-CH₃ | (CH₂)₂CH(CH₃)CH₂C(CH₃)₃ | * |
| 148 | 1 | NH | H | CH₃ | CH₃ | 5-CH₃ | CH(n-Pr)(CH₂)₂CH(CH₃)₂ | * |
| 149 | 1 | NH | H | CH₃ | CH₃ | 5-CH₃ | CH(C₂H₅)(CH)₂CH(CH₃)₂ | * |
| 150 | 1 | NH | H | CH₃ | CH₃ | 5-CH₃ | CH(n-Bu)₂ | 9 |
| 151 | 1 | NH | H | CH₃ | CH₃ | 5-CH₃ | CH(CH₂CH₂CH(CH₃)₂)₂ | * |
| 152 | 1 | NH | H | CH₃ | CH₃ | 5-CH₃ | CH(C₂H₅)CH₂CH₂C(═CH₂)CH₂ | * |
| 153 | 1 | NH | H | CH₃ | CH₃ | 5-CH₃ | CH₂CH₂S(t-Bu) | * |
| 154 | 1 | NH | H | CH₃ | CH₃ | 5-CH₃ | (CH₂)₃CH(CH₃)₂ | * |
| 155 | 1 | S | H | CH₃ | CH₃ | 5-CH₃ | CH(n-Bu)₂ | * |
| 156 | 1 | S | H | CH₃ | CH₃ | 5-CH₃ | (CH₂)₃CH(CH₃)₂ | * |
| 157 | 1 | S | H | CH₃ | CH₃ | 5-CH₃ | CH(n-Pr)₂ | * |
| 158 | 1 | S | H | CH₃ | CH₃ | 5-CH₃ | CH₂CH(CH₃)CH₂C(t-Bu) | * |
| 159 | 1 | S | H | CH₃ | CH₃ | 5-CH₃ | CH(CH₂CH₂CH(CH₃)₂)₂ | * |
| 160 | 1 | S | H | CH₃ | CH₃ | 5-CH₃ | (CH(n-Pr)(n-Bu) | * |
| 161 | 1 | S | H | CH₃ | CH₃ | 5-CH₃ | CH(C₂H₅)CH₂C(═CH₂)CH₃ | |
| 162 | 1 | S | H | CH₃ | CH₃ | 5-CH₃ | CH₂(C₂H₅)CH₂CH₂CH(CH₃)₂ | * |
| 171 | 2 | O | CH₃ | CH₃ | CH₃ | 3,5-di-Cl | (CH₂)₃Si(CH₃)₃ | 160-162 |
| 172 | 1 | O | H | CH₃ | CH₃ | 5-Cl | (CH₂)₃Si(CH₃)₃ | 55-58 |
| 173 | 1 | O | CH₃ | CH₃ | CH₃ | 5-Cl | (CH₂)₃Si(CH₃)₃ | * |
| 174 | 1 | NH | H | CH₃ | CH₃ | 5-CH₃ | C(O)CH₂S(O)(t-Bu) | * |
| 175 | 1 | O | H | CH₃ | CH₃ | 5-Cl | (CH₂)₃C(CH₃)₃ | * |
| 176 | 1 | O | H | CH₃ | CH₃ | 5-Cl | (CH₂)₃C(CH₃)₃ | * |
| 182 | 2 | O | H | C₂H₅ | CH₃ | 3,5-di-Cl | (CH₂)₃Si(CH₃)₃ | * |
| 189 | 1 | NH | H | CH₃ | CH₃ | 5-CH₃ | C(O)NHCH₂CH(CH₃)₂ | 147‥149 |
| 190 | 1 | NH | H | CH₃ | CH₃ | 5-CH₃ | C(O)NHCH₂C(CH₃)₃ | 180-182 |
| 193 | 1 | NH | H | CH₃ | CH₃ | 5-CH₃ | C(O)N(CH₃)CH₂C(CH₃)₃ | 158-160 |
| 196 | 1 | O | H | C₂H₅ | CH₃ | 5-CH₃ | (CH₂)₃Si(CH₃)₃ | * |
| 197 | 1 | O | H | C₂H₅ | CH₃ | 5-Cl | (CH₂)₃CH(CH₃)₃ | * |
| 198 | 1 | O | H | C₂H₅ | CH₃ | 5-Cl | CH(CH₃)CH₂CH₂CH(CH₃)₂ | * |
| 199 | 1 | O | H | C₂H₅ | CH₃ | 5-CH₃ | (CH₂)₃C(CH₃)₃ | * |
| 200 | 2 | O | H | C₂H₅ | CH₃ | 3-Cl-5-CH₃ | (CH₂)₃CH(CH₃)₂ | * |
| 201 | 2 | O | H | C₂H₅ | CH₃ | 3-Cl-5-CH₃ | (CH₂)₃C(CH₃)₃ | * |
| 202 | 1 | O | H | C₂H₅ | OCH₃ | 5-Cl | (CH₂)₃CH(CH₃)₃ | * |
| 203 | 1 | O | H | C₂H₅ | SCH₃ | 5-Cl | (CH₂)₃CH(CH₃)₃ | * |
| 204 | 1 | O | H | c-Pr | SCH₃ | 5-Cl | (CH₂)₃CH(CH₃)₃ | 62-64 |
| 205 | 1 | O | H | i-Pr | SCH₃ | 5-Cl | (CH₂)₃CH(CH₃)₃ | * |
| 206 | 1 | O | H | n-Pr | SCH₃ | 5-Cl | (CH₂)₃CH(CH₃)₃ | * |
| 207 | 1 | O | H | CHC≡CH | CH₃ | 5-Cl | (CH₂)₃CH(CH₃)₃ | * |
| 208 | 2 | O | H | C₂H₅ | CH₃ | 5-Cl-6-Br | (CH₂)₃CH(CH₃)₃ | * |

INDEX TABLE C

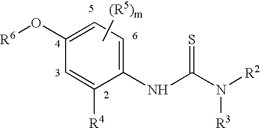

| Compound | m | R² | R³ | R⁴ | R⁵ | R⁶ | m.p. (° C.) |
|---|---|---|---|---|---|---|---|
| 77 | 1 | C₂H₅ | CH₃ | CH₃ | 5-CH₃ | (CH₂)₃Si(CH₃)₂(C₂H₅) | 94-95 |
| 78 | 1 | n-Pr | CH₃ | CH₃ | 5-CH₃ | (CH₂)₃Si(CH₃)₂(C₂H₅) | * |
| 79 | 1 | C₂H₅ | CH₃ | CH₃ | 5-CH₃ | (CH₂)₃Si(CH₃)(C₂H₅)₂ | 81-82 |
| 80 | 2 | C₂H₅ | CH₃ | Cl | 3,5-diCl | (CH₂)₃Si(CH₃)₃ | 94-97 |
| 81 | 2 | n-Pr | CH₃ | Cl | 3,5-diCl | (CH₂)₃Si(CH₃)₃ | 121-123 |
| 82 | 2 | i-Pr | CH₃ | Cl | 3,5-diCl | (CH₂)₃Si(CH₃)₃ | 118-119 |
| 83 | 2 | CH₂CH═CH₂ | CH₃ | Cl | 3,5-diCl | (CH₂)₃Si(CH₃)₃ | 64-65 |
| 84 | 1 | C₂H₅ | CH₃ | CH₃ | 5-Cl | (CH₂)₃Si(CH₃)₂(C₂H₅) | * |
| 85 | 1 | CH₂CH═CH₂ | CH₃ | CH₃ | 5-Cl | (CH₂)₃Si(CH₃)₃ | * |
| 86 | 1 | CH₂CH═CH₂ | CH₃ | CH₃ | 5-CH₃ | (CH₂)₃Si(CH₃)₃ | * |
| 87 | 1 | C₂H₅ | CH₃ | CH₃ | 5-F | (CH₂)₃Si(CH₃)₃ | * |
| 88 | 1 | n-Pr | CH₃ | CH₃ | 5-F | (CH₂)₃Si(CH₃)₃ | * |
| 89 | 1 | n-Bu | CH₃ | CH₃ | 5-F | (CH₂)₃Si(CH₃)₃ | * |
| 90 | 1 | i-Pr | CH₃ | CH₃ | 5-F | (CH₂)₃Si(CH₃)₃ | * |
| 91 | 1 | n-Bu | CH₃ | CH₃ | 5-i-Pr | (CH₂)₃Si(CH₃)₃ | * |
| 92 | 1 | i-Pr | CH₃ | CH₃ | 5-i-Pr | (CH₂)₃Si(CH₃)₃ | * |
| 93 | 1 | n-Pr | CH₃ | CH₃ | 5-i-Pr | (CH₂)₃Si(CH₃)₃ | * |
| 94 | 1 | C₂H₅ | CH₃ | CH₃ | 5-i-Pr | (CH₂)₃Si(CH₃)₃ | * |
| 106 | 1 | C₂H₅ | CH₃ | CH₃ | 5-CH₃ | (CH₂)₃CH(CH₃)₂ | * |
| 107 | 1 | CH₃ | CH₃ | CH₃ | 5-CH₃ | (CH₂)₃CH(CH₃)₂ | * |
| 108 | 1 | C₂H₅ | C₂H₅ | CH₃ | 5-CH₃ | (CH₂)₃CH(CH₃)₂ | * |
| 112 | 1 | CH₃ | C₂H₅ | CH₃ | 5-Cl | (CH₂)₃CH(CH₃)₂ | 138-140 |
| 113 | 1 | C₂H₅ | C₂H₅ | CH₃ | 5-Cl | (CH₂)₃CH(CH₃)₂ | 191-192 |
| 114 | 1 | C₂H₅ | CH₃ | CH₃ | 5-Cl | (CH₂)₃CH(CH₃)₂ | 58-60 |
| 117 | 2 | C₂H₅ | C₂H₅ | CH₃ | 3,5-di-Cl | (CH₂)₃CH(CH₃)₂ | 112-114 |
| 118 | 2 | C₂H₅ | CH₃ | CH₃ | 3,5-di-Cl | (CH₂)₃CH(CH₃)₂ | 68-70 |
| 119 | 2 | CH₃ | CH₃ | CH₃ | 3,5-di-Cl | (CH₂)₃CH(CH₃)₂ | 136-138 |
| 120 | 1 | C₂H₅ | C₂H₅ | CH₃ | 5-Cl | (CH₂)₃C(CH₃)₃ | 118-120 |
| 121 | 2 | CH₃ | CH₃ | CH₃ | 3,5-di-Cl | (CH₂)₃C(CH₃)₃ | 150-152 |
| 122 | 2 | C₂H₅ | CH₃ | CH₃ | 3,5-di-Cl | (CH₂)₃C(CH₃)₃ | 122-124 |
| 123 | 1 | CH₃ | CH₃ | Cl | 5-Cl | (CH₂)₃CH(CH₃)₂ | 128-130 |
| 124 | 1 | C₂H₅ | CH₃ | Cl | 5-Cl | (CH₂)₃CH(CH₃)₂ | 70-72 |
| 125 | 1 | C₂H₅ | CH₃ | Cl | 5-Cl | (CH₂)₃CH(CH₃)₂ | 90-92 |
| 127 | 1 | i-Pr | C₂H₅ | Cl | 5-Cl | (CH₂)₃CH(CH₃)₂ | * |
| 133 | 2 | CH₃ | CH₃ | CH₃ | 3-Cl-5-CH₃ | (CH₂)₃Si(CH₃)₃ | 128-130 |
| 134 | 2 | C₂H₅ | CH₃ | CH₃ | 3-Cl-5-CH₃ | (CH₂)₃Si(CH₃)₃ | 110-112 |
| 136 | 2 | CH₃ | CH₃ | CH₃ | 3-Cl-5-CH₃ | (CH₂)₃CH(CH₃)₃ | 136-138 |
| 137 | 2 | C₂H₅ | CH₃ | CH₃ | 3-Cl-5-CH₃ | (CH₂)₃CH(CH₃)₃ | * |
| 138 | 2 | CH₃ | CH₃ | CH₃ | 3-Cl-5-CH₃ | (CH₂)₃C(CH₃)₃ | 148-150 |
| 139 | 2 | C₂H₅ | CH₃ | CH₃ | 3-Cl-5-CH₃ | (CH₂)₃C(CH₃)₃ | 120-123 |
| 163 | 1 | C₂H₅ | C₂H₅ | CH₃ | 5-CH₃ | (CH₂)₃Si(CH₃)₃ | * |
| 164 | 1 | C₂H₅ | CH₃ | CH₃ | 5-CH₃ | (CH₂)₃Si(CH₃)₃ | * |
| 165 | 1 | CH₃ | CH₃ | CH₃ | 5-CH₃ | (CH₂)₂O(t-Bu) | * |
| 167 | 1 | CH₃ | CH₃ | CH₃ | 5-CH₃ | (CH₂)₃Si(CH₃)₃ | * |
| 168 | 1 | CH₃ | CH₃ | CH₃ | 5-Cl | (CH₂)₃Si(CH₃)₃ | 98-99 |
| 169 (Ex. 6) | 1 | C₂H₅ | CH₃ | CH₃ | 5-Cl | (CH₂)₃Si(CH₃)₃ | 71-72 |
| 170 | 1 | C₂H₅ | C₂H₅ | CH₃ | 5-Cl | (CH₂)₃Si(CH₃)₃ | 62-63 |
| 177 | 1 | C₂H₅ | C₂H₅ | CH₃ | 5-Cl | (CH₂)₃C(CH₃)₃ | * |
| 178 | 1 | C₂H₅ | CH₃ | CH₃ | 5-Cl | (CH₂)₃C(CH₃)₃ | 88-90 |
| 179 | 2 | C₂H₅ | C₂H₅ | CH₃ | 3,5-di-Cl | (CH₂)₃Si(CH₃)₃ | 90-101 |
| 180 | 2 | CH₃ | CH₃ | CH₃ | 3,5-di-Cl | (CH₂)₃Si(CH₃)₃ | 89-90 |
| 181 | 2 | C₂H₅ | CH₃ | CH₃ | 3,5-di-Cl | (CH₂)₃Si(CH₃)₃ | 79-82 |
| 183 | 1 | CH₃ | CH₃ | Cl | 5-Cl | (CH₂)₃Si(CH₃)₃ | 75-78 |
| 184 | 1 | C₂H₅ | CH₃ | Cl | 5-Cl | (CH₂)₃Si(CH₃)₃ | 85-88 |
| 185 | 1 | C₂H₅ | C₂H₅ | Cl | 5-Cl | (CH₂)₃Si(CH₃)₃ | 91-92 |
| 186 | 1 | CH₃ | CH₃ | Cl | 5-Cl | (CH₂)₃C(CH₃)₃ | 106-108 |
| 187 | 1 | C₂H₅ | CH₃ | Cl | 5-Cl | (CH₂)₃C(CH₃)₃ | 86-87 |
| 188 | 1 | C₂H₅ | C₂H₅ | Cl | 5-Cl | (CH₂)₃C(CH₃)₃ | 88-89 |
| 191 | 1 | C₂H₅ | C₂H₅ | CH₃ | 5-CH₃ | (CH₂)₃C(CH₃)₃ | * |
| 192 | 1 | CH₃ | CH₃ | CH₃ | 5-CH₃ | (CH₂)₃C(CH₃)₃ | 102-104 |
| 194 | 1 | C₂H₅ | CH₃ | CH₃ | 5-CH₃ | (CH₂)₃C(CH₃)₃ | 82-84 |

INDEX TABLE D

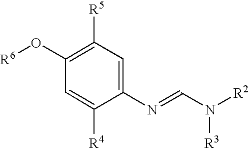

| Compound | R² + R³ | R⁴ | R⁵ | R⁶ | m.p. (° C.) |
|---|---|---|---|---|---|
| 95 | (CH₂)₄ | CH₃ | Cl | (CH₂)₃Si(CH₃)₃ | * |
| 209 | (CH₂)₃ | CH₃ | Cl | (CH₂)₃Si(CH₃)₃ | * |

*See Index Table F for ¹H NMR data.

INDEX TABLE E

| Cmpd No. | ¹H NMR Data (CDCl₃ solution unless indicated otherwise)^{a} |
|---|---|
| 1 | δ 1.72(s, 3H), 1.78(s, 3H), 2.17(s, 3H), 2.24(s, 3H), 2.99(s, 6H), |
| | 4.46(d, 2H), 5.5(t, 1H), 6.55(s, 1H), 6.66(s, 1H), 7.38(s, 1H). |
| 2 | δ 1.6-1.8(m, 9H), 1.9-2.5(m, 10H), 2.98(s, 6H), 4.46(d, 2H), 5.1(m, 1H), |
| | 5.5(m, 1H), 6.54(s, 1H), 6.66(s, 1H), 7.38(s, 1H). |
| 3 | δ 1.6-2.4(m, 26H), 2.99(s, 6H), 4.5(d, 2H), 5-5.2(m, 2H), 5.5(m, 1H), |
| | 6.54(s, 1H), 6.66(s, 1H), 7.38(s, 1H). |
| 4 | δ 1.25(s, 9H), 2.21(s, 3H), 2.23(s, 3H), 2.99(s, 6H), 4.79(s, 2H), |
| | 6.50(s, 1H), 6.55(s, 1H), 7.37(s, 1H). |
| 5 | δ 1.5-2.3(m, 12H), 2.98(s, 6H), 3.92(t, 2H), 4.95-5.1(m, 2H), |
| | 5.7-5.9(m, 1H), 6.54(s, 1H), 6.63(s, 1H), 7.37(s, 1H). |
| 6 | δ 1.8-1.92(m, 2H), 2.17-2.3(m, 8H), 2.98(s, 6H), 3.92(t, 2H), |
| | 4.97-5.13(m, 2H), 5.8-5.95(m, 1H), 5.55(s, 1H), 6.64(s, 1H), 7.37(s, 1H). |
| 7 | δ 1.6-2.04(m, 6H), 2.17(s, 3H), 2.22(s, 3H), 2.99(s, 6H), 3.26(s, 9H), |
| | 3.97(t, 2H), 6.54(s, 1H), 6.64(s, 1H), 7.38(s, 1H). |
| 8 | δ 0.96(d, 6H), 1.67(q, 2H), 1.87(m, 1H), 2.15(s, 3H), 2.23(s, 3H), |
| | 2.98(s, 6H), 3.93(t, 2H), 6.54(s, 1H), 6.64(s, 1H), 7.37(s, 1H). |
| 9 | δ 1.04(d, 6H), 1.8-2.35(m, 11H), 2.98(s, 6H), 3.93(t, 2H), 4.72(d, 1H), |
| | 4.98(d, 1H), 6.55(s, 1H), 6.64(s, 1H), 7.38(s, 1H). |
| 10 | δ 0.87(d, 6H), 0.94(d, 3H), 1.1-1.9(m, 10H), 2.16(s, 3H), 2.23(s, 3H), |
| | 2.98(s, 6H), 3.93(m, 2H), 6.54(s, 1H), 6.63(s, 1H), 7.38(s, 1H). |
| 11 | δ 0.91(s, 9H), 0.98(d, 3H), 1.05-1.35(m, 2H), 1.5-1.9(m, 3H), |
| | 2.16(s, 3H), 2.23(s, 3H), 2.98(s, 6H), 3.92(t, 3H), 6.54(s, 1H), 6.62(s, 1H), |
| | 7.38(s, 1H). |
| 12 | δ 0.99(s, 9H), 1.72(t, 2H), 2.15(s, 3H), 2.24(s, 3H), 2.98(s, 6H), |
| | 3.96(t, 2H), 6.54(s, 1H), 6.63(s, 1H), 7.38(s, 1H). |
| 13 | δ 0.91(d, 6H), 1.28-1.82(m, 5H), 2.16(s, 3H), 2.23(s, 3H), 2.98(s, 6H), |
| | 3.89(t, 2H), 6.54(s, 1H), 6.63(s, 1H), 7.37(s, 1H). |
| 14 | δ 0.95(d, 3H), 1.18-2.1(m, 13H), 2.15(s, 3H), 2.23(s, 3H), 2.97(s, 6H), |
| | 3.93(m, 2H), 5.1(t, 1H), 6.54(s, 1H), 6.63(s, 1H), 7.37(s, 1H). |
| 15 | δ 0.95(d, 3H), 1.18-2.1(m, 13H), 2.15(s, 3H), 2.23(s, 3H), 2.98(s, 6H), |
| | 3.94(m, 2H), 5.1(t, 1H), 6.54(s, 1H), 6.63(s, 1H), 7.37(s, 1H). |
| 16 | δ 1.9-2.1(m, 4H), 2.16(s, 3H), 2.23(s, 3H), 2.98(s, 6H), 3.63(t, 2H), |
| | 3.95(t, 2H), 6.55(s, 1H), 6.62(s, 1H), 7.37(s, 1H). |
| 17 | δ 1.6-2(m, 6H), 2.16(s, 3H), 2.23(s, 3H), 2.98(s, 6H), 3.57(t, 2H), |
| | 3.92(t, 2H), 6.54(s, 1H), 6.62(s, 1H), 7.37(s, 1H). |
| 18 | δ 0.91(m, 3H), 1.2-1.8(m, 9H), 2.15(s, 3H), 2.22(s, 3H), 2.98(s, 6H), |
| | 4.21(m, 1H), 6.53(s, 1H), 6.64(s, 1H), 7.39(s, 1H). |
| 19 | δ 0.93(t, 3H), 1.3-1.55(m, 4H), 1.7-1.82(m, 2H), 2.16(s, 3H), 2.23(s, 3H), |
| | 2.98(s, 6H), 3.9(t, 2H), 6.54(s, 1H), 6.63(s, 1H), 7.37(s, 1H). |
| 20 | δ 0.9(t, 3H), 1.3-1.56(m, 6H), 1.7-1.82(m, 2H), 2.16(s, 3H), 2.23(s, 3H), |
| | 2.98(s, 6H), 3.9(t, 2H), 6.55(s, 1H), 6.63(s, 1H), 7.38(s, 1H). |
| 21 | δ 0.89(t, 3H), 1.2-1.6(m, 8H), 1.7-1.82(m, 2H), 2.16(s, 3H), 2.23(s, 3H), |
| | 2.98(s, 6H), 3.9(t, 2H), 6.54(s, 1H), 6.64(s, 1H), 7.37(s, 1H). |
| 22 | δ 0.89(t, 3H), 1.2-1.56(m, 10H), 1.7-1.82(m, 2H), 2.16(s, 3H), |
| | 2.23(s, 3H), 2.98(s, 6H), 3.9(t, 2H), 6.54(s, 1H), 6.63(s, 1H), 7.38(s, 1H). |
| 23 | δ 0.88(t, 3H), 1.2-1.56(m, 12H), 1.7-1.82(m, 2H), 2.16(s, 3H), |
| | 2.23(s, 3H), 2.98(s, 6H), 3.9(t, 2H), 6.54(s, 1H), 6.63(s, 1H), 7.37(s, 1H). |
| 24 | δ 0.88(t, 3H), 1.2-1.56(m, 14H), 1.7-1.82(m, 2H), 2.16(s, 3H), |
| | 2.23(s, 3H), 2.98(s, 6H), 3.9(t, 2H), 6.54(s, 1H), 6.63(s, 1H), 7.37(s, 1H). |
| 25 | δ 0.88(t, 3H), 1.2-1.82(m, 20H), 2.16(s, 3H), 2.23(s, 3H), 2.98(s, 6H), |
| | 3.9(t, 2H), 6.54(s, 1H), 6.63(s, 1H), 7.37(s, 1H). |
| 26 | δ 0.02(t, 9H), 0.6(m, 2H), 1.7-1.82(m, 2H), 2.17(s, 3H), 2.23(s, 3H), |
| | 2.98(s, 6H), 3.87(t, 2H), 6.54(s, 1H), 6.62(s, 1H), 7.38(s, 1H). |
| 27 | δ 0.05(s, 6H), 0.9(s, 9H), 1.97(m, 2H), 2.15(s, 3H), 2.23(s, 3H), |
| | 2.98(s, 6H), 3.82(t, 2H), 4.0(t, 2H), 6.54(s, 1H), 6.64(s, 1H), 7.37(s, 1H). |
| 28 | δ 0.9(t, 6H), 1.2-1.4(m, 8H), 1.5-1.7(m, 4H), 2.15(s, 3H), 2.2(s, 3H), |
| | 3.0(s, 6H), 4.1(m, 1H), 6.5(s, 1H), 6.6(s, 1H), 7.4(s, 1H). |
| 29 | δ 0.9(t, 6H), 1.2-1.4(m, 6H), 1.5-1.7(m, 4H), 2.15(s, 3H), 2.25(s, 3H), |
| | 3.0(s, 6H), 4.05-4.2(m, 1H), 6.5(s, 1H), 6.6(s, 1H), 7.4(s, 1H). |
| 30 | δ 0.9(m, 6H), 1.2-1.4(m, 12H), 1.5-1.7(m, 4H), 2.1(s, 3H), 2.2(s, 3H), |
| | 3.0(s, 6H), 4.05-4.2(m, 1H), 6.45(s, 1H), 6.6(s, 1H), 7.35(s, H). |
| 31 | δ 0.8(d, 6H), 0.9(t, 3H), 1.2-1.4(m, 2H), 1.5-1.7(m, 4H), 2.1(s, 3H), |
| | 2.2(s, 3H), 3.0(s, 6H), 3.95-4.1(m, 1H), 6.5(s, 1H), 6.6(s, 1H), 7.4(s, 1H). |
| 32 | δ 0.8(d, 6H), 1.2(d, 3H), 1.4-1.6(m, 2H), 1.6-1.75(m, 2H), 2.15(s, 3H), |
| | 2.2(s, 3H), 2.95(s, 6H), 4.10-4.2(m, 1H), 6.5(s, 1H), 6.6(s, 1H), 7.4(s, 1H). |
| 33 | δ 0.8(d, 6H), 0.9(t, 3H), 1.2-1.4(m, 6H), 1.5-1.7(m, 4H), 2.15(s, 3H), |
| | 2.25(s, 3H), 3.0(s, 6H), 4.05-4.2(m, 1H), 6.5(s, 1H), 6.6(s, 1H), 7.4(s, 1H). |
| 34 | δ 0.9(t, 6H), 1.55-1.75(m, 4H), 2.1(s, 3H), 2.2(s, 3H), 2.95(s, 6H), |
| | 3.95-4.1(m, 1H), 6.5(s, 1H), 6.6(s, 1H), 7.4(s, 1H). |
| 35 | δ 0.85(d, 6H), 0.95(d, 6H), 1.2-1.4(m, 4H), 1.5-1.8(m, 6H), 2.1(s, 3H), |
| | 2.2(s, 3H), 2.95(s, 6H), 3.8-3.95(m, 1H), 6.5(s, 1H), 6.6(s, 1H), 7.4(s, 1H). |
| 36 | δ 0.8-0.9(t, 6H), 1.3-1.5(m, 4H), 1.5-1.65(m, 4H), 2.15(s, 3H), |
| | 2.25(s, 3H), 3.0(s, 6H), 4.05-4.2(m, 1H), 6.5(s, 1H), 6.6(s, 1H), 7.4(s, 1H). |
| 37 | δ 0.8-0.9(q, 6H), 1.2-1.4(m, 14H), 1.5-1.7(m, 4H), 2.1(s, 3H), 2.2(s, 3H), |
| | 2.95(s, 6H), 4.05-4.1(m, 1H), 6.5(s, 1H), 6.6(s, 1H), 7.4(s, 1H). |
| 38 | δ 0.06(s, 9H), 1.64(s, 2H), 2.20(s, 3H), 2.24(s, 3H), 2.98(s, 6H), |
| | 4.31(s, 2H), 4.75(s, 1H), 5.03(s, 1H), 6.55(s, 1H), 6.61(s, 1H), 7.38(s, 1H). |
| 39 | δ 1.66(s, 3H), 1.72(s, 3H), 2.16(s, 3H), 2.22(s, 3H), 2.45(q, 2H), |
| | 2.98(s, 6H), 3.88(t, 2H), 5.23(t, 1H), 6.54(s, 1H), 6.63(s, 1H), 7.37(s, 1H). |
| 40 | δ 1.04(s, 9H), 2.18(s, 3H), 2.22(s, 3H), 2.98(s, 6H), 4.43(d, 2H), |
| | 5.6(m, 1H), 5.8(d, 1H), 6.54(s, 1H), 6.65(s, 1H), 7.38(s, 1H). |
| 41 | δ 1.22(s, 9H), 2.16(s, 3H), 2.22(s, 3H), 2.98(s, 6H), 3.69(t, 2H), |
| | 4.02(t, 2H), 6.53(s, 1H), 6.66(s, 1H), 7.37(s, 1H). |
| 42 | δ 1.62(s, 6H), 1.96(m, 4H), 2.16(s, 3H), 2.23(s, 3H), 2.98(s, 6H), |
| | 3.94(t, 2H), 6.55(s, 1H), 6.62(s, 1H), 7.37(s, 1H). |
| 43 | δ 1.18(s, 6H), 1.6-1.9(m, 4H), 2.16(s, 3H), 2.23(s, 3H), 2.98(s, 6H), |
| | 3.2(s, 3H), 3.9(t, 2H), 6.54(s, 1H), 6.62(s, 1H), 7.37(s, 1H). |
| 44 | δ 1.15-1.25(m, 9H), 1.6-1.9(m, 4H), 2.16(s, 3H), 2.23(s, 3H), |
| | 2.98(s, 6H), 3.4(q, 2H), 3.9(t, 2H), 6.54(s, 1H), 6.62(s, 1H), 7.37(s, 1H). |
| 45 | δ 1.26(s, 6H), 1.6-1.97(m, 4H), 2.16(s, 3H), 2.23(s, 3H), 2.98(s, 6H), |
| | 3.94(t, 2H), 6.57(s, 1H), 6.63(s, 1H), 7.37(s, 1H). |
| 46 | δ 1-1.1(m, 6H), 1.51(s, 3H), 1.6-2.1(m, 4H), 2.16(s, 3H), 2.23(s, 3H), |
| | 2.99(s, 6H), 3.94(m, 2H), 6.55(s, 1H), 6.61(s, 1H), 7.37(s, 1H). |
| 47 | δ 1.2-2(m, 12H), 2.16(s, 3H), 2.23(s, 3H), 2.98(s, 6H), 3.2(s, 3H), |
| | 3.94(t, 2H), 6.55(s, 1H), 6.62(s, 1H), 7.37(s, 1H). |
| 48 | δ 0.88(d, 6H), 1.2-1.9(m, 7H), 2.16(s, 3H), 2.23(s, 3H), 2.98(s, 6H), |
| | 3.9(t, 2H), 6.54(s, 1H), 6.63(s, 1H), 7.37(s, 1H). |
| 49 | δ 0.8-2(m, 15H), 2.16(s, 3H), 2.23(s, 3H), 2.98(s, 6H), 3.9(t, 2H), |
| | 6.54(s, 1H), 6.63(s, 1H), 7.37(s, 1H). |
| 50 | δ 0.92(s, 9H), 1.34(m, 2H), 1.74(m, 2H), 2.16(s, 3H), 2.23(s, 3H), |
| | 2.98(s, 6H), 3.88(t, 2H), 6.54(s, 1H), 6.62(s, 1H), 7.37(s, 1H). |
| 51 | δ 0.01(s, 6H), 0.46-0.7(m, 4H), 0.93(t, 3H), 1.7-1.87(m, 2H), |
| | 2.18(s, 3H), 2.24(s, 3H), 3.0(s, 6H), 3.88(t, 2H), 6.56(s, 1H), 6.64(s, 1H), |
| | 7.39(s, 1H). |
| 52 | δ 0.01(s, 6H), 0.46-0.7(m, 4H), 0.97(t, 3H), 1.27-1.4(m, 2H), |
| | 1.7-1.87(m, 2H), 2.18(s, 3H), 2.24(s, 3H), 2.99(s, 6H), 3.87(t, 2H), 6.56(s, 1H), |
| | 6.63(s, 1H), 7.38(s, 1H). |
| 53 | δ 0.00(s, 3H), 0.46-0.7(m, 6H), 0.93(t, 6H), 1.7-1.87(m, 2H), |
| | 2.21(s, 3H), 2.27(s, 3H), 3.0(s, 6H), 3.9(t, 2H), 6.59(s, 1H), 6.66(s, 1H), 7.42(s, 1H). |
| 54 | δ 0.02(s, 9H), 0.6(m, 2H), 1.2(t, 3H), 1.8(m, 2H), 2.23(s, 3H), |
| | 2.98(s, 3H), 3.35(br s, 2H), 3.93(t, 2H), 6.74(s, 1H), 6.77(s, 1H), 7.4(s, 1H). |
| 55 | δ 0.03(s, 9H), 0.6(m, 2H), 1.83(m, 2H), 3.05(s, 6H), 3.92(t, 2H), |
| | 6.82(s, 1H), 7.41(s, 1H). |
| 56 | δ 0.02(s, 9H), 0.6(m, 2H), 1.8(m, 2H), 2.23(s, 3H), 2.96(s, 3H), |
| | 3.75-3.97(m, 4H), 5.23(m, 2H), 5.83(m, 1H), 6.74(s, 1H), 6.77(s, 1H), 7.42(s, 1H). |
| 57 | δ 0.00(s, 6H), 0.46-0.65(m, 4H), 0.95(t, 3H), 1.21(t, 3H), 1.82(m, 2H), |
| | 2.24(s, 3H), 2.99(s, 3H), 3.37(br s, 2H), 3.94(t, 2H), 6.75(s, 1H), |
| | 6.78(s, 1H), 7.4(s, 1H). |
| 58 | δ 0.02(s, 9H), 0.6(m, 2H), 0.92(t, 3H), 1.61(m, 2H), 1.8(m, 2H), |
| | 2.22(s, 3H), 2.98(s, 3H), 3.22(br s, 2H), 3.92(t, 2H), 6.74(s, 1H), |
| | 6.76(s, 1H), 7.4(s, 1H). |
| 59 | δ 0.02(s, 9H), 0.6(m, 2H), 1.2(t, 3H), 1.79(m, 2H), 2.21(s, 3H), |
| | 2.98(s, 3H), 3.35(br s, 2H), 3.94(t, 2H), 6.55(d, 1H), 6.77(d, 1H), 7.4(s, 1H). |
| 60 | δ 0.02(s, 9H), 0.6(m, 2H), 0.92(t, 3H), 1.61(m, 2H), 1.79(m, 2H), |
| | 2.2(s, 3H), 2.98(s, 3H), 3.21(br s, 2H), 3.93(t, 2H), 6.55(d, 1H), |
| | 6.77(d, 1H), 7.4(s, 1H). |
| 61 | δ 0.02(s, 9H), 0.6(m, 2H), 0.72(m, 4H), 1.8(m, 2H), 2.22(s, 3H), |
| | 2.65(m, 1H), 3.01(s, 3H), 3.93(t, 2H), 6.74(s, 1H), 6.77(s, 1H), 7.58(s, 1H). |
| 62 | δ 0.01(s, 9H), 0.6(m, 2H), 0.95(t, 3H), 1.34(m, 2H), 1.57(m, 2H), |
| | 1.78(m, 2H), 2.2(s, 3H), 2.98(s, 3H), 3.24(br s, 2H), 3.93(t, 2H), 6.55(d, 1H), |
| | 6.77(d, 1H), 7.39(s, 1H). |
| 63 | δ 0.01(s, 9H), 0.6(m, 2H), 1.23(d, 6H), 1.79(m, 2H), 2.21(s, 3H), |
| | 2.9(s, 3H), 3.64(br s, 1H), 3.93(t, 2H), 6.55(d, 1H), 6.77(d, 1H), 7.43(s, 1H). |
| 64 | δ 0.01(s, 9H), 0.6(m, 2H), 1.79(m, 2H), 2.2(s, 3H), 2.96(s, 3H), |
| | 3.9-4.0(m, 4H), 5.21(m, 2H), 5.81(m, 1H), 6.55(d, 1H), 6.77(d, 1H), 7.42(s, 1H). |
| 65 | δ −0.01(s, 6H), 0.47-0.8(m, 8H), 0.94(t, 3H), 1.8(m, 2H), 2.22(s, 3H), |
| | 2.65(m, 1H), 3.01(s, 3H), 3.93(t, 2H), 6.74(s, 1H), 6.77(s, 1H), 7.59(s, 1H). |
| 66 | δ −0.02(s, 6H), 0.45-0.63(m, 4H), 0.93(t, 3H), 1.2(t, 3H), 1.78(m, 2H), |
| | 2.21(s, 3H), 2.98(s, 3H), 3.37(br s, 2H), 3.93(t, 2H), 6.55(d, 1H), |
| | 6.77(d, 1H), 7.4(s, 1H). |
| 67 | δ −0.02(s, 6H), 0.45-0.63(m, 4H), 0.9-1(m, 6H), 1.61(m, 2H), |
| | 1.78(m, 2H), 2.2(s, 3H), 2.98(s, 3H), 3.2(br s, 2H), 3.93(t, 2H), 6.52(d, 1H), |
| | 6.77(d, 1H), 7.4(s, 1H). |
| 68 | δ −0.02(s, 6H), 0.45-0.63(m, 4H), 0.9-1(m, 6H), 1.31(m, 2H), |
| | 1.57(m, 2H), 1.78(m, 2H), 2.2(s, 3H), 2.98(s, 3H), 3.25(br s, 2H), |
| | 3.93(t, 2H), 6.52(d, 1H), 6.77(d, 1H), 7.4(s, 1H). |
| 69 | δ −0.02(s, 6H), 0.45-0.63(m, 4H), 0.96(t, 3H), 1.23(d, 6H), 1.78(m, 2H), |
| | 2.21(s, 3H), 2.89(s, 3H), 3.65(br s, 1H), 3.93(t, 2H), 6.55(d, 1H), |
| | 6.77(d, 1H), 7.45(s, 1H). |
| 70 | δ −0.01(s, 6H), 0.45-0.63(m, 4H), 0.94(t, 3H), 1.78(m, 2H), 2.21(s, 3H), |
| | 2.97(s, 3H), 3.9-4.0(m, 4H), 5.21(m, 2H), 5.81(m, 1H), 6.57(d, 1H), |
| | 6.78(d, 1H), 7.43(s, 1H). |
| 71 | δ −0.02(s, 6H), 0.45-0.8(m, 8H), 0.94(t, 3H), 1.78(m, 2H), 2.2(s, 3H), |
| | 2.67(m, 1H), 2.98(s, 3H), 3.93(t, 2H), 6.55(d, 1H), 6.77(d, 1H), 7.58(s, 1H). |
| 72 | δ 0.01(s, 9H), 0.59(m, 2H), 0.72(m, 4H), 1.79(m, 2H), 2.2(s, 3H), |
| | 2.65(m, 1H), 3.01(s, 3H), 3.93(t, 2H), 6.55(d, 1H), 6.77(d, 1H), 7.58(s, 1H). |
| 73 | δ 0.00(s, 9H), 0.6(m, 2H), 0.93(t, 3H), 1.19(d, 6H), 1.3(m, 2H), |
| | 1.55(m, 2H), 1.75(m, 2H), 2.2(s, 3H), 2.95(s, 3H), 3.3(m, 3H), 3.85(t, 2H), |
| | 6.55(s, 1H), 6.65(s, 1H), 7.4(s, 1H). |
| 74 | δ 0.01(s, 9H), 0.6(m, 2H), 1.22(m, 12H), 1.8(m, 2H), 2.2(s, 3H), |
| | 2.86(s, 3H), 3.3(m, 1H), 3.87(t, 2H), 6.58(s, 1H), 6.62(s, 1H), 7.45(s, 1H). |
| 75 | δ 0.00(s, 9H), 0.6(m, 2H), 0.9(t, 3H), 1.2(d, 6H), 1.55-1.8(m, 4H), |
| | 2.19(s, 3H), 2.96(s, 3H), 3.2(m, 3H), 3.85(t, 2H), 6.57(s, 1H), 6.62(s, 1H), |
| | 7.37(s, 1H). |
| 76 | δ 0.00(s, 9H), 0.6(m, 2H), 1.2(m, 9H), 1.7(m, 2H), 2.2(s, 3H), |
| | 2.96(s, 3H), 3.3(m, 3H), 3.85(t, 2H), 6.57(s, 1H), 6.62(s, 1H), 7.4(s, 1H). |
| 78 | δ 0.01(s, 6H), 0.46-0.67(m, 4H), 0.9-1.0(m, 6H), 1.67-1.82(m, 4H), |
| | 2.17(s, 3H), 2.22(s, 3H), 3.27(s, 3H), 3.75(t, 2H), 3.9(t, 2H), 6.64(s, 1H), |
| | 6.7(s, 1H), 6.95(s, 1H). |
| 84 | δ 0.00(s, 6H), 0.46-0.67(m, 4H), 0.94(t, 3H), 1.29(t, 3H), |
| | 1.77-1.9(m, 2H), 2.23(s, 3H), 3.26(s, 3H), 3.87(q, 2H), 3.96(t, 2H), 6.65(s, 1H), |
| | 6.76(s, 1H), 7.19(s, 1H). |
| 85 | δ 0.03(s, 9H), 0.6(m, 2H), 1.82(m, 2H), 2.21(s, 3H), 3.33(s, 3H), |
| | 3.96(t, 2H), 4.4(d, 2H), 5.3(m, 2H), 5.9(m, 1H), 6.75(m, 2H), 7.2(s, 1H). |
| 86 | δ 0.04(s, 9H), 0.6(m, 2H), 1.78(m, 2H), 2.18(s, 3H), 2.21(s, 3H), |
| | 3.33(s, 3H), 3.9(t, 2H), 4.4(d, 2H), 5.3(m, 2H), 5.9(m, 1H), 6.64(s, 1H), |
| | 6.79(s, 1H), 6.94(s, 1H). |
| 87 | δ 0.02(s, 9H), 0.6(m, 2H), 1.28(t, 3H), 1.8(m, 2H), 2.2(s, 3H), |
| | 3.25(s, 3H), 3.86(q, 2H), 3.94(t, 2H), 6.65(s, 1H), 6.77(d, 1H), 6.95(d, 1H). |
| 88 | δ 0.02(s, 9H), 0.6(m, 2H), 0.97(t, 3H), 1.67-1.82(m, 4H), 2.19(s, 3H), |
| | 3.27(s, 3H), 3.74(t, 2H), 3.94(t, 2H), 6.69(s, 1H), 6.79(d, 1H), 6.97(d, 1H). |
| 89 | δ 0.02(s, 9H), 0.6(m, 2H), 0.97(t, 3H), 1.39(m, 2H), 1.62-1.82(m, 4H), |
| | 2.2(s, 3H), 3.27(s, 3H), 3.77(t, 2H), 3.96(t, 2H), 6.65(s, 1H), |
| | 6.79(d, 1H), 6.97(d, 1H). |
| 90 | δ 0.02(s, 9H), 0.6(m, 2H), 1.22(d, 6H), 1.8(m, 2H), 2.2(s, 3H), |
| | 3.01(s, 3H), 3.96(t, 2H), 5.44(m, 1H), 6.65(s, 1H), 6.79(d, 1H), 6.95(d, 1H). |
| 91 | δ 0.00(s, 9H), 0.6(m, 2H), 0.97(t, 3H), 1.18(d, 6H), 1.4(m, 2H), |
| | 1.6-1.8(m, 4H), 2.2(s, 3H), 3.21(m, 4H), 3.7(m, 2H), 3.87(t, 2H), 6.63(s, 1H), |
| | 6.7(s, 1H), 6.93(s, 1H). |
| 92 | δ 0.01(s, 9H), 0.6(m, 2H), 1.2(m, 12H), 1.8(m, 2H), 2.2(s, 3H), |
| | 2.91(s, 3H), 3.3(m, 1H), 3.87(t, 2H), 5.4(m, 1H), 6.63(s, 1H), 6.7(s, 1H), 6.91(s, 1H). |
| 93 | δ 0.00(s, 9H), 0.6(m, 2H), 0.97(t, 3H), 1.18(d, 6H), 1.8(m, 4H), |
| | 2.19(s, 3H), 3.22(m, 4H), 3.7(m, 2H), 3.87(m, 2H), 6.63(s, 1H), |
| | 6.7(s, 1H), 6.94(s, 1H). |
| 94 | δ: 0.03(s, 9H), 0.6(m, 2H), 1.18(d, 6H), 1.25(t, 3H), 1.7(m, 2H), |
| | 2.2(s, 3H), 3.2-3.3(m, 4H), 3.87(m, 4H), 6.57(s, 1H), 6.7(s, 1H), 6.9(s, 1H). |
| 95 | δ 0.02(s, 9H), 0.6(m, 2H), 1.8(m, 2H), 1.94(m, 4H), 2.24(s, 3H), |
| | 3.48(m, 4H), 3.93(t, 2H), 6.73(s, 1H), 6.77(s, 1H), 7.6(s, H). |
| 96 | δ 0.95(d, 6H), 1.25-1.4(m, 2H), 1.5-1.7(m, 3H), 2.0(s, 3H), 2.15(s, 3H), |
| | 3.0(s, 6H), 6.4(s, 1H), 6.6(s, 1H). |
| 97 | δ 0.8-0.95(m, 9H), 1.15-1.65(m, 9H), 1.75(s, 3H), 2.0(s, 3H), |
| | 2.10(s, 3H), 3.0(s, 6H), 4.4(m, 1H), 6.35(s, 1H), 6.6(s, 1H). |
| 98 | δ 0.9(s, 9H), 1.0(d, 3H), 1.0-1.6(m, 5H), 1.75(s, 3H), 2.0(s, 3H), |
| | 2.15(s, 3H), 3.0(s, 6H), 6.4(s, 1H), 6.6(s, 1H). |
| 99 | δ 0.9(t, 6H), 1.3-1.7(m, 16H), 1.8(s, 3H), 2.0(s, 3H), 2.2(s, 3H), |
| | 3.05(s, 6H), 4.1(m, 1H), 6.35(s, 1H), 6.65(s, 1H). |
| 100 | δ 0.8-1.0(m, 10H), 1.2-1.7(m, 6H), 1.8(s, 3H), 2.0(s, 3H), 2.15(s, 3H), |
| | 3.0(s, 6H), 4.05(m, 1H), 6.35(s, 1H), 6.6(s, 1H). |
| 101 | δ 0.9(t, 6H), 1.4-1.7(m, 8H), 1.8(s, 3H), 2.0(s, 3H), 2.15(s, 3H), 3.05(s, |
| | 6H), 4.1(m, 1H), 6.4(s, 1H), 6.6(s, 1H). |
| 102 | δ 0.9(t, 6H), 1.25(d, 3H), 1.3-1.7(m, 5H), 1.8(s, 3H), 2.0(s, 3H), |
| | 2.15(s, 3H), 3.05(s, 6H), 4.15(m, 1H), 6.4(s, 1H), 6.6(s, 1H). |
| 103 | δ 0.9(d, 12H), 1.2-1.7(m, 10H), 1.8(s, 3H), 2.0(s, 3H), 2.15(s, 3H), |
| | 3.0(s, 6H), 4.1(m, 1H), 6.4(s, 1H), 6.6(s, 1H) |
| 104 | δ 0.9-1.0(m, 3H), 1.25(m, 3H), 1.5-1.7(m, 6H), 1.8(s, 3H), 2.0(s, 3H), |
| | 2.15(s, 3H), 3.0(s, 6H), 4.1(m, 1H), 4.7(d, 2H), 6.4(s, 1H), 6.6(s, 1H). |
| 105 | δ 0.9(d, 6H), 1.2(d, 2H), 1.25(m, 2H), 1.4-1.6(m, 4H), 2.2(s, 3H), |
| | 2.37(s, 3H), 6.6(s, 1H), 7.15(s, 1H), 7.4(s, 1H). |
| 106 | δ 0.95(d, 6H), 1.28(t, 2H), 1.35(m, 1H), 1.6(m, 2H), 1.8(m, 2H), |
| | 2.18(s, 3H), 2.1(s, 3H), 3.22(s, 3H), 3.88(q, 2H), 3.92(t, 2H), 6.6(s, 1H), |
| | 6.9(s, 1H). |
| 108 | δ 0.9(d, 6H), 1.2-1.4(t & m, 8H), 1.6(m, 2H), 1.75(m, 2H), 2.15(s, 3H), |
| | 2.2(s, 3H), 3.7(q, 4H), 3.9(t, 2H), 6.6(s, 1H), 6.9(s, 1H) |
| 110 | δ 0.9(d, 6H), 1.05(m, 2H), 1.4(m, 1H), 1.7(m, 2H), 1.8(s, 3H), |
| | 2.0(s, 3H), 3.0(s, 6H), 3.95(t, 2H), 6.65(s, 1H), 6.75(s, 1H). |
| 111 | δ 0.9(d, 6H), 1.35(m, 2H), 1.65(m, 2H), 1.7(m, 2H), 2.25(s, 3H), |
| | 3.0(s, 6H), 3.95(s, 6H), 6.65(s, 1H), 7.3(s, 1H). |
| 115 | δ 0.9(d, 6H), 1.4(t, 2H), 1.6(m, 1H), 1.8(m, 2H), 2.3(s, 3H), 3.0(s, 6H), |
| | 3.9(t, 2H), 6.7(s, 1H), 7.2(s, 1H). |
| 116 | δ 0.95(d, 6H), 1.3-1.5(m, 2H), 1.5-1.7(m, 2H), 1.8(s, 3H), |
| | 1.8-1.95(m, 1H), 2.2(s, 3H), 3.0(s, 6H), 4.8(t, 2H), 6.8(s, 1H). |
| 126 | δ 0.95(d, 6H), 1.3(t, 2H), 1.6(m, 1H), 1.8(m, 2H), 3.0(s, 6H), 3.9(t, 2H), |
| | 6.9(s, 1H), 7.4(s, 1H). |
| 127 | δ 0.9(d, 6H), 1.2(d, 6H), 1.3(m, 2H), 1.6(m, 1H), 1.8(m, 2H), |
| | 3.05(s, 3H), 3.95(t, 2H), 5.40(m, 1H), 6.8(s, 1H), 6.9(s, 1H), 7.80(s, 1H). |
| 128 | δ 0.00(s, 9H) 0.62(m, 2H), 2.1(s, 3H), 3.00(s, 6H), 3.55(s, 3H), |
| | 3.85(t, 2H), 6.4(s, 1H), 6.6(s, 1H). |
| 129 | δ 0.0(s, 9H), 0.6(m, 2H), 1.2(t, 2H), 1.8(m, 2H), 2.08(s, 3H), |
| | 2.93(s, 3H), 3.3(q, 2H), 3.52(s, 3H), 3.8(t, 2H), 6.652(s, 1H), 6.66(s, 1H). |
| 130 | δ 0.0(s, 9H), 0.6(m, 2H), 1.8(m, 2H), 2.1(s, 3H), 3.0(s, 6H), 3.6(t, 2H), |
| | 6.8(d, 2H). |
| 131 | δ 0.00(s, 9H), 0.62(m, 2H), 1.2(t, 3H), 1.8(s, 3H), 2.1(s, 6H), |
| | 3.00(s, 3H), 3.3(q, 2H), 3.5(s, 3H), 3.9(t, 2H), 6.45(s, 1H), 6.6(s, 1H). |
| 132 | δ 0.89(d, 6H), 1.34(m, 2H), 1.587(m, 1H), 1.8(m, 2H), 2.2(s, 3H), |
| | 2.26(s, 3H), 2.96(s, 6H), 3.78(t, 2H), 6.43(s, 1H), 7.3(s, 1H). |
| 135 | δ 0.89(s, 9H), 1.35(m, 2H), 1.8(m, 2H), 2.2(s, 3H), 2.25(s, 3H), |
| | 3.0(s, 6H), 3.8(t, 2H), 6.45(s, 1H), 7.3(s, 1H). |
| 137 | δ 0.95(d, 6H), 1.3(t, 3H), 1.4(m, 2H), 1.6(m, 1H), 1.85(m, 2H), |
| | 2.3(s, 6H), 3.35(s, 3H), 3.9(m, 4H), 6.7(s, 1H), 6.95(s, 1H). |
| 140 | δ 0.0(s, 9H), 0.5-0.65(m, 2H), 1.2(t, 3H), 1.6-1.85(m, 2H), 2.2(s, 3H), |
| | 2.25(s, 3H), 2.95(s, 3H), 3.3(br s, 2H), 3.75(t, 2H), 6.4(s, 1H), 7.3(s, 1H). |
| 141 | δ 0.9(m, 6H), 1.2-1.25(m, 6H), 1.4-1.5(m, 4H), 2.2(s, 3H), 2.3(s, 3H), |
| | 2.9(m, 1H), 3.0(s, 6H), 6.6(s, 1H), 7.15(s, 1H), 7.2(s, 1H). |
| 142 | δ 0.9(m, 6H), 1.2-1.7(m, 10H), 1.75(s, 3H), 1.95(s, 3H), 2.1(s, 3H), |
| | 3.0(s, 6H), 4.1(m, 1H), 6.45(s, 1H), 6.6(s, 1H). |
| 143 | δ 0.9(m, 6H), 1.2-1.5(m, 8H), 1.6(m, 4H), 1.8(s, 3H), 2.0(s, 3H), |
| | 2.1(s, 3H), 3.0(s, 6H), 4.1(m, 1H), 6.4(s, 1H), 6.7(s, 1H). |
| 144 | δ 0.8-0.9(m, 6H), 1.1(d, 3H), 1.2-1.6(m, 5H), 2.05(s, 3H), 2.2(s, 3H), |
| | 2.95(s, 6H), 3.4(m, 1H), 6.4(s, 1H), 7.4(s, 1H). |
| 145 | δ 0.8-0.9(m, 6H), 1.1-1.5(m, 16H), 1.2-1.6(m, 5H), 2.0(s, 3H), |
| | 2.2(s, 3H), 2.9(s, 6H), 3.3(m, 1H), 6.4(s, 1H), 6.45(s, 1H), 7.4(s, 1H). |
| 146 | δ 0.9(m, 6H), 1.25-1.5(m, 8H), 2.0(s, 3H), 2.2(s, 3H), 3.0(s, 6H), |
| | 3.35(m, 1H), 6.4(s, 1H), 6.45(s, 1H), 7.4(s, 1H). |
| 147 | δ 0.85(s, 9H), 0.95(d, 3H), 1.2(m, 2H), 145(m, 1H), 1.6(m, 2H), 2.0(s, 3H), |
| | 2.2(s, 3H), 3.0(s, 6H), 3.1(m, 1H), 6.4(s, 1H), 6.5(s, 1H), 7.2(s, 1H). |
| 148 | δ 0.8-0.9(m, 9H), 1.2-1.3(m, 6H), 1.4-1.5(m, 5H), 2.0(s, 3H), 2.2(s, 3H), |
| | 3.0(s, 6H), 3.3(m, 1H), 6.4(s, 1H), 6.5(s, 1H), 7.4(s, 1H). |
| 149 | δ 0.8-0.9(m, 9H), 1.15-1.3(m, 2H), 1.4-1.6(m, 5H), 2.0(s, 3H), |
| | 2.2(s, 3H), 2.95(s, 6H), 3.2(m, 1H), 6.4(s, 1H), 6.5(s, 1H), 7.4(s, 1H). |
| 150 | δ 0.8-0.9(m, 6H), 1.2-1.4(m, 8H), 1.4-1.5(m, 4H), 2.0(s, 3H), 2.2(s, 3H), |
| | 2.95(s, 6H), 3.3(m, 1H), 6.35(s, 1H), 6.45(s, 1H), 7.35(s, 1H). |
| 151 | δ 0.8-0.9(m, 12H), 1.1-1.3(m, 4H), 1.4-1.5(m, 6H), 2.0(s, 3H), |
| | 2.2(s, 3H), 2.95(s, 6H), 3.25(m, 1H), 6.35(s, 1H), 6.45(s, 1H), 7.35(s, 1H). |
| 152 | δ 0.9(m, 3H), 1.4-1.7(m, 6H), 1.7(m, 3H), 2.1(s, 3H), 2.2(s, 3H), |
| | 3.0(s, 6H), 3.3(m, 1H), 4.7(d, 2H), 6.4(s, 1H), 6.55(s, 1H), 7.4(s, 1H). |
| 153 | δ 1.3(s, 9H), 2.1(s, 3H), 2.2(s, 3H), 2.8(t, 2H), 2.95(s, 6H), 3.3(t, 2H), |
| | 6.4(s, 1H), 6.5(s, 1H), 7.4(s, 1H). |
| 154 | δ 0.9(dd, 6H), 1.2-1.3(m, 2H), 1.5-1.7(m, 3H), 2.05(s, 3H), 2.2(s, 3H), |
| | 2.95(s, 6H), 3.05(m, 2H), 6.45(s, 1H), 6.5(s, 1H), 7.35(s, 1H). |
| 155 | δ 0.95(t, 6H), 1.3-1.7(m, 12H), 2.25(s, 3H), 2.4(s, 3H), 2.9(m, 1H), |
| | 3.0(s, 6H), 6.6(s, 1H), 7.2(s, 1H), 7.4(s, 1H). |
| 156 | δ 0.9(d, 6H), 1.4(m, 2H), 1.6(m, 2H), 2.2(s, 3H), 2.4(s, 3H), 2.8(t, 2H), |
| | 3.0(s, 6H), 6.6(s, 1H), 7.1(s, 1H), 7.4(s, 1H). |
| 157 | δ 0.95(t, 6H), 1.2-1.6(m, 10H), 2.25(s, 3H), 2.4(s, 3H), 2.9(m, 1H), |
| | 3.0(s, 6H), 6.6(s, 1H), 7.2(s, 1H), 7.4(s, 1H). |
| 158 | δ 0.85(s, 9H), 0.95(d, 3H), 1.4(m, 2H), 2.25(s, 3H), 2.4(s, 3H), |
| | 2.8(m, 2H), 3.0(s, 6H), 6.55(s, 1H), 7.05(s, 1H), 7.4(s, 1H). |
| 159 | δ 0.85(d, 12H), 1.25-1.6(m, 10H), 2.25(s, 3H), 2.40(s, 3H), |
| | 2.95(m, 1H), 3.05(s, 6H), 6.60(s, 1H), 7.20(s, 1H), 7.45(s, 1H). |
| 160 | δ 0.9(t, 6H), 1.25-1.6(m, 10H), 2.2(s, 3H), 2.35(s, 3H), 2.9(m, 1H), |
| | 3.0(s, 6H), 6.5(s, 1H), 7.25(s, 1H), 7.4(s, 1H). |
| 161 | δ 0.9(t, 3H), 1.0(m, 2H), 1.6(s, 3H), 2.25(s, 3H), 2.4(s, 3H), 3.05(s, 6H), |
| | 3.1(m, 1H), 4.7(m, 2H), 6.55(s, 1H), 7.20(s, 1H), 7.45(s, 1H). |
| 162 | δ 0.9(d, 6H), 1.0(t, 3H), 1.3-1.7(m, 5H), 2.20(s, 3H), 2.4(s, 3H), |
| | 2.9(m, 1H), 3.0(s, 6H), 6.6(s, 1H), 7.20(s, 1H), 7.45(s, 1H). |
| 163 | δ 0.00(s, 9H), 0.60(m, 2H), 1.30(t, 6H), 1.75(m, 2H), 2.15(s, 3H), |
| | 2.3(s, 3H), 3.45(q, 4H), 3.85(t, 2H), 6.65(s, 1H), 6.90(s, 1H), 7.35(s, 1H). |
| 165 | δ 1.25(s, 9H), 2.15(s, 3H), 2.25(s, 3H), 2.8(s, 3H), 3.5(s, 6H), |
| | 3.65(m, 2H), 3.95(m, 2H), 6.65(s, 1H), 6.85(s, 1H). |
| 167 | δ 0.00(s, 9H), 0.60(m, 2H), 1.65(m, 2H), 2.15(s, 3H), 2.25(s, 3H), |
| | 3.3(s, 6H), 3.85(t, 2H), 6.62(s, 1H), 6.75(br s, 1H), 6.9(s, 1H). |
| 173 | δ 0.00(s, 9H), 0.62(m, 2H), 1.72(s, 3H), 1.8(m, 2H), 1.96(s, 3H), |
| | 3.05(s, 6H), 3.88(t, 2H), 6.62(s, 1H), 6.73(s, 1H). |
| 174 | δ 1.40(s, 9H), 2.32(s, 3H), 2.35(s, 3H), 3.00(s, 6H), 3.55(s, 2H), |
| | 6.60(s, 1H), 7.38(s, 1H), 7.60(s, 1H), 8.70(br s, 1H). |
| 175 | δ 0.80(s, 9H), 1.20-1.40(m, 4H), 1.8(s, 3H), 3.0(s, 6H), 3.9(t, 2H), 6.60 |
| | (s, 1H), 6.70(s, 1H), 7.25(s, 1H). |
| 176 | δ 0.80(s, 9H), 1.30(m, 2H), 1.5(m, 2H), 1.8(s, 3H), 2.0(s, 3H), |
| | 3.0(s, 6H), 3.95(t, 2H), 6.60(s, 1H), 6.70(s, 1H). |
| 177 | δ 0.90(s, 9H), 1.25(m, 2H), 1.45(t, 6H), 1.80(m, 2H) 2.20,(s, 3H), |
| | 3.80(q, 4H), 3.95(t, 2H), 6.40(bs, 1H), 6.50(s, 1H), 7.20(s, 1H) |
| 182 | δ 0.00(s, 9H), 0.60(m, 2H), 1.80(m, 2H), 2.15(s, 3H), 2.95(s, 6H), |
| | 3.85(t, 2H), 6.65(s, 1H), 7.4(s, 1H). |
| 191 | δ 0.92(s, 9H), 1.26-1.35(m, 8H), 1.75(m, 2H), 2.15(s, 3H), 2.2(s, 3H), |
| | 3.75(q, 4H), 3.9(t, 2H), 6.6(s, 1H), 6.7(s, 1H), 6.9(s, 1H). |
| 196 | δ 0.00(s, 9H), 0.6(m, 2H), 1.15(t, 3H), 1.7(m, 2H), 2.13(s, 3H), |
| | 2.19(s, 3H), 2.93(s, 3H), 3.3(m, 2H), 3.83(t, 2H), 6.5(s, 1H), 6.59(s, 1H), |
| | 7.36(br s, 1H), |
| 197 | δ 0.9(d, 6H), 1.15(t, 3H), 1.3-1.45(m, 2H), 1.5-1.7(m, 1H), |
| | 1.7-1.9(m, 2H), 2.2(s, 3H), 2.9(s, 3H), 3.3(m, 2H), 3.9(t, 2H), 6.7(s, 1H), |
| | 6.8(s, 1H), 7.4(br s, 1H). |
| 198 | δ 0.95(d, 6H), 1.15(t, 3H), 1.25(d, 3H), 1.35(m, 2H), 1.55(m, 2H), |
| | 1.7(m, 1H), 2.1(s, 3H), 2.9(s, 3H), 3.3(br s, 2H), 4.2(m, 1H), 6.7(s, 1H), 7.4(s, 1H). |
| 199 | δ 0.9(d, 9H), 1.18(t, 3H), 1.3(m, 2H), 1.7(m, 2H), 2.17(s, 3H), |
| | 2.2(s, 3H), 2.95(s, 3H), 3.3(br m, 2H), 3.85(t, 2H), 6.5(s, 1H), 6.6(s, 1H), |
| | 7.3(s, 1H). |
| 200 | δ 0.9(d, 6H), 1.18(t, 2H), 1.3(m, 2H), 1.55(m, 1H), 1.78(m, 2H), |
| | 2.2(s, 3H), 2.26(s, 3H), 2.94(s, 3H), 3.3(br m, 2H), 3.78(t, 2H), 6.4(s, 1H), |
| | 7.3(s, 1H). |
| 201 | δ 0.9(d, 9H), 1.18(t, 3H), 1.3(m, 2H), 1.7(m, 2H), 2.2(s, 3H), |
| | 2.26(s, 3H), 2.94(s, 3H), 3.3(br m, 2H), 3.78(t, 2H), 6.4(s, 1H), 7.3(s, 1H). |
| 202 | δ 0.02(s, 9H), 0.62(m, 2H), 1.2(t, 3H), 1.82(m, 2H), 3(s, 3H), |
| | 3.2-3.6(m, 2H), 3.82(s, 3H), 3.95(t, 2H), 6.51(s, 1H), 6.79(s, 1H), 7.47(br, |
| | 1H). |
| 203 | δ 0.02(s, 9H), 0.62(m, 2H), 1.22(t, 3H), 1.82(m, 2H), 2.4(s, 3H), |
| | 3.01(s, 3H), 3.2-3.6(m, 2H), 3.96(t, 2H), 6.69(s, 1H), 6.79(s, 1H), |
| | 7.3-7.53(br, 1H). |
| 205 | δ 0.02(s, 9H), 0.65(m, 2H), 1.24(d, 6H), 1.82(m, 2H), 2.4(s, 3H), |
| | 2.94(br s, 3H), 3.64(m, 1H), 3.96(t, 2H), 6.69(s, 1H), 6.79(s, 1H), 7.6(s, 1H). |
| 206 | δ 0.02(s, 9H), 0.62(m, 2H), 0.92(t, 3H), 1.62(m, 2H), 1.82(m, 2H), |
| | 2.4(s, 3H), 3.02(s, 3H), 3.1-3.5(m, 2H), 3.96(t, 2H), 6.69(s, 1H), 6.79(s, |
| | 1H), 7.45(br s, 1H). |
| 207 | δ 0.02(s, 9H), 0.62(m, 2H), 1.82(m, 2H), 2.23(s, 3H), 2.27(s, 1H), |
| | 3.04(s, 3H), 3.93(t, 2H), 4.17(br s, 2H), 6.74(s, 1H), 6.78(s, 1H), 7.4(s, |
| | 1H). |
| 208 | δ 0.02(s, 9H), 0.61(m, 2H), 1.23(t, 3H), 1.8(m, 2H), 2.16(s, 3H), |
| | 3.01(s, 3H), 3.1-3.6(m, 2H), 3.93(t, 2H), 6.72(s, 1H), 7.22(br s, 1H). |
| 209 | δ 0.02(s, 9H), 0.6(m, 2H), 1.8(m, 2H), 2.23(s, 3H), 2.43(m, 2H), |
| | 3.93(t, 2H), 4.3(t, 4H), 6.72(s, 1H), 6.75(s, 1H), 7.31(s, 1H). |

^{a1}H NMR data are in ppm downfield from tetramethylsilane. Couplings are designated by (s)-singlet, (d)-doublet, (t)-triplet, (q)-quartet, (m)-multiplet, (dd)-doublet of doublets, (dt)-doublet of triplets, (br s)-broad singlet.

### BIOLOGICAL EXAMPLES OF THE INVENTION

General protocol for preparing test suspensions: Test compounds were first dissolved in acetone in an amount equal to 3% of the final volume and then suspended at the desired concentration (in ppm) in acetone and purified water (50/50 mix) containing 250 ppm of the surfactant Trem® 014 (polyhydric alcohol esters). The resulting test suspensions were then used in the following tests. Spraying a 200 ppm test suspension to the point of run-off on the test plants was the equivalent of a rate of 500 g/ha.

### Test A

The test suspension was sprayed to the point of run-off on wheat seedlings. The following day the seedlings were inoculated with a spore dust of Erysiphe graminis f. sp. tritici, (the causal agent of wheat powdery mildew) and incubated in a growth chamber at 20° C. for 7 days, after which disease ratings were made.

### Test B

The test suspension was sprayed to the point of run-off on wheat seedlings. The following day the seedlings were inoculated with a spore suspension of Puccinia recondita (the causal agent of wheat leaf rust) and incubated in a saturated atmosphere at 20° C. for 24 h, and then moved to a growth chamber at 20° C. for 6 days, after which disease ratings were made.

### Test C

The test suspension was sprayed to the point of run-off on wheat seedlings. The following day the seedlings were inoculated with a spore suspension of Septoria nodorum (the causal agent of Septoria glume blotch) and incubated in a saturated atmosphere at 20° C. for 48 h, and then moved to a growth chamber at 20° C. for 9 days, after which disease ratings were made.

Results for Tests A-C are given in Table A. In the table, a rating of 100 indicates 100% disease control and a rating of 0 indicates no disease control (relative to the controls). A dash (-) indicates no test results.

TABLE A

| Cmpd No. | Test A | Test B | Test C |
|---|---|---|---|
| 1 | 32 | 100 | 92 |
| 2 | 95 | 100 | 36 |
| 3 | 0 | 87 | 0 |
| 4 | 0 | 92 | 0 |
| 5 | 0 | 100 | 89 |
| 6 | 0 | 100 | 60 |
| 7 | 0 | 0 | 0 |
| 8 | 97 | 100 | 98 |
| 9 | 98 | 100 | 97 |
| 10 | 97 | 100 | 0 |
| 11 | 97 | 100 | 100 |
| 12 | 97 | 100 | 80 |
| 13 | 97 | 100 | 100 |
| 14 | 90 | 100 | 0 |
| 15 | 94 | 100 | 0 |
| 16 | 88 | 100 | 97 |
| 17 | 92 | 100 | 100 |
| 18 | 98 | 100 | 98 |
| 19 | 96 | 100 | 100 |
| 20 | 96 | 100 | 99 |
| 21 | 98 | 100 | 96 |
| 22 | 98 | 100 | 88 |
| 23 | 97 | 98 | 13 |
| 24 | 86 | 23 | 0 |
| 25 | 0 | 90 | 0 |
| 26 | 98 | 100 | 100 |
| 27 | 99 | 100 | 100 |
| 28 | 0 | 97 | 0 |
| 29 | 99 | 100 | 58 |
| 30 | 0 | 100 | 0 |
| 31 | 93 | 100 | 53 |
| 32 | 97 | 100 | 95 |
| 33 | 95 | 100 | 0 |
| 34 | 96 | 100 | 0 |
| 35 | 95 | 100 | 100 |
| 36 | 88 | 100 | 0 |
| 37 | — | — | — |
| 38 | 96 | 100 | 20 |
| 39 | 0 | 100 | 94 |
| 40 | 97 | 100 | 100 |
| 41 | 79 | 99 | 47 |
| 42 | 96 | 99 | 63 |
| 43 | 96 | 100 | 93 |
| 44 | 99 | 100 | 99 |
| 45 | 0 | 80 | 0 |
| 46 | 97 | 100 | 97 |
| 47 | 29 | 99 | 80 |
| 48 | 99 | 100 | 96 |
| 49 | 99 | 99 | 83 |
| 50 | 99 | 67 | 100 |
| 51 | 96 | 100 | 100 |
| 52 | 100 | 100 | 99 |
| 53 | 100 | 100 | 99 |
| 54 | 100 | 100 | 100 |
| 55 | 0 | 19 | 0 |
| 56 | 100 | 100 | 100 |
| 57 | 100 | 100 | 100 |
| 58 | 100 | 100 | 100 |
| 59 | 100 | 100 | 100 |
| 60 | 100 | 100 | 100 |
| 61 | 100 | 100 | 100 |
| 62 | 100 | 100 | 100 |
| 63 | 100 | 100 | 100 |
| 64 | 100 | 100 | 100 |
| 65 | 100 | 100 | 96 |
| 66 | — | — | — |
| 67 | — | — | — |
| 68 | — | — | — |
| 69 | — | — | — |
| 70 | — | — | — |
| 71 | — | — | — |
| 72 | — | — | — |
| 73 | 99 | 61 | 66 |
| 74 | 100 | 100 | 100 |
| 75 | 100 | 100 | 100 |
| 76 | 100 | 100 | 100 |
| 77 | 100 | 100 | 100 |
| 78 | 0 | 98 | 100 |
| 79 | 0 | 99 | 100 |
| 83 | 0 | 9 | 0 |
| 84 | 100 | 100 | 100 |
| 85 | 100 | 99 | 100 |
| 86 | 100 | 99 | 100 |
| 87 | — | — | — |
| 88 | — | — | — |
| 89 | — | — | — |
| 90 | — | — | — |
| 91 | 0 | 26 | 0 |
| 92 | 100 | 100 | 100 |
| 93 | 99 | 100 | 99 |
| 94 | 99 | 100 | 100 |
| 95 | 100 | 100 | 100 |
| 96 | 0 | 100 | 100 |
| 97 | 0 | 45 | 85 |
| 98 | 0 | 60 | 94 |
| 99 | 0 | 9 | 0 |
| 100 | 0 | 86 | 76 |
| 101 | 100 | 100 | 100 |
| 102 | 21 | 95 | 89 |
| 103 | 31 | 0 | 0 |
| 104 | 0 | 23 | 0 |
| 105 | 97 | 100 | 98 |
| 106 | 100 | 100 | 100 |
| 107 | 60 | 99 | 99 |
| 108 | 87 | 89 | 96 |
| 110 | 42 | 97 | 99 |
| 111 | 99 | 100 | 100 |
| 112 | 95 | 99 | 99 |
| 113 | 91 | 99 | 100 |
| 114 | 99 | 100 | 100 |
| 115 | 85 | 85 | 100 |
| 116 | 87 | 92 | 100 |
| 117 | 29 | 37 | 60 |
| 118 | 99 | 100 | 78 |
| 119 | 0 | 64 | 78 |
| 120 | 91 | 8 | 0 |
| 121 | 49 | 85 | 67 |
| 122 | 99 | 100 | 0 |
| 123 | 54 | 46 | 100 |
| 124 | 98 | 98 | 100 |
| 125 | 96 | 97 | 100 |
| 126 | 95 | 40 | 100 |
| 127 | 0 | 99 | 100 |
| 128 | 98 | 95 | 73 |
| 129 | 100 | 100 | 67 |
| 130 | 100 | 97 | 0 |
| 131 | 67 | 100 | 96 |
| 132 | 98 | 100 | 97 |
| 133 | 99 | 85 | 53 |
| 134 | 100 | 100 | 81 |
| 135 | 100 | 100 | 92 |
| 136 | 95 | 91 | 84 |
| 137 | 100 | 100 | 84 |
| 138 | 98 | 74 | 60 |
| 139 | 100 | 100 | 99 |
| 140 | 100 | 100 | 100 |
| 141 | 0 | 99 | 100 |
| 142 | 0 | 0 | 53 |
| 143 | 0 | 0 | 80 |
| 147 | 0 | 0 | 53 |
| 148 | 0 | 0 | 47 |
| 150 | 0 | 0 | 47 |
| 151 | 0 | 0 | 60 |
| 154 | 0 | 0 | 47 |
| 155 | 0 | 23 | 95 |
| 156 | 93 | 100 | 100 |
| 157 | 0 | 96 | 99 |
| 158 | 61 | 98 | 56 |
| 159 | 94 | 100 | 47 |
| 160 | 0 | 55 | 0 |
| 161 | 72 | 100 | 53 |
| 162 | 21 | 99 | 67 |
| 163 | 32 | 100 | 73 |
| 164 | 100 | 100 | 100 |
| 165 | 0 | 28 | 0 |
| 167 | 99 | 99 | 100 |
| 168 | 99 | 100 | 100 |
| 169 | 99 | 100 | 100 |
| 170 | 99 | 100 | 99 |
| 172 | 100 | 100 | 100 |
| 173 | 32 | 90 | 99 |
| 175 | 97 | 100 | 100 |
| 176 | 43 | 99 | 100 |
| 177 | 96 | 100 | 100 |
| 178 | 100 | 100 | 100 |
| 179 | 20 | 23 | 0 |
| 180 | 75 | 58 | 0 |
| 181 | 100 | 100 | 67 |
| 182 | 98 | 79 | 67 |
| 183 | 99 | 85 | 90 |
| 184 | 100 | 99 | 78 |
| 185 | 99 | 98 | 63 |
| 186 | 94 | 9 | 0 |
| 187 | 100 | 99 | 78 |
| 188 | 100 | 79 | 90 |
| 189 | 0 | 9 | 0 |
| 190 | 0 | 68 | 0 |
| 191 | 63 | 99 | 91 |
| 192 | 99 | 100 | 100 |
| 193 | 0 | 23 | 0 |
| 194 | 99 | 100 | 100 |
| 196 | 100 | 100 | 100 |
| 197 | 100 | 100 | 100 |
| 198 | 100 | 100 | 100 |
| 199 | 100 | 100 | 100 |
| 200 | 100 | 100 | 100 |
| 201 | 100 | 100 | 100 |

1. A compound of Formula I and or an agriculturally suitable salt thereof, 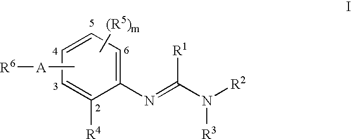
wherein:
R¹ is H, OH, SH, SO₃H, CN, —OR⁷ or —SR⁷; C₁-C₁₀ alkyl, C₂-C₁₀ alkenyl, C₂-C₅ alkoxycarbonyl, C₂-C₁₀ alkynyl, a C₃-C₆ carbocycle or a 3-, 4-, 5- or 6-membered heterocycle, each optionally substituted; provided that when R¹ is a heterocycle containing nitrogen as a ring member, it is not attached to the remainder of Formula I through said nitrogen ring member;
R² is H, CN, —OR⁷, or —SR⁷; C₁-C₁₀ alkyl, C₂-C₁₀ alkenyl, C₂-C₁₀ alkynyl, C₃-C₆ carbocycle, a 3-, 4-, 5- or 6-membered heterocycle or C₂-C₁₀ alkylcarbonyl, each optionally substituted;
R³ is H; C₁-C₁₀ alkyl, C₂-C₁₀ alkenyl, C₂-C₁₀ alkynyl, a C₃-C₆ carbocycle, a 3-, 4-, 5- or 6-membered heterocycle or C₂-C₁₀ alkylcarbonyl, each optionally substituted; or
R² and R³ are taken together with their interconnecting nitrogen to form a heterocyclic ring containing 3 to 7 atoms, said ring consisting of said interconnecting nitrogen atom, carbon and optionally one or two additional atoms selected from the group consisting of nitrogen, sulfur and oxygen, and said ring being optionally substituted with one or more R⁹;
R⁴ and each R⁵ are each independently C₁-C₆ alkyl, C₂-C₆ alkenyl, C₂-C₆ alkynyl, C₃-C₆ cycloalkyl, C₁-C₆ haloalkyl, C₂-C₆ haloalkenyl, C₂-C₆ haloalkynyl, C₃-C₆ halocycloalkyl, halogen, CN, CHO, CO₂H, CONH₂, SF₅, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₁-C₄ alkylamino, C₂-C₈ dialkylamino, C₃-C₆ cycloalkylamino, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl;
R⁶ is C₅-C₂₁ alkyl, C₅-C₂₁ alkenyl, C₅-C₂₁ alkynyl, C₄-C₉ alkoxycarbonyl, C₄-C₆ alkylaminocarbonyl, C₃-C₁₀ dialkylaminocarbonyl or C₃-C₁₂ trialkylsilyl, each optionally substituted; or R⁶ is C₁-C₄ alkyl or C₂-C₉ alkylcarbonyl, each substituted with one or more R¹²;
A is a direct bond, O, S(O), or NR¹⁰;
each R⁷ is independently C₁-C₆ alkyl, C₂-C₆ alkenyl, C₂-C₆ alkynyl, a C₃-C₆ carbocycle or a 3-, 4-, 5- or 6-membered heterocycle, each optionally substituted;
each R⁹ is independently halogen, CN, NO₂, C₁-C₄ alkoxy, C₁-C₄ alkyl, C₁-C₄ haloalkoxy or C₁-C₄ alkylthio;
R¹⁰ is H, C₁-C₆ alkyl, C₂-C₆ alkenyl, C₂-C₆ alkynyl, C₁-C₄ alkylsulfonyl, C₁-C₄ haloalkylsulfonyl, C₂-C₆ alkylcarbonyl, C₂-C₆ alkoxycarbonyl, C₂-C₆ alkylaminocarbonyl, C₃-C₈ dialkylaminocarbonyl or C₃-C₆ trialkylsilyl;
each R¹² is independently CO₂H, CONH₂, NO₂, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₃-C₁₀ alkylaminoalkylcarbonyl, C₃-C₈ dialkylaminocarbonyl, C₄-C₈ dialkylaminoalkylcarbonyl, C₃-C₉ alkylthioalkylcarbonyl, C₃-C₉ halotrialkylsilyl, C₄-C₉ alkoxytrialkylsilyl, C₃-C₉ trialkylsilyl or C₃-C₉ trialkylsilyloxy;
n is 0, 1 or 2; and
m is 0, 1, 2 or 3.

2. A compound of claim 1 wherein:
R¹ is H, SH, SO₃H, CN, —OR⁷ or —SR⁷; C₁-C₁₀ alkyl, C₂-C₁₀ alkenyl or C₂-C₁₀ alkynyl, each optionally substituted with one or more R⁸; or a C₃-C₆ carbocycle or a 3-, 4,5- or 6-membered heterocycle, each optionally substituted with one or more R⁹;
R² is H, CN, —OR⁷ or —SR⁷; C₁-C₁₀ alkyl, C₂-C₁₀ alkenyl, C₂-C₁₀ alkynyl or C₂-C₁₀ alkylcarbonyl, each optionally substituted with one or more R⁸; or a C₃-C₆ carbocycle or a 3-, 4,5- or 6-membered heterocycle, each optionally substituted with one or more R⁹;
R³ is H; C₁-C₁₀ alkyl, C₂-C₁₀ alkenyl, C₂-C₁₀ alkynyl or C₂-C₁₀ alkylcarbonyl, each optionally substituted with one or more R⁸; or a C₃-C₆ carbocycle or a 3-, 4-, 5- or 6-membered heterocycle, each optionally substituted with one or more R⁹; or
R² and R³ are taken together with their interconnecting nitrogen to form a heterocyclic ring containing 3 to 7 atoms, said ring consisting of said interconnecting nitrogen atom, carbon and optionally one or two additional atoms selected from the group consisting of nitrogen, sulfur and oxygen, and said ring being optionally substituted with one or more R⁹;
R⁶ is C₅-C₂₁ alkyl, C₅-C₂₁ alkenyl, C₅-C₂₁ alkynyl, C₄-C₉ alkoxycarbonyl, C₄-C₆ alkylaminocarbonyl, C₃-C₁₀ dialkylaminocarbonyl or C₃-C₁₂ trialkylsilyl, each optionally substituted with one or more R¹¹; or R⁶ is C₁-C₄ alkyl or C₂-C₉ alkylcarbonyl, each substituted with one or more R¹²;
each R⁷ is independently C₁-C₆ alkyl, C₂-C₆ alkenyl, C₂-C₆ alkynyl, each optionally substituted with one or more R⁸; or a C₃-C₆ carbocycle or a 3-, 4,5- or 6-membered heterocycle, each optionally substituted with one or more R⁹;
each R⁸ is independently halogen, CN, NO₂, C₁-C₄ alkoxy, C₁-C₄ haloalkoxy or C₁-C₄ alkylthio; and
each R¹¹ is independently halogen, CO₂H, CONH₂, NO₂, hydroxy, C₁-C₆ alkoxy, C₁-C₆ haloalkoxy, C₂-C₆ alkylthio, C₁-C₆ alkylsulfinyl, C₁-C₆ alkylsulfonyl, C₁-C₆ haloalkylthio, C₁-C₆ haloalkylsulfinyl, C₁-C₆ haloalkylsulfonyl, C₁-C₆ alkylamino, C₂-C₈ dialkylamino, C₂-C₆ alkylcarbonyl, C₂-C₆ alkoxycarbonyl, C₃-C₉ alkoxyalkylcarbonyl, C₂-C₆ alkylaminocarbonyl, C₄-C₁₀ alkylaminoalkylcarbonyl, C₃-C₈ dialkylaminocarbonyl, C₄-C₈ dialkylaminoalkylcarbonyl, C₃-C₉ alkylthioalkylcarbonyl, C₂-C₈ dialkylphosphoryl, C₂-C₈ dialkylphosphinyl, C₃-C₉ trialkylsilyl or C₃-C₉ trialkylsilyloxy.

3. A compound of claim 2 wherein
R¹ is H, SH or C₁-C₁₀ alkyl,
R² is H, CN, —OR⁷ or —SR⁷; C₁-C₁₀ alkyl, C₂-C₁₀ alkenyl, C₂-C₁₀ alkynyl, each optionally substituted with one or more R⁸; or phenyl optionally substituted with 1 to 3 R⁹;
R³ is H; C₁-C₁₀ alkyl, C₂-C₁₀ alkenyl or C₂-C₁₀ alkynyl, each optionally substituted with one or more R⁸; or phenyl optionally substituted with 1 to 3 R⁹; or
R² and R³ are taken together with their interconnecting nitrogen to form a heterocyclic ring containing 3 to 7 atoms, said ring consisting of said interconnecting nitrogen atom, carbon and optionally one or two additional atoms selected from the group consisting of nitrogen, sulfur and oxygen, and said ring being optionally substituted with one or more R⁹;
R⁴ and R⁵ are each independently C₁-C₆ alkyl, C₂-C₆ alkenyl, C₂-C₆ alkynyl, C₁-C₆ haloalkyl, halogen, CO₂H, CONH₂, C₁-C₄ alkoxy, C₁-C₄ haloalkoxy, C₁-C₄ alkylthio, C₁-C₄ alkylsulfinyl, C₁-C₄ alkylsulfonyl, C₁-C₄ haloalkylthio, C₁-C₄ haloalkylsulfinyl, C₁-C₄ haloalkylsulfonyl, C₂-C₆ alkylcarbonyl, C₂-C₆ alkoxycarbonyl, C₁-C₆ alkylaminocarbonyl, CN, CHO or C₃-C₈ dialkylaminocarbonyl;
R⁶ is C₅-C₁₅ alkyl, C₅-C₁₅ alkenyl or C₅-C₁₅ alkynyl, each optionally substituted with one or more R¹¹; or R⁶ is C₁-C₄ alkyl substituted with one or more R¹²;
each R⁷ is independently C₁-C₆ alkyl, optionally substituted with one or more R⁸;
A is a direct bond, O or S(O)ₙ; and
m is 0, 1 or 2.

4. A compound of claim 3 wherein
A is attached to the remainder of Formula I at the 4 position of the benzene ring.

5. A compound of claim 4 wherein
R² and R³ are each independently H or C₁-C₁₀ alkyl; or
R² and R³ are taken together with their interconnecting nitrogen to form a heterocyclic ring containing 3 to 7 atoms, said ring consisting of said interconnecting nitrogen atom, carbon and optionally one or two additional atoms selected from the group consisting of nitrogen, sulfur and oxygen, and said ring being optionally substituted with one or more R⁹;
R⁴ and R⁵ are each independently halogen, CN, CHO, C₁-C₆ alkyl, C₁-C₄ alkoxy, C₁-C₄ haloalkoxy, C₁-C₄ alkylthio, C₁-C₄ alkylsulfinyl, C₁-C₄ haloalkylthio, C₁-C₄ haloalkylsulfinyl or C₁-C₆ haloalkyl;
One R⁵ is attached to the remainder of Formula I at the 5 position of the benzene ring and an optional second R⁵ is attached at the 6 position of the benzene ring, and m is 1 or 2.

6. A compound of claim 5 wherein
R¹ is H; and
R⁶ is C₆-C₁₅ alkyl wherein at least one of the fourth and fifth carbon from A has one or no hydrogen attached or C₅-C₁₅ 2-alkenyl wherein the fourth or fifth carbon from A has one or no hydrogen attached.

7. A compound of claim 5 wherein
R¹ is H; and
R⁶ is C₁-C₄ alkyl substituted with one or more substituents selected from the group consisting of C₂-C₆ alkylthio, C₁-C₆ alkylsulfinyl, C₂-C₆ alkoxycarbonyl, C₂-C₈ dialkylamino, C₂-C₆ alkylcarbonyl, C₃-C₉ alkoxyalkylcarbonyl, C₂-C₆ alkylaminocarbonyl, C₃-C₈ dialkylaminocarbonyl, C₃-C₉ trialkylsilyl, C₃-C₉ halotrialkylsilyl, C₄-C₉ alkoxytrialkylsilyl or C₃-C₉ trialkylsilyloxy.

8. A fungicidal composition comprising a fungicidally effective amount of a compound of claim 1 and at least one additional component selected from the group consisting of surfactants, solid diluents and liquid diluents.

9. A fungicidal composition comprising a mixture of a compound of claim 1 and at least one other fungicide having a different mode of action.

10. A method for controlling plant diseases caused by fungal plant pathogens comprising applying to the plant or portion thereof, or to the plant seed or seedling, a fungicidally effective amount of a compound of claim 1.
